(19) United States
(12) Patent Application Publication
(10) Pub. No.: US 2009/0129992 A1
(43) Pub. Date: May 21, 2009

(54) Reactor for Preparing Hydrogen Compounds

(75) Inventor: Randell L. Mills, Yardley, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: BLACKLIGHT POWER, INC.

(21) Appl. No.: 12/153,613

(22) Filed: May 21, 2008

Related U.S. Application Data
(63) Continuation-in-part of application No. 09/110,694, filed on Jul. 7, 1998, now abandoned.
(60) Provisional application No. 60/053,378, filed on Jul. 22, 1997.
(60) Provisional application No. 60/068,913, filed on Dec. 29, 1997.
(60) Provisional application No. 60/074,006, filed on Feb. 9, 1998.
(60) Provisional application No. 60/080,647, filed on Apr. 3, 1998.

(51) Int. Cl. B01J 19/00

(52) U.S. Cl. 422/112; 422/211; 422/198; 422/186.3

(57) ABSTRACT

A reactor is provided to produce compounds comprising at least one neutral, positive, or negative increased binding energy hydrogen species having a binding energy greater than the binding energy of the corresponding ordinary hydrogen species, or greater than the binding energy of any hydrogen species for which the corresponding ordinary hydrogen species is unstable or is not observed; and at least one other element. The reactor comprises a vessel containing an electron source and a source of increased binding energy hydrogen atoms having a binding energy of about

$$\frac{13.6 eV}{{( \frac{1}{p} )}^{2}}$$

where p is an integer greater than 1. Electrons from said electron source react with increased binding energy hydrogen atoms from said source in said vessel thereby producing said compounds. The source of increased binding energy hydrogen atoms may be a hydrogen catalysis cell selected from a group consisting of an electrolytic cell, a gas cell, a gas discharge cell, and a plasma torch cell. The hydrogen catalysis cell comprises a second vessel containing a source of atomic hydrogen; at least one of a solid, molten, liquid, or gaseous catalyst having a net enthalpy of reaction of at least m/2·27 eV, where m is an integer, whereby the hydrogen atoms react with the catalyst in the second vessel thereby producing a hydrogen atom having a binding energy of about

$$\frac{13.6 eV}{{( \frac{1}{p} )}^{2}}$$

where p is an integer greater than 1.

### CROSS-REFERENCE TO RELATED APPLICATIONS

This is a continuation-in-part of co-pending application Ser. No. 09/009,294, filed Jan. 20, 1998. The priority of the following U.S. provisional applications is also claimed: Ser. No. 60/053,378, filed Jul. 22, 1997; Ser. No. 60/068,913, filed Dec. 29, 1997; Ser. No. 60/074,006, filed Feb. 9, 1998, and Ser. No. 60/080,647, filed Apr. 3, 1998.

### I. INTRODUCTION

1. Field of the Invention

This invention relates to a new composition of matter comprising a hydride ion having a binding energy greater than about 0.8 eV (hereinafter “hydrino hydride ion”). The new hydride ion may also be combined with a cation, such as a proton, to yield novel compounds.

2. Background of the Invention

2.1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in Mills, R., The Grand Unified Theory of Classical Quantum Mechanics, September 1996 Edition (“'96 Mills GUT”), provided by BlackLight Power, Inc., Great Valley Corporate Center, 41 Great Valley Parkway, Malvern, Pa. 19355; and in prior applications PCT/US96/07949, PCT/US94/02219, PCT/US91/8496, and PCT/US90/1998, the entire disclosures of which are all incorporated herein by reference (hereinafter “Mills Prior Publications”). The binding energy, of an atom, ion or molecule, also known as the ionization energy, is the energy required to remove one electron from the atom, ion or molecule.

A hydrogen atom having the binding energy given in Eq. (1) is hereafter referred to as a hydrino atom or hydrino. The designation for a hydrino of radius a_{H}/p , where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.21 eV (2)

where m is an integer.

This catalysis releases energy with a commensurate decrease in size of the hydrogen atom, rₙ=na_{H}. For example, the catalysis of H(n=1) to H(n=1/2) releases 40.8 eV, and the hydrogen radius decreases from a_{H} to

$$\frac{1}{2} {a}_{H} .$$

One such catalytic system involves potassium. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (2).

$$\begin{matrix}27.28 eV + {K}^{+} + H [ \frac{{a}_{H}}{p} ] \to K + {K}^{2 +} + H [ \frac{{a}_{H}}{( p + 1 )} ] + [ {( p + 1 )}^{2} - {p}^{2} ] \times 13.6 eV & ( 3 ) \\ K + {K}^{2 +} \to {K}^{+} + {K}^{+} + 27.28 eV & ( 4 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 5 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) \to {H}_{2} O ( l ) \qquad ( 6 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m 27.2 eV.

2.2 Hydride Ions

A hydride ion comprises two indistinguishable electrons bound to a proton. Alkali and alkaline earth hydrides react violently with water to release hydrogen gas which burns in air ignited by the heat of the reaction with water. Typically metal hydrides decompose upon heating at a temperature well below the melting point of the parent metal.

### II. SUMMARY OF THE INVENTION

Novel Compounds are Provided Comprising

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged. The other element provides the balancing charge to form a neutral compound. The former group of compounds is characterized by molecular and coordinate bonding; the latter group is characterized by ionic bonding.

The increased binding energy hydrogen species are formed by reacting one or more hydrino atoms with one or more of an electron, hydrino atom, a compound containing at least one of said increased binding energy hydrogen species, and at least one other atom, molecule, or ion other than an increased binding energy hydrogen species.

In one embodiment of the invention, a compound contains one or more increased binding energy hydrogen species selected from the group consisting of Hₙ, Hₙ⁻, and Hₙ⁺ where n is an integer from one to three.

According to a preferred embodiment of the invention, a compound is provided, comprising at least one increased binding energy hydrogen species selected from the group consisting of (a) hydride ion having a binding energy greater than about 0.8 eV (“increased binding energy hydride ion” or “hydrino hydride ion”); (b) hydrogen atom having a binding energy greater than about 13.6 eV (“increased binding energy hydrogen atom” or “hydrino”); (c) hydrogen molecule having a first binding energy greater than about 15.5 eV (“increased binding energy hydrogen molecule” or “dihydrino”); and (d) molecular hydrogen ion having a binding energy greater than about 16.4 eV (“increased binding energy molecular hydrogen ion” or “dihydrino molecular ion”).

The compounds of the present invention have one or more unique properties which distinguishes them from the same compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) stability at room temperature and above; and (f) stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solid probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), and 24.) differential scanning calorimetry (DSC).

According to the present invention, a hydride ion (H⁻) is provided having a binding energy greater than 0.8 eV. Hydride ions having a binding of about 3, 7, 11, 17, 23, 29, 36, 43, 49, 55, 61, 66, 69, 71 and 72 eV are provided. Compositions comprising the novel hydride ion are also provided.

The binding energy of the novel hydride ion is given by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 7 )$$

where p is an integer greater than one, s=1/2, π is pi, is Planck's constant bar, μₒ, is the permeability of vacuum, mₑ is the mass of the electron, μₑ is the reduced electron mass, aₒ is the Bohr radius, and e is the elementary charge.

The hydride ion of the present invention is formed by the reaction of an electron with a hydrino, that is, a hydrogen atom having a binding energy of about

$$\frac{13.6 eV}{{n}^{2}} , where n = \frac{1}{p}$$

and p is an integer greater than 1. The resulting hydride ion is referred to as a hydrino hydride ion, hereinafter designated as H⁻(n=1/p) or H⁻(1/p):

$$\begin{matrix}H [ \frac{{a}_{H}}{p} ] + {e}^{-} \to {H}^{-} ( n = 1 / p ) & ( 8 ) a \\ H [ \frac{{a}_{H}}{p} ] + {e}^{-} \to {H}^{-} ( 1 / p ) & ( 8 ) b\end{matrix}$$

The hydrino hydride ion is distinguished from an ordinary hydride ion comprising an ordinary hydrogen nucleus and two electrons having a binding energy of 0.8 eV. The latter is hereafter referred to as “ordinary hydride ion” or “normal hydride ion” The hydrino hydride ion comprises a hydrogen nucleus and two indistinguishable electrons at a binding energy according to Eq. (7).

The binding energies of the hydrino hydride ion, H⁻(n=1/p) as a function of p, where p is an integer, are shown in TABLE 1.

TABLE 1
The representative binding energy of the hydrino hydride ion
H⁻(n = 1/p) as a function of p, Eq. (7).

| | r₁ | Binding | Wavelength |
|---|---|---|---|
| Hydride Ion | (aₒ)^{a} | Energy^{b} (eV) | (nm) |
| H⁻(n = 1/2) | 0.9330 | 3.047 | 407 |
| H⁻(n = 1/3) | 0.6220 | 6.610 | 188 |
| H⁻(n = 1/4) | 0.4665 | 11.23 | 110 |
| H⁻(n = 1/5) | 0.3732 | 16.70 | 74.2 |
| H⁻(n = 1/6) | 0.3110 | 22.81 | 54.4 |
| H⁻(n = 1/7) | 0.2666 | 29.34 | 42.3 |
| H⁻(n = 1/8) | 0.2333 | 36.08 | 34.4 |
| H⁻(n = 1/9) | 0.2073 | 42.83 | 28.9 |
| H⁻(n = 1/10) | 0.1866 | 49.37 | 25.1 |
| H⁻(n = 1/11) | 0.1696 | 55.49 | 22.3 |
| H⁻(n = 1/12) | 0.1555 | 60.97 | 20.3 |
| H⁻(n = 1/13) | 0.1435 | 65.62 | 18.9 |
| H⁻(n = 1/14) | 0.1333 | 69.21 | 17.9 |
| H⁻(n = 1/15) | 0.1244 | 71.53 | 17.3 |
| H⁻(n = 1/16) | 0.1166 | 72.38 | 17.1 |

^{a}Equation (21), infra.
^{b}Equation (22), infra.

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.46 eV (“ordinary hydrogen molecule”); (d) hydrogen molecular ion, 16.4 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species selected from the group consisting of (a) a hydrogen atom having a binding energy of about

$$\frac{13.6 eV}{{( \frac{1}{p} )}^{2}}$$

where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )$$

where p is an integer, preferably an integer from 2 to 200, s=1/2, π is pi, is Planck's constant bar, μₒ is the permeability of vacuum, mₑ is the mass of the electron, μₑ is the reduced electron mass, aₒ is the Bohr radius, and e is the elementary charge; (c) H₄⁺(1/p); (d) a trihydrino molecular ion, H₃⁺(1/p), having a binding energy of about

$$\frac{22.6}{{( \frac{1}{p} )}^{2}} eV$$

where p is an integer, preferably an integer from 2 to 200; (e) a dihydrino having a binding energy of about

$$\frac{15.5}{{( \frac{1}{p} )}^{2}} eV$$

where p is an integer, preferably and integer from 2 to 200; (f) a dihydrino molecular ion with a binding energy of about

$$\frac{16.4}{{( \frac{1}{p} )}^{2}} eV$$

where p is an integer, preferably an integer from 2 to 200. “About” in the context herein means±10% of the calculated binding energy value.

The compounds of the present invention are preferably greater than 50 atomic percent pure. More preferably, the compounds are greater than 90 atomic percent pure. Most preferably, the compounds are greater than 98′ atomic percent pure.

According to one embodiment of the invention wherein the compound comprises a negatively charged increased binding energy hydrogen species, the compound further comprise one or more cations, such as a proton, or H₃⁺.

The compounds of the invention may further comprise one or more normal hydrogen atoms and/or normal hydrogen molecules, in addition to the increased binding energy hydrogen species.

The compound may have the formula MH, MH₂, or M₂H₂, wherein M is an alkali cation and H is an increased binding energy hydride ion or an increased binding energy hydrogen atom.

The compound may have the formula MHₙ wherein n is 1 or 2, M is an alkaline earth cation and H is an increased binding energy hydride ion or an increased binding energy hydrogen atom.

The compound may have the formula MHX wherein M is an alkali cation, X is one of a neutral atom such as halogen atom, a molecule, or a singly negatively charged anion such as halogen anion, and H is an increased binding energy hydride ion or an increased binding energy hydrogen atom.

The compound may have the formula MHX wherein M is an alkaline earth cation, X is a singly negatively charged anion, and H is an increased binding energy hydride ion or an increased binding energy hydrogen atom.

The compound may have the formula MHX wherein M is an alkaline earth cation, X is a double negatively charged anion, and H is an increased binding energy hydrogen atom.

The compound may have the formula M₂HX wherein M is an alkali cation, X is a singly negatively charged anion, and H is an increased binding energy hydride ion or an increased binding energy hydrogen atom.

The compound may have the formula MHₙ wherein n is an integer from 1 to 5, M is an alkaline cation and the hydrogen content Hₙ of the compound comprises at least one increased binding energy hydrogen species.

The compound may have the formula M₂Hₙ wherein n is an integer from 1 to 4, M is an alkaline earth cation and the hydrogen content Hₙ of the compound comprises at least one increased binding energy hydrogen species.

The compound may have the formula M₂XHₙ wherein n is an integer from 1 to 3, M is an alkaline earth cation, X is a singly negatively charged anion, and the hydrogen content Hₙ of the compound comprises at least one increased binding energy hydrogen species.

The compound may have the formula M₂X₂Hₙ wherein n is 1 or 2, M is an alkaline earth cation, X is a singly negatively charged anion, and the hydrogen content Hₙ of the compound comprises at least one increased binding energy hydrogen species.

The compound may have the formula M₂X₃H wherein M is an alkaline earth cation, X is a singly negatively charged anion, and H is an increased binding energy hydride ion or an increased binding energy hydrogen atom.

The compound may have the formula M₂XHₙ wherein n is 1 or 2, M is an alkaline earth cation, X is a double negatively charged anion, and the hydrogen content. Hₙ of the compound comprises at least one increased binding energy hydrogen species.

The compound may have the formula M₂XX′H wherein M is an alkaline earth cation, X is a singly negatively charged anion, X′ is a double negatively charged anion, and H is an increased binding energy hydride ion or an increased binding energy hydrogen atom.

The compound may have the formula MM′Hₙ wherein n is an integer from 1 to 3, M is an alkaline earth cation, M′ is an alkali metal cation and the hydrogen content Hₙ of the compound comprises at least one increased binding energy hydrogen species.

The compound may have the formula MM′XHₙ wherein n is 1 or 2, M is an alkaline earth cation, M′ is an alkali metal cation, X is a singly negatively charged anion and the hydrogen content Hₙ of the compound comprises at least one increased binding energy hydrogen species.

The compound may have the formula MM′XH wherein M is an alkaline earth cation, M′ is an alkali metal cation, X is a double negatively charged anion and H is an increased binding energy hydride ion or an increased binding energy hydrogen atom.

The compound may have the formula MM′XX′H wherein M is an alkaline earth cation, M′ is an alkali metal cation, X and X′ are singly negatively charged anion and H is an increased binding energy hydride ion or an increased binding energy hydrogen atom.

The compound may have the formula HₙS wherein n is 1 or 2 and the hydrogen content Hₙ of the compound comprises at least one increased binding energy hydrogen species.

The compound may have the formula MXX′Hₙ wherein n is an integer from 1 to 5, M is an alkali or alkaline earth cation, X is a singly or double negatively charged anion, X′ is Si, Al, Ni, a transition element, an inner transition element, or a rare earth element, and the hydrogen content Hₙ of the compound comprises at least one increased binding energy hydrogen species.

The compound may have the formula MAlHₙ wherein n is an integer from 1 to 0.6, M is an alkali or alkaline earth cation and the hydrogen content Hₙ of the compound comprises at least one increased binding energy hydrogen species.

The compound may have the formula MHₙ wherein n is an integer from 1 to 6, M is a transition element, an inner transition element, a rare earth element, or Ni, and the hydrogen content Hₙ of the compound comprises at least one increased binding energy hydrogen species.

The compound may have the formula MNiHₙ wherein n is an integer from 1 to 6, M is an alkali cation, alkaline earth cation, silicon, or aluminum, and the hydrogen content Hₙ of the compound comprises at least one increased binding energy hydrogen species.

The compound may have the formula MXHₙ wherein n is an integer from 1 to 6, M is an alkali cation, alkaline earth cation, silicon, or aluminum, X is a transition element, inner transition element, or a rare earth element cation, and the hydrogen content H, of the compound comprises at least one increased binding energy hydrogen species.

The compound may have the formula MXAlX′Hₙ wherein n is 1 or 2, M is an alkali or alkaline earth cation, X and X′ are either a singly negatively charged anion or a double negatively charged anion, and the hydrogen content H, of the compound comprises at least one increased binding energy hydrogen species.

The compound may have the formula TiHₙ wherein n is an integer from 1 to 4, and the hydrogen content Hₙ of the compound comprises at least one increased binding energy hydrogen species.

The compound may have the formula Al₂Hₙ wherein n is an integer from 1 to 4, and the hydrogen content Hₙ of the compound comprises at least one increased binding energy hydrogen species.

The compound may have the formula [KHₘKCO₃]ₙ wherein m and n are each an integer and the hydrogen content Hₘ of the compound comprises at least one increased binding energy hydrogen species.

The compound may have the formula [KHₘKNO₃]⁺ nX⁻ wherein m and n are each an integer, X is a singly negatively charged anion, and the hydrogen content Hₘ of the compound comprises at least one increased binding energy hydrogen species.

The compound may have the formula [KHKNO₃]ₙ wherein n is an integer and the hydrogen content H of the compound comprises at least one increased binding energy hydrogen species.

The compound may have the formula [KHKOH]ₙ wherein n is an integer and the hydrogen content H of the compound comprises at least one increased binding energy hydrogen species.

The compound including an anion or cation may have the formula [MHₘM′X′]ₙ wherein m and n are each an integer, M and M′ are each an alkali or alkaline earth cation, X is a singly or double negatively charged anion, and the hydrogen content Hₘ of the compound comprises at least one increased binding energy hydrogen species.

The compound including an anion or cation may have the formula [MHₘM′X′]ₙ⁺nX⁻ wherein m and n are each an integer, M and M′ are each an alkali or alkaline earth cation, X and X′ are a singly or double negatively charged anion, and the hydrogen content Hₘ of the compound comprises at least one increased binding energy hydrogen species.

The compound may have the formula MXSiX′Hₙ wherein n is 1 or 2, M is an alkali or alkaline earth cation, X and X′ are either a singly negatively charged anion or a double negatively charged anion, and the hydrogen content H, of the compound comprises at least one increased binding energy hydrogen species.

The compound may have the formula MSiHₙ wherein n is an integer from 1 to 6, M is an alkali or alkaline earth cation, and the hydrogen content Hₙ of the compound comprises at least one increased binding energy hydrogen species.

The compound may have the formula SiₙH₄ₙ wherein n is an integer and the hydrogen content H₄ₙ of the compound comprises at least one increased binding energy hydrogen species.

The compound may have the formula SiₙH₃ₙ wherein n is an integer and the hydrogen content H₃ₙ of the compound comprises at least one increased binding energy hydrogen species.

The compound may have the formula SiₙH₃ₙOₘ wherein n and m are integers and the hydrogen content H₃ₙ of the compound comprises at least one increased binding energy hydrogen species.

The compound may have the formula SiₓH_{4x-2y} wherein x and y are each an integer and the hydrogen content H_{4x-2y} of the compound comprises at least one increased binding energy hydrogen species.

The compound may have the formula SiₓH₄ₓO_{y} wherein x and y are each an integer and the hydrogen content H₄ₓ of the compound comprises at least one increased binding energy hydrogen species.

The compound may have the formula SiₙH₄ₙ.H₂O wherein n is an integer and the hydrogen content H₄ₙ of the compound comprises at least one increased binding energy hydrogen species.

The compound may have the formula SiₙH₂ₙ₊₂ wherein n is an integer and the hydrogen content H₂₊₂ of the compound comprises at least one increased binding energy hydrogen species.

The compound may have the formula SiₓH₂ₓ₊₂O_{y} wherein x and y are each an integer and the hydrogen content H₂ₓ₊₂ of the compound comprises at least one increased binding energy hydrogen species.

The compound may have the formula SiₙH₄ₙ₋₂O wherein n is an integer and the hydrogen content H₄ₙ₋₂ of the compound comprises at least one increased binding energy hydrogen species.

The compound may have the formula MSi₄ₙH₁₀ₙOₙ wherein n is an integer, M is an alkali or alkaline earth cation, and the hydrogen content H₁₀ₙ of the compound comprises at least one increased binding energy hydrogen species.

The compound may have the formula MSi₄ₙH₁₀ₙOₙ₊₁ wherein n is an integer, M is an alkali or alkaline earth cation, and the hydrogen content H₁₀ₙ of the compound comprises at least one increased binding energy hydrogen species.

The compound may have the formula M_{q}SiₙHₘOₚ wherein q, n, m, and p are integers, M is an alkali or alkaline earth cation, and the hydrogen content Hₘ of the compound comprises at least one increased binding energy hydrogen species.

The compound may have the formula M_{q}SiₙHₘ wherein q, n, and m are integers, M is an alkali or alkaline earth cation, and the hydrogen content Hₘ of the compound comprises at least one increased binding energy hydrogen species.

The compound may have the formula SiₙHₘOₚ wherein n, m, and p are integers, and the hydrogen content Hₘ of the compound comprises at least one increased binding energy hydrogen species.

The compound may have the formula SiₙHₘ wherein n, and m are integers, and the hydrogen content Hₘ of the compound comprises at least one increased binding energy hydrogen species.

The compound may have the formula MSiHₙ wherein n is an integer from 1 to 8, M is an alkali or alkaline earth cation, and the hydrogen content Hₙ of the compound comprises at least one increased binding energy hydrogen species.

The compound may have the formula Si₂Hₙ wherein n is an integer from 1 to 8, and the hydrogen content Hₙ of the compound comprises at least one increased binding energy hydrogen species.

The compound may have the formula SiHₙ wherein n is an integer from 1 to 8, and the hydrogen content Hₙ of the compound comprises at least one increased binding energy hydrogen species.

The compound may have the formula SiO₂Hₙ wherein n is an integer from 1 to 6, and the hydrogen content Hₙ of the compound comprises at least one increased binding energy hydrogen species.

The compound may have the formula MSiO₂Hₙ wherein n is an integer from 1 to 6, M is an alkali or alkaline earth cation, and the hydrogen content Hₙ of the compound comprises at least one increased binding energy hydrogen species.

The compound may have the formula MSi₂Hₙ wherein n is an integer from 1 to 14, M is an alkali or alkaline earth cation, and the hydrogen content Hₙ of the compound comprises at least one increased binding energy hydrogen species.

The compound may have the formula M₂SiHₙ wherein n is an integer from 1 to 8, M is an alkali or alkaline earth cation, and the hydrogen content Hₙ of the compound comprises at least one increased binding energy hydrogen species.

In MHX, M₂HX, M₂XHₙ, M₂X₂Hₙ, M₂X₃H, M₂XX′H, MM′XHₙ, MM′XX′H, MXX′Hₙ, MXAlX′Hₙ, the singly negatively charged anion may be a halogen ion, hydroxide ion, hydrogen carbonate ion, or nitrate ion.

In MHX, M₂XHₙ, M₂XX′H, MM′XH, MXX′Hₙ, MXAlX′Hₙ, the double negatively charged anion may be a carbonate ion, oxide, or sulfate ion.

In MXSiX′Hₙ, MSiHn, SiₙH₄ₙ, SiₙH₃ₙ, SiₙH₃ₙOₘ, SiₓH_{4x-2y}O_{y}, SiₓH₄ₓO_{y}, SiₙH₄ₙ.H₂O, SiₙH₂ₙ₊₂, SiₓH₂ₓ₊₂O_{y}, SiₙH₄ₙ₋₂O, MSi₄ₙH₁₀ₙOₙ, MSi₄ₙH₁₀ₙOₙ₊₁, M_{q}SiₙHₘOₚ, M_{q}SiₙHₘ, SiₙHₘOₚ, SiₙHₘ, MSiHₙ, Si₂Hₙ, SiHₙ, SiO₂Hₙ, MSiO₂Hₙ, MSi₂Hₙ, M₂SiHₙ, the observed characteristics such as stoichiometry, thermal stability, and/or reactivity such as reactivity with oxygen are different from that of the corresponding ordinary compound wherein the hydrogen content is only ordinary hydrogen H. The unique observed characteristics are dependent on the increased binding energy of the hydrogen species.

Applications of the compounds include use in batteries, fuel cells, cutting materials, light weight high strength structural materials and synthetic fibers, cathodes for thermionic generators, photoluminescent compounds, corrosion resistant coatings, heat resistant coatings, phosphors for lighting, optical coatings, optical filters, extreme ultraviolet laser media, fiber optic cables, magnets and magnetic computer storage media, and etching agents, masking agents, dopants in semiconductor fabrication, and fuels. Increased binding energy hydrogen compounds are useful in chemical synthetic processing methods and refining methods. The increased binding energy hydrogen ion has application as the negative ion of the electrolyte of a high voltage electrolytic cell.

According to another aspect of the invention, dihydrinos, are produced by reacting protons with hydrino hydride ions, or by the thermal decomposition of hydrino hydride ions, or by the thermal or chemical decomposition of increased binding energy hydrogen compounds.

A method is provided for preparing a compound comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}} ϑ$$

where p is an integer, preferably an integer from 2 to 200. The increased binding energy hydrogen atom is reacted with an electron, to produce an increased binding energy hydride ion. The increased binding energy hydride ion is reacted with one or more cations to produce a compound comprising at least one increased binding energy hydride ion.

The invention is also directed to a reactor for producing increased binding energy hydrogen compounds of the invention, such as hydrino hydride compounds. Such a reactor is hereinafter referred to as a “hydrino hydride reactor”. The hydrino hydride reactor comprises a cell for making hydrinos and an electron source. The reactor produces hydride ions having the binding energy of Eq. (7). The cell for making hydrinos may take the form of an electrolytic cell, a gas cell, a gas discharge cell, or a plasma torch cell, for example. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only protium (¹H), but also deuterium and tritium. Electrons from the electron source contact the hydrinos and react to form hydrino hydride ions.

The reactors described herein as “hydrino hydride reactors” are capable of producing not only hydrino hydride ions and compounds, but also the other increased binding energy hydrogen compounds of the present invention. Hence, the designation “hydrino hydride reactors” should not be understood as being limiting with respect to the nature of the increased binding energy hydrogen compound produced.

In the electrolytic cell, hydrinos are reduced (i.e. gain an electron) to form hydrino hydride ions by contacting any of the following 1.) a cathode, 2.) a reductant which comprises the cell, 3.) any of the reactor components, or 4.) a reductant extraneous to the operation of the cell (i.e. a consumable reductant added to the cell from an outside source) (items 2.-4. are hereinafter, collectively referred to as “the hydrino reducing reagent”). In the gas cell, the hydrinos are reduced to hydrino hydride ions by the hydrino reducing reagent. In the gas discharge cell, the hydrinos are reduced to hydrino hydride ions by 1.) contacting the cathode; 2.) reduction by plasma electrons, or 3.) contacting the hydrino reducing reagent. In the plasma torch cell, the hydrinos are reduced to hydrino hydride ions by 1.) reduction by plasma electrons, or 2.) contacting the hydrino reducing reagent. In one embodiment, the electron source comprising the hydrino hydride ion reducing reagent is effective only in the presence of hydrino atoms.

According to one aspect of the present invention, novel compounds are formed from hydrino hydride ions and cations. In the electrolytic cell, the cation may be either an oxidized species of the material of the cell cathode or anode, a cation of an added reductant, or a cation of the electrolyte (such as a cation comprising the catalyst). The cation of the electrolyte may be a cation of the catalyst. In the gas cell, the cation is an oxidized species of the material of the cell, a cation comprising the molecular hydrogen dissociation material which produces atomic hydrogen, a cation comprising an added reductant, or a cation present in the cell (such as a cation comprising the catalyst). In the discharge cell, the cation is either an oxidized species of the material of the cathode or anode, a cation of an added reductant, or a cation present in the cell (such as a cation comprising the catalyst). In the plasma torch cell, the cation is either an oxidized species of the material of the cell, a cation of an added reductant, or a cation present in the cell (such as a cation comprising the catalyst).

A battery is provided comprising a cathode and cathode compartment containing an oxidant; an anode and an anode compartment containing a reductant, and a salt bridge completing a circuit between the cathode and anode compartments. Increased binding energy hydrogen compounds may serve as oxidants of the battery cathode half reaction. The oxidant may be an increased binding energy hydrogen compound. A cation Mⁿ⁺ (where n is an integer) bound to a hydrino hydride ion such that the binding energy of the cation or atom M⁽ⁿ⁻¹⁾⁺ is less than the binding energy of the hydrino hydride ion

$${H}^{-} ( \frac{1}{p} )$$

may serve as the oxidant. Alternatively, a hydrino hydride ion may be selected for a given cation such that the hydrino hydride ion is not oxidized by the cation. Thus, the oxidant

$${M}^{n +} {{H}^{-} ( \frac{1}{p} )}_{n}$$

comprises a cation Mⁿ⁺, where n is an integer and the hydrino hydride ion

$${H}^{-} ( \frac{1}{p} ) ,$$

where p is an integer greater than 1, that is selected such that its binding energy is greater than that of M⁽ⁿ⁻¹⁾⁺. By selecting a stable cation-hydrino hydride anion compound, a battery oxidant is provided wherein the reduction potential is determined by the binding energies of the cation and anion of the oxidant.

The battery oxidant may be, for example, an increased binding energy hydrogen compound comprising a dihydrino molecular ion bound to a hydrino hydride ion such that the binding energy of the reduced dihydrino molecular ion, the dihydrino molecule

$${H}_{2}^{*} [ 2 {c}^{′} = \frac{\sqrt{2} {a}_{o}}{p} ] ,$$

is less than the binding energy of the hydrino hydride ion

$${H}^{-} ( \frac{1}{{p}^{′}} ) .$$

oxidant is the compound

$${{H}_{2}^{*} [ 2 {c}^{′} = \frac{2 {a}_{o}}{p} ]}^{+} {H}^{-} ( 1 / {p}^{′} )$$

where p of the dihydrino molecular ion is 2 and p′ of the hydrino hydride ion is 13, 14, 15, 16, 17, 18, or 19. Alternatively, in the case of He²⁺(H⁻(1/p))₂ or Fe⁴⁺ (H⁻(1/p))₄, p of the hydrino hydride ion may be 11 to 20 because the binding energy of He⁺ and Fe³⁺ is 54.4 eV and 54.8 eV, respectively. Thus, in the case of He²⁺(H⁻(1/p))₂, the hydride ion is selected to have a higher binding energy than He⁺(54.4 eV). In the case of Fe⁴⁺ (H⁻(1/p))₄ the hydride ion is selected to have a higher binding energy than Fe³⁺ (54.8 eV).

In one embodiment of the battery, hydrino hydride ions complete the circuit during battery operation by migrating from the cathode compartment to the anode compartment through a salt bridge. The salt a bridge may comprise an anion conducting membrane and/or an anion conductor. The bridge may comprise, for example, an anion conducting membrane and/or an anion conductor. The salt bridge may be formed of a zeolite, a lanthanide boride (such as MB₆, where M is a lanthanide), or an alkaline earth boride (such as MB, where M is an alkaline earth) which is selective as an anion conductor based on the small size of the hydrino hydride anion.

The battery is optionally made rechargeable. According to an embodiment of a rechargeable battery, a cathode compartment contains reduced oxidant and a anode compartment contains an oxidized reductant. The battery further comprises an ion such as the hydrino hydride ion which migrates to complete the circuit. To permit the battery to be recharged, the oxidant comprising increased binding energy hydrogen compounds must be capable of being generated by the application of a proper voltage to the battery to yield the desired oxidant. A representative proper voltage is from about one volt to about 100 volts. The oxidant

$${M}^{n +} {{H}^{-} ( \frac{1}{p} )}_{n}$$

comprises a desired cation formed at a desired voltage, selected such that the n-thionization energy IPₙ to form the cation Mⁿ⁺ from M⁽ⁿ⁻¹⁾⁺, where n is an integer, is less than the binding energy of the hydrino hydride ion

$${H}^{-} ( \frac{1}{p} ) ,$$

where p is an integer greater than 1.

The reduced oxidant may be, for example, iron metal, and the oxidized reductant having a source of hydrino hydride ions may be, for example, potassium hydrino hydride (K⁺H⁻(1/p)). The application of a proper voltage oxidizes the reduced oxidant (Fe) to the desired oxidation state (Fe⁴⁺) to form the oxidant (Fe⁴⁺(H⁻(1/p))₄ where p of the hydrino hydride ion is an integer from 11 to 20). The application of the proper voltage also reduces the oxidized reductant (K⁺) to the desired oxidation state (K) to form the reductant (potassium metal). The hydrino hydride ions complete the circuit by migrating from the anode compartment to the cathode compartment through the salt bridge.

In an embodiment of the battery, the cathode compartment functions as the cathode.

Increased binding energy hydrogen compounds providing a hydrino hydride ion may be used to synthesize desired compositions of matter by electrolysis. The hydrino hydride ion may serve as the negative ion of the electrolyte of a high voltage electrolytic cell. The desired compounds such as Zintl phase silicides and silanes may be synthesized using electrolysis without the decomposition of the anion, electrolyte, or the electrolytic solution. The hydrino hydride ion binding energy is greater than any ordinary species formed during operation of the cell. The cell is operated at a desired voltage which forms the desired product without decomposition of the hydrino hydride ion. In the case that the desired product is cation Mⁿ⁺ (where n is an integer), the hydrino hydride ion

$${H}^{-} ( \frac{1}{p} )$$

is selected such that its binding energy is greater than that of M⁽ⁿ⁻¹⁾⁺. The desired cations formed at the desired voltage may be selected such that the n-thionization energy IPₙ to form the cation Mⁿ⁺ from M⁽ⁿ⁻¹⁾⁺ (where n is an integer) is less than the binding energy of the hydrino hydride ion

$${H}^{-} ( \frac{1}{p} ) .$$

Alternatively, a hydrino hydride ion may be selected for the desired cation such that it is not oxidized by the cation. For example, in the case of He²⁺ or Fe⁴⁺, p of the hydrino hydride ion may be 11 to 20 because the binding energy of He⁺ and Fe³⁺ is 54.4 eV and 54.8 eV, respectively. Thus, in the case of a desired compound He²⁺(H⁻(1/p))₂, the hydride ion is selected to have a higher binding energy than He⁺(54.4 eV). In the case of a desired compound Fe⁴⁺(H⁻(1/p))₄ the hydride ion is selected to have a higher binding energy than Fe³⁺ (54.8 eV). The hydrino hydride ion is selected such that the electrolyte does not decompose during operation to generate the desired product.

A fuel cell of the present invention comprises a source of oxidant, a cathode contained in a cathode compartment in communication with the source of oxidant, an anode in an anode compartment, and a salt bridge completing a circuit between the cathode and anode compartments. The oxidant may be hydrinos from the oxidant source. The hydrinos react to form hydrino hydride ions as a cathode half reaction. Increased binding energy hydrogen compounds may provide hydrinos. The hydrinos may be supplied to the cathode from the oxidant source by thermally or chemically decomposing increased binding energy hydrogen compounds. Alternatively, the source of oxidant may be an electrolytic cell, gas cell, gas discharge cell, or plasma torch cell hydrino hydride reactor of the present invention. An alternative oxidant of the fuel cell comprises increased binding energy hydrogen compounds. For example, a cation Mn⁺ (Where n is an integer) bound to a hydrino hydride ion such that the binding energy of the cation or atom M⁽ⁿ⁻¹⁾⁺ is less than the binding energy of the hydrino hydride ion

$${H}^{-} ( \frac{1}{p} )$$

may serve as the oxidant. The source of oxidant, such as

$${M}^{n +} {{H}^{-} ( \frac{1}{p} )}_{n}$$

may be an electrolytic cell, gas cell, gas discharge cell, or plasma torch cell hydrino hydride reactor of the present invention.

In an embodiment of the fuel cell, the cathode compartment functions as the cathode.

According to another embodiment of the invention, a fuel is provided comprising at least one increased binding energy hydrogen compound.

According to another aspect of the invention, energy is released by the thermal decomposition or chemical reaction of at least one of the following reactants: (1) increased binding energy hydrogen compound; (2) hydrino; or (3) dihydrino. The decomposition or chemical reaction produces at least one of (a) increased binding energy hydrogen compound with a different stoichiometry than the reactants, (b) an increased binding energy hydrogen compound having the same stoichiometry comprising one or more increased binding energy species that have a higher binding energy than the corresponding species of the reactant(s), (c) hydrino, (d) dihydrino having a higher binding energy than the reactant dihydrino, or (e) hydrino having a higher binding energy than the reactant hydrino. Exemplary increased binding energy hydrogen compounds as reactants and products include those given in the Experimental Section and the Additional Increased Binding Energy Compounds Section.

Another application of the increased binding energy hydrogen compounds is as a dopant in the fabrication of a thermionic cathode with a different preferably higher voltage than the starting material. For example, the starting material may be tungsten, molybdenum, or oxides thereof. In a preferred embodiment of a doped thermionic cathode, the dopant is hydrino hydride ion. Materials such as metals may be doped with hydrino hydride ions by ion implantation, epitaxy, or vacuum deposition to form a superior thermionic cathode. The specific p hydrino hydride ion (H⁻(n=1/p) where p is an integer) may be selected to provide the desired property such as voltage following doping.

Another application of the increased binding energy hydrogen compounds is as a dopant or dopant component in the fabrication of doped semiconductors each with an altered band gap relative to the starting material. For example, the starting material may be an ordinary semiconductor, an ordinary doped semiconductor, or an ordinary dopant such as silicon, germanium, gallium, indium, arsenic, phosphorous, antimony, boron, aluminum, Group III elements, Group IV elements, cr Group V elements. In a preferred embodiment of the doped semiconductor, the dopant or dopant component is hydrino hydride ion. Materials such as silicon may be doped with hydrino hydride ions by ion implantation, epitaxy, or vacuum deposition to form a superior doped semiconductor. The specific p hydrino hydride ion (H⁻(n=1/p) where p is an integer) may be selected to provide the desired property such as band gap following doping.

Other objects, features, and characteristics of the present invention, as well as the methods of operation and the functions of the related elements, will become apparent upon consideration of the following description and the appended claims with reference to the accompanying drawings, all of which form a part of this specification, wherein like reference numerals designate corresponding parts in the various figures.

### III. BRIEF DESCRIPTION OF THE DRAWINGS

FIG. 1 is a schematic drawing of a hydride reactor in accordance with the present invention;

FIG. 2 is a schematic drawing of an electrolytic cell hydride reactor in accordance with the present invention;

FIG. 3 is a schematic drawing of a gas cell hydride reactor in accordance with the present invention;

FIG. 4 is a schematic drawing of an experimental gas cell hydride reactor in accordance with the present invention;

FIG. 5 is a schematic drawing of a gas discharge cell hydride reactor in accordance with the present invention;

FIG. 6 is a schematic of an experimental gas discharge cell hydride reactor in accordance with the present invention;

FIG. 7 is a schematic drawing of a plasma torch cell hydride reactor in accordance with the present invention;

FIG. 8 is a schematic drawing of another plasma torch cell hydride reactor in accordance with the present invention;

FIG. 9 is a schematic drawing of a fuel cell in accordance with the present invention;

FIG. 9A is a schematic drawing of a battery in accordance with the present invention;

FIG. 10 is the 0 to 1200 eV binding energy region of an X-ray Photoelectron Spectrum (XPS) of a control glassy carbon rod;

FIG. 11 is the survey spectrum of a glassy carbon rod cathode following electrolysis of a 0.57M K₂CO₃ electrolyte (sample #1) with the primary elements identified;

FIG. 12 is the low binding energy range (0-285 eV) of a glassy carbon rod cathode following electrolysis of a 0.57M K₂CO₃ electrolyte (sample #1);

FIG. 13 is the 55 to 70 eV binding energy region of an X-ray Photoelectron Spectrum (XPS) of a glassy carbon rod cathode following electrolysis of a 0.57M K₂CO₃ electrolyte (sample #1);

FIG. 14 is the 0 to 70 eV binding energy region of a high resolution X-ray Photoelectron Spectrum (XPS) of a glassy carbon rod cathode following electrolysis of a 0.57M K₂CO₃ electrolyte (sample #2);

FIG. 15 is the 0 to 70 eV binding energy region of a high resolution X-ray Photoelectron Spectrum (XPS) of a glassy carbon rod cathode following electrolysis of a 0.57M K₂CO₃ electrolyte and storage for three months (sample #3);

FIG. 16 is the survey spectrum of crystals prepared by filtering the electrolyte from the K₂CO₃ electrolytic cell that produced 6.3×10⁸ J of enthalpy of formation of increased binding energy hydrogen compounds (sample #4) with the primary elements identified;

FIG. 17 is the 0 to 75 eV binding energy region of a high resolution X-ray Photoelectron Spectrum (XPS) of crystals prepared by filtering the electrolyte from the K₂CO₃ electrolytic cell that produced 6.3×10⁸ J of enthalpy of formation of increased binding energy hydrogen compounds (sample #4);

FIG. 18 is the survey spectrum of crystals prepared by acidifying the electrolyte from the K₂CO₃ electrolytic cell that produced 6.3×10⁸ J of enthalpy of formation of increased binding energy hydrogen compounds, and concentrating the acidified solution until crystals formed on standing at room temperature (sample #5) with the primary elements identified;

FIG. 19 is the 0 to 75 eV binding energy region of a high resolution X-ray Photoelectron Spectrum (XPS) of crystals prepared by acidifying the electrolyte from the K₂CO₃ electrolytic cell that produced 6.3×10⁸ J of enthalpy of formation of increased binding energy hydrogen compounds, and concentrating the acidified solution until crystals formed on standing at room temperature (sample #5);

FIG. 20 is the survey spectrum of crystals prepared by concentrating the electrolyte from a K₂CO₃ electrolytic cell operated by Thermacore, Inc. until a precipitate just formed (sample #6) with the primary elements identified;

FIG. 21 is the 0 to 75 eV binding energy region of a high resolution X-ray Photoelectron Spectrum (XPS) of crystals prepared by concentrating the electrolyte from a K₂CO₃ electrolytic cell operated by Thermacore, Inc. until a precipitate just formed (sample #6) with the primary elements identified;

FIG. 22 is the superposition of the 0 to 75 eV binding energy region of the high resolution X-ray Photoelectron Spectrum (XPS) of sample #4, sample #5, sample #6, and sample #7;

FIG. 23 is the stacked high resolution X-ray Photoelectron Spectra (XPS) (0 to 75 eV binding energy region) in the order from bottom to top of sample #8, sample #9, and sample #9A;

FIG. 24 is the mass spectrum (m/e=0-110) of the vapors from the crystals from the electrolyte of the K₂CO₃ electrolytic cell hydrino hydride reactor that was made 1 M in LiNO₃ and acidified with HNO₃ (electrolytic cell sample #3.) with a sample heater temperature of 200° C.;

FIG. 25A is the mass spectrum (m/e=0-110) of the vapors from the crystals filtered from the electrolyte of the K₂CO₃ electrolytic cell hydrino hydride reactor (electrolytic cell sample #4) with a sample heater temperature of 185° C.;

FIG. 25B is the mass spectrum (m/e=0-110) of the vapors from the crystals filtered from the electrolyte of the K₂CO₃ electrolytic cell hydrino hydride reactor (electrolytic cell sample #4) with a sample heater temperature of 225. ° C.;

FIG. 25C is the mass spectrum (m/e=0-200) of the vapors from the crystals filtered from the electrolyte of the K₂CO₃ electrolytic cell hydrino hydride reactor (electrolytic cell sample #4) with a sample heater temperature of 234° C. with the assignments of major component hydrino hydride silane compounds and silane fragment peaks;

FIG. 25D is the mass spectrum (m/e=0-200) of the vapors from the crystals filtered from the electrolyte of the K₂CO₃ electrolytic cell hydrino hydride reactor (electrolytic cell sample #4) with a sample heater temperature of 249° C. with the assignments of major component hydrino hydride silane and siloxane compounds and silane fragment peaks;

FIG. 26A is the mass spectrum (m/e=0-110) of the vapors from the yellow-white crystals that formed on the outer edge of a crystallization dish from the acidified electrolyte of the K₂CO₃ electrolytic cell operated by Thermacore, Inc. that produced 1.6×10⁹ J of enthalpy of formation of increased binding energy hydrogen compounds (electrolytic cell sample #5) with a sample heater temperature of 220° C.;

FIG. 26B is the mass spectrum (m/e=0-110) of the vapors from the yellow-white crystals that formed on the outer edge of a crystallization dish from the acidified electrolyte of the K₂CO₃ electrolytic cell operated by Thermacore, Inc. that produced 1.6×10⁹ J of enthalpy of formation of increased binding energy hydrogen compounds (electrolytic cell sample #5) with a sample heater temperature of 275° C.;

FIG. 26C is the mass spectrum (m/e=0-110) of the vapors from the yellow-white crystals that formed on the outer edge of a crystallization dish from the acidified electrolyte of the K₂CO₃ electrolytic cell operated by Thermacore, Inc. that produced 1.6×10⁹ J of enthalpy of formation of increased binding energy hydrogen compounds (electrolytic cell sample d#6) with a sample heater temperature of 212° C.;

FIG. 26D is the mass spectrum (m/e=0-200) of the vapors from the yellow-white crystals that formed on the outer edge of a crystallization dish from the acidified electrolyte of the K₂CO₃ electrolytic cell operated by Thermacore, Inc. that produced 1.6×10⁹ J of enthalpy of formation of increased binding energy hydrogen compounds (electrolytic cell sample #6) with a sample heater temperature of 147° C. with the assignments of major component hydrino hydride silane compounds and silane fragment peaks;

FIG. 27 is the mass spectrum (m/e=0-110) of the vapors from the cryopumped crystals isolated from the 40° C. cap of a gas cell hydrino hydride reactor comprising a KI catalyst, stainless steel filament leads, and a W filament (gas cell sample #1) with the sample dynamically heated from 90° C. to 120° C. while the scan was being obtained in the mass range m/e=75-100;

FIG. 28A is the mass spectrum (m/e=0-110) of the sample shown in FIG. 27 with the succeeding repeat scan where the total time of each scan was 75 seconds;

FIG. 28B is the mass spectrum (m/e=0-110) of the sample shown in FIG. 27 scanned 4 minutes later with a sample temperature of 200

FIG. 29 is the mass spectrum (m/e=0-7110) of the vapors from the cryopumped crystals isolated from the 40° C. cap of a gas cell hydrino hydride reactor comprising a KI catalyst, stainless steel filament leads, and a W filament (gas cell sample #2) with a sample temperature of 225° C.;

FIG. 30A is the mass spectrum (m/e=0-200) of the vapors from the crystals prepared from a dark colored band at the top of a gas cell hydrino hydride reactor comprising a KI catalyst, stainless steel filament leads, and a W filament (gas cell sample #3A) with a sample heater temperature of 253° C. with the assignments of major component hydrino hydride silane compounds and silane fragment peaks;

FIG. 30B is the mass spectrum (m/e=0-200) of the vapors from the crystals prepared from a dark colored band at the top of a gas cell hydrino hydride reactor comprising a KI catalyst, stainless steel filament leads, and a W filament (gas cell sample #3B) with a sample heater temperature of 216° C. with the assignments of major component hydrino hydride silane and siloxane compounds and silane fragment peaks;

FIG. 31 is the mass spectrum (m/e=0-200) of the vapors from pure crystals of iodine obtained immediately following the spectrum shown in FIGS. 30A and 30B;

FIG. 32 is the mass spectrum (m/e=0-110) of the vapors from the crystals from the body of a gas cell hydrino hydride reactor comprising a KI catalyst, stainless steel filament leads, and a W filament (gas cell sample #4) with a sample heater temperature of 226° C.;

FIG. 33 is the 0 to 75 eV binding energy region of a high resolution X-ray Photoelectron Spectrum (XPS) of recrystallized crystals prepared from the gas cell hydrino hydride reactor comprising a KI catalyst, stainless steel filament leads, and a W filament (gas cell sample #4) corresponding to the mass spectrum shown in FIG. 32;

FIG. 34A is the mass spectrum (m/e=0-110) of the vapors from the cryopumped crystals isolated from the 40° C. cap of a gas cell hydrino hydride reactor comprising a RbI catalyst, stainless steel filament leads, and a W filament (gas cell sample # 5) with a sample temperature of 205° C.;

FIG. 34B is the mass spectrum (m/e=0-200) of the vapors from the cryopumped crystals isolated from the 40° C. cap of a gas cell hydrino hydride reactor comprising a RbI catalyst, stainless steel filament leads, and a W filament (gas cell sample # 5) with a sample temperature of 201° C. with the assignments of major component hydrino hydride silane and siloxane compounds and silane fragments;

FIG. 34C is the mass spectrum (m/e=0-200) of the vapors from the cryopumped crystals isolated from the 40° C. cap of a gas cell hydrino hydride reactor comprising a RbI catalyst, stainless steel filament leads, and a W filament (gas cell sample # 5) with a sample temperature of 235° C. with the assignments of major component hydrino hydride silane and siloxane compounds and silane fragments;

FIG. 35 is the mass spectrum (m/e=0-10) of the vapors from the crystals from a gas discharge cell hydrino hydride reactor comprising a KI catalyst and a Ni electrodes with a sample heater temperature of 225° C.;

FIG. 36 is the mass spectrum (m/e=0-110) of the vapors from the crystals from a plasma torch cell hydrino hydride reactor with a sample heater temperature of 250° C. with the assignments of major component aluminum hydrino hydride compounds and fragment peaks;

FIG. 37 is the mass spectrum as a function of time of hydrogen (m/e=2 and (m/e=1), water (m/e=18, m/e=2, and (m/e=1), carbon dioxide (m/e=44 and m/e=12), and hydrocarbon fragment CH₃⁺(m/e=15), and carbon (m/e=12) obtained following recording the mass spectra of the crystals from the electrolytic cell, the gas cell, the gas discharge cell, and the plasma torch cell hydrino hydride reactors;

FIG. 38 is the mass spectrum (m/e=0-50) of the gasses from the Ni tubing cathode of the K₂CO₃ electrolytic cell on-line with the mass spectrometer;

FIG. 39 is the mass spectrum (m/e=0-50) of the MIT sample comprising nonrecombinable gas from a K₂CO₃ electrolytic cell;

FIG. 40 is the output power versus time during the catalysis of hydrogen and the response to helium in a Calvet cell containing a heated platinum filament and KNO₃ powder in a quartz boat that was heated by the filament;

FIG. 41A is the mass spectrum (m/e=0-50) of the gasses from the Pennsylvania State University Calvet cell following the catalysis of hydrogen that were collected in an evacuated stainless steel sample bottle;

FIG. 41B is the mass spectrum (m/e=0-50) of the gasses from the Pennsylvania State University Calvet cell following the catalysis of hydrogen that were collected in an evacuated stainless steel sample bottle at low sample pressure;

FIG. 42 is the mass spectrum (m/e=0-200) of the gasses from the Pennsylvania State University Calvet cell following the catalysis of hydrogen that were collected in an evacuated stainless steel sample bottle;

FIG. 43 is the results of the measurement of the enthalpy of the decomposition reaction of hydrino hydride compounds using an adiabatic calorimeter with virgin nickel wires and cathodes from a Na₂CO₃ electrolytic cell and a K₂CO₃ electrolytic cell that produced 6.3×10⁸ J of enthalpy of formation of increased binding energy hydrogen compounds;

FIG. 44 is the gas chromatographic analysis (60 meter column) of the gasses released from the sample collected from the plasma torch manifold when the sample was heated to 400° C.;

FIG. 45 is the gas chromatographic analysis (60 meter column) of high purity hydrogen;

FIG. 46 is the gas chromatographic analysis (60 meter column) of gasses from the thermal decomposition of a nickel wire cathode from a K₂CO₃ electrolytic cell that was heated in a vacuum vessel;

FIG. 47 is the gas chromatographic analysis (60 meter column) of gasses of a hydrogen discharge with the catalyst (KI) where the reaction gasses flowed through a 100% CuO recombiner and were sampled by an on-line gas chromatograph;

FIG. 48 is the X-ray Diffraction (XRD) data before hydrogen flow over the ionic hydrogen spillover catalytic material: 40% by weight potassium nitrate (KNO₃) on Grafoil with 5% by weight 1%-Pt-on-graphitic carbon;

FIG. 49 is the X-ray Diffraction (XRD) data after hydrogen flow over the ionic hydrogen spillover catalytic material: 40% by weight potassium nitrate (KNO₃) on Grafoil with 5% by weight 1%-Pt-on-graphitic carbon;

FIG. 50 is the X-ray Diffraction (XRD) pattern of the crystals from the stored nickel cathode of the K₂CO₃ electrolytic cell hydrino hydride reactor (sample #1A).

FIG. 51 is the X-ray Diffraction (XRD) pattern of the crystals prepared by concentrating the electrolyte from a K₂CO₃ electrolytic cell operated by Thermacore, Inc. until a precipitate just formed (sample #2);

FIG. 52 is the schematic of an apparatus including a discharge cell light source, an extreme ultraviolet (EUV) spectrometer for windowless EUV spectroscopy, and a mass spectrometer used to observe hydrino, hydrino hydride ion, hydrino hydride compound, and dihydrino molecular ion formations and transitions;

FIG. 53 is the EUV spectrum (20-75 nm) recorded of normal hydrogen and hydrogen catalysis with KNO₃ catalyst vaporized from the catalyst reservoir by heating;

FIG. 54 is the EUV spectrum (90-93 nm) recorded of hydrogen catalysis with KI catalyst vaporized from the nickel foam metal cathode by the plasma discharge;

FIG. 55 is the EUV spectrum (89-93 nm) recorded of hydrogen catalysis with a five way stainless steel cross discharge cell that served as the anode, a stainless steel hollow cathode, and KI catalyst that was vaporized directly into the plasma of the hollow cathode from the catalyst reservoir by heating superimposed on four control (no catalyst) runs;

FIG. 56 is the EUV spectrum (90-92.2 nm) recorded of hydrogen catalysis with KI catalyst vaporized from the hollow copper cathode by the plasma discharge;

FIG. 57 is the EUV spectrum (20-120 nm) recorded of normal hydrogen excited by a discharge cell which comprised a five way stainless steel cross that served as the anode with a hollow stainless steel cathode;

FIG. 58 is the EUV spectrum (20-120 nm) recorded of hydrino hydride compounds synthesized with KI catalyst vaporized from the catalyst reservoir by heating wherein the transitions were excited by the plasma discharge in a discharge cell which comprised a five way stainless steel cross that served as the anode and a hollow stainless steel cathode;

FIG. 59 is the EUV spectrum (120-124.5 nm) recorded of hydrogen catalysis to form hydrino that reacted with discharge plasma protons wherein the KI catalyst was vaporized from the cell walls by the plasma discharge;

FIG. 60 is the stacked TOFSIMS spectra m/e=94-99 in the order from bottome to top of TOFSIMS sample #8 and sample #10;

FIG. 61A is the stacked TOFSIMS spectra m/e=0-50 in the order from bottom to top of TOFSIMS sample #2, sample #4, sample #1, sample #6, and sample #8;

FIG. 61B is the stacked TOFSIMS spectra m/e=0-50 in the order from bottom to top of TOFSIMS sample #9, sample #10, sample #11, and sample #12;

FIG. 62 is the stacked mass spectra (m/e=0-200) of the vapors from the crystals prepared from the cap of a gas cell hydrino hydride reactor comprising a KI catalyst, stainless steel filament leads, and a W filament with a sample heater temperature of 157° C. in the order from top to bottom of IP-30 eV, IP=70 eV, and IP=150 eV;

FIG. 63 is the mass spectrum (m/e=0-50) of the vapors from the crystals prepared by concentrating 300 cc of the K₂CO₃ electrolyte from the cell described herein that produced 6.3×10⁸ J of enthalpy of formation of increased binding energy hydrogen compounds using a rotary evaporator at 50° C. until a precipitate just formed (XPS sample #7; TOFSIMS sample #8) with a sample heater temperature of 100° C. and an IP=70 eV;

FIG. 64 is the survey spectrum of crystals prepared by concentrating the electrolyte from the K₂CO₃ electrolytic cell that produced 6.3×10⁸ J of enthalpy of formation of increased binding energy hydrogen compounds with a rotary evaporator, and allowing crystals to form on standing at room temperature (XPS sample #7) with the primary elements identified;

FIG. 65 is the 675 eV to 765 eV binding energy region of an X-ray Photoelectron Spectrum (XPS) of the cryopumped crystals isolated from the 40° C. cap of a gas cell hydrino hydride reactor comprising a Kr catalyst, stainless steel filament leads, and a W filament (XPS sample #13) with Fe 2 p₁ and Fe 2 p₃ peaks identified;

FIG. 66 is the 0 to 110 eV binding energy region of an X-ray Photoelectron—Spectrum (XPS) of the cryopumped crystals isolated from the cap of a gas cell hydrino hydride reactor comprising a KI catalyst, stainless steel filament leads, and a W filament (XPS sample #14);

FIG. 67 is the 0 eV to 80 eV binding energy region of an X-ray Photoelectron Spectrum (XPS) of KI (XPS sample #15);

FIG. 68 is the FTIR spectrum of sample #1 from which the FTIR spectrum of the reference potassium carbonate was digitally subtracted;

FIG. 69 is the overlap FTIR spectrum of sample #1 and the FTIR spectrum of the reference potassium carbonate;

FIG. 70 is the FTIR spectrum of sample #4;

FIG. 71 is the stacked Raman spectrum of 1.) a nickel wire that was removed from the cathode of the K₂CO₃ electrolytic cell operated by Thermacore, Inc. that was rinsed with distilled water and dried wherein the cell produced 1.6×10⁹ J of enthalpy of formation of increased binding energy hydrogen compounds, 2.) a nickel wire that was removed from the cathode of a control Na₂CO₃ electrolytic cell operated by BlackLight Power, Inc. that was rinsed with distilled water and dried, and 3.) the same nickel wire (NI 200 0.0197″, HTN36NOAG1, A1 Wire Tech, Inc.) that was used in the electrolytic cells of sample #2 and sample #3;

FIG. 72 is the Raman spectrum of crystals prepared by concentrating the electrolyte from the K₂CO₃ electrolytic cell that produced 6.3×10⁸ J of enthalpy of formation of increased binding energy hydrogen compounds with a rotary evaporator, and allowing crystals to form on standing at room temperature (sample #4); and

FIG. 73 is the magic angle solid NMR spectrum of crystals prepared by concentrating the electrolyte from a K₂CO₃ electrolytic cell operated by Thermacore, Inc. until a precipitate just formed (sample #1);

FIG. 74 is the 0-160 eV binding energy region of a survey X-ray Photoelectron Spectrum (XPS) of sample #12 with the primary elements and dihydrino peaks identified;

FIG. 75 is the stacked TGA results of 1.) the reference comprising 99.999% KNO₃ (TGA/DTA sample #1) 2.) crystals from the yellow white crystals that formed on the outer edge of a crystallization dish from the acidified electrolyte of the K₂CO₃ electrolytic cell operated by Thermacore, Inc. that produced 1.6×10⁹ J of enthalpy of formation of increased binding energy hydrogen compounds (TGA/DTA sample #2).

FIG. 76 is the stacked DTA results of 1.) the reference comprising 99.999% KNO₃ (TGA/DTA sample #1) 2.) crystals from the yellow white acidified electrolyte of the K₂CO₃ electrolytic cell operated by Thermacore, Inc. that produced 1.6×10⁹ J of enthalpy of formation of increased binding energy hydrogen compounds (TGA/DTA sample #2).

### IV. DETAILED DESCRIPTION OF THE INVENTION

Formation of a hydride ion having a binding energy greater than about 0.8 eV, i.e., a hydrino hydride ion, allows for production of alkali and alkaline earth hydrides having enhanced stability or slow reactivity in water. In addition, very stable metal hydrides can be produced with hydrino hydride ions.

Increased binding energy hydrogen species form very strong bonds with certain cations and have unique properties with many applications such as cutting materials (as a replacement for diamond, for example); structural materials and synthetic fibers such as novel inorganic polymers. Due to the small mass of such the hydrino hydride ion, these materials are lighter in weight than present materials containing a other anions.

Increased binding energy hydrogen species have many additional applications such as cathodes for thermionic generators; formation of photoluminescent compounds (e.g. Zintl phase silicides and silanes containing increased binding energy hydrogen species); corrosion resistant coatings; heat resistant coatings; phosphors for lighting; optical coatings; optical filters (e.g., due to the unique continuum emission and absorption bands of the increased binding energy hydrogen species); extreme ultraviolet laser media (e.g., as a compound with a with highly positively charged cation); fiber optic cables (e.g., as a material with a low attenuation for electromagnetic radiation and a high refractive index); magnets and magnetic computer storage media (e.g., as a compound with a ferromagnetic cation such as iron, nickel, or chromium); chemical synthetic processing methods; and refining methods. The specific p hydrino hydride ion. (H⁻(n=1/p) where p is an integer) may be selected to provide the desired property such as voltage following doping.

The reactions resulting in the formation of the increased binding energy hydrogen compounds are useful in chemical etching processes, such as semiconductor etching to form computer chips, for example. Hydrino hydride ions are useful as dopants for semiconductors, to alter the energies of the conduction and valance bands of the semiconductor materials. Hydrino hydride ions may be incorporated into semiconductor materials by ion implantation, beam epitaxy, or vacuum deposition. The specific p hydrino hydride ion (H⁻(n=1/p) where p is an integer) may be selected to provide the desired property such as band gap following doping.

Hydrino hydride compounds are useful semiconductor masking agents. Hydrino species-terminated (versus hydrogen-terminated) silicon may be utilized.

The highly stable hydrino hydride ion has application as the negative ion of the electrolyte of a high voltage electrolytic cell. In a further application, a hydrino hydride ion with extreme stability represents a significant improvement as the product of a cathode half reaction of a fuel cell or battery over conventional cathode products of present batteries and fuel cells. The hydrino hydride reaction of Eq. (8) releases much more energy.

A further advanced battery application of hydrino hydride ions is in the fabrication of batteries. A battery comprising, as an oxidant compound, a hydrino hydride compound formed of a highly oxidized cation and a hydrino hydride ion (“hydrino hydride battery”), has a lighter weight, higher voltage, higher power, and greater energy density than a conventional battery. In one embodiment, a hydrino hydride battery has a cell voltage of about 100 times that of conventional batteries. The hydrino hydride battery also has a lower resistance than conventional batteries. Thus, the power of the inventive battery is more than 10,000 times the power of ordinary batteries. Furthermore, a hydrino hydride battery can posses energy densities of greater than 100,000 watt hours per kilogram. The most advanced of conventional batteries have energy densities of less that 200 watt hours per kilogram.

Due to the rapid kinetics and the extraordinary exothermic nature of the reactions of increased binding energy hydrogen compounds, particularly hydrino hydride compounds, other applications include solid fuels.

### 1. Hydride Ion

A hydrino atom

$$H [ \frac{{a}_{H}}{p} ]$$

reacts with an electron to form a corresponding hydrino hydride ion H⁻(n=1/p) as given by Eq. (8). Hydride ions are a special case of two-electron atoms each comprising a nucleus and an “electron 1” and an “electron 2”. The derivation of the binding energies of two-electron atoms is given by the '96 Mills GUT. A brief summary of the hydride binding energy derivation follows whereby the equation numbers of the format (#.###) correspond to those given in the '96 Mills GUT.

The hydride ion comprises two indistinguishable electrons bound to a proton of Z=+1. Each electron experiences a centrifugal force, and the balancing centripetal force (on each electron) is produced by the electric force between the electron and the nucleus. In addition, a magnetic force exits between the two electrons causing the electrons to pair.

1.1 Determination of the Orbitsphere Radius, rₙ

Consider the binding of a second electron to a hydrogen atom to form a hydride ion. The second electron experiences no central electric force because the electric field is zero outside of the radius of the first electron. However, the second electron experiences a magnetic force due to electron 1 causing it to spin pair with electron 1. Thus, electron 1 experiences the reaction force of electron 2 which acts as a centrifugal force. The force balance equation can be determined by equating the total forces acting on the two bound electrons taken together. The force balance equation for the paired electron orbitsphere is obtained by equating the forces on the mass and charge densities. The centrifugal force of both electrons is given by Eq. (7.1) and Eq. (7.2) where the mass is 2mₑ. Electric field lines end on charge. Since both electrons are paired at the same radius, the number of field lines ending on the charge density of electron 1 equals the number that end on the charge density of electron 2. The electric force is proportional to the number of field lines; thus, the centripetal electric force, Fₑₗₑ, between the electrons and the nucleus is

$${F}_{ele ( electron 1.2 )} = \frac{\frac{1}{2} {e}^{2}}{4 {πɛ}_{o} {r}_{n}^{2}} \qquad ( 12 )$$

where εₒ is the permittivity of free-space. The outward magnetic force on the two paired electrons is given by the negative of Eq. (7.15) where the mass is 2mₑ. The outward centrifugal force and magnetic forces on electrons 1 and 2 are balanced by the electric force

$$\frac{{ℏ}^{2}}{2 {m}_{e} {r}_{2}^{3}} = \frac{\frac{1}{2} {e}^{2}}{2 {πɛ}_{o} {r}_{2}^{2}} - \frac{1}{Z} \frac{{ℏ}^{2}}{2 {m}_{e} {r}_{2}^{3}} \sqrt{s ( s + 1 )} \qquad ( 13 )$$

where Z=1. Solving for r₂,

$${r}_{2} = {r}_{1} = {a}_{0} ( 1 + \sqrt{s ( s + 1 )} ) ; s = \frac{1}{2} \qquad ( 14 )$$

That is, the final radius of electron 2, r₂, is given by Eq. (14); this is also the final radius of electron 1.

### 1.2 Binding Energy

During ionization, electron 2 is moved to infinity. By the selection rules for absorption of electromagnetic radiation dictated by conservation of angular momentum, absorption of a photon causes the spin axes of the antiparallel spin-paired electrons to become parallel. The unpairing energy, E_{unpairing} (magnetic), is given by Eq. (7.30) and Eq. (14) multiplied by two because the magnetic energy is proportional to the square of the magnetic field as derived in Eqs. (1.122-1.129). A repulsive magnetic force exists on the electron to be ionized due to the parallel alignment of the spin axes. The energy to move electron 2 to a radius which is infinitesimally greater than that of electron 1 is zero. In this case, the only force acting on electron 2 is the magnetic force. Due to conservation of energy, the potential energy change to move electron 2 to infinity to ionize the hydride ion can be calculated from the magnetic force of Eq. (13). The magnetic work, E_{magwork}, is the negative integral of the magnetic force (the second term on the right side of Eq. (13)) from r₂ to infinity,

$${E}_{magwork} = {\int }_{{r}_{2}}^{∞} \frac{{ℏ}^{2}}{2 {m}_{e} {r}^{3}} \sqrt{s ( s + 1 )} d r \qquad ( 15 )$$

where r₂ is given by Eq. (14). The result of the integration is

$${E}_{magwork} = - \frac{{ℏ}^{2} \sqrt{s ( s + 1 )}}{4 {m}_{e} {{a}_{0}^{2} [ 1 + \sqrt{s ( s + 1 )} ]}^{2}} \qquad ( 16 )$$

where

$$s = \frac{1}{2} .$$

By moving electron 2 to infinity, electron 1 moves to the radius r₁=α_{H}, and the corresponding magnetic energy, E_{electron 1 final} (magnetic), is given by Eq. (7.30). In the present case of an inverse squared central field, the binding energy is one half the negative of the potential energy [Fowles, G. R., Analytical Mechanics, Third Edition, Holt, Rinehart, and Winston, N.Y., (1977), pp. 154-156.]. Thus, the binding energy is given by subtracting the two magnetic energy terms from one half the negative of the magnetic work wherein mₑ is the electron reduced mass μₑ given by Eq. (1.167) due to the electrodynamic magnetic force between electron 2 and the nucleus given by one half that of Eq. (1.164). The factor of one half follows from Eq. (13).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ 1 + \sqrt{s ( s + 1 )} ]}^{2}} - \\ \frac{π {μ}_{o} {e}^{2} {ℏ}^{2}}{{m}_{e}^{2} {a}_{0}^{3}} ( 1 + \frac{{2}^{2}}{{[ 1 + \sqrt{s ( s + 1 )} ]}^{3}} )\end{matrix} \qquad ( 17 )$$

The binding energy of the ordinary hydride ion H⁻(n=1) is 0.75402 eV according to Eq. (17). The experimental value given by Dean [John A. Dean, Editor, Lange's Handbook of Chemistry, Thirteenth Edition, McGraw-Hill Book Company, New York, (1985), p. 3-10.] is 0.754209 eV which corresponds to a wavelength of λ=1644 nm. Thus, both values approximate to a binding energy of about 0.8 eV.

### 1.3 Hydrino Hydride Ion

The hydrino atom H(1/2) can form a stable hydride ion, namely, the hydrino hydride ion H⁻(n=1/2). The central field of the hydrino atom is twice that of the hydrogen atom, and it follows from Eq. (13) that the radius of the hydrino hydride ion H⁻(n=1/2) is one half that of an ordinary hydrogen hydride ion, H⁻(n=1), given by Eq. (14).

$${r}_{2} = {r}_{1} = \frac{{a}_{0}}{2} ( 1 + \sqrt{s ( s + 1 )} ) ; s = \frac{1}{2} \qquad ( 18 )$$

The energy follows from Eq. (17) and Eq. (18).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{2} ]}^{2}} - \\ \frac{π {μ}_{o} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{2} ]}^{3}} )\end{matrix} \qquad ( 19 )$$

The binding energy of the hydrino hydride ion H⁻(n=1/2) is 3.047 eV according to Eq. (19), which corresponds to a wavelength of λ=407 nm. In general, the central field of hydrino atom H(n=1/p); p=integer is p times that of the hydrogen atom. Thus, the force balance equation is

$$\frac{{ℏ}^{2}}{2 {m}_{e} {r}_{2}^{3}} = \frac{\frac{p}{2} {e}^{2}}{4 π {ɛ}_{o} {r}_{2}^{2}} - \frac{1}{Z} \frac{{ℏ}^{2}}{2 {m}_{e} {r}_{2}^{3}} \sqrt{s ( s + 1 )} \qquad ( 20 )$$

where Z=1 because the field is zero for r>r₁. Solving for r₂,

$${r}_{2} = {r}_{1} = \frac{{a}_{0}}{p} ( 1 + \sqrt{s ( s + 1 )} ) ; s = \frac{1}{2} \qquad ( 21 )$$

From Eq. (21), the radius of the hydrino hydride ion H⁻(n=1/p); p=integer is 1/p that of atomic hydrogen hydride, H⁻(n=1), given by Eq. (14). The energy follows from Eq. (20) and Eq. (21).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \\ \frac{π {μ}_{o} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )\end{matrix} \qquad ( 22 )$$

TABLE 1, supra, provides the binding energy of the hydrino hydride ion H⁻(n=1/p) as a function of p according to Eq. (22).

### 2. Hydride Reactor

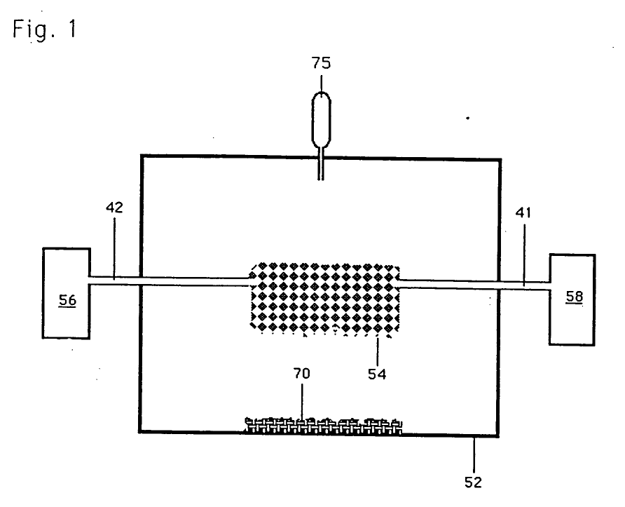

One embodiment of the present invention involves a hydride reactor shown in FIG. 1, comprising a vessel 52 containing a catalysis mixture 54. The catalysis mixture 54 comprises a source of atomic hydrogen 56 supplied through hydrogen supply passage 42 and a catalyst 58 supplied through catalyst supply passage 41. Catalyst 58 has a net enthalpy of reaction of about

$$\frac{m}{2} \cdot 27.21 eV ,$$

where m is an integer, preferably an integer less than 400. The catalysis involves reacting atomic hydrogen from the source 56 with the catalyst 58 to form hydrinos. The hydride reactor further includes an electron source 70 for contacting hydrinos with electrons, to reduce the hydrinos to hydrino hydride ions.

The source of hydrogen can be hydrogen gas, water, ordinary hydride, or metal-hydrogen solutions. The water may be dissociated to form hydrogen atoms by, for example, thermal dissociation or electrolysis. According to one embodiment of the invention, molecular hydrogen is dissociated into atomic hydrogen by a molecular hydrogen dissociating catalyst. Such dissociating catalysts include, for example, noble metals such as palladium and platinum, refractory metals such as molybdenum and tungsten, transition metals, such as nickel and titanium, inner transition metals such as niobium and zirconium, and other such materials listed in the Prior Mills Publications.

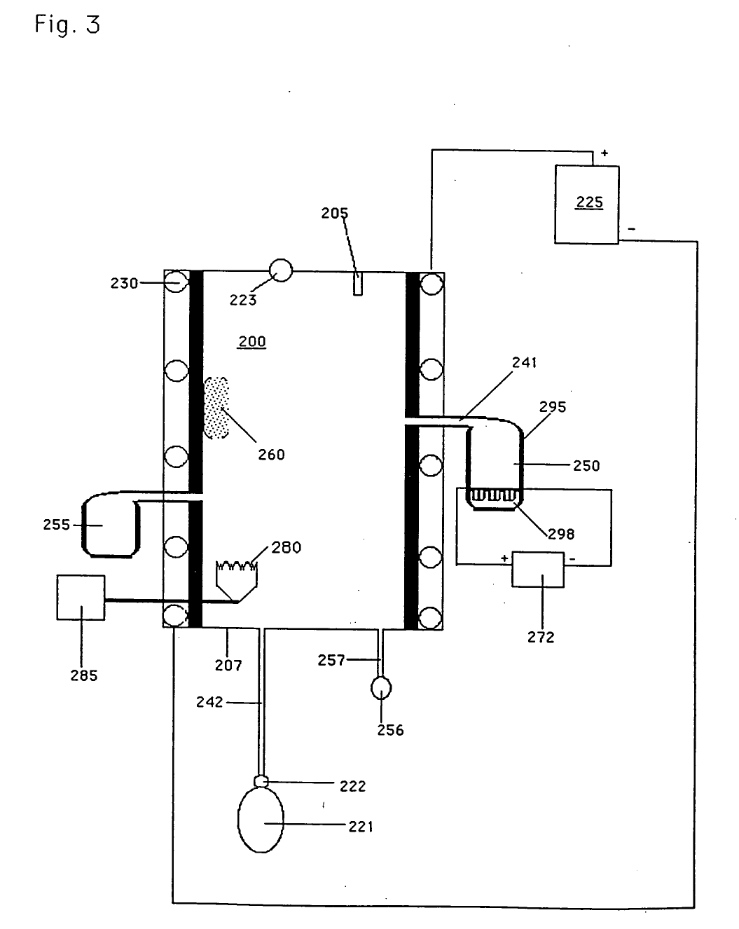

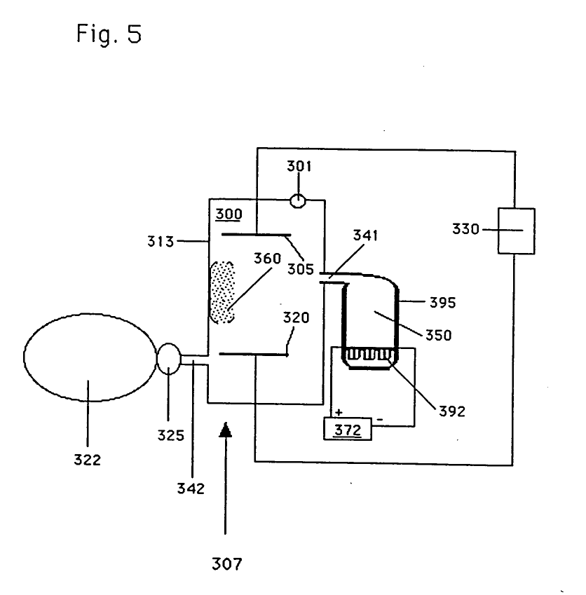

According to another embodiment of the invention utilizing a gas cell hydride reactor or gas discharge cell hydride reactor as shown in FIGS. 3 and 5, respectively, a photon source dissociates hydrogen molecules to hydrogen atoms.

In all the hydrino hydride reactor embodiments of the present invention, the means to form hydrino can be one or more of an electrochemical, chemical, photochemical, thermal, free radical, sonic, or nuclear reaction(s), or inelastic photon or particle scattering reaction(s). In the latter two cases, the hydride reactor comprises a particle source and/or photon source 75 as shown in FIG. 1, to supply the reaction as an inelastic scattering reaction. In one embodiment of the hydrino hydride reactor, the catalyst includes an electrocatalytic ion or couple(s) in the molten, liquid, gaseous, or solid state given in the Tables of the Prior Mills Publications (e.g. TABLE 4 of PCT/US90/01998 and pages 25-46, 80-108 of PCT/US94/02219).

Where the catalysis occurs in the gas phase, the catalyst may be maintained at a pressure less than atmospheric, preferably in the range 10 millitorr to 100 torr. The atomic and/or molecular hydrogen reactant is maintained at a pressure less than atmospheric, preferably in the range 10 millitorr to 100 torr.

Each of the hydrino hydride reactor embodiments of the present invention (electrolytic cell hydride reactor, gas cell hydride reactor, gas discharge cell hydride reactor, and plasma torch cell hydride reactor) comprises the following: a source of atomic hydrogen; at least one of a solid, molten, liquid, or gaseous catalyst for generating hydrinos; and a vessel for containing the atomic hydrogen and the catalyst. Methods and apparatus for producing hydrinos, including a listing of effective catalysts and sources of hydrogen atoms, are described in the Prior Mills Publications. Methodologies for identifying hydrinos are also described. The hydrinos so produced react with the electrons to form hydrino hydride ions. Methods to reduce hydrinos to hydrino hydride ions include, for example, the following: in the electrolytic cell hydride reactor, reduction at the cathode; in the gas cell hydride reactor, chemical reduction by a reactant; in the gas discharge cell hydride reactor, reduction by the plasma electrons or by the cathode of the gas discharge cell; in the plasma torch hydride reactor, reduction by plasma electrons.

### 2.1 Electrolytic Cell Hydride Reactor

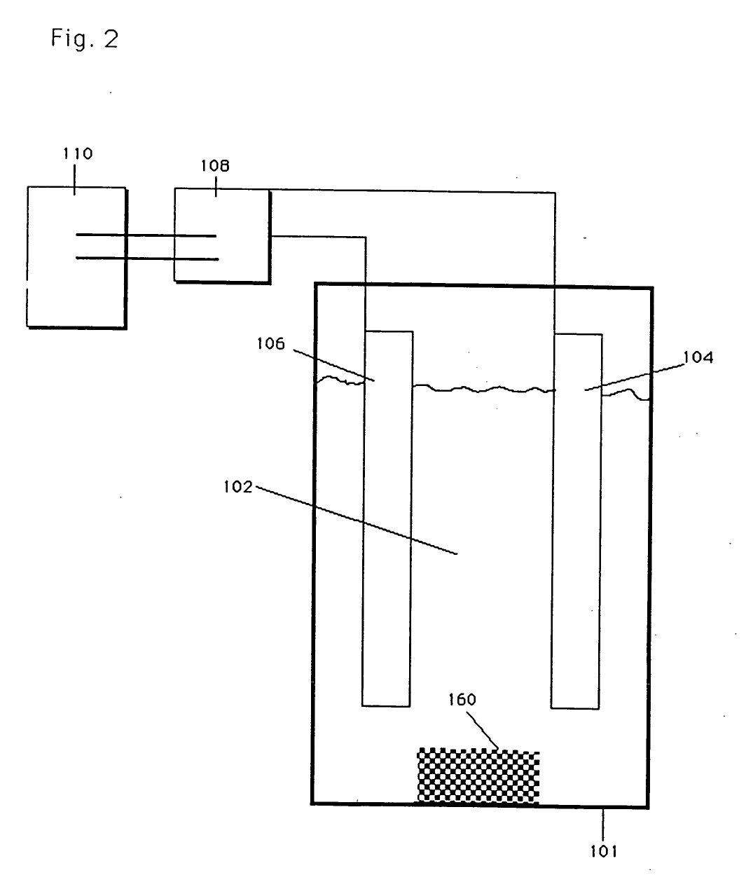

An electrolytic cell hydride reactor of the present invention is shown in FIG. 2. An electric current is passed through an electrolytic solution 102 contained in vessel 101 by the application of a voltage. The voltage is applied to an anode 104 and cathode 106 by a power controller 108 powered by a power supply 110. The electrolytic solution 102 contains a catalyst for producing hydrino atoms.

According to one embodiment of the electrolytic cell hydride reactor, cathode 106 is formed of nickel cathode 106 and anode 104 is formed of platinized titanium or nickel. The electrolytic solution 102 comprising an about 0.5M aqueous K₂CO₃ electrolytic solution (K⁺/K⁺ catalyst) is electrolyzed. The cell is operated within a voltage range of 1.4 to 3 volts. In one embodiment of the invention, the electrolytic solution 102 is molten.

Hydrino atoms form at the cathode 106 via contact of the catalyst of electrolyte 102 with the hydrogen atoms generated at the cathode 106. The electrolytic cell hydride reactor apparatus further comprises a source of electrons in contact with the hydrinos generated in the cell, to form hydrino hydride ions. The hydrinos are reduced (i.e. gain the electron) in the electrolytic cell to hydrino hydride ions. Reduction occurs by contacting the hydrinos with any of the following: 1.) the cathode 106, 2.) a reductant which comprises the cell vessel 101, or 3.) any of the reactor's components such as features designated as anode 104 or electrolyte 102, or 4.) a reductant 160 extraneous to the operation of the cell (i.e. a consumable reductant added to the cell from an outside source). Any of these reductants may comprise an electron source for reducing hydrinos to hydrino hydride ions.

A compound may form in the electrolytic cell between the hydrino hydride ions and cations. The cations may comprise, for example, an oxidized species of the material of the cathode or anode, a cation of an added reductant, or a cation of the electrolyte (such as a cation comprising the catalyst).

### 2.2 Gas Cell Hydride Reactor

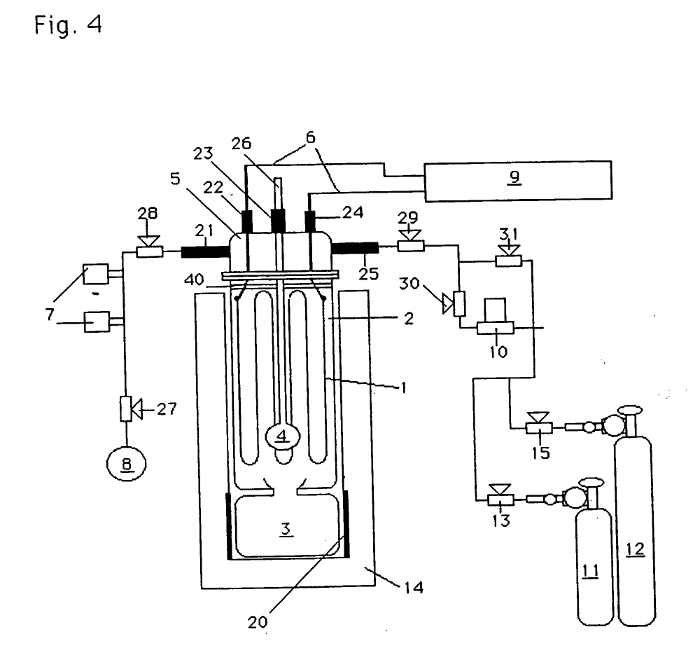

According to another embodiment of the invention, a reactor for producing hydrino hydride ions may take the form of a hydrogen gas cell hydride reactor. A gas cell hydride reactor of the present invention is shown in FIG. 3. Also, the construction and operation of an experimental gas cell hydride reactor shown in FIG. 4 is described in the Identification of Hydrino Hydride Compounds by Mass Spectroscopy Section (Gas Cell Sample), infra. In both cells, reactant hydrinos are provided by an electrocatalytic reaction and/or a disproportionation reaction. Catalysis may occur in the gas phase.

The reactor of FIG. 3 comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257. The apparatus further comprises a source of electrons in contact with the hydrinos to form hydrino hydride ions.

A catalyst 250 for generating hydrino atoms can be placed in a catalyst reservoir 295. The catalyst in the gas phase may comprise the electrocatalytic ions and couples described in the Mills Prior Publications. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The molecular and atomic hydrogen partial pressures in the reactor vessel 207, as well as the catalyst partial pressure, is preferably maintained in the range of 10 millitorr to 100 torr. Most preferably, the hydrogen partial pressure in the reaction vessel 207 is maintained at about 200 millitorr.

Molecular hydrogen may be dissociated in the vessel into atomic hydrogen by a dissociating material. The dissociating material may comprise, for example, a noble metal such as platinum or palladium, a transition metal such as nickel and titanium, an inner transition metal such as niobium and zirconium, or a refractory metal such as tungsten or molybdenum. The dissociating material may be maintained at an elevated temperature by the heat liberated by the hydrogen catalysis (hydrino generation) and hydrino reduction taking place in the reactor. The dissociating material may also be maintained at elevated temperature by temperature control means 230, which may take the form of a heating coil as shown in cross section in FIG. 3. The heating coil is powered by a power supply 225.

Molecular hydrogen may be dissociated into atomic hydrogen by application of electromagnetic radiation, such as UV light provided by a photon source 205

Molecular hydrogen may be dissociated into atomic hydrogen by a hot filament or grid 280 powered by power supply 285.

The hydrogen dissociation occurs such that the dissociated hydrogen atoms contact a catalyst which is in a molten, liquid, gaseous, or solid form to produce hydrino atoms. The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply.

The rate of production of hydrinos by the gas cell hydride reactor can be controlled by controlling the amount of catalyst in the gas phase and/or by controlling the concentration of atomic hydrogen. The rate of production of hydrino hydride ions can be controlled by controlling the concentration of hydrinos, such as by controlling the rate of production of hydrinos. The concentration of gaseous catalyst in vessel chamber 200 may be controlled by controlling the initial amount of the volatile catalyst present in the chamber 200. The concentration of gaseous catalyst in chamber 200 may also be controlled by controlling the catalyst temperature, by adjusting the catalyst reservoir heater 298, or by adjusting a catalyst boat heater when the catalyst is contained in a boat inside the reactor. The vapor pressure of the volatile catalyst 250 in the chamber 200 is determined by the temperature of the catalyst reservoir 295, or the temperature of the catalyst boat, because each is colder than the reactor vessel 207. The reactor vessel 207 temperature is maintained at a higher operating temperature than catalyst reservoir 295 with heat liberated by the hydrogen catalysis (hydrino generation) and hydrino reduction. The reactor vessel temperature may also be maintained by a temperature control means, such as heating coil 230 shown in cross section in FIG. 3. Heating coil 230 is powered by power supply 225. The reactor temperature further controls the reaction rates such as hydrogen dissociation and catalysis.

The preferred operating temperature depends, in part, on the nature of the material comprising the reactor vessel 207. The temperature of a stainless steel alloy reactor vessel 207 is preferably maintained at 200-1200° C. The temperature of a molybdenum reactor vessel 207 is preferably maintained at 200-1800° C. The temperature of a tungsten reactor vessel 207 is preferably maintained at 200-3000° C.

The temperature of a quartz or ceramic reactor vessel 207 is preferably maintained at 200-1800° C.

The concentration of atomic hydrogen in vessel chamber 200 can be controlled by the amount of atomic hydrogen generated by the hydrogen dissociation material. The rate of molecular hydrogen dissociation is controlled by controlling the surface area, the temperature, and the selection of the dissociation material. The concentration of atomic hydrogen may also be controlled by the amount of atomic hydrogen provided by the atomic hydrogen source 280. The concentration of atomic hydrogen can be further controlled by the amount of molecular hydrogen supplied from the hydrogen source 221 controlled by a flow controller 222 and a pressure sensor 223. The reaction rate may be monitored by windowless ultraviolet (UV) emission spectroscopy to detect the intensity of the UV emission due to the catalysis and the hydrino hydride ion and compound emissions.

The gas cell hydride reactor further comprises an electron source 260 in contact with the generated hydrinos to form hydrino hydride ions. In the gas cell hydride reactor of FIG. 3, hydrinos are reduced to hydrino hydride ions by contacting a reductant comprising the reactor vessel 207. Alternatively, hydrinos are reduced to hydrino hydride ions by contact with any of the reactor's components, such as, photon source 205, catalyst 250, catalyst reservoir 295, catalyst reservoir heater 298, hot filament grid 280, pressure sensor 223, hydrogen source 221, flow controller 222, vacuum pump 256, vacuum line 257, catalyst supply passage 241, or hydrogen supply passage 242. Hydrinos may also be reduced by contact with a reductant extraneous to the operation of the cell (i.e. a consumable reductant added to the cell from an outside source). Electron source 260 is such a reductant.

Compounds comprising a hydrino hydride anion and a cation may be formed in the gas cell. The cation which forms the hydrino hydride compound may comprise a cation of the material of the cell, a cation comprising the molecular hydrogen dissociation material which produces atomic hydrogen, a cation comprising an added reductant, or a cation present in the cell (such as the cation of the catalyst).

In another embodiment of the gas cell hydride reactor, the vessel of the reactor is the combustion chamber of an internal combustion engine, rocket engine, or gas turbine. A gaseous catalyst forms hydrinos from hydrogen atoms produced by pyrolysis of a hydrocarbon during hydrocarbon combustion. A hydrocarbon- or hydrogen-containing fuel contains the catalyst. The catalyst is vaporized (becomes gaseous) during the combustion. In another embodiment, the catalyst is a thermally stable salt of rubidium or potassium such as RbF, RbCl, RbBr, RbI, Rb₂S₂, RbOH, Rb₂SO₄, Rb₂CO₃, Rb₃PO₄, and KF, KCl, KBr, KI, K₂S₂, KOH, K₂SO₄, K₂CO₃, K₃PO₄, K₂GeF₄. Additional counterions of the electrocatalytic ion or couple include organic anions, such as wetting or emulsifying agents.

In another embodiment of the invention utilizing a combustion engine to generate hydrogen atoms, the hydrocarbon- or hydrogen-containing fuel further comprises water and a solvated source of catalyst, such as emulsified electrocatalytic ions or couples. During pyrolysis, water serves as a further source of hydrogen atoms which undergo catalysis. The water can be dissociated into hydrogen atoms thermally or catalytically on a surface, such as the cylinder or piston head. The surface may comprise material for dissociating water to hydrogen and oxygen. The water dissociating material may comprise an element, compound, alloy, or mixture of transition elements or inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), or Cs intercalated carbon (graphite).

In another embodiment of the invention utilizing an engine to generate hydrogen atoms through pyrolysis, vaporized catalyst is drawn from the catalyst reservoir 295 through the catalyst supply passage 241 into vessel chamber 200. The chamber corresponds to the engine cylinder. This occurs during each engine cycle. The amount of catalyst 250 used per engine cycle may be determined by the vapor pressure of the catalyst and the gaseous displacement volume of the catalyst reservoir 295. The vapor pressure of the catalyst may be controlled by controlling the temperature of the catalyst reservoir 295 with the reservoir heater 298. A source of electrons, such as a hydrino reducing reagent in contact with hydrinos, results in the formation of hydrino hydride ions.

### 2.3 Gas Discharge Cell Hydride Reactor

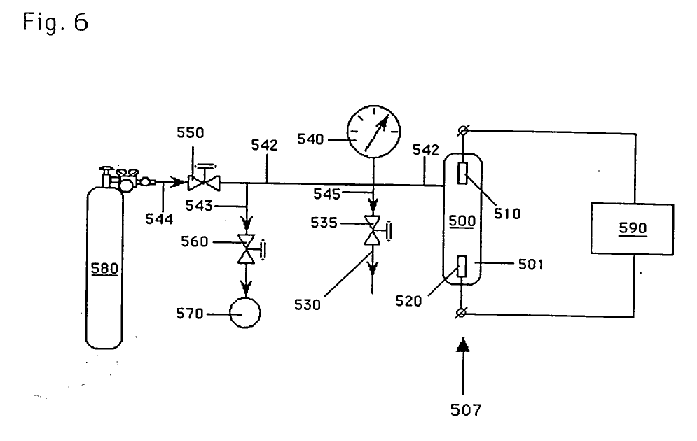

A gas discharge cell hydride reactor of the present invention is shown in FIG. 5, and an experimental gas discharge cell hydride reactor is shown in FIG. 6. The construction and operation of the experimental gas discharge cell hydride reactor shown in FIG. 6 is described in the Identification of Hydrino Hydride Compounds by Mass Spectroscopy Section (Discharge Cell Sample), infra.

The gas discharge cell hydride reactor of FIG. 5, includes a gas discharge cell 307 comprising a hydrogen isotope gas-filled glow discharge vacuum vessel 313 having a chamber 300. A hydrogen source 322 supplies hydrogen to the chamber 300 through control valve 325 via a hydrogen supply passage 342. A catalyst for generating hydrinos, such as the compounds described in Mills Prior Publications (e.g. TABLE 4 of PCT/US90/01998 and pages 25-46, 80-108 of PCT/US94/02219) is contained in catalyst reservoir 395. A voltage and current source 330 causes current to pass between a cathode 305 and an anode 320. The current may be reversible.

In one embodiment of the gas discharge cell hydride reactor, the wall of vessel 313 is conducting and serves as the anode. In another embodiment, the cathode 305 is hollow such as a hollow, nickel, aluminum, copper, or stainless steel hollow cathode.

The cathode 305 may be coated with the catalyst for generating hydrinos. The catalysis to form hydrinos occurs on the cathode surface. To form hydrogen atoms for generation of hydrinos, molecular hydrogen is dissociated on the cathode. To this end, the cathode is formed of a hydrogen dissociative material. Alternatively, the molecular hydrogen is dissociated by the discharge.

According to another embodiment of the invention, the catalyst for generating hydrinos is in gaseous form. For example, the discharge may be utilized to vaporize the catalyst to provide a gaseous catalyst. Alternatively, the gaseous catalyst is produced by the discharge current. For example, the gaseous catalyst may be provided by a discharge in potassium metal to form K⁺/K⁺, rubidium metal to form Rb⁺, or titanium metal to form Ti²⁺. The gaseous hydrogen atoms for reaction with the gaseous catalyst are provided by a discharge of molecular hydrogen gas such that the catalysis occurs in the gas phase.

Another embodiment of the gas discharge cell hydride reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment of the gas discharge cell hydride reactor where catalysis occurs in the gas phase utilizes a controllable gaseous catalyst. Gaseous hydrogen atoms provided by a discharge of molecular hydrogen gas. A chemically resistant (does not react or degrade during the operation of the reactor) open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The gas discharge cell may be operated at room temperature by continuously supplying catalyst. Alternatively, to prevent the catalyst from condensing in the cell, the temperature is maintained above the temperature of the catalyst source, catalyst reservoir 395 or catalyst boat. For example, the temperature of a stainless steel alloy cell is 0-1200° C.; the temperature of a molybdenum cell is 0-1800° C.; the temperature of a tungsten cell is 0-3000° C.; and the temperature of a glass, quartz, or ceramic cell is 0-1800° C. The discharge voltage may be in the range of 1000 to 50,000 volts. The current may be in the range of 1 μA to 1 A, preferably about 1 mA

The gas discharge cell apparatus includes an electron source in contact with the hydrinos, in order to generate hydrino hydride ions.

The hydrinos are reduced to hydrino hydride ions by contact with cathode 305, with plasma electrons of the discharge, or with the vessel 313. Also, hydrinos may be reduced by contact with any of the reactor components, such as anode 320, catalyst 350, heater 392, catalyst reservoir 395, selective venting valve 301, control valve 325, hydrogen source 322, hydrogen supply passage 342 or catalyst supply passage 341. According to yet another variation, hydrinos are reduced by a reductant 360 extraneous to the operation of the cell (e.g. a consumable reductant added to the cell from an outside source).

Compounds comprising a hydrino hydride anion and a cation may be formed in the gas discharge cell. The cation which forms the hydrino hydride compound may comprise an oxidized species of the material comprising the cathode or the anode, a cation of an added reductant, or a cation present in the cell (such as a cation of the catalyst).

In one embodiment of the gas discharge cell apparatus, potassium or rubidium hydrino hydride is prepared in the gas discharge cell 307. The catalyst reservoir 395 contains KI or RbI catalyst. The catalyst vapor pressure in the gas discharge cell is controlled by heater 392. The catalyst reservoir 395 is heated with the heater 392 to maintain the catalyst vapor pressure proximal to the cathode 305 preferably in the pressure range 10 millitorr to 100 torr, more preferably at about 200 mtorr. In another embodiment, the cathode 305 and the anode 320 of the gas discharge cell 307 are coated with KI or RbI catalyst. The catalyst is vaporized during the operation of the cell. The hydrogen supply from source 322 is adjusted with control 325 to supply hydrogen and maintain the hydrogen pressure in the 10 millitorr to 100 torr range.

In one embodiment of the gas discharge cell hydride reactor apparatus, catalysis occurs in a hydrogen gas discharge cell using a catalyst with a net enthalpy of about 27.2 electron volts. The catalyst (e.g. potassium ions) is vaporized by the discharge. The discharge also produces reactant hydrogen atoms. Catalysis using potassium ions results in the emission of extreme ultraviolet (UV) photons. In addition to the transition

$$H [ \frac{{a}_{H}}{1} ] {}^{{K}^{+} / {K}^{+}} H [ \frac{{a}_{H}}{2} ] + 912 Å ,$$

the disproportionation reaction described in the Disproportionation of Energy States Section of PCT/US96/07949 causes additional emission of extreme UV at 912 Å and 304 Å. Extreme UV photons ionize hydrogen resulting in the emission of the normal spectrum of hydrogen which includes visible light. Thus, the extreme UV emission from the catalysis is observable indirectly as indicated by the conversion of the extreme UV to visible wavelengths. At the same time, hydrinos react with electrons to form hydrino hydride ions having the continuum absorption and emission lines given in TABLE 1, supra. These lines are observable by emission spectroscopy which identify catalysis and increased binding energy hydrogen compounds.

### 2.4 Plasma Torch Cell Hydride Reactor

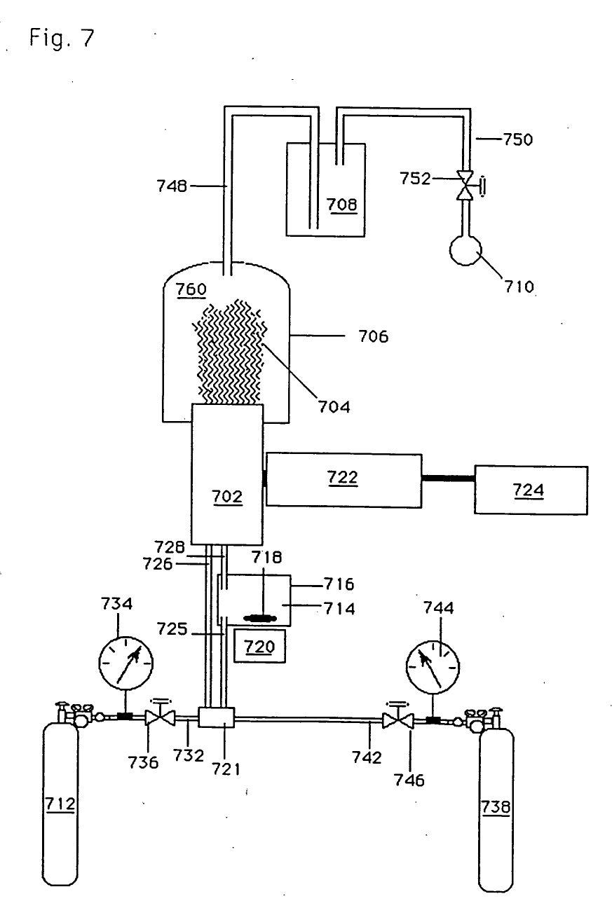

A plasma torch cell hydride reactor of the present invention is shown in FIG. 7. A plasma torch 702 provides a hydrogen isotope plasma 704 enclosed by a manifold 706. Hydrogen from hydrogen supply 738 and plasma gas from plasma gas supply 712, along with a catalyst 714 for forming hydrinos, is supplied to torch 702. The plasma may comprise argon, for example. The catalyst may comprise any of the compounds described in Mills Prior Publications (e.g. TABLE 4 of PCT/US90/01998 and pages 25-46, 80-108 of PCT/US94/02219). The catalyst is contained in a catalyst reservoir 716. The reservoir is equipped with a mechanical agitator, such as a magnetic stirring bar 718 driven by magnetic stirring bar motor 720. The catalyst is supplied to plasma torch 702 through passage 728.

Hydrogen is supplied to the torch 702 by a hydrogen passage 726. Alternatively, both hydrogen and catalyst may be supplied through passage 728. The plasma gas is supplied to the torch by a plasma gas passage 726. Alternatively, both plasma gas and catalyst may be supplied through passage 728.

Hydrogen flows from hydrogen supply 738 to a catalyst reservoir 716 via passage 742. The flow of hydrogen is controlled by hydrogen flow controller 744 and valve 746. Plasma gas flows from the plasma gas supply 712 via passage 732. The flow of plasma gas is controlled by plasma gas flow controller 734 and valve 736. A mixture of plasma gas and hydrogen is supplied to the torch via passage 726 and to the catalyst reservoir 716 via passage 725. The mixture is controlled by hydrogen-plasma-gas mixer and mixture flow regulator 721. The hydrogen and plasma gas mixture serves as a carrier gas for catalyst particles which are dispersed into the gas stream as fine particles by mechanical agitation. The aerosolized catalyst and hydrogen gas of the mixture flow into the plasma torch 702 and become gaseous hydrogen atoms and vaporized catalyst ions (such as K⁺ ions from KI) in the plasma 704. The plasma is powered by a microwave generator 724 wherein the microwaves are tuned by a tunable microwave cavity 722. Catalysis occurs in the gas phase.

The amount of gaseous catalyst in the plasma torch is controlled by controlling the rate that catalyst is aerosolized with the mechanical agitator. The amount of gaseous catalyst is also controlled by controlling the carrier gas flow rate where the carrier gas includes a hydrogen and plasma gas mixture (e.g., hydrogen and argon). The amount of gaseous hydrogen atoms to the plasma torch is controlled by controlling the hydrogen flow rate and the ratio of hydrogen to, plasma gas in the mixture. The hydrogen flow rate and the plasma gas flow rate to the hydrogen-plasma-gas mixer and mixture flow regulator 721 are controlled by flow rate controllers 734 and 744, and by valves 736 and 746. Mixer regulator 721 controls the hydrogen-plasma mixture to the torch and the catalyst reservoir. The catalysis rate is also controlled by controlling the temperature of the plasma with microwave generator 724.

Hydrino atoms and hydrino hydride ions are produced in the plasma 704. Hydrino hydride compounds are cryopumped onto the manifold 706, or they flow into hydrino hydride compound trap 708 through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

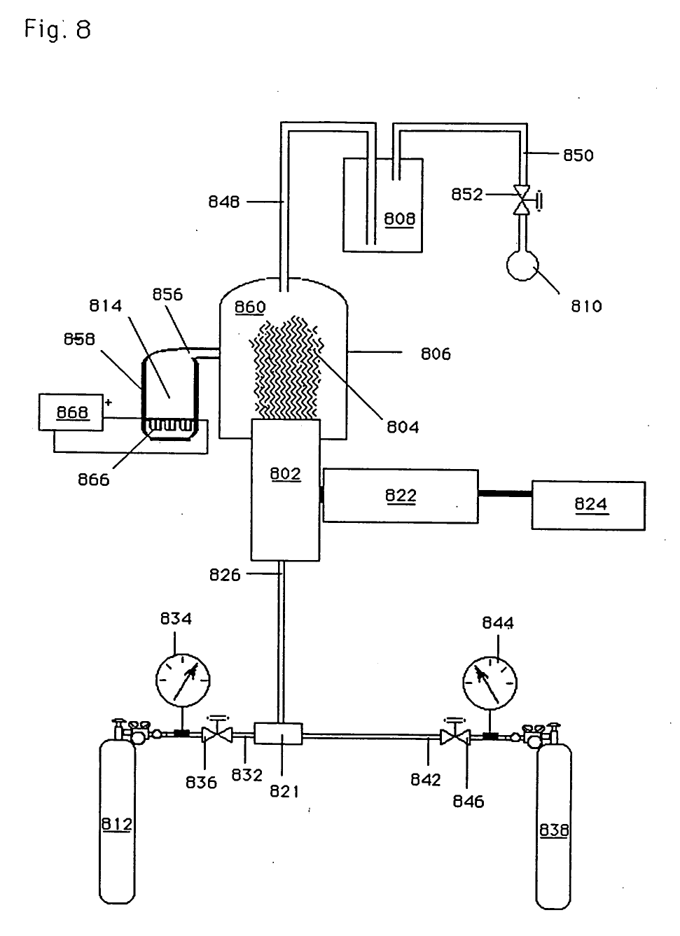

In another embodiment of the plasma torch cell hydride reactor shown in FIG. 8, at least one of plasma torch 802 or manifold 806 has a catalyst supply passage 856 for passage of the gaseous catalyst from a catalyst reservoir 858 to the plasma 804. The catalyst in the catalyst reservoir 858 is heated by a catalyst reservoir heater 866 having a power supply 868 to provide the gaseous catalyst to the plasma 804. The catalyst vapor pressure is controlled by controlling the temperature of the catalyst reservoir 858 by adjusting the heater 866 with its power supply 868. The remaining elements of FIG. 8 have the same structure and function of the corresponding elements of FIG. 7. In other words, element 812 of FIG. 8 is a plasma gas supply corresponding to the plasma gas supply 712 of FIG. 7, element 838 of FIG. 8 is a hydrogen supply corresponding to hydrogen supply 738 of FIG. 7, and so forth.

In another embodiment of the plasma torch cell hydride reactor, a chemically resistant open container such as a ceramic boat located inside the manifold contains the catalyst. The plasma torch manifold forms a cell which is operated at an elevated temperature such that the catalyst in the boat is sublimed, boiled, or volatilized into the gas phase. Alternatively, the catalyst in the catalyst boat is heated with a boat heater having a power supply to provide the gaseous catalyst to the plasma. The catalyst vapor pressure is controlled by controlling the temperature of the cell with a cell heater, or by controlling the temperature of the boat by adjusting the boat heater with an associated power supply.

The plasma temperature in the plasma torch cell hydride reactor is advantageously maintained in the range of 5,000-30,000° C. The cell may be operated at room temperature by continuously supplying catalyst. Alternatively, to prevent the catalyst from condensing in the cell, the cell temperature is maintained above that of the catalyst source, catalyst reservoir 758 or catalyst boat. The operating temperature depends, in part, on the nature of the material comprising the cell. The temperature for a stainless steel alloy cell is preferably 0-1200° C. The temperature for a molybdenum cell is preferably 0-1800° C. The temperature for a tungsten cell is preferably 0-3000° C. The temperature for a glass, quartz, or ceramic cell is preferably 0-1800° C. Where the manifold 706 is open to the atmosphere, the cell pressure is atmospheric.

An exemplary plasma gas for the plasma torch hydride reactor is argon. Exemplary aerosol flow rates are 0.8 standard liters per minute (slm) hydrogen and 0.15 slm argon. An exemplary argon plasma flow rate is 5 slm. An exemplary forward input power is 1000 W, and an exemplary reflected power is 10-20 W.

In other embodiments of the plasma torch hydride reactor, the mechanical catalyst agitator (magnetic stirring bar 718 and magnetic stirring bar motor 720) is replaced with an aspirator, atomizer, or nebulizer to form an aerosol of the catalyst 714 dissolved or suspended in a liquid medium such as water. The medium is contained in the catalyst reservoir 716. Or, the aspirator, atomizer, or nebulizer injects the catalyst directly into the plasma 704. The nebulized or atomized catalyst is carried into the plasma 704 by a carrier gas, such as hydrogen.

The plasma torch hydride reactor further includes an electron source in contact with the hydrinos, for generating hydrino hydride ions. In the plasma torch cell, the hydrinos are reduced to hydrino hydride ions by contacting 1.) the manifold 706, 2.) plasma electrons, or 4.) any of the reactor components such as plasma torch 702, catalyst supply passage 756, or catalyst reservoir 758, or 5) a reductant extraneous to the operation of the cell (e.g. a consumable reductant added to the cell from an outside source).

Compounds comprising a hydrino hydride anion and a cation may be formed in the gas cell. The cation which forms the hydrino hydride compound may comprise a cation of an oxidized species of the material forming the torch or the manifold, a cation of an added reductant, or a cation present in the plasma (such as a cation of the catalyst).

### 3. Purification of Increased Binding Energy Hydrogen Compounds

Increased binding energy hydrogen compounds formed in the hydride reactor may be isolated and purified from the catalyst remaining in the reactor following operation. In the case of the electrolytic cell, gas cell, gas discharge cell, and plasma torch cell hydride reactors, increased binding energy hydrogen compounds are obtained by physical collection, precipitation and recrystallization, or centrifugation. The increased binding energy hydrogen compounds may be further purified by the methods described hereafter.

A method to isolate and purify the increased binding energy hydrogen compounds is described as follows. In the case of the electrolytic cell hydride reactor, water is removed from the electrolyte by evaporation, to obtain a solid mixture. The catalyst containing the increased binding energy hydrogen compound is suspended in a suitable solvent, such as water, which preferentially dissolves the catalyst but not the increased binding energy hydrogen compound. The solvent is filtered, and the insoluble increased binding energy hydrogen compound crystals are collected.

According to an alternative method for isolating and purifying the increased binding energy hydrogen compounds, the remaining catalyst is dissolved and the increased binding energy hydrogen compounds are suspended in a suitable solvent which preferentially dissolves the catalyst but not the increased binding energy hydrogen compounds. The increased binding energy hydrogen compound crystals are then allowed to grow on the surfaces of the cell. The solvent is then poured off and the increased binding energy hydrogen compound crystals are collected.

Increased binding energy hydrogen compounds may also be purified from the catalyst, such as a potassium salt catalyst for example, by a process which uses different cation exchanges of the catalyst or increased binding energy hydrogen compounds, or anion exchanges of the catalyst. The exchanges change the difference in solubility of the increased binding energy hydrogen compounds relative to the catalyst or other ions present. Alternatively, the increased binding energy hydrogen compounds may be precipitated and recrystallized, exploiting differential solubility in solvents such as organic solvents and organic solvent/aqueous mixtures. Yet another method of isolating and purifying the increased binding energy hydrogen compounds from the catalyst is to utilize thin layer, gas, or liquid chromatography, such as high pressure liquid chromatography (HPLC).

Increased binding energy hydrogen compounds may also be purified by distillation, sublimation, or cryopumping such as under reduced pressure, such as 10 μtorr to 1 torr. The mixture of compounds is placed in a heated vessel containing a vacuum and possessing a cryotrap. The cryotrap may comprise a cold finger or a section of the vessel having a temperature gradient. The mixture is heated. Depending on the relative volatilities of the components of the mixture, the increased binding energy hydrogen compounds are collected as the sublimate or the residue. If the increased binding energy hydrogen compounds are more volatile than the other components of the mixture, then they are collected in the cryotrap. If the increased binding energy hydrogen compounds are less volatile, the other mixture components are collected in the cryotrap, and the increased binding energy hydrogen compounds are collected as the residue.

One such method to purify increased binding energy hydrogen compounds from a catalyst such as a potassium salt comprises distillation or sublimation. The catalyst, such as a potassium salt, is distilled off or sublimed and the residual increased binding energy hydrogen compound crystals remains. Accordingly, the product of the hydride reactor is dissolved in a solvent such as water, and the solution is filtered to remove particulates and or contaminants. The anion of the catalyst is then exchanged to increase the difference in the boiling points of increased binding energy hydrogen compounds versus the catalyst. For example, nitrate may be exchanged for carbonate or iodide to reduce the boiling point of the catalyst. In the case of a carbonate catalyst anion, nitrate may replace carbonate with the addition of nitric acid. In the case of an iodide catalyst anion, nitrate may replace iodide with the oxidation of the iodide to iodine with H₂O₂ and nitric acid to yield the nitrate. Nitrite replaces the iodide ion with the addition of nitric acid only. In the final step of the method, the converted catalyst salt is sublimed and the residual increased binding energy hydrogen compound crystals are collected.

Another embodiment of the method to purify increased binding energy hydrogen compounds from a catalyst, such as a potassium salt, comprises distillation, sublimation, or cryopumping wherein the increased binding energy hydrogen compounds have a higher vapor pressure than the catalyst. Increased binding energy hydrogen compound crystals are the distillate or sublimate which is collected. The separation is increased by exchanging the anion of the catalyst to increase its boiling point.

In another embodiment of the increased binding energy hydrogen compound isolation method, substitution of the catalyst anion is employed such that the resulting compound has a low melting point. A mixture comprising increased binding energy hydrogen compounds is melted. The increased binding energy hydrogen compounds are insoluble in the melt and thus precipitates from the melt. The melting is conducted under vacuum such that the anion-exchanged catalyst product such as potassium nitrate partially sublimes. The mixture comprising increased binding energy hydrogen compound precipitate is dissolved in a minimum volume of a suitable solvent such as water which preferentially dissolves the catalyst but not the increased binding energy hydrogen compound crystals. Or, increased binding energy hydrogen compounds are precipitated from a dissolved mixture. The mixture is then filtered to obtain increased binding energy hydrogen compound crystals.

One approach to purifying increased binding energy hydrogen compounds comprises precipitation and recrystallization. In one such method, increased binding energy hydrogen compounds are recrystallized from an iodide solution containing increased binding energy hydrogen compounds and one or more of potassium, lithium or sodium iodide which will not precipitate until the concentration is greater than about 10 M. Thus, increased binding energy hydrogen compounds can be preferentially precipitated. In the case of a carbonate solution, the iodide can be formed by neutralization with hydro iodic acid (HI).

According to one such embodiment to purify increased binding energy hydrogen compounds from a potassium iodide catalyst, the KI catalyst is rinsed from the gas cell, gas discharge cell or plasma torch hydride reactor and filtered. The concentration of the filtrate is then adjusted to approximately 5 M by addition of water or by concentration via evaporation. Increased binding energy hydrogen compound crystals are permitted to form on standing. The precipitate is then filtered. In one embodiment, increased binding energy hydrogen compounds are precipitated from an acidic solution (e.g. the pH range 6 to 1) by addition of an acid such as nitric, hydrochloric, hydro iodic, or sulfuric acid.

In an alternative method of purification, increased binding energy hydrogen compounds are precipitated from an aqueous mixture by addition of a co-precipitating anion, cation or compound. For example, a soluble sulfate, phosphate, or nitrate compound is added to cause the increased binding energy hydrogen compounds to preferentially precipitate. Increased binding energy hydrogen compounds are isolated from the electrolyte of a K₂CO₃ electrolytic cell by the following steps. K₂CO₃ electrolyte from the electrolytic cell is made approximately 1 M in a cation that precipitates hydrino hydride ion or increased binding energy hydrogen compounds, such as the cation provided by LiNO₃, NaNO₃, or Mg(NO₃)₂. In addition or alternatively, the electrolyte may be acidified with an acid such as HNO₃. The solution is the concentrated until a precipitate is formed. The solution is filtered to obtain the crystals. Alternatively, the solution is allowed to evaporate on a crystallization dish so that increased binding energy hydrogen compounds crystallize separately from the other compounds. In this case, the crystals are separated physically.

The increased binding energy hydrogen species can bond to a cation with unpaired electrons such as a transition or rare earth cation to form a paramagnetic or ferromagnetic compound. In one separation embodiment, the increased binding energy hydrogen compounds are separated from impurities, by magnetic separation in crystalline form by sifting the mixture over a magnet (e.g., an electromagnet). The increased binding energy hydrogen compounds adhere to the magnet. The crystals are then removed mechanically, or by rinsing. In the latter case, the rinse liquid is removed by evaporation. In the case of electromagnetic separation, the electromagnet is inactivated and the increased binding energy hydrogen compound crystals are collected.

In alternative separation embodiment, the increased binding energy hydrogen compounds are separated from impurities, by electrostatic separation in crystalline form by sifting the mixture over a charged collector (e.g., a capacitor plate). The increased binding energy hydrogen compounds adhere to the collector. The crystals are then removed mechanically, or by rinsing. In the latter case, the rinse liquid is removed by evaporation. In the case of electrostatic separation, the charged collector is inactivated and the increased binding energy hydrogen compound crystals are collected.

The increased binding energy hydrogen compounds are substantially pure as isolated and purified by the exemplary methods given herein. That is, the isolated material comprises greater than 50 atomic percent of said compound.

The cation of the isolated hydrino hydride ion may be replaced by a different desired cation (e.g. K⁺ replaced by Li⁺) by reaction upon heating and concentrating the solution containing the desired cation or via ion exchange chromatography.

Methods of purification to remove cations and anions to obtain the desired increased binding energy hydrogen compounds include those given by Bailar [Comprehensive Inorganic Chemistry, Editorial Board J. C. Bailar, H. J. Emeleus, R. Nyholm, A. F. Trotman-Dickenson, Pergamon Press] including pp. 528-529 which are incorporated herein by reference.

### 5. Identification of Increased Binding Energy Hydrogen Compounds

The increased binding energy hydrogen compounds may be identified by a variety of methods such as: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solid probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), and 24.) differential scanning calorimetry (DSC).

XPS dispositively identifies each increased binding energy hydrogen species of a compound by its characteristic binding energy. High resolution mass spectroscopy such as TOFSIMS and ESITOFMS provides absolute identification of an increased binding energy hydrogen compound based on its unique high resolution mass. The XRD pattern of each hydrino hydride compound is unique and provides for its absolute identification. Ultraviolet (UV) and visible emission spectroscopy of excited increased binding energy hydrogen compounds uniquely identify them by the presence of characteristic hydrino hydride ion continuum lines and/or characteristic emission lines of increased binding energy hydrogen species of each compound. Spectroscopic identification of increased binding energy hydrogen compounds is obtained by performing extreme ultraviolet (EUV) and ultraviolet (UV) emission spectroscopy and mass spectroscopy of volatilized purified crystals. The excited emission of increased binding energy hydrogen compounds is observed wherein the source of excitation is a plasma discharge, and the mass spectrum is recorded with an on-line mass spectrometer to identify volatilized compounds. An in situ method to spectroscopically identify the catalysis of hydrogen to form hydrinos and to identify hydrino hydride ions and increased binding energy hydrogen compounds is on-line EUV and UV spectroscopy and a mass spectroscopy of a hydrino hydride reactor of the present invention. The emission spectrum of the catalysis of hydrogen and the emission due to formation and excitation of hydrino hydride compounds is recorded.

Increased binding energy hydrogen compounds were dispositively identified by the disclosed methods as given in the EXPERIMENTAL Section.

### 6. Dihydrino

The theoretical introduction to dihydrinos is provided in the '96Mills GUT. Two hydrino atoms

$$H [ \frac{{a}_{H}}{p} ]$$

may react to form a diatomic molecule referred to as a dihydrino

$${H}_{2}^{*} [ 2 {c}^{′} = \frac{\sqrt{2} {a}_{0}}{p} ] \cdot 2 H [ \frac{{a}_{H}}{p} ] \to {H}_{2}^{*} [ 2 {c}^{′} = \frac{\sqrt{2} {a}_{0}}{p} ] \qquad ( 23 )$$

where p is an integer. The dihydrino comprises a hydrogen molecule having a total energy,

$${E}_{T} ( {H}_{2}^{*} [ 2 {c}^{′} = \frac{\sqrt{2} {a}_{0}}{p} ] ) , \\ {E}_{T} ( {H}_{2}^{*} [ 2 {c}^{′} = \frac{\sqrt{2} {a}_{0}}{p} ] ) = - 13.6 eV [ ( 2 {p}^{2} \sqrt{2} - {p}^{2} \sqrt{2} + \frac{{p}^{2} \sqrt{2}}{2} ) ln \frac{\sqrt{2} + 1}{\sqrt{2} - 1} {p}^{2} \sqrt{2} ] \qquad ( 24 )$$

where 2c′ is the internuclear distance and aₒ is the Bohr radius. Thus, the relative internuclear distances (sizes) of dihydrinos are fractional. Without considering the correction due to zero order vibration, the bond dissociation energy,

$${E}_{D} ( {H}_{2}^{*} [ 2 {c}^{′} = \frac{\sqrt{2} {a}_{0}}{p} ] ) ,$$

is given by the difference between the energy of two hydrino atoms each given by the negative of Eq. (1) and the total energy of the dihydrino molecule given by Eq. (24). (The bond dissociation energy is defined as the energy required to break the bond).

$${E}_{T} ( {{H}_{2}^{*} [ 2 {c}^{′} = \frac{2 {a}_{0}}{p} ]}^{+} ) = 13.6 eV ( - 4 {p}^{2} ln 3 + {p}^{2} + 2 {p}^{2} ln 3 ) \qquad ( 26 )$$

The first binding energy, BE₁, of the dihydrino molecular ion with consideration of zero order vibration is about

$$B {E}_{1} = \frac{16.4}{{( \frac{1}{p} )}^{2}} eV \qquad ( 27 )$$

where p is an integer greater than 1, preferably from 2 to 200. Without considering the correction due to zero order vibration, the bond dissociation energy,

$${E}_{D} ( {{H}_{2}^{*} [ 2 {c}^{′} = \frac{2 {a}_{0}}{p} ]}^{+} ) ,$$

is the difference between the negative of the binding energy of the corresponding hydrino atom given by Eq. (1) and

$${E}_{T} ( {{H}_{2}^{*} [ 2 {c}^{′} = \frac{2 {a}_{0}}{p} ]}^{+} )$$

given by Eq. (26).

$${E}_{D} ( {{H}_{2}^{+} [ 2 {c}^{′} = \frac{2 {a}_{o}}{p} ]}^{+} ) = E ( H [ \frac{{a}_{H}}{p} ] ) - {E}_{T} ( {{H}_{2}^{+} [ 2 {c}^{′} = \frac{2 {a}_{o}}{p} ]}^{+} ) \qquad ( 28 )$$

The first binding energy, BE₁, of the dihydrino molecule

$${H}_{2}^{+} [ 2 {c}^{′} = \frac{\sqrt{2} {a}_{o}}{p} ] \to {{H}_{2}^{+} [ 2 {c}^{′} = \frac{2 {a}_{o}}{p} ]}^{+} + {e}^{-} \qquad ( 29 )$$

is given by Eq. (26) minus Eq. (24).

$${BE}_{1} = {E}_{T} ( {{H}_{2}^{+} [ 2 {c}^{′} = \frac{2 {a}_{o}}{p} ]}^{+} ) - {E}_{T} ( {H}_{2}^{+} [ 2 {c}^{′} = \frac{\sqrt{2} {a}_{o}}{p} ] ) \qquad ( 30 )$$

The second binding energy, BE₂, is given by the negative of Eq. (26). The first binding energy, BE₁, of the dihydrino molecule with consideration of zero order vibration is about

$${BE}_{1} = \frac{15.5}{{( \frac{1}{p} )}^{2}} eV \qquad ( 31 )$$

where p is an integer greater than 1, preferably from 2 to 200. The dihydrino and the dihydrino ion are further described in the '96 Mills GUT, and PCT/US96/07949 and PCT/US/94/02219.

The dihydrino molecule reacts with a dihydrino molecular ion to form a hydrino atom H(1/p) and an increased binding energy molecular ion H₃⁺(1/p) comprising three protons (three nuclei of atomic number one) and two electrons wherein the integer p corresponds to that of the hydrino, the dihydrino molecule, and the dihydrino molecular ion. The molecular ion H₃⁺(1/p) is hereafter referred to as the “trihydrino molecular ion”. The reaction is

$${H}_{2}^{+} [ 2 {c}^{′} = \frac{\sqrt{2} {a}_{o}}{p} ] + {{H}_{2}^{+} [ 2 {c}^{′} = \frac{2 {a}_{o}}{p} ]}^{+} \to {H}_{4}^{+} ( 1 / p ) \to {H}_{3}^{+} ( 1 / p ) + H ( 1 / p ) \qquad ( 32 )$$

H₄⁺(1/p) serves as a signature for the presence of dihydrino molecules and molecular ions such as those dihydrino molecules and molecular ions formed by fragmentation of increased binding energy hydrogen compounds in a mass spectrometer, as demonstrated in the Identification of Hydrino Hydride Compounds by Mass Spectroscopy Section and the Identification of the Dihydrino Molecule by Mass Spectroscopy Section, infra.

The dihydrino molecule

$${H}_{2}^{+} [ 2 {c}^{′} = \frac{\sqrt{2 } {a}_{o}}{p} ]$$

also reacts with a proton to form trihydrino molecular ion H₃⁺(1/p). The reaction is

$${H}_{2}^{+} [ 2 {c}^{′} = \frac{\sqrt{2 } {a}_{o}}{p} ] + {H}^{+} \to {H}_{3}^{+} ( 1 / p ) \qquad ( 33 )$$

The binding energy, BE, of the trihydrino molecular ion is about

$$BE = \frac{22.6}{{( \frac{1}{p} )}^{2}} eV \qquad ( 34 )$$

where p is an integer greater than 1, preferably from 2 to 200.

A method to prepare dihydrino gas from the hydrino hydride ion comprises reacting hydrino hydride ion containing compound with a source of protons. The protons may be protons of an acid, protons of a plasma of a gas discharge cell, or protons from a metal hydride, for example The reaction of hydrino hydride ion

$${H}^{-} ( \frac{1}{p} )$$

with a proton is

$${H}^{-} ( \frac{1}{p} ) + {H}^{+} \to {H}_{2}^{+} [ 2 {c}^{′} = \frac{\sqrt{2 } {a}_{o}}{p} ] + energy \qquad ( 35 )$$

One way to generate dihydrino gas from hydrino hydride compound is by thermally decomposing the compound. For example, potassium hydrino hydride is heated until potassium metal and dihydrino gas are formed. An example of a thermal decomposition reaction of hydrino hydride compound

$${M}^{+} {H}^{-} ( \frac{1}{p} ) is$$

is

$$2 {M}^{+} {H}^{-} ( \frac{1}{p} ) {}^{△} {H}_{2}^{+} [ 2 {c}^{′} = \frac{\sqrt{2 } {a}_{o}}{p} ] + energy + 2 M \qquad ( 36 )$$

where M⁺ is the cation.

A hydrino can react with α-proton to form a dihydrino ion which further reacts with an electron to form a dihydrino molecule.

$$H [ \frac{{a}_{H}}{p} ] + {H}^{+} \to {{H}_{2}^{+} [ 2 {c}^{′} = \frac{2 {a}_{o}}{p} ]}^{+} + e - \to {H}_{2}^{+} [ 2 {c}^{′} = \frac{\sqrt{2 } {a}_{o}}{p} ] \qquad ( 37 )$$

The energy of the reaction of the hydrino atom with a proton is given by the negative of the bond energy of the dihydrino ion (Eq. (28)). The energy given by the reduction of the dihydrino ion by an electron is the negative of the first binding energy (Eq. (30)). These reactions emit UV radiation. UV spectroscopy is a way to monitor the emitted radiation.

A reaction for preparing dihydrino gas is given by Eq. (37). Sources of reactant protons comprise, for example, a metal hydride (e.g. a transition metal such as nickel hydride), and a gas discharge cell. In the case of a metal hydride proton source, hydrino atoms are formed in an electrolytic cell comprising a catalyst electrolyte and a metal cathode which forms a hydride. Permeation of hydrino atoms through the metal hydride containing protons results in the synthesis of dihydrinos according to Eq. (37). The resulting dihydrino gas may be collected from the inside of an evacuated hollow cathode that is sealed at one end. The dihydrinos produced according to Eq. (37) diffuse into the cavity of the cathode and are collected. Hydrinos also diffuse through the cathode and react with protons of the hydride of the cathode.

In the case of a gas discharge cell proton source, hydrinos are formed in a hydrogen gas discharge cell wherein a catalyst is present in the vapor phase. Ionization of hydrogen atoms by the gas discharge cell provides protons to react with hydrinos in the gas phase to form dihydrino molecules according to Eq. (37). Dihydrino gas may be purified by gas chromatography or by combusting normal hydrogen with a recombiner such as a CuO recombiner.

According to another embodiment of the present invention, dihydrino is prepared from increased binding energy hydrogen compounds by thermally decomposing the compound to release dihydrino gas. Dihydrino may also be prepared from increased binding energy hydrogen compounds by chemically decomposing the compound. For example, the compound is chemically decomposed by reaction with a cation such as Li⁺ with NiH₆ to liberate dihydrino gas according to the following methods: 1.) run a 0.57M K₂CO₃ electrolytic cell with nickel electrodes for an extended period of time such as one year; 2.) make the electrolyte about 1 M in LiNO₃ and acidify it with HNO₃; 3.) evaporate the solution to dryness; 4.) heat the resulting solid mixture until it melts; 5.) continue to apply heat until the solution turns black from the decomposition of increased binding energy hydrogen compounds such as NiH₆ to NiO, dihydrino gas, and lithium hydrino hydride; 6.) collect the dihydrino gas, and 7.) identify dihydrino by methods such as gas chromatography, gas phase XPS, or Raman spectroscopy.

### 6.1 Dihydrino Gas Identification

Dihydrino gas is identified as a higher ionizing mass two in the mass spectrometer. Dihydrino is also identified by mass spectroscopy by the presence of a m/e=4 peak and a m/e=2 that splits at low pressure. The dihydrino gas peaks occur at retention times different from normal hydrogen during gas chromatography at cryogenic temperatures, after passing through a 100% H₂/O₂ recombiner (e.g. CuO recombiner). In the case of

$${H}_{2}^{+} [ 2 {c}^{′} = \frac{\sqrt{2 } {a}_{o}}{p} ] ,$$

dihydrino gas is identified as the split m/e=2 peak in the high resolution magnetic sector mass spectrometer, as a 62.2 eV peak in the gas phase XPS, and as a peak with 4 times the vibrational energy of normal molecular hydrogen via Raman spectroscopy. In the case of stimulated Raman spectroscopy, a YAG laser excitation is used to observe Raman Stokes and antiStokes lines due to vibration of dihydrino

$${H}_{2}^{+} [ 2 {c}^{′} = \frac{\sqrt{2 } {a}_{o}}{p} ] or {D}_{2}^{+} [ 2 {c}^{′} = \frac{\sqrt{2 } {a}_{o}}{2} ]$$

that is liquefied on the cryopump spectroscopy stage. A further method of identification comprises performing XPS (X-ray Photoelectron Spectroscopy) on dihydrino liquefied on a stage. Dihydrinos may be further identified by XPS by their characteristic binding energies given in TABLE 3 wherein dihydrino is present in a compound comprising dihydrino and at least one other element. Dihydrino is dispositively identified in the EXPERIMENTAL Section.

### 7. Additional Increased Binding Energy Hydrogen Compounds

In a further embodiment of the present invention, hydrino hydride ions are reacted or bonded to any positively charged atom of the periodic chart such as an alkali or alkaline earth cation, or a proton. Hydrino hydride ions may also react with or bond to any organic molecule, inorganic molecule, compound, metal, nonmetal, or semiconductor to form an organic molecule, inorganic molecule, compound, metal, nonmetal, or semiconductor. Additionally, hydrino hydride ions may react with or bond to H₃⁺, H₃⁺(1/p), H₄⁺(1/p), or dihydrino molecular ions

$${{H}_{2}^{*} [ 2 {c}^{′} = \frac{2 {a}_{o}}{p} ]}^{+} .$$

Dihydrino molecular ions may bond to hydrino hydride ions such that the binding energy of the reduced dihydrino molecular ion, the dihydrino molecule

$${H}_{2}^{*} [ 2 {c}^{′} = \frac{\sqrt{2} {a}_{o}}{p} ] ,$$

is less than the binding energy of the hydrino hydride ion

$${H}^{-} ( \frac{1}{p} )$$

of the compound.

The reactants which may react with hydrino hydride ions include neutral atoms, negatively or positively charged atomic and molecular ions, and free radicals. In one embodiment to form hydrino hydride containing compounds, hydrino hydride ions are reacted with a metal. Thus, in one embodiment of the electrolytic cell hydride reactor, hydrino, hydrino hydride ion, or dihydrino produced during operation at the cathode reacts with the cathode to form a compound, and in one embodiment of the gas cell hydride reactor, hydrino, hydrino hydride ion, or dihydrino produced during operation reacts with the dissociation material or source of atomic hydrogen to form a compound. A metal-hydrino hydride material is thus produced.

Exemplary types of compounds of the present invention include those that follow. Each compound of the invention includes at least one hydrogen species H which is a hydrino hydride ion or a hydrino atom; or in the case of compounds containing two or more hydrogen species H, at least one such H is a hydrino hydride ion or a hydrino atom, and/or two or more hydrogen species of the compound are present in the compound in the form of dihydrino molecular ion (two hydrogens) and/or dihydrino molecule (two hydrogens). The compounds of the present invention may further comprise an ordinary hydrogen atom, or an ordinary hydrogen molecule, in addition to one or more of the increased binding energy hydrogen species. In general, such ordinary hydrogen atom(s) and ordinary hydrogen molecule(s) of the following exemplary compounds are herein called “hydrogen”:

H⁻(1/p)H₃⁺; MH, MH₂, and M₂H₂ where M is an alkali cation (in the case of M₂H₂, the alkali cations may be different) and, H is a hydrino hydride ion or hydrino atom; MHₙ=1 to 2 where M is an alkaline earth cation and H is a hydrino hydride ion or hydrino atom; MHX where M is an alkali cation, X is a neutral atom or molecule or a single negatively charged anion such as halogen ion, hydroxide ion, hydrogen carbonate ion, or nitrate ion, and H is a hydrino hydride ion or hydrino atom; MHX where M is an alkaline earth cation, X is a single negatively charged anion such as halogen ion, hydroxide ion, hydrogen carbonate ion, or nitrate ion, and H is a hydrino hydride ion or hydrino atom; MHX where M is an alkaline earth cation, X is a double negatively charged anion such as carbonate ion or sulfate ion, and H is a hydrino atom; M₂HX where M is an alkali cation (the alkali cations may be different), X is a single negatively charged anion such as halogen ion, hydroxide ion, hydrogen carbonate ion, or nitrate ion, and H is a hydrino hydride ion or hydrino atom; MHₙ n=1 to 5 where M is an alkaline cation and H is at least one of a hydrino hydride ion, hydrino atom, dihydrino molecular ion, dihydrino molecule, and may further comprise an ordinary hydrogen atom, or ordinary hydrogen molecule; M₂Hₙ=1 to 4 where M is an alkaline earth cation and H is at least one of a hydrino hydride ion, hydrino atom, dihydrino molecular ion, dihydrino molecule, and may further comprise an ordinary hydrogen atom, or ordinary hydrogen molecule (the alkaline earth cations may be different); M₂XHₙ=1 to 3 where M is an alkaline earth cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom, or ordinary hydrogen molecule (the alkaline earth cations may be different); M₂X₂Hₙ n=1 to 2 where M is an alkaline earth cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom (the alkaline earth cations may be different); M₂X₃H where M is an alkaline earth cation, X is a single negatively charged anion such as halogen ion, hydroxide ion, hydrogen carbonate ion, or nitrate ion, and H is a hydrino hydride ion, or hydrino atom (the alkaline earth cations may be different); M₂XHₙ n=1 to 2 where M is an alkaline earth cation, X is a double negatively charged anion such as carbonate ion or sulfate ion, and H is at least one of a hydrino hydride ion, hydrino atom, dihydrino molecular ion, dihydrino molecule, and may further comprise an ordinary hydrogen atom (the alkaline earth cations may be different); M₂XX′H where M is an alkaline earth cation, X is a single negatively charged anion such as halogen ion, hydroxide ion, hydrogen carbonate ion, or nitrate ion, X′ is a double negatively charged anion such as carbonate ion or sulfate ion, and H is a hydrino hydride ion or hydrino atom (the alkaline earth cations may be different); MM′ Hₙ n=1 to 3 where M is an alkaline earth cation, M′ is an alkali metal cation, and H is at least one of a hydrino hydride ion, hydrino atom, dihydrino molecular ion, dihydrino molecule, and may further comprise an ordinary hydrogen atom, or ordinary hydrogen molecule; MM′ XHₙ n=1 to 2 where M is an alkaline earth cation, M′ is an alkali metal cation, X is a single negatively charged anion such as halogen ion, hydroxide ion, hydrogen carbonate ion, or nitrate ion, and H is at least one of a hydrino hydride ion, hydrino atom, dihydrino molecular ion, dihydrino molecule, and may further comprise an ordinary hydrogen atom; MM′ XH where M is an alkaline earth cation, M′ is an alkali metal cation, X is a double negatively charged anion such as carbonate ion or sulfate ion, and H is a hydrino hydride ion or hydrino atom; MM′ XX′ H where M is an alkaline earth cation, M′ is an alkali metal cation, X and X are each a single negatively charged anion such as halogen ion, hydroxide ion, hydrogen carbonate ion, or nitrate ion, and H is a hydrino hydride ion or hydrino atom; HₙS n=1 to 2 where H is at least one of a hydrino hydride ion, hydrino atom, dihydrino molecular ion, dihydrino molecule, and may further comprise an ordinary hydrogen atom; MSiHₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MXSiHₙ n=1 to 5 where M is an alkali or alkaline earth cation, Si may be replaced by Al, Ni, transition, inner transition, or rare earth element, X is a single negatively charged anion such as halogen ion, hydroxide ion, hydrogen carbonate ion, or nitrate ion, or a double negative charged anion such as carbonate ion or sulfate ion, and H is at least one of a hydrino hydride ion, hydrino atom, dihydrino molecular ion, dihydrino molecule, and may further comprise an ordinary hydrogen atom, or ordinary hydrogen molecule; MAlHₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MHₙ n=1 to 6 where M is a transition, inner transition, or rare earth element cation such as nickel and H is at least one of a hydrino hydride ion, hydrino atom, dihydrino molecular ion, dihydrino molecule, and may further comprise an ordinary hydrogen atom, or ordinary hydrogen molecule; MNiHₙ n=1 to 6 where M is an alkali cation, alkaline earth cation, silicon, or aluminum and H is at least one of a hydrino-hydride ion, hydrino atom, dihydrino molecular ion, dihydrino molecule, and may further comprise an ordinary hydrogen atom, or ordinary hydrogen molecule, and nickel may be substituted by another transition metal, inner transition, or rare earth cation; TiHₙ n=1 to 4 where H is at least one of a hydrino hydride ion, hydrino atom, dihydrino molecular ion, dihydrino molecule, and may further comprise an ordinary hydrogen atom, or ordinary hydrogen molecule; Al₂Hₙ n=1 to 4 where H is at least one of a hydrino hydride ion, hydrino atom, dihydrino molecular ion, dihydrino molecule, and may further comprise an ordinary hydrogen atom, or ordinary hydrogen molecule; MXAlX′ Hₙ n==1 to 2 where M is an alkali or alkaline earth cation, X and X′ are each a single negatively charged anion such as halogen ion, hydroxide ion, hydrogen carbonate ion, or nitrate ion, or a double negative charged anion such as carbonate ion or sulfate ion, H is at least one of a hydrino hydride ion, hydrino atom, dihydrino molecular ion, dihydrino molecule, and may further comprise an ordinary hydrogen atom, and another cation such as Si may replace Al; [KHₘKCO₃]ₙ m, n=integer where H is at least one of a hydrino hydride ion, hydrino atom, dihydrino molecular ion, dihydrino molecule, and may further comprise an ordinary hydrogen atom;

[KHKOH]ₙ n=integer where H is at least one of a hydrino hydride ion, hydrino atom, dihydrino molecular ion, dihydrino molecule, and may further comprise an ordinary hydrogen atom;
[KHₘKNO₃]ₙ⁺nX⁻ m, n=integer where X is a single negatively charged anion such as halogen ion, hydroxide ion, hydrogen carbonate ion, or nitrate ion and H is at least one of a hydrino hydride ion, hydrino atom, dihydrino molecular ion, dihydrino molecule, and may further comprise an ordinary hydrogen atom; [KHKNO₃]ₙ=integer H is at least one of a hydrino hydride ion, hydrino atom, dihydrino molecular ion, dihydrino molecule, and may further comprise an ordinary hydrogen atom; [MHₘM′X]ₙ m, n=integer comprising a neutral compound or an anion or cation where M and M′ are each an alkali or alkaline earth cation, X is a single negatively charged anion such as halogen ion, hydroxide ion, hydrogen carbonate ion, or nitrate ion or a double negatively charged anion such as carbonate ion or sulfate ion, and H is at least one of a hydrino hydride ion, hydrino atom, dihydrino molecular ion, dihydrino molecule, and may further comprise an ordinary hydrogen atom; [MHₘM′X′]ₙ⁺ nX⁻ m, n=integer where M and M′ are each an alkali or alkaline earth cation, X and X′ are each a single negatively charged anion such as halogen ion, hydroxide ion, hydrogen carbonate ion, or nitrate ion or a double negatively charged anion such as carbonate ion or sulfate ion, and H is at least one of a hydrino hydride ion, hydrino atom, dihydrino molecular ion, dihydrino molecule, and may further comprise an ordinary hydrogen atom, and [MHₘM′X′]ₙ⁻ nM″⁺ m, n=integer where M, M′, and M″ are each an alkali or alkaline earth cation, X and X′ are each a single negatively charged anion such as halogen ion, hydroxide ion, hydrogen carbonate ion, or nitrate ion or a double negatively charged anion such as carbonate ion or sulfate ion, and H is at least one of a hydrino hydride ion, hydrino atom, dihydrino molecular ion, dihydrino molecule, and may further comprise an ordinary hydrogen atom.

Preferred metals comprising the increased binding energy hydrogen compounds (such as MHₙ n=1 to 8) include the Group VIB (Cr, Mo, W) and Group IB (Cu, Ag, Au) elements. The compounds are useful for purification of the metals. The purification is achieved via formation of the increased binding energy hydrogen compounds that have a high vapor pressure. Each compound is isolated by cryopumping.

Exemplary silanes, siloxanes, and silicates that may form polymers (up to MW=100,000 dalton), each have unique observed characteristics different from those of the corresponding ordinary compound wherein the hydrogen content is only ordinary hydrogen H. The observed characteristics which are dependent on the increased binding energy of the hydrogen species include stoichiometry, stability at elevated temperature, and stability in air. Exemplary compounds are: M₂SiHₙ n=1 to 8 where M is an alkali or alkaline earth cation (the cations may be different) and H is at least one of a hydrino hydride ion, hydrino atom, dihydrino molecular ion, dihydrino molecule, and may further comprise an ordinary hydrogen atom, or ordinary hydrogen molecule; Si₂Hₙ n=1 to 8 where H is at least one of a hydrino hydride ion, hydrino atom, dihydrino molecular ion, dihydrino molecule, and may further comprise an ordinary hydrogen atom, or ordinary hydrogen molecule; SiHₙ n=1 to 8 where H is at least one of a hydrino hydride ion, hydrino atom, dihydrino molecular ion, dihydrino molecule, and may further comprise an ordinary hydrogen atom, or ordinary hydrogen molecule; SiₙH₄ₙ n=integer where H is at least one of a hydrino hydride ion, hydrino atom, dihydrino molecular ion, dihydrino molecule, and may further comprise an ordinary hydrogen atom, or ordinary hydrogen molecule; SiₙH₃ₙ n=integer where H is at least one of a hydrino hydride ion, hydrino atom, dihydrino molecular ion, dihydrino molecule, and may further comprise an ordinary hydrogen atom, or ordinary hydrogen molecule; SiₙH₄ₙO m, n=integer where H is at least one of a hydrino hydride ion, hydrino atom, dihydrino molecular ion, dihydrino molecule, and may further comprise an ordinary hydrogen atom, or ordinary hydrogen molecule; SiₓH_{4x-2y}O_{y} x, y=integer where H is at least one of a hydrino hydride ion, hydrino atom, dihydrino molecular ion, dihydrino molecule, and may further comprise an ordinary hydrogen atom, or ordinary hydrogen molecule; SiₓH₄ₓO_{y} x, y=integer where H is at least one of a hydrino hydride ion, hydrino atom, dihydrino molecular ion, dihydrino molecule, and may further comprise an ordinary hydrogen atom, or ordinary hydrogen molecule; SiₙH₄.H₂O n=integer where H is at least one of a hydrino hydride ion, hydrino atom, dihydrino molecular ion, dihydrino molecule, and may further comprise an ordinary hydrogen atom, or ordinary hydrogen molecule; SiₙH₂ₙ₊₂ n=integer where H is at least one of a hydrino hydride ion, hydrino atom, dihydrino molecular ion, dihydrino molecule, and may further comprise an ordinary hydrogen atom, or ordinary hydrogen molecule; SiₓH₂ₓ₊₂O_{y} x, y=integer where H is at least one of a hydrino hydride ion, hydrino atom, dihydrino molecular ion, dihydrino molecule, and may further comprise an ordinary hydrogen atom, or ordinary hydrogen molecule; MSi₄ₙH₁₀ₙOₙ n=integer where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MSi₄ₙH₁₀ₙOₙ₊₁ n=integer where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; M_{q}SiₙHₘOₚ q, n, m, p=integer where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; M_{q}SiₙHₘ q, n, m=integer where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; SiₙHₘOₚ n, m, p=integer where H is at least one of a hydrino hydride ion, hydrino atom, dihydrino molecular ion, dihydrino molecule, and may further comprise an ordinary hydrogen atom, or ordinary hydrogen molecule; SiₙHₘ n, m=integer where H is at least one of a hydrino hydride ion, hydrino atom, dihydrino molecular ion, dihydrino molecule, and may further comprise an ordinary hydrogen atom, or ordinary hydrogen molecule; SiO₂Hₙ n=1 to 6 where H is at least one of a hydrino hydride ion, hydrino atom, dihydrino molecular ion, dihydrino molecule, and may further comprise an ordinary hydrogen atom, or ordinary hydrogen molecule; MSiO₂Hₙ n=1 to 6 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; MSi₂Hₙ n=0 to 14 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; M₂SiHₙ n=1 to 8 where M is an alkali or alkaline earth cation and H is at least one of a hydrino hydride ion, hydrino atom, dihydrino molecular ion, dihydrino molecule, and may further comprise an ordinary hydrogen atom, or ordinary hydrogen molecule; and polyalkylsiloxane where H is at least one of a hydrino hydride ion, hydrino atom, dihydrino molecular ion, dihydrino molecule, and may further comprise an ordinary hydrogen atom, or ordinary hydrogen molecule.

In an embodiment of a superconductor of reduced dimensionality of the present invention, hydrino, dihydrino, and/or hydride ion is reacted with or bonded to a source of electrons. The source of electrons may be any positively charged atom of the periodic chart such as an alkali, alkaline earth, transition metal, inner transition metal, rare earth, lanthanide, or actinide cation to form a structure described by a lattice described in '96 Mills GUT (pages 255-264 which are incorporated by reference).

Increased binding energy hydrogen compounds may be oxidized or reduced to form additional such compounds by applying a voltage to the battery disclosed in the HYDRINO HYDRIDE BATTERY Section. The additional compounds may be formed via the cathode and/or anode half reactions.

Alternatively, increased binding energy hydrogen compounds may be formed by reacting hydrino atoms from at least one of an electrolytic cell, a gas cell, a gas discharge cell, or a plasma torch cell with silicon to form terminated silicon such as hydrino atom versus hydrogen terminated silicon. For example, silicon is placed inside the cell such that the hydrino produced therein reacts with the silicon to form the increased binding energy hydrogen species-terminated silicon. The species as a terminator of silicon may serve as a masking agent for solid state electronic circuit production.

Another application of the increased binding energy hydrogen compounds is as a dopant or dopant component in the fabrication of doped semiconductors each with an altered band gap relative to the starting material. For example, the starting material may be an ordinary semiconductor, an ordinary doped semiconductor, or an ordinary dopant such as silicon, germanium, gallium, indium, arsenic, phosphorous, antimony, boron, aluminum, Group III elements, Group IV elements, or Group V elements. In a preferred embodiment of the doped semiconductor, the dopant or dopant component is hydrino hydride ion. Materials such as silicon may be doped with hydrino hydride ions by ion implantation, epitaxy, or vacuum deposition to form a superior doped semiconductor. Apparatus and methods of ion implantation, epitaxy, and vacuum deposition such as those used by persons skilled in the art are described in the following references which are incorporated herein by reference: Fadei Komarov, Ion Beam Modification of Metals, Gordon and Breach Science Publishers, Philadelphia, 1992, especially pp.-1-37; Emanuele Rimini, Ion Implantation: Basics to Device Fabrication, Kluwer Academic Publishers, Boston, 1995, especially pp. 33-252; 315-348; 173-212; J. F. Ziegler, (Editor), Ion Implantation Science and Technology, Second Edition, Academic Press, Inc., Boston, 1988, especially pp. 219-377. The specific p hydrino hydride ion (H⁻(n=1/p) where p is an integer) may be selected to provide the desired property such as band gap following doping.

The increased binding energy hydrogen compounds may be reacted with a thermionic cathode material to lower the Fermi energy of the material. This provides a thermionic generator with a higher voltage than that of the undoped starting material. For example, a starting material is tungsten, molybdenum, or oxides thereof. In a preferred embodiment of a doped thermionic cathode, the dopant is hydrino hydride ion. Materials such as metals may be doped with hydrino hydride ions by ion implantation, epitaxy, or vacuum deposition to form a superior thermionic cathode. Apparatus and methods of ion implantation, epitaxy, and vacuum deposition such as those used by persons skilled in the art are described in the following references which are incorporated herein by reference: Fadei Komarov, Ion Beam Modification of Metals, Gordon and Breach Science Publishers, Philadelphia, 1992, especially pp.-1-37; Emanuele Rimini, Ion Implantation: Basics to Device Fabrication, Kluwer Academic Publishers, Boston, 1995, especially pp. 33-252; 315-348; 173-212; J. F. Ziegler, (Editor), Ion Implantation Science and Technology, Second Edition, Academic Press, Inc., Boston, 1988, especially pp. 219-377.

### 8. Hydrino Hydride Getter

Each of the various reactors of the present invention comprises: a source of atomic hydrogen; at least one of a solid, molten, liquid, or gaseous catalyst; a catalysis vessel containing atomic hydrogen and the catalyst; and a source of electrons. The reactor may further comprise a getter, which functions as a scavenger to prevent hydrino atoms from reacting with components of the cell to form a hydrino hydride compound. The getter may also be used to reverse the reaction between the hydrinos and the cell components to form a hydrino hydride compound containing a substitute cation of the hydrino hydride ion.

The getter may comprise a metal with a low work function, such as an alkali or alkaline earth metal. The getter may alternatively comprise a source of electrons and cations. For example, the electron or cation source may be (1) a plasma of a discharge cell or plasma torch cell providing electrons and protons; (2) a metal hydride such as a transition or rare element hydride providing electrons and protons; or (3) an acid providing protons.

In another embodiment of the getter, the cell components comprise a metal which is regenerated at high temperature, by electrolysis, or by plasma etching, or the metal has a high work function and is resistant to reaction with hydrino to otherwise form hydrino hydride compound.

In yet another getter embodiment, the cell is comprised of a material which reacts with hydrino or hydrino hydride ion to form a composition of matter which is acceptable or superior to the parent material as a component of the cell (e.g. more resilient with a longer functional life-time). For example, the cell of the hydrino hydride reactor may comprise, be lined by or be coated with at least one of 1.) a material that is resistant to oxidation, such as the compounds disclosed herein; 2.) a material which is oxidized by the hydrino such that a protective layer is formed (e.g., an anion impermeable layer that prevents further oxidation); or 3.) a material which forms a protective layer which is mechanically stable, insoluble in the catalysis material, does not diffuse into the catalysis material, and/or is not volatile at the operating temperature of the cell of the hydrino hydride reactor.

Increased binding energy hydrogen metal compounds such as NiHₙ and WHₙ where n is an integer, form during the operation of the hydrino hydride reactor as shown in the EXPERIMENTAL Section, infra. In one embodiment of the present invention, the getter comprises a metal such as nickel or tungsten which forms said compounds that decompose to restore the metal surface of the desired component of the hydrino hydride reactor (e.g., cell wall or hydrogen dissociator). For example, the cell of the hydrino hydride reactor is composed of metal, or is composed of quartz or a ceramic which has been metallized by, for example, vacuum deposition. In this case, the cell comprises the getter.

In the case that the increased binding energy hydrogen compounds have a lower vapor pressure than the catalyst, the getter may a be cryotrap in communication with the cell. The cryotrap condenses the increased binding energy hydrogen compounds when the getter is maintained at a temperature intermediate between the cell temperature and the temperature of the catalyst reservoir. There is little or no condensation of the catalyst in the cryotrap. An exemplary getter comprising the cryotrap 255 of the gas cell hydride reactor is shown in FIG. 3.

In the case that the increased binding energy hydrogen compounds have a higher vapor pressure than the catalyst, the cell possesses a heated catalyst reservoir in communication with the cell. The reservoir provides vaporized catalyst to the cell. Periodically, the catalyst reservoir is maintained at a temperature which causes the catalyst to condense with little or no condensation of the increased binding energy hydrogen compounds. The increased binding energy hydrogen compounds are maintained in the gas phase at the elevated temperature of the cell and are removed by a pump such as a vacuum pump or a cryopump. An exemplary pump 256 of the gas cell hydride reactor is shown in FIG. 3.

The getter may be used in conjunction with the gas cell hydrino hydride reactor to form a continuous chemical reactor to produce increased binding energy hydrogen compounds. The increased binding energy hydrogen compounds so produced in the reactor may have a higher vapor pressure than the catalyst. In that case, the cell possesses a heated catalyst reservoir which continuously provides vaporized catalyst to the cell. The compounds and the catalyst are continuously cryopumped to the getter during operation. The cryopumped material is collected, and the increased binding energy hydrogen compounds are purified from the catalyst by the methods described herein.

As indicated above, the hydrino hydride ion can bond to a cation with unpaired electrons, such as a transition or rare earth cation, to form a paramagnetic or ferromagnetic compound. In one embodiment of the gas cell hydride reactor, the hydrino hydride getter comprises a magnet whereby magnetic hydrino hydride compound is removed from the gas phase by attaching to the magnetic getter.

The electron of a hydrino hydride ion can be removed by a hydrino atom of a higher binding energy level than the product ionized hydrino. The ionized hydrino hydride ion can further undergo catalysis and disproportionation to release further energy. Over time, the hydrino hydride ion products tend toward the most stable hydrino hydride, ion H⁻(n=1/16). By removing or adding hydrino hydride compounds, the power and energy produced by the cell may be controlled. Accordingly, the getter takes the form of a regulator of the vapor pressure of hydrino hydride compounds, to control the power or energy produced by the cell. Such a hydrino hydride compound vapor pressure regulator includes a pump wherein the vapor pressure is determined by the rate of pumping. The hydrino hydride compound vapor pressure regulator also may include a cryotrap wherein the temperature of the cryotrap determines the vapor pressure of the hydrino hydride compound. A further embodiment of the hydrino hydride compound vapor pressure regulator comprises a flow restriction to a cryotrap of constant temperature wherein the flow rate to the trap determines the steady state hydrino hydride compound vapor pressure. Exemplary flow restrictions include adjustable quartz, zirconium, or tungsten plugs. The plug 40 shown in FIG. 4 may be permeable to hydrogen as a molecular or atomic hydrogen source.

### 9. Hydrino Hydride Fuel Cell

As the product of a cathode half reaction of a fuel cell or battery, a hydrino hydride ion with extreme stability represents a significant improvement over conventional cathode products of present batteries and fuel cells. This is due to the much greater energy release of the hydrino hydride reaction of Eq. (8).

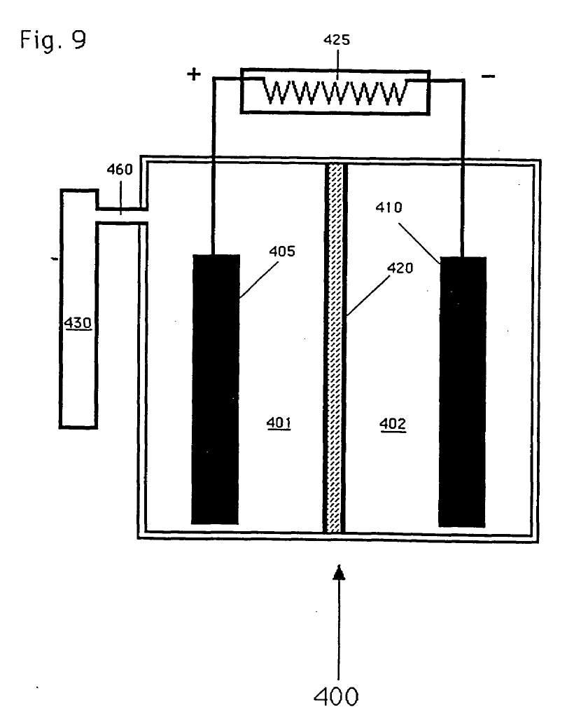

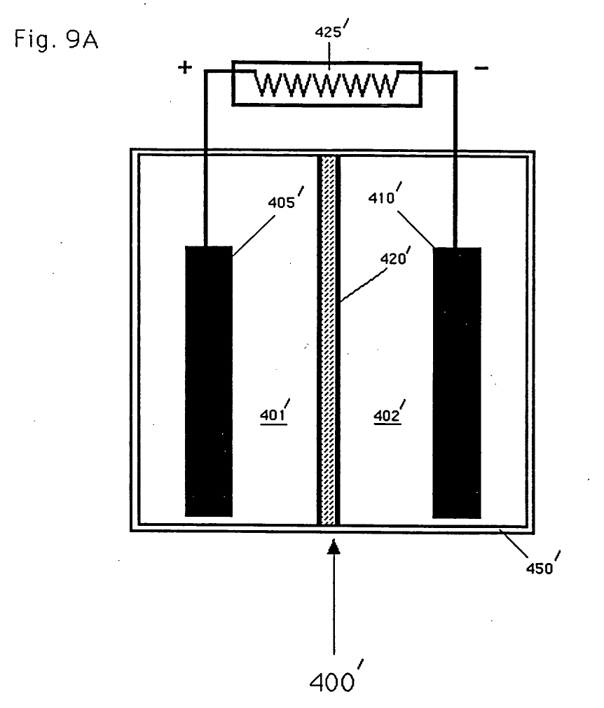

A fuel cell 400 of the present invention shown in FIG. 9 comprises a source of oxidant 430, a cathode 405 contained in a cathode compartment 401 in communication with the source of oxidant 430, an anode 410 in an anode compartment 402, a salt bridge 420 completing a circuit between the cathode compartment 401 and anode compartment 402, and an electrical load 425. The oxidant may be hydrinos from the oxidant source 430. The hydrinos react to form hydrino hydride ions as a cathode half reaction (Eq. (38)). Increased binding energy hydrogen compounds may provide hydrinos. The hydrinos may be supplied to the cathode from the oxidant source 430 by thermally or chemically decomposing increased binding energy hydrogen compounds. The hydrino may be obtained by the reaction of an increased binding energy hydrogen compound with an element that replaces the increased binding energy hydrogen species in the compound. Alternatively, the source of oxidant 430 may be an electrolytic cell, gas cell, gas discharge cell, or plasma torch cell hydrino hydride reactor of the present invention. An alternative oxidant of the fuel cell 400 comprises increased binding energy hydrogen compounds. For example, a cation Mⁿ⁺ (where n is an integer) bound to a hydrino hydride ion such that the binding energy of the cation or atom M⁽ⁿ⁻¹⁾⁺ is less than the binding energy of the hydrino hydride ion

$${H}^{-} ( \frac{1}{p} )$$

may serve as the oxidant. The source of oxidant 430, such as

$${M}^{n +} {{H}^{-} ( \frac{1}{p} )}_{n}$$

may be an electrolytic cell, gas cell, gas discharge cell, or plasma torch cell hydrino hydride reactor of the present invention.

In another fuel cell embodiment, a hydrino source 430 communicates with vessel 400 via a hydrino passage 460. Hydrino source 430 is a hydrino-producing cell according to the present invention, i.e., an electrolytic cell, a gas cell, a gas discharge cell, or a plasma torch cell. Hydrinos are supplied via hydrino passage 460.

The introduced hydrinos,

$$H [ \frac{{a}_{H}}{p} ] ,$$

react with electrons at the cathode 405 of the fuel cell to form hydrino hydride ions, H⁻(1/p). A reductant reacts with the anode 410 to supply electrons to flow through the load 425 to the cathode 405, and a suitable cation completes the circuit by migrating from the anode compartment 402 to the cathode compartment 401 through the salt bridge 420. Alternatively, a suitable anion such as a hydrino hydride ion completes the circuit by migrating from the cathode compartment 401 to the anode compartment 402 through the silt bridge 420. The reductant may be any electrochemical reductant, such as zinc. In one embodiment, the reductant has a high oxidation potential and the cathode may be copper.

The cathode half reaction of the cell is:

$$H [ \frac{{a}_{H}}{p} ] + {e}^{-} \to {H}^{-} ( 1 / p ) \qquad ( 38 )$$

The anode half reaction is:

reductant→reductant⁺+e⁻ (39)

The overall cell reaction is:

$$H [ \frac{{a}_{H}}{p} ] + reductant \to {reductant}^{+} + {H}^{-} ( 1 / p ) \qquad ( 40 )$$

In one embodiment of the fuel cell, the cathode compartment 401 functions as the cathode. In that embodiment, the cathode may serve as a hydrino getter.

### 10. Hydrino Hydride Battery

A battery according to the present invention is shown in FIG. 9A. In battery 400′, the increased binding energy hydrogen compounds are oxidants; they comprise the oxidant of the cathode half reaction of the battery. The oxidant may be, for example, an increased binding energy hydrogen compound comprising a dihydrino molecular ion bound to a hydrino hydride ion such that the binding energy of the reduced dihydrino molecular ion, the dihydrino molecule

$${H}_{2}^{*} [ 2 {c}^{′} = \frac{\sqrt{2} {a}_{o}}{p} ] ,$$

is less than the binding energy of the hydrino hydride ion

$${H}^{-} ( \frac{1}{{p}^{′}} ) .$$

One such oxidant is the compound

$${{H}_{2}^{*} [ 2 {c}^{′} = \frac{2 {a}_{o}}{p} ]}^{+} {H}^{-} ( 1 / {p}^{′} )$$

where p of the dihydrino molecular ion is 2 and p′ of the hydrino hydride ion is 13, 14, 15, 16, 17, 18, or 19.

An alternative oxidant may be a compound comprising a cation Mⁿ⁺ (where n is an integer) bound to a hydrino hydride ion such that the binding energy of the cation or atom M⁽ⁿ⁻¹⁾⁺is less than the binding energy of the hydrino hydride ion

$${H}^{-} ( \frac{1}{p} ) .$$

Cations may be selected from those given in Table 2-1. Ionization Energies of the Elements (eV) [R. L. DeKock, H. B. Gray, Chemical Structure and Bonding, The Benjamin Cummings Publishing Company, Menlo Park, Calif., (1980) pp. 76-77, incorporated herein by reference] such that the n-thionization energy IPₙ to form the cation Mⁿ⁺ from M⁽ⁿ⁻¹⁾⁺ (where n is an integer) is less than the binding energy of the hydrino hydride ion

$${H}^{-} ( \frac{1}{p} ) .$$

Alternatively, a hydrino hydride ion may be selected for a given cation such that the hydrino hydride ion is not oxidized by the cation. Thus, the oxidant

$${M}^{n +} {{H}^{-} ( \frac{1}{p} )}_{n}$$

comprises a cation Mⁿ⁺, where n is an integer and the hydrino hydride ion

$${H}^{-} ( \frac{1}{p} ) ,$$

where p is an integer greater than 1, that is selected such that its binding energy is greater than that of M⁽ⁿ⁻¹⁾⁺. For example, in the case of He²⁺(H⁻(1/p))₂ or Fe⁴⁺ (H⁻(1/p))₄, p of the hydrino hydride ion may be 11 to 20 because the binding energy of He⁺ and Fe³⁺ is 54.4 eV and 54.8 eV, respectively. Thus, in the case of He²⁺(H⁻(1/p))₂, the hydride ion is selected to have a higher binding energy than He⁺(54.4 eV). In the case of Fe⁴⁺ (H⁻(1/p))₄ the hydride ion is selected to have a higher binding energy than Fe³⁺ (54.8 eV). By selecting a stable cation-hydrino hydride anion compound, a battery oxidant is provided wherein the reduction potential is determined by the binding energies of the cation and anion of the oxidant.

In another embodiment of the battery, hydrino hydride ions complete the circuit during battery operation by migrating from the cathode compartment 401′ to the anode compartment 402′, through salt bridge 420′. The bridge may comprise, for example, an anion conducting membrane and/or an anion conductor. The salt bridge may be formed of a zeolite, a lanthanide boride (such as MB₆, where M is a lanthanide), or an alkaline earth boride (such as MB₆ where M is an alkaline earth) which is selective as an anion conductor based on the small size of the hydrino hydride anion.

The battery is optionally made rechargeable. According to an embodiment of a rechargeable battery, the cathode compartment 401′ contains reduced oxidant and the anode compartment contains an oxidized reductant. The battery further comprises an ion which migrates to complete the circuit. To permit the battery to be recharged, the oxidant comprising increased binding energy hydrogen compounds must be capable of being generated by the application of a proper voltage to the battery to yield the desired oxidant. A representative proper voltage is from about one volt to about 100 volts. The oxidant

$${M}^{n +} {{H}^{-} ( \frac{1}{p} )}_{n}$$

comprises a desired cation formed at a desired voltage, selected such that the n-thionization energy IPₙ to form the cation Mⁿ⁺ from M⁽ⁿ⁻¹⁾⁺, where n is an integer, is less than the binding energy of the hydrino hydride ion

$${H}^{-} ( \frac{1}{p} ) ,$$

where p is an integer greater than 1.

According to another rechargeable battery embodiment, the oxidized reductant comprises a source of hydrino hydride ions such as increased binding energy hydrogen compounds. The application of the proper voltage oxidizes the reduced oxidant to a desired oxidation state to form the oxidant of the battery and reduces the oxidized reductant to a desired oxidation state to form the reductant. The hydrino hydride ions complete a circuit by migrating from the anode compartment 402′ to the cathode compartment 401′ through the salt bridge 420′. The salt bridge 420′ may be formed by an anion conducting membrane or an anion conductor. The reduced oxidant may be, for example, iron metal, and the oxidized reductant having a source of hydrino hydride ions may be, for example, potassium hydrino hydride (K⁺H⁻(1/p)). The application of a proper voltage oxidizes the reduced oxidant (Fe) to the desired oxidation state (Fe⁴⁺) to form the oxidant (Fe⁴⁺ (H⁻(1/p))₄ where p of the hydrino hydride ion is an integer from 11 to 20). The application of the proper voltage also reduces the oxidized reductant (K⁺) to the desired oxidation state (K) to form the reductant (potassium metal). The hydrino hydride ions complete the circuit by migrating from the anode compartment 402′ to the cathode compartment 401′ through the salt bridge 420′.

In an embodiment of the battery, the reductant includes a source of protons wherein the protons complete the circuit by migrating from the anode compartment 402′ to the cathode compartment 401′ through the salt bridge 420′. The salt bridge may be a proton conducting membrane and/or a proton conductor such as solid state perovskite-type proton conductors based on SrCeO₃ such as SrCe_{0.9}Y_{0.08}Nb_{0.02}O_{2.97} and SrCeO_{0.95}Yb_{0.05}O₃— alpha. Sources of protons include compounds comprising hydrogen atoms, molecules, and/or protons such as the increased binding energy hydrogen compounds, water, molecular hydrogen, hydroxide, ordinary hydride ion, ammonium hydroxide, and HX wherein X⁻ is a halogen ion. For example, oxidation of the reductant comprising a source of protons generates protons and a gas which may be vented while operating the battery.

In another embodiment of a rechargeable battery, application of a voltage oxidizes the reduced oxidant to the desired oxidation state to form the oxidant, and reduces the oxidized reductant to a desired oxidation state to form the reductant. Protons complete the circuit by migrating from the cathode compartment 401′ to the anode compartment 402′ through the salt bridge 420′ such as a proton conducting membrane and/or a proton conductor.

In an embodiment of the battery, the oxidant and/or reductant are molten with heat supplied by the internal resistance of the battery or by external heater 450′. Hydrino hydride ions and/or protons of the molten battery reactants complete the circuit by migrating through the salt bridge 420′.

In another embodiment of the battery, the cathode compartment 401′ and/or the cathode 405′ may formed by, lined by, or coated with at least one of the following 1.) a material that is resistant to oxidation such as increased binding energy hydrogen compounds; 2.) a material which is oxidized by the oxidant such that a protective layer is formed, e.g., an anion impermeable layer that prevents further oxidation wherein the cathode layer is electrically conductive; 3.) a material which forms a protective layer which is mechanically stable, insoluble in the oxidant material, and/or does not diffuse into the oxidant material wherein the cathode layer is electrically conductive.

To prevent corrosion, the increased binding energy hydrogen compounds comprising the oxidant may be suspended in vacuum and/or may be magnetically or electrostatically suspended such that the oxidant does not oxidize the cathode compartment 401′. Alternatively, the oxidant may suspended and/or electrically isolated from the circuit when current is not desired. The oxidant may be isolated from the wall of the cathode compartment by a capacitor or an insulator.

The hydrino hydride ion may be recovered by the methods of purification given herein and recycled.

In an embodiment of the battery, the cathode compartment 401′ functions as the cathode.

A higher voltage battery comprises an integer number n of said battery cells in series wherein the voltage of the series, compound cell, is about n×60 volts.

### 12. Additional Catalysts

According to one embodiment of the present invention, catalysts are provided which react with ordinary hydride ions and hydrino hydride ions to form increased binding energy hydride ions. In addition, catalysts are provided which react with two-electron atoms or ions to form increased binding energy two-electron atoms or ions. Catalysts are also provided which react with three-electron atoms or ions to form increased binding energy three-electron atoms or ions. In all cases, the reactor comprises a solid, molten, liquid, or gaseous catalyst; a vessel containing the reactant hydride ion, or two- or three-electron atom or ion; and the catalyst. The catalysis occurs by reaction of the reactant with the catalyst. Increased binding energy hydride ions are hydrino hydride ions as previously defined. Increased binding energy two- and three-electron atoms and ions are ions having a higher binding energy than the known corresponding atomic or ionic species.

Hydrino hydride ion H⁻(1/p) of a desired p can be synthesized by reduction of the corresponding hydrino according to Eq. (8). Alternatively, a hydrino hydride ion can be catalyzed to undergo a transition to an increased binding energy state to yield the desired hydrino hydride ion. Such a catalyst has a net enthalpy equivalent to about the difference in binding energies of the product and the reactant hydrino hydride ions each given by Eq. (7). For example, the catalyst for the reaction

$${H}^{-} ( \frac{1}{p} ) \to {H}^{-} ( \frac{1}{p + m} ) \qquad ( 43 )$$

where p and m are integers has an enthalpy of about

$$Binding Energy of {H}^{-} ( \frac{1}{p + m} ) - Binding Energy of {H}^{-} ( \frac{1}{p} ) \qquad ( 44 )$$

where each binding energy is given by Eq. (7). Another catalyst has a net enthalpy equivalent to the magnitude of the initial, increase in potential energy of the reactant hydrino hydride ion corresponding to an increase of its central field by an integer m. For example, the catalyst for the reaction

$${H}^{-} ( \frac{1}{p} ) \to {H}^{-} ( \frac{1}{p + m} ) \qquad ( 45 )$$

where p and m are integers has an enthalpy of about

$$\frac{2 ( p + m ) {e}^{2}}{4 π {ɛ}_{0} r} \qquad ( 46 )$$

where π is pi, e is the elementary charge, ε₀ the permittivity of vacuum, and r is the radius of H⁻(1/p) given by Eq. (21).

A catalyst for the transition of any atom, ion, molecule, or molecular ion to an increased binding energy state has a net enthalpy equivalent to the magnitude of the initial increase in potential energy of the reactant corresponding to an increase of its central field by an integer m. For example, the catalyst for the reaction of any two-electron atom with Z≧2 to an increased binding energy state having a final central field which is increased by m given by

Two Electron Atom(Z)→4 Two Electron Atom(Z+m) (47)

where Z is the number of protons of the atom and m is an integer has an enthalpy of about

$$\frac{2 ( Z - 1 + m ) {e}^{2}}{4 π {ɛ}_{0} r} \qquad ( 48 )$$

where r is the radius of the two electron atom given by Eq. (7.19) of '96 Mills GUT. The radius is

$$r = {a}_{0} ( \frac{1}{Z - 1} - \frac{\sqrt{3 / 4}}{Z ( Z - 1 )} ) \qquad ( 49 )$$

where aₒ is the Bohr radius. A catalyst for the reaction of lithium to an increased binding energy state having a final central field which is increased by m has an enthalpy of about

$$\frac{( Z - 2 + m ) {e}^{2}}{4 π {ɛ}_{0} {r}_{3}} \qquad ( 50 )$$

where r₃ is the radius of the third electron of lithium given by Eq. (10.13) of '96 Mills GUT. The radius is.

$${r}_{3} = \frac{{a}_{o}}{[ 1 - \frac{\sqrt{3 / 4}}{4 ( \frac{1}{2} - \frac{\sqrt{3 / 4}}{6} )} ]} \\ {r}_{3} = 2.5559 {a}_{o} \qquad ( 51 )$$

A catalyst for the reaction of any three-electron atom having Z>3 to an increased binding energy state having a final central field which is increased by m has an enthalpy of about

$$\frac{( Z - 2 + m ) {e}^{2}}{4 π {ɛ}_{0} {r}_{3}} \qquad ( 52 )$$

where r₃ is the radius of the third electron of the three electron atom given by Eq. (10.37) of '96 Mills GUT. The radius is

$${r}_{3} = \frac{{a}_{o} [ 1 + [ \frac{Z - 3}{Z - 2} ] \frac{{r}_{1}}{{r}_{3}} 10 \sqrt{\frac{3}{4}} ]}{[ ( Z - 2 ) - \frac{\sqrt{\frac{3}{4}}}{4 {r}_{1}} ]} , {r}_{1} in units of {a}_{o} \qquad ( 53 )$$

where r₁ the radius of electron one and electron two given by Eq. (49).

### 13. Experimental

### 13.1 Identification of Hydrinos, Dihydrinos, and Hydrino Hydride Ions by XPS (X-ray Photoelectron Spectroscopy)

XPS is capable of measuring the binding energy, E_{b}, of each electron of an atom. A photon source with energy Eₕᵥ is used to ionize electrons from the sample. The ionized electrons are emitted with energy E_{kinetic}:

E_{kinetic}=E_{hV}−E_{b}−Eᵣ (54)

where Eᵣ is a negligible recoil energy. The kinetic energies of the emitted electrons are measured by measuring the magnetic field strengths necessary to have them hit a detector. E_{kinetic} and Eₕᵥ are experimentally known and are used to calculate E_{b}, the binding energy of each atom. Thus, XPS incontrovertibly identifies an atom.

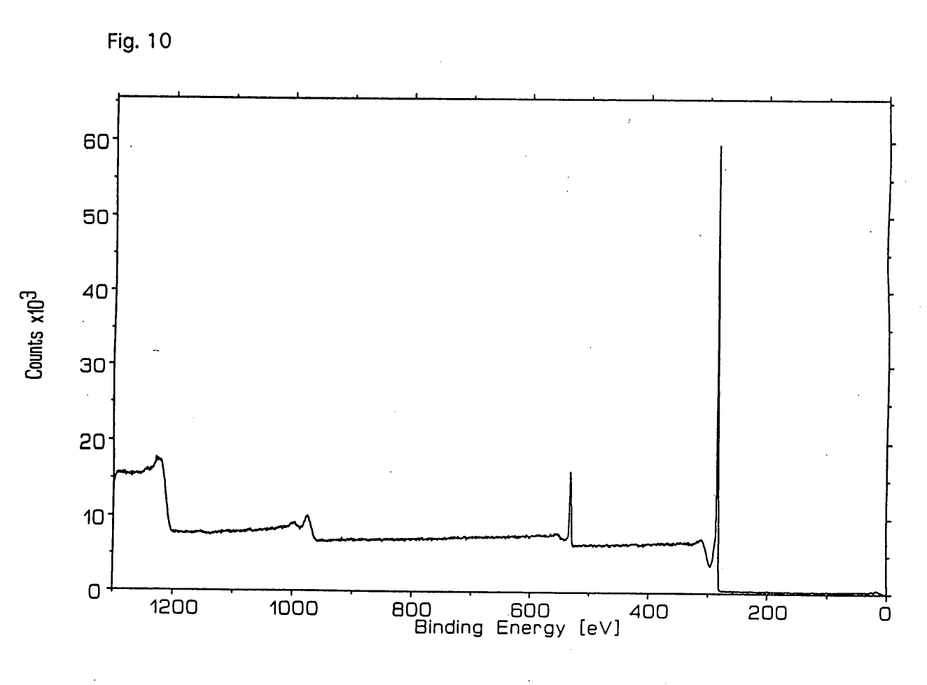

Increased binding energy hydrogen compounds are given in the Additional Increased Binding Energy Compounds Section. The binding energy of various hydrino hydride ions and hydrinos may be obtained according to Eq. (7) and Eq. (1), respectively. XPS was used to confirm the production of the n=1/2 to n=1/16 hydrino hydride ions, E_{b}=3 eV to 73 eV, the n=1/2 to n=1/4 hydrinos, E_{b}=54.4 eV to 217.6 eV, and the n=1/2 to n=1/4 dihydrino molecules, E_{b}=62.3 to 248 eV. In the case of hydrino atoms and dihydrino molecules, this range is the lowest magnitude in energy. The peaks in this range are predicted to be the most abundant. In the case of hydrino hydride ion, n=1/16 is the most stable hydrino hydride ion. Thus, XPS of the energy range E_{b}=3 eV to 73 eV detects these states. XPS was performed on a surface without background interference to these peaks by the cathode. Carbon has essentially zero background from 0 eV to 287 eV as shown in FIG. 10. Thus, in the case of a carbon cathode, there was no interference in the n=1/2 to n=1/16 hydrino hydride ion, the n=1/2 to n=1/4 hydrino, and the n=1/2 to n=1/4 dihydrino peaks.

The hydrino hydride ion binding energies according to Eq. (7) are given in TABLE 1, hydrino binding energies according to Eq. (1) appear in TABLE 2, and dihydrino molecular binding energies according to Eq. (31) are given in TABLE 3.

TABLE 2
The representative binding energy of the hydrino atom as a
function of n, Eq. (1).

| n | E_{b} (eV) |
|---|---|
| 1 | 13.6 |
| ½ | 54.4 |
| ⅓ | 122.4 |
| ¼ | 217.6 |

TABLE 3
The representative binding energy of the dihydrino molecule
as a function of n, Eq. (31).

| n | E_{b} (eV) |
|---|---|
| 1 | 15.46 |
| ½ | 62.3 |
| ⅓ | 139.5 |
| ¼ | 248 |

### 13.1.1 Experimental Method of Hydrino Atom and Dihydrino Molecule Identification by XPS

A series of XPS analyses were made on a carbon cathode used in electrolysis of aqueous potassium carbonate by the Zettlemoyer Center for Surface Studies, Sinclair Laboratory, Lehigh University to identify hydrino and dihydrino binding energy peaks wherein the sample was thoroughly washed to remove water soluble hydrino hydride compounds. A high quality spectrum was obtained over a binding energy range of 300 to 0 eV. This energy region completely covers the C 2 p region as well as the region around 55 eV which is the approximate location of the H(n=1/2) binding energy, 54.4 eV, the region around 123 eV which is the approximate location of the H(n=1/3) binding energy, 122.4 eV, the region around 218 eV which is the approximate location of the H(n=1/4) binding energy, 217.6 eV, the region around 63 eV which is the approximate location of the dihydrino molecule

$${H}_{2}^{*} [ n = \frac{1}{2} ; 2 {c}^{′} = \frac{\sqrt{2} {a}_{0}}{2} ]$$

binding energy, 62.3 eV, the region around 140 eV which is the approximate location of the dihydrino molecule

$${H}_{2}^{*} [ n = \frac{1}{3} ; 2 {c}^{′} = \frac{\sqrt{2} {a}_{0}}{3} ]$$

binding energy, 139.5 eV, and the region around 250 eV which is the approximate location of the dihydrino molecule

$${H}_{2}^{*} [ n = \frac{1}{4} ; 2 {c}^{′} = \frac{\sqrt{2} {a}_{0}}{4} ]$$

binding energy, 248 eV.

Sample #1. The cathode and anode each comprised a 5 cm by 2 mm diameter high purity glassy carbon rod. The electrolyte comprised 0.57 M K₂CO₃ (Puratronic 99.999%). The electrolysis was performed at 2.75 volts for three weeks. The cathode was removed from the cell, thoroughly rinsed immediately with distilled water, and dried with a N₂ stream. A piece of suitable size was cut from the electrode, mounted on a sample stub, and placed in the vacuum system.

### 13.1.2 Results and Discussion

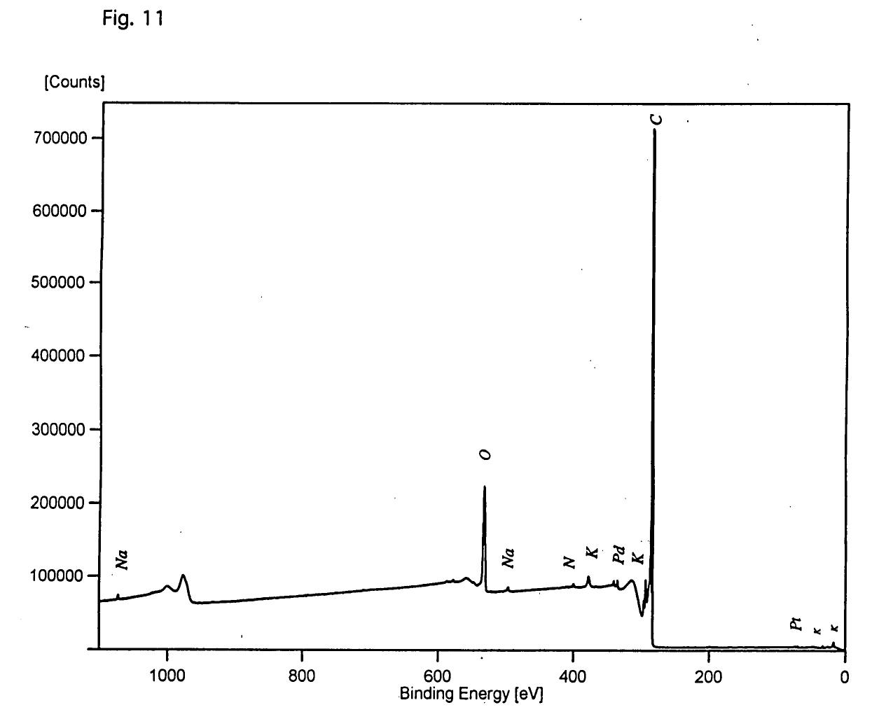

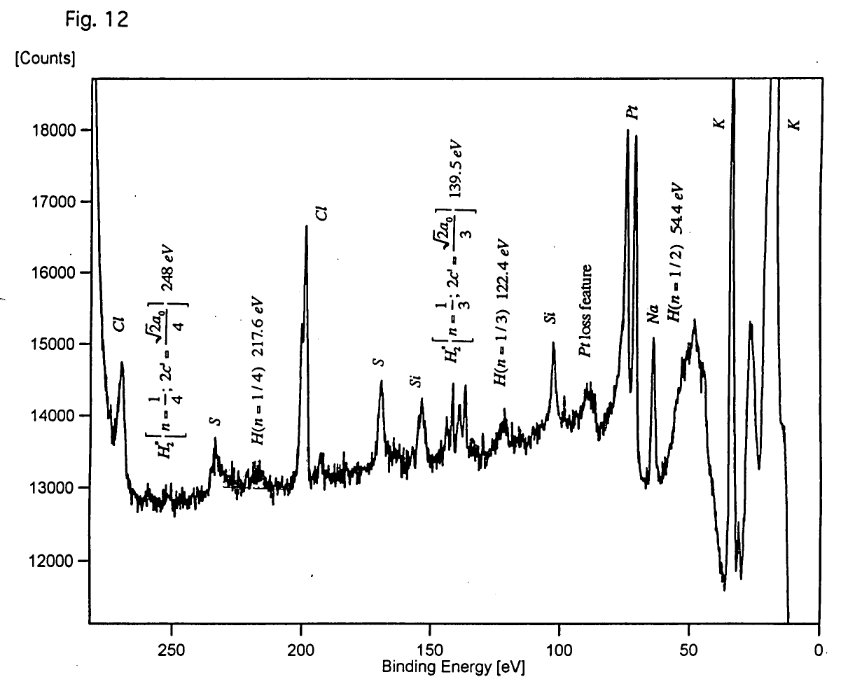

The 0 to 1200 eV binding energy region of an X-ray Photoelectron Spectrum (XPS) of a control glassy carbon rod is shown in FIG. 10. A survey spectrum of sample #1 is shown in FIG. 11. The primary elements are identified on the figure. Most of the unidentified peaks are secondary peaks or loss features associated with the primary elements. FIG. 12 shows the low binding energy range (0-285 eV) for sample #1. Shown in FIG. 12 is the hydrino atom H(n=1/2) peak at a binding energy of 54 eV, the hydrino atom H(n=1/3) at a binding energy of 122.5 eV, and the hydrino atom H(n=1/4) at a binding energy of 218 eV. These broad labeled peaks are the ones of most interest because they fall near the predicted binding energy for the hydrino (n=1/2), 54.4 eV, (n=1/3), 122.4 eV, and (n=1/4), 217.6 eV, respectively. Although the agreement is remarkable, it was necessary to eliminate all other possible known explanations before assigning the 54 eV, 122.5 eV, and 218 eV features to the hydrino, H(n=1/2), H(n=1/3), and H(n=1/4), respectively. As shown below, each of these possible known explanations are eliminated.

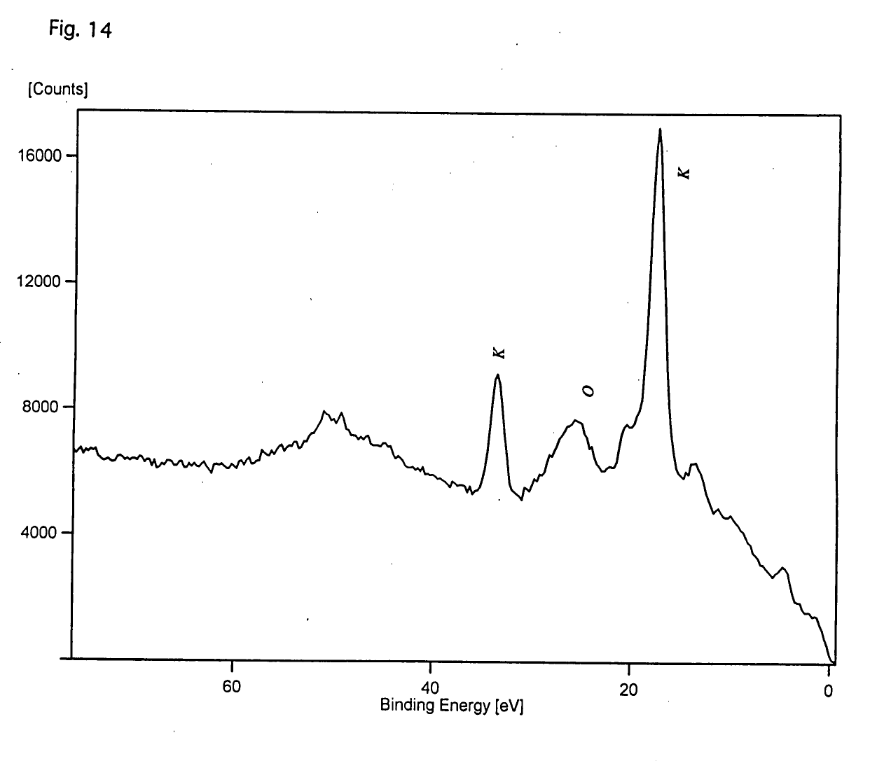

Elements that potentially could give rise to a peak near 54 eV can be divided into three categories: 1.) fine structure or loss features associated with one of the major surface components, namely carbon (C) or potassium (K); 2.) elements that have their primary peaks in the vicinity of 54 eV, namely lithium (Li); 3.) elements that have their secondary peaks in the vicinity of 54 eV, namely iron (Fe). In the case of fine structure or loss features, carbon is eliminated due to the absence of such fine structure or loss features associated with carbon as shown in the XPS spectrum of pure carbon, FIG. 10. Potassium is eliminated because the shape of the 54 eV feature is distinctly different from the recoil feature as shown in FIG. 14. Lithium (Li) and iron (Fe) are eliminated due to the absence of the other peaks of these elements, some of which would appear with much greater intensity than the peak of about 54 eV (e.g. the 710 and 723 eV peaks of Fe are missing from the survey scan and the oxygen peak at 23 eV is too small to be due to LiO). These XPS results are consistent with the assignment of the broad peak at 54 eV to the hydrino, H(n=1/2).

Elements that potentially could give rise to a peak near 122.4 eV can be divided into two categories: fine structure or loss features associated with one of the major surface components, namely carbon (C); elements that have their secondary peaks in the vicinity of 122.4 eV, namely copper (Cu) and iodine (I). In the case of fine structure or loss features, carbon is eliminated due to the absence of such fine structure or loss features associated with carbon as shown in the XPS spectrum of pure carbon, FIG. 10. The cases of elements' that have their primary or secondary peaks in the vicinity of 122.4 eV are eliminated due to the absence of the other peaks of these elements, some of which would appear with much greater intensity than the peak of about 122.4 eV (e.g. the 620 and 631 eV peaks of I are missing and the 931 and 951 eV peaks of Cu are missing). These XPS results are consistent with the assignment of the broad peak at 122.5 eV to the hydrino, H(n=1/3). Elements that potentially could give rise to a peak near 217.6 eV can be divided into two categories: fine structure or loss features associated with one of the major surface components, namely carbon (C); fine structure or loss features associated with one of the major surface contaminants, namely chlorine (Cl). In the case of fine structure or loss features, carbon is eliminated due to the absence of such fine structure or loss features associated with carbon as shown in the XPS spectrum of pure carbon, FIG. 10. The case of elements that have their primary peaks in the vicinity of 217.6 eV is unlikely because the binding energies of chlorine in this region are 199 eV and 201 eV which does not match the peak at 217.6 eV. Moreover, the flat baseline is inconsistent the assignment of a chlorine recoil peak. These XPS results are consistent with the assignment of the broad peak at 218 to H(n=1/4).

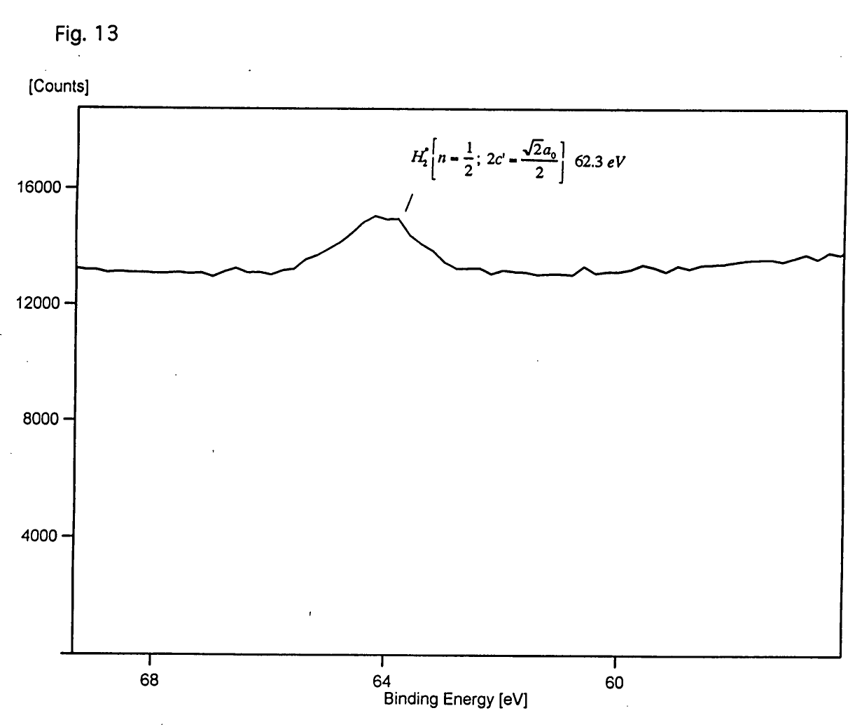

Shown in FIG. 13 is the dihydrino

$${H}_{2}^{*} [ n = \frac{1}{2} ; 2 {c}^{′} = \frac{\sqrt{2} {a}_{0}}{2} ]$$

molecular peak at a binding energy of 63 eV as shoulder on the Na peak. Shown in FIG. 12 are the dihydrino

$${H}_{2}^{*} [ n = \frac{1}{3} ; 2 {c}^{′} = \frac{\sqrt{2} {a}_{0}}{3} ]$$

molecular peak at a binding energy of 140 eV and the dihydrino

$${H}_{2}^{*} [ n = \frac{1}{4} ; 2 {c}^{′} = \frac{\sqrt{2} {a}_{0}}{4} ]$$

molecular peak at a binding energy of 249 eV. Although the agreement is remarkable, it was necessary to eliminate all other possible explanations before assigning the 63 eV, 140 eV, and 249 eV features to the dihydrino,

$${H}_{2}^{*} [ n = \frac{1}{2} ; 2 {c}^{′} = \frac{\sqrt{2} {a}_{0}}{2} ] , {H}_{2}^{*} [ n = \frac{1}{3} ; 2 {c}^{′} = \frac{\sqrt{2} {a}_{0}}{3} ] , and$$

$${H}_{2}^{*} [ n = \frac{1}{4} ; 2 {c}^{′} = \frac{\sqrt{2} {a}_{0}}{4} ] ,$$

respectively.

The only substantial candidate element that potentially could give rise to a peak near 63 eV is Ti; however, none of the other Ti peaks are present. In the case of the 140 eV peak, the only substantial candidate elements are Zn and Pb. These elements are eliminated because both elements would give rise to other peaks of equal or greater intensity (e.g. 413 eV and 435 eV for Pb and 1021 eV and 1044 eV for Zn) which are absent. In the case of the 249 eV peak, the only substantial candidate element is Rb. This element is eliminated because it would give rise to other peaks of equal or greater intensity (e.g. 240, 111, and 112 Rb peaks) which are absent.

The XPS results are consistent with the assignment of the shoulder at 63 eV to

$${H}_{2}^{*} [ n = \frac{1}{2} ; 2 {c}^{′} = \frac{\sqrt{2} {a}_{0}}{2} ] ,$$

the split peaks at 140 eV to

$${H}_{2}^{*} [ n = \frac{1}{3} ; 2 {c}^{′} = \frac{\sqrt{2} {a}_{0}}{3} ] ,$$

and the split peaks at 249 eV to

$${H}_{2}^{*} [ n = \frac{1}{4} ; 2 {c}^{′} = \frac{\sqrt{2} {a}_{0}}{4} ] .$$

These results agree with the predicted binding energies given by Eq. (31) as shown in TABLE 3.

Hydrino atoms and dihydrino molecules may bind with hydrino hydride ions forming compounds such as NiHₙ where n is an integer. This is demonstrated in the Identification of Hydrino Hydride Compounds by Time-Of-Flight-Secondary-Ion-Mass-Spectroscopy (TOFSIMS) Section, and represents novel chemistry. The presence of hydrino and dihydrino peaks is enhanced by the presence of platinum and palladium on this sample which can form such bonds. The abnormal breath of the peaks, shifting of their energy, and the splitting of peaks is consistent with this type of bonding to multiple elements.

### 13.1.3 Experimental Method of Hydrino Hydride Ion Identification by XPS

A series of XPS analyses were made on a carbon cathodes used in electrolysis of aqueous potassium carbonate and on crystalline samples by the Zettlemoyer Center for Surface Studies, Sinclair Laboratory, Lehigh University, to identify hydrino hydride ion binding energy peaks. A high quality spectrum was obtained over a binding energy range of 0 to 300 eV. This energy region completely covers the C 2 p region and the region around the hydrino hydride ion binding energies 3 eV (H(n=1/2)) to 73 eV (H⁻(n=116)). (In some cases, the region around 3 eV was difficult to obtain due to sample charging). Samples #2 and #3 were prepared as follows:

### 13.1.3.1 Carbon Electrode Samples

Sample #2. The cathode and anode each comprised a 5 cm by 2 mm diameter high purity glassy carbon rod. The electrolyte comprised 0.57 M K₂CO₃ (Puratronic 99.999%). The electrolysis was performed at 2.75 volts for three weeks. The cathode was removed from the cell, rinsed immediately with distilled water, and dried with a N₂ stream. A piece of suitable size was cut from the electrode, mounted on a sample stub, and placed in the vacuum system.

Sample #3. The remaining portion of the electrode of sample #2 was stored in a sealed plastic bag for three months at which time a piece of suitable size was cut from the electrode, mounted on a sample stub, placed in the vacuum system, and XPS scanned.

13.1.3.2 Crystal Samples from an Electrolytic Cell

Hydrino hydride compounds were prepared during the electrolysis of an aqueous solution of K₂CO₃ corresponding to the catalyst K⁺/K⁺. The cell comprised a 10 gallon (33 in.×15 in.) Nalgene tank (Model # 54100-0010). Two 4 inch long by ½ inch diameter terminal bolts were secured in the lid, and a cord for a calibration heater was inserted through the lid. The cell assembly is shown in FIG. 2.

The cathode comprised 1.) a 5 gallon polyethylene bucket which served as a perforated (mesh) support structure where 0.5 inch holes were drilled over all surfaces at 0.75 inch spacings of the hole centers and 2.) 5000 meters of 0.5 mm diameter clean, cold drawn nickel wire (NI 200 0.0197″, HTN36NOAG1, A1 Wire Tech, Inc.). The wire was wound uniformly around the outside of the mesh support as 150 sections of 33 meter length. The ends of each of the 150 sections were spun to form three cables of 50 sections per cable. The cables were pressed in a terminal connector which was bolted to the cathode terminal post. The connection was covered with epoxy to prevent corrosion.

The anode comprised an array of 15 platinized titanium anodes (10-Engelhard Pt/Ti mesh 1.6″×8″ with one ¾″ by 7″ stem attached to the 1.6″ side plated with 100 U series 3000; and 5-Engelhard 1″ diameter×8″ length titanium tubes with one ¾″×7″ stem affixed to the interior of one end and plated with 100 U Pt series 3000). A ¾″ wide tab was made at the end of the stem of each anode by bending it at a right angle to the anode. A ¼″ hole was drilled in the center of each tab. The tabs were bolted to a 12.25″ diameter polyethylene disk (Rubbermaid Model #JN2-2669) equidistantly around the circumference. Thus, an array was fabricated having the 15 anodes suspended from the disk. The anodes were bolted with ¼″ polyethylene bolts. Sandwiched between each anode tab and the disk was a flattened nickel cylinder also bolted to the tab and the disk. The cylinder was made from a 7.5 cm by 9 cm long×0.125 mm thick nickel foil. The cylinder traversed the disk and the other end of each was pressed about a 10 AWG/600 V copper Wire. The connection was sealed with shrink tubing and epoxy. The wires were pressed into two terminal connectors and bolted to the anode terminal. The connection was covered with epoxy to prevent corrosion.

Before assembly, the anode array was cleaned in 3 M HCL for 5 minutes and rinsed with distilled water. The cathode was cleaned by placing it in a tank of 0.57 M K₂CO₃/3% H₂O₂ for 6 hours and then rinsing it with distilled water. The anode was placed in the support between the central and outer cathodes, and the electrode assembly was placed in the tank containing electrolyte. The power supply was connected to the terminals with battery cables.

The electrolyte solution comprised 28 liters of 0.57 M K₂CO₃ (Alfa K₂CO₃ 99±%).

The calibration heater comprised a 57.6 ohm. 1000 watt Incolloy 800 jacketed Nichrome heater which was suspended from the polyethylene disk of the anode array. It was powered by an Invar constant power (±0.1% supply(Model #TP 36-18). The voltage (±0.1%) and current (±0.1%) were recorded with a Fluke 8600A digital multimeter.

Electrolysis was performed at 20 amps constant current with a constant current (±0.02%) power supply (Kepco Model # ATE 6-100M).

The voltage (±0.1%) was recorded with a Fluke 8600A digital multimeter. The current (±0.5%) was read from an Ohio Semitronics CTA 101 current transducer.

The temperature (±0.1° C.) was recorded with a microprocessor thermometer Omega HH21 using a type K thermocouple which was inserted through a ¼″ hole in the tank lid and anode array disk. To eliminate the possibility that temperature gradients were present, the temperature was measured throughout the tank. No position variation was found to within the detection of the thermocouple (±0.1° C.).

The temperature rise above ambient (ΔT=T(electrolysis only)−T(blank)) and electrolysis power were recorded daily. The heating coefficient was determined “on the fly” by turning an internal resistance heater off and on, and inferring the cell constant from the difference between the losses with and without the heater. 20 watts of heater power were added to the electrolytic cell every 72 hours where 24 hours was allowed for steady state to be achieved. The temperature rise above ambient (ΔT₂=T(electrolysis+heater)−T(blank)) was recorded as well as the electrolysis power and heater power.

In all temperature measurements, the “blank” comprised 28 liters of water in a 10 gallon (33″×15″) Nalgene tank with lid (Model #54100-0010). The stirrer comprised a 1 cm diameter by 43 cm long glass rod to which an 0.8 cm by 2.5 cm Teflon half moon paddle was fastened at one end. The other end was connected to a variable speed stirring motor (Talboys Instrument Corporation Model # 1075C). The stirring rod was rotated at 250 RPM.

The “blank” (nonelectrolysis cell) was stirred to simulate stirring in the electrolytic cell due to gas sparging. The one watt of heat from stirring resulted in the blank cell operating at 0.2° C. above ambient.

The temperature (±0.1° C.) of the “blank” was recorded with a microprocessor thermometer (Omega HH21 Series) which was inserted through a ¼″ hole in the tank lid.

A cell that produced 6.3×10⁸ J of enthalpy of formation of increased binding energy hydrogen compounds was operated by BlackLight Power, Inc. (Malvern, Pa.), hereinafter “BLP Electrolytic Cell”. The cell was equivalent to that described herein. The cell description is also given by Mills et al. [R. Mills, W. Good, and R. Shaubach, Fusion Technol. 25, 103 (1994)] except that it lacked the additional central cathode.

Thermacore Inc. (Lancaster, Pa.) operated an electrolytic cell described by Mills et al. [R. Mills, W. Good, and R. Shaubach, Fusion Technol. 25, 103 (1994)] herein after “Thermacore Electrolytic Cell”. This cell had produced an enthalpy of formation of increased binding energy hydrogen compounds of 1.6×10⁹ J that exceeded the total input enthalpy given by the product of the electrolysis voltage and current over time by a factor greater than 8.

Crystals were obtained from the electrolyte as samples #4, #5, #6, #7, #8, #9, and #9A:

Sample #4. The sample was prepared by filtering the K₂CO₃ electrolyte of the BLP Electrolytic Cell described in the Crystal Samples from an Electrolytic Cell Section with a Whatman 110 mm filter paper (Cat. No. 1450 110) to obtain white crystals. XPS was obtained by mounting the sample on a polyethylene support. Mass spectra (mass spectroscopy electrolytic cell sample #4) and TOFSIMS (TOFSIMS sample #5) were also obtained.

Sample #5. The sample was prepared by acidifying the K₂CO₃ electrolyte from the BLP Electrolytic Cell with HNO₃, and concentrating the acidified solution until yellow-white crystals formed on standing at room temperature. XPS was obtained by mounting the sample on a polyethylene support. The mass spectra of a similar sample (mass spectroscopy electrolytic cell sample #3), TOFSIMS spectra (TOFSIMS w sample #6), and TGA/DTA (TGA/DTA sample #2) was also obtained.

Sample #6. The sample was prepared by concentrating the K₂CO₃ electrolyte from the Thermacore Electrolytic Cell described in the Crystal Samples from an Electrolytic Cell Section until yellow-white crystals just formed. XPS was obtained by mounting the sample on a polyethylene support. XRD (XRD sample #2), TOFSIMS (TOFSIMS sample #1), FTIR (FTIR sample #1), NMR(NMR sample #1), ESITOFMS (ESITOFMS sample #2) were also performed.

Sample #7. The sample was prepared by concentrating 300 cc of the K₂CO₃ electrolyte from the BLP Electrolytic Cell using a rotary evaporator at 50° C. until a precipitate just formed. The volume was about 50 cc. Additional electrolyte was added while heating at 50° C. until the crystals disappeared. Crystals were then grown over three weeks by allowing the saturated solution to stand in a sealed round bottom flask for three weeks at 25° C. The yield was 1 g. The XPS spectrum of the crystals was obtained by mounting the sample on a polyethylene support. The TOFSIMS (TOFSIMS sample #8), ³⁹K NMR (³⁹K NMR sample #1), Raman spectroscopy (Raman sample #4), and ESITOFMS (ESITOFMS sample #3) were also obtained.

Sample #8. The sample was prepared by acidifying 100 cc of the K₂CO₃ electrolyte from the BLP Electrolytic Cell with H₂SO₄. The solution was allowed to stand open for three months at room temperature in a 250 ml beaker. Fine white crystals formed on the walls of the beaker by a mechanism equivalent to thin layer chromatography involving atmospheric water vapor as the moving phase and the Pyrex silica of the beaker as the stationary phase. The crystals were collected, and XPS was performed. TOFSIMS (TOFSIMS sample #11) was also performed.

Sample #9. The cathode of a K₂CO₃ electrolytic cell run at Idaho National Engineering Laboratories (INEL) for 6 months that was identical to that of described in the Crystal Samples from an Electrolytic Cell Section was placed in 28 liters of 0.6M K₂CO₃/10% H₂O₂. 200 cc of the solution was acidified with HNO₃. The solution was concentrated to 100 cc and allowed to stand for a week until large clear pentagonal crystals formed. The crystals were filtered, and XPS was performed.

Sample #9A. The cathode of a K₂CO₃ electrolytic cell run at Idaho National Engineering Laboratories (INEL) for 6 months that was identical to that of described in the Crystal Samples from an Electrolytic Cell Section was placed in 28 liters of 0.6M K₂CO₃/10% H₂O₂. 200 cc of the solution was acidified with HNO₃. The solution was allowed to stand open for three months at room temperature in a 250 ml beaker. White nodular crystals formed on the walls of the beaker by a mechanism equivalent to thin layer chromatography involving atmospheric water vapor as the moving phase and the Pyrex silica of the beaker as the stationary phase. The crystals were collected, and XPS was performed. TOFSIMS (TOFSIMS sample #12) was also performed.

### 13.1.4 Results and Discussion

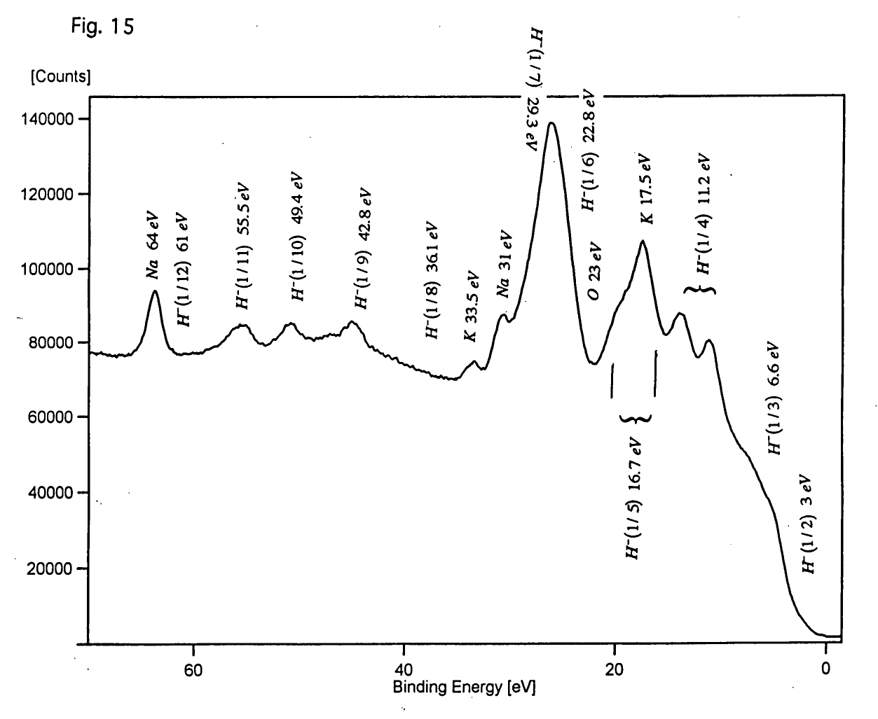

The low binding energy range (0-75 eV) of the glassy carbon rod cathode following electrolysis of a 0.57M K₂CO₃ electrolyte before (sample #2) and after (sample # 3) storage for three months is shown in FIG. 14 and FIG. 15, respectively. For the sample scanned immediately following electrolysis, the position of the potassium peaks, K, and the oxygen peak, O, are identified in FIG. 14. The high resolution XPS of the same electrode following three months of storage is shown in FIG. 15. The hydrino hydride ion peaks H⁻(n=1/p) for p=2 to p=12, the potassium peaks, K, and the sodium peaks, Na, and the oxygen peak, O, (which is a minor contributor since it must be smaller than the potassium peaks) are identified in FIG. 15. (Further hydrino hydride ion peaks to p=16 were identified in the survey scan in the region 65 eV to 73 eV (not shown)). The peaks at the positions of the predicted binding energies of hydrino hydride ions significantly increased while the potassium peaks at 18 and 34 significantly deceased relatively. Sodium peaks at 1072 eV and 495 eV (in the survey scan (not shown)), 64 eV, and 31 eV (FIG. 15) also developed with storage. The mechanism of the enhancement of the hydrino hydride ion peaks on storage is crystal growth from the bulk of the electrode of a predominantly sodium hydrino hydride. (X-ray diffraction of crystals grown on a stored nickel cathode showed peaks that could not be assigned to known compounds as given in the Identification of Hydrino Hydride Compounds by XRD Section.) These changes with storage substantially eliminate impurities as the source of the peaks assigned to hydrino hydride ions since impurity peaks would broaden and decrease in intensity due to oxidation if any change would occur at all.

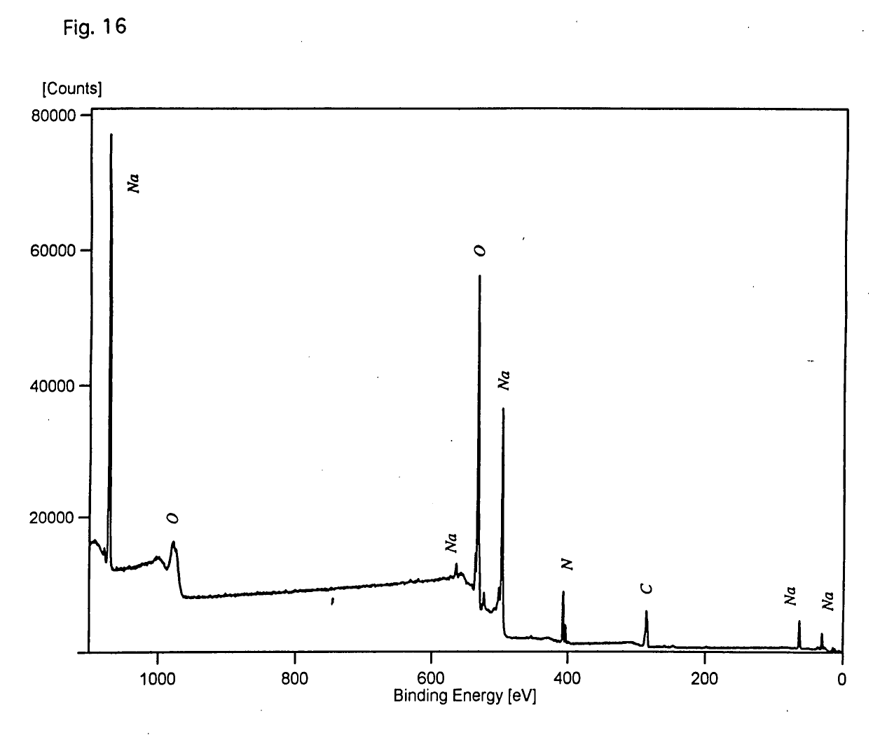

Isolation of pure hydrino hydride compounds from the electrolyte is the means of eliminating impurities from the XPS sample which concomitantly dispositively eliminates impurities as an alternative assignment to the hydrino hydride ion peaks. Samples #4, #5, and #6 were purified from a K₂CO₃ electrolyte. The survey scans are shown in FIGS. 16, 18, and 20, respectively, with the primary elements identified. No impurities are present in the survey scans which can be assigned to peaks in the low binding energy region with the exception of sodium at 64 and 31 eV, potassium at 18 and 34 eV, and oxygen at 23 eV. Accordingly, any other peaks in this region must be due to novel compositions.

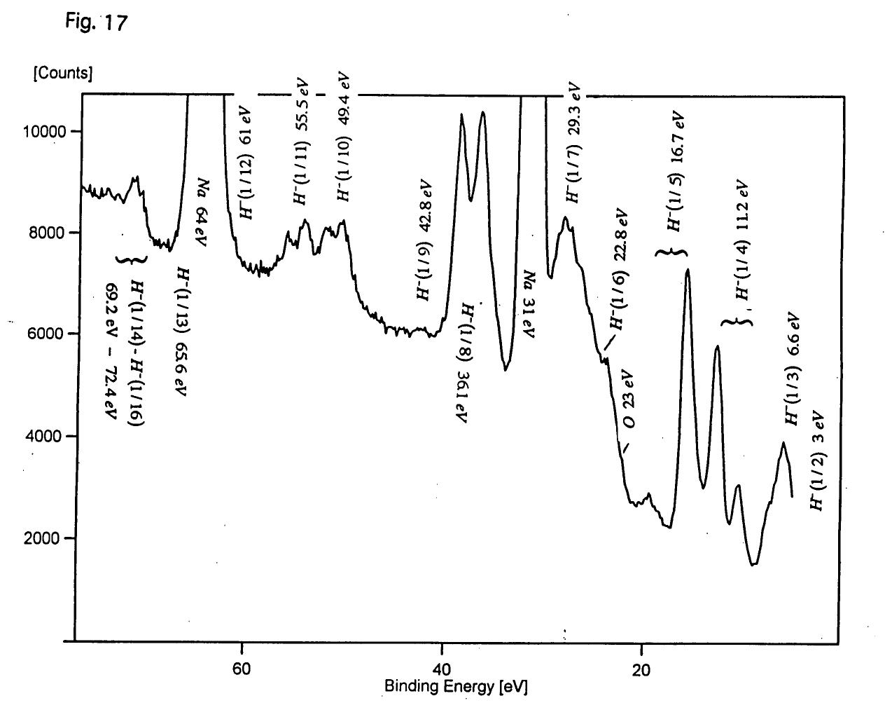

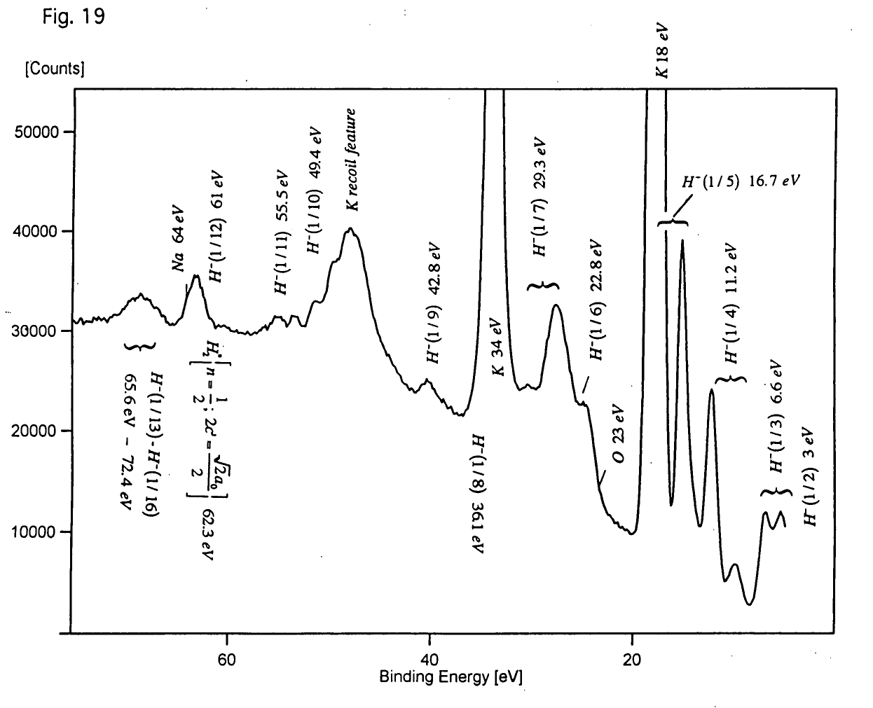

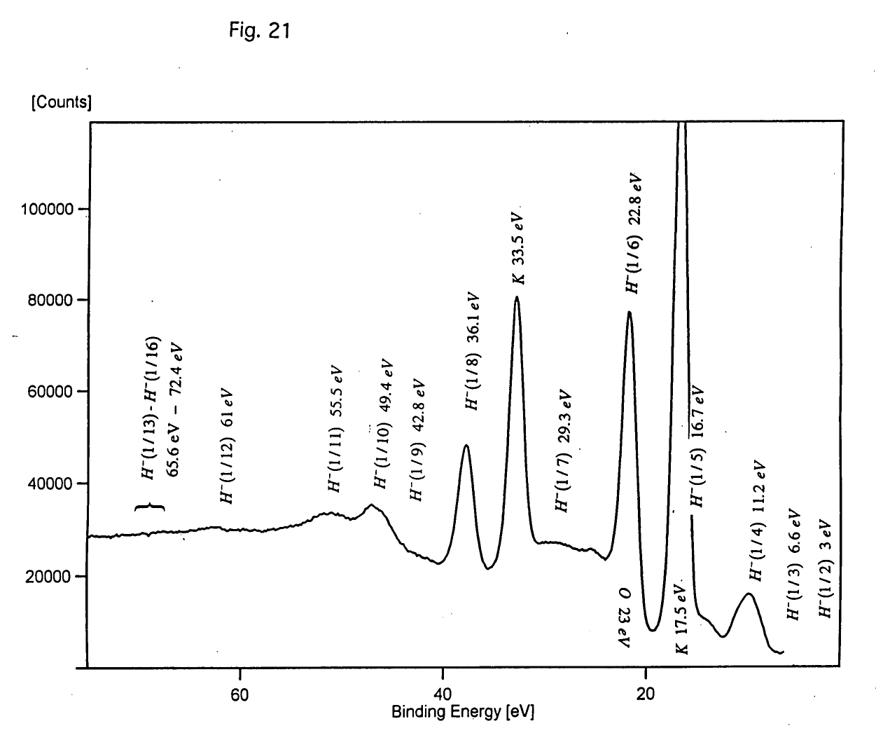

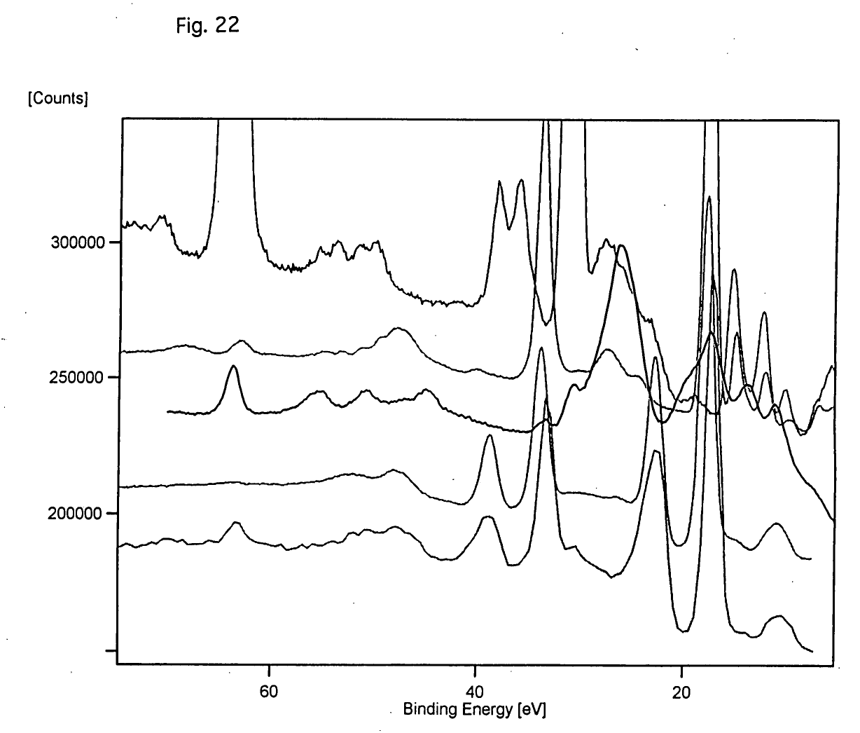

The hydrino hydride ion peaks H⁻(n=1/p) for p=2 to p=16 and the oxygen peak, O, are identified for each of the samples #4, #5, and #6 in FIGS. 17, 19, and 21, respectively. In addition, the sodium peaks, Na, of sample #4 and sample #5 are identified in FIG. 17 and FIG. 19, respectively. The potassium peaks, K, of sample #5 and sample # 6 are identified in FIG. 19 and FIG. 21, respectively. The low binding energy range (0-75 eV) XPS spectra of crystals from a 0.57M K₂CO₃ electrolyte (sample #4, #5, #6, and #7) are superimposed in FIG. 22 which demonstrates that the correspondence of the hydrino hydride ion peaks from the different samples is excellent. These peaks were not present in the case of the XPS of matching samples except that Na₂CO₃ replaced K₂CO₃ as the electrolyte. The crystals of sample #5 and sample #6 had a yellow color. The yellow color may be due to the continuum absorption of H⁻(n=112) in the near UV, 407 nm continuum.

During acidification of sample #5 the pH repetitively increased from 3 to 9 at which time additional acid was added with carbon dioxide release. The increase in pH (release of, base by the solute) was dependent on the temperature and concentration of the solution. This observation was consistent with HCO₃⁻ release from hydrino hydride compounds such as KHKHCO₃ given in the Identification of Hydrino Hydride Compounds by Time-Of-Flight-Secondary-Ion-Mass-Spectroscopy (TOFSIMS) Section. A reaction consistent with this observation is the displacement reaction of NO₃⁻ for HCO₃⁻ or CO₃²⁻.

The data provide the identification of hydrino hydride ions whose XPS peaks can not be assigned to impurities. Several of the peaks are split such as the H⁻(n=1/4), H⁻(n=1/5), H⁻(n=1/8), H⁻(n=1/10), and H⁻(n=1/11) peaks shown in FIG. 17. The splitting indicates that several compounds comprising the same hydrino hydride ion are present and further indicates the possibility of bridged structures of the compounds given in the Identification of Hydrino Hydride Compounds by Time-Of-Flight-Secondary-Ion-Mass-Spectroscopy (TOFSIMS) Section such as

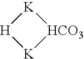

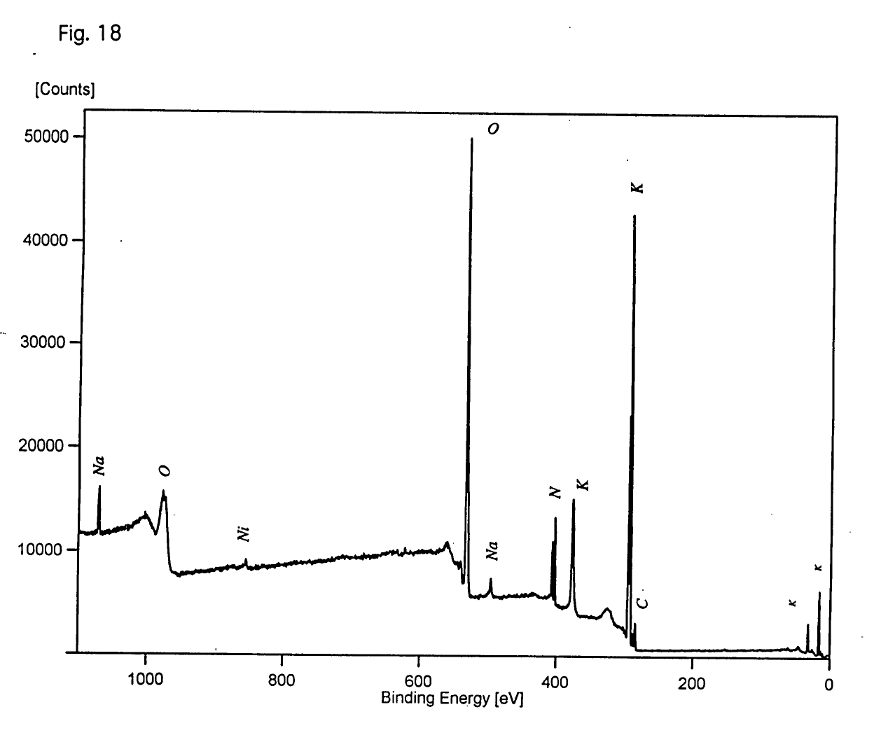

including dimers such as K₂H₂ and Na₂H₂. FIG. 18 indicates a water soluble nickel compound (Ni is present in the survey scan of sample #5). Furthermore, the

$${H}_{2}^{*} [ n = \frac{1}{2} ; 2 {c}^{′} = \frac{\sqrt{2} {a}_{0}}{2} ]$$

peak is shown in the 0-75 eV scan of sample #5 (FIG. 19). The XPS and TOFSIMS results are consistent in the identification of metal increased binding energy hydrogen compounds MHₙ where n is an integer, M is a metal, and H is an increased binding energy hydrogen species. For example, a structure for NiH₆ is

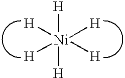

The large sodium peaks of the XPS of the stored carbon cathode of a K₂CO₃ electrolytic cell (sample #3) and the crystals from a K₂CO₃ electrolyte (sample #4) indicate that hydrino hydride compounds preferentially form with sodium over potassium. The hydrino hydride ion peak H⁻(n=1/8) shown in FIGS. 15, 19, and 21 at a binding energy of 36.1 eV is broad due to a contribution from the loss feature of potassium at 33 eV that superimposes the hydrino hydride ion peak H⁻(n=1/8) in these XPS scans. The data further indicate that the distribution of hydrino hydride ions tends to successively lower states over time. From Eq. (7), the most stable hydrino hydride ion is H⁻(n=1/16) which is predicted to be the favored product over time. No hydrino hydride ion states of higher binding energy were detected.

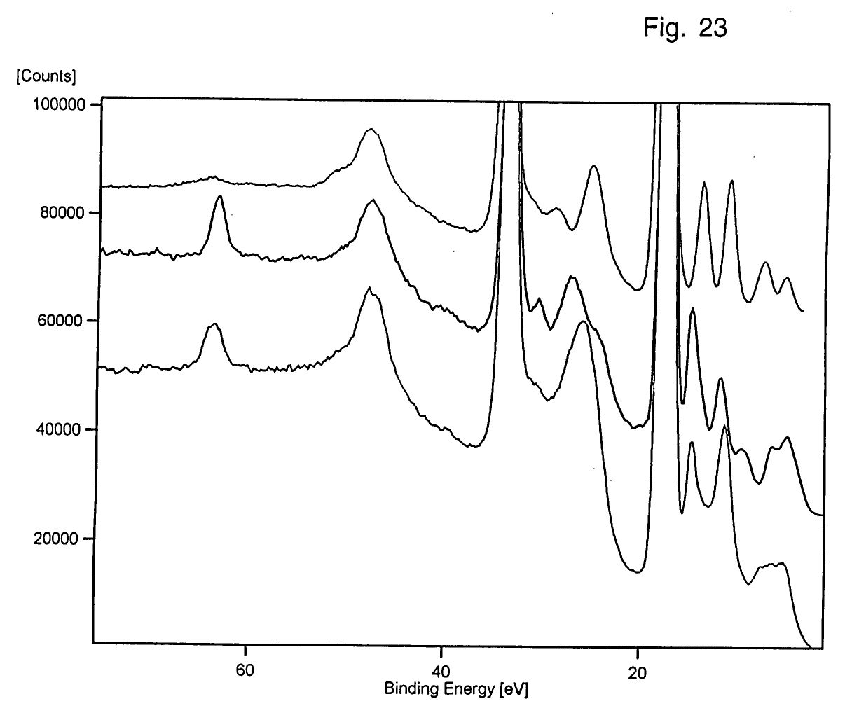

The stacked high resolution X-ray Photoelectron Spectra (XPS) (0 to 75 eV binding energy region) in the order from bottom to top of sample #8, sample #9, and sample #9A is given in FIG. 23. The hydrino hydride ions H⁻(n=1/p) for p=3 to p=16 were observed. In each case, the intensity of the hydrino hydride ion peaks were observed to increase relative to the starting material. The spectrum for sample #9 confirms that hydrino hydride compounds were purified by acidification with nitric acid followed by precipitation. The spectra for sample #8 and sample #9A confirm that hydrindo hydride compounds were purified by a mechanism equivalent to thin layer chromatography involving atmospheric water vapor as the moving phase and the Pyrex silica of the beaker as the stationary phase.

### 13.2 Identification of Hydrino Hydride Compounds by Mass Spectroscopy

Elemental analysis of the electrolyte of the 28 liter K₂CO₃ BLP Electrolytic Cell demonstrated that the potassium content of the electrolyte had decrease from the initial 56% composition by weight to 33% composition by weight. The measured pH was 9.85; whereas, the pH at the initial time of operation was 11.5. The pH of the Thermacore Electrolytic Cell was originally 11.5 corresponding to the K₂CO₃ concentration of 0.57 M which was confirmed by elemental analysis. Following the 15 month continuous energy production run, the pH was measured to be 9.04, and it was observed by drying the electrolyte and weighing it that over 90% of the electrolyte had been lost from the cell. The loss of potassium in both cases was assigned to the formation of volatile potassium hydrino hydride compounds whereby hydrino was produced by catalysis of hydrogen atoms that then reacted with water to form hydrino hydride compound and oxygen. The reaction is:

$$\begin{matrix}2 H [ \frac{{a}_{H}}{p} ] + {H}_{2} O \to 2 {H}^{-} ( 1 / p ) + 2 {H}^{+} + \frac{1}{2} {O}_{2} & ( 55 ) \\ 2 {H}^{-} ( 1 / p ) + 2 {K}_{2} {CO}_{3} + 2 {H}^{+} \to 2 {KHCO}_{3} + 2 KH ( 1 / p ) & ( 56 ) \\ 2 H [ \frac{{a}_{H}}{p} ] + {H}_{2} O + 2 {K}_{2} {CO}_{3} \to 2 {KHCO}_{3} + 2 KH ( 1 / p ) + \frac{1}{2} {O}_{2} & ( 57 )\end{matrix}$$

This reaction is consistent with the elemental analysis (Galbraith Laboratories) of the electrolyte of the BlackLight Power, Inc. cell as predominantly KHCO₃ and hydrino hydride compounds including KH(1/p)ₙ, where n is an integer, based on the excess hydrogen content which was 30% in excess of that of KHCO₃ (1.3 versus 1 atomic percent). The volatility of KH(1/p)ₙ, where n is an integer, would give rise to a potassium deficit over time.

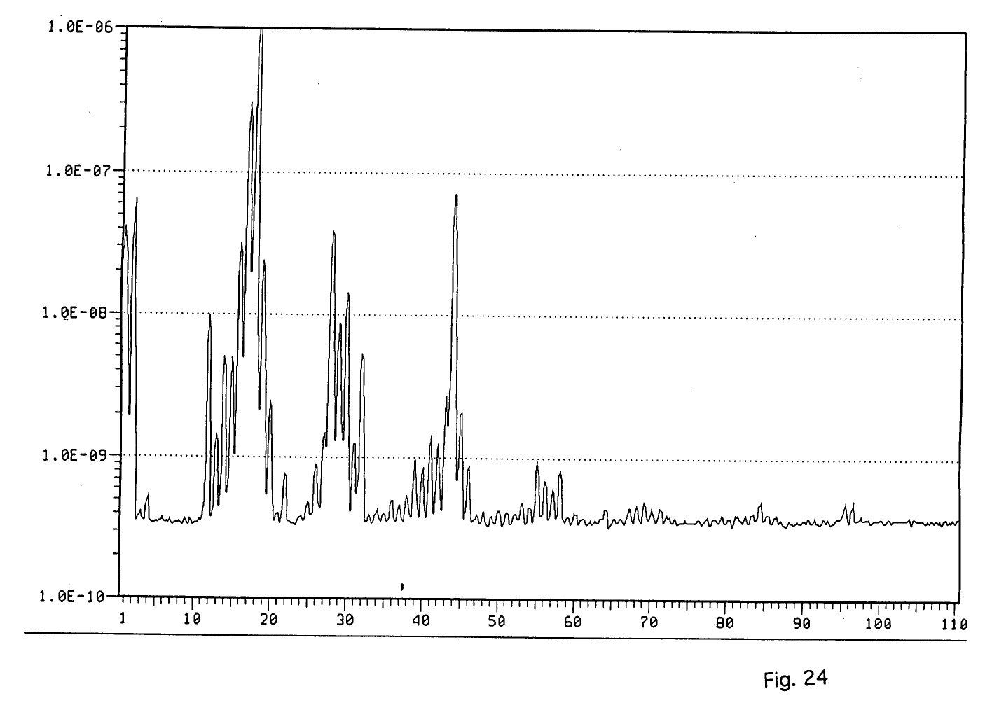

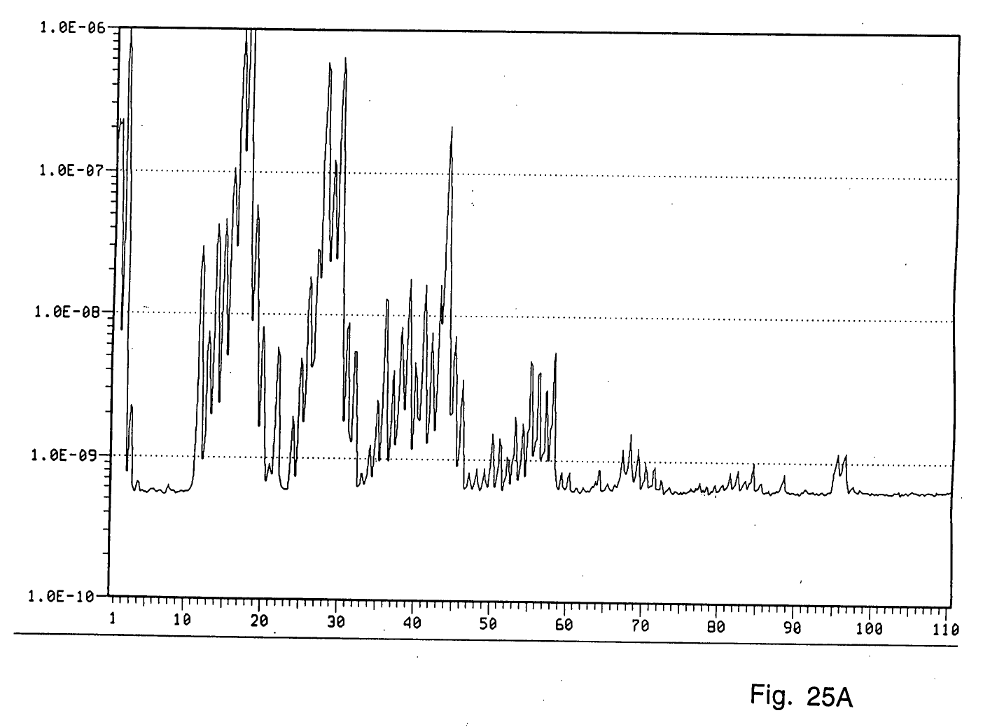

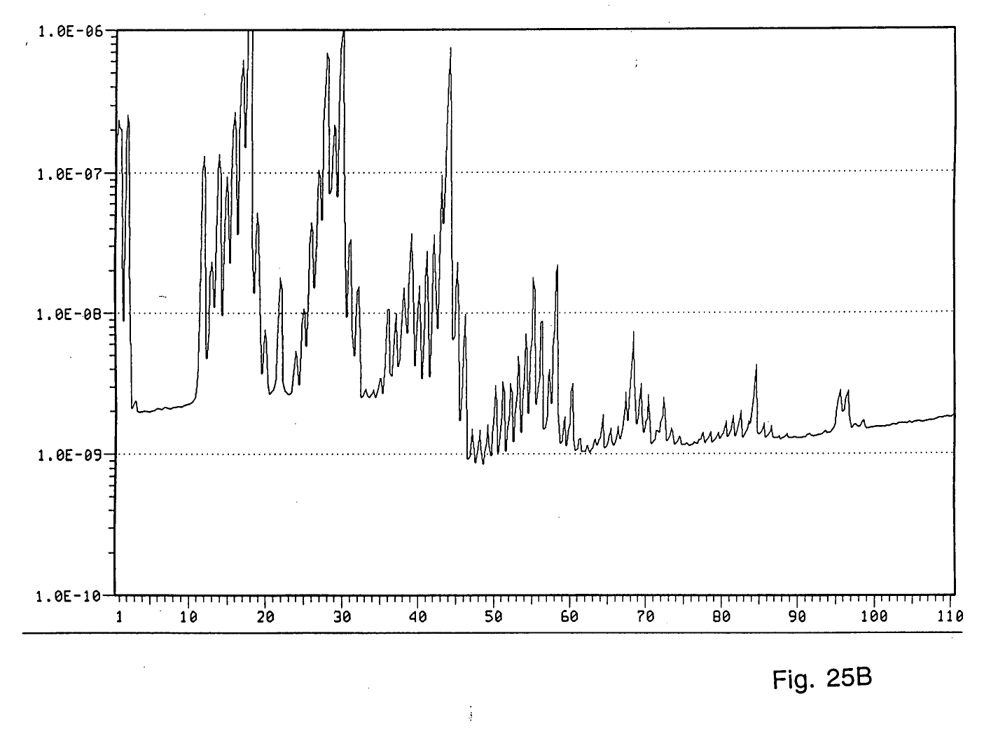

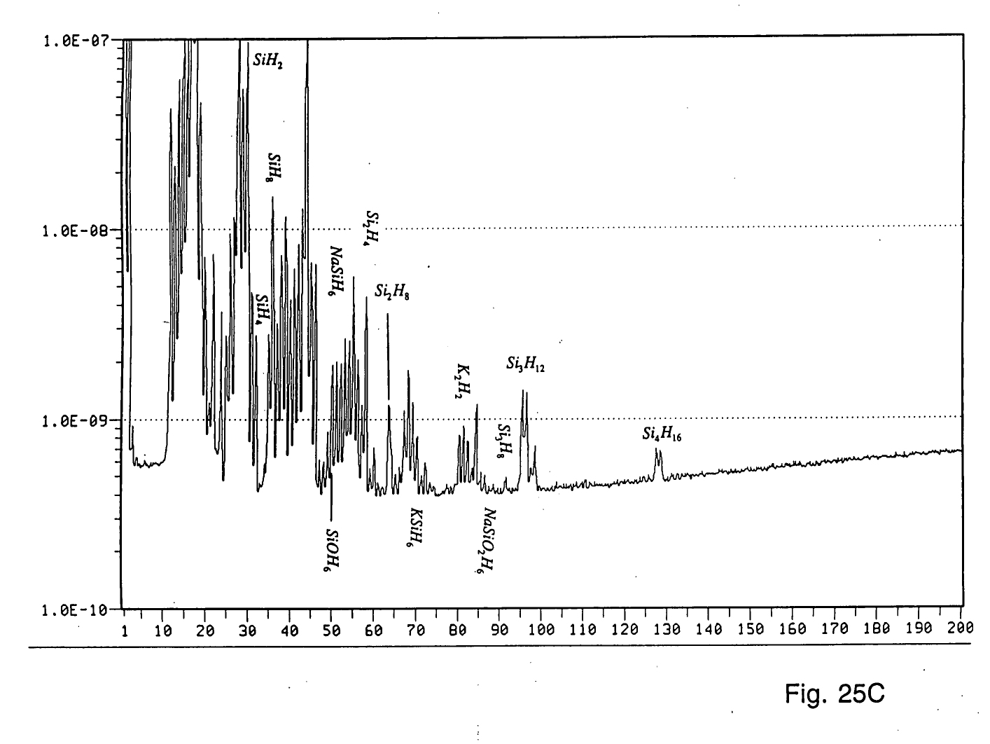

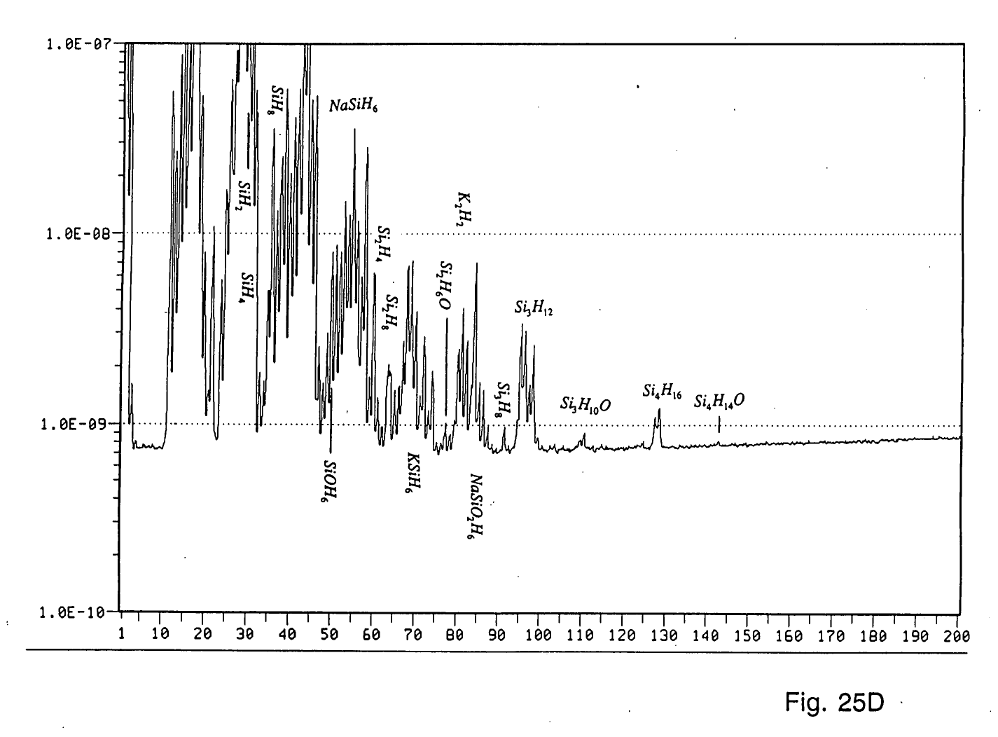

The possibility of using mass spectroscopy to detect volatile hydrino hydride compounds was explored. A number of hydrino hydride compounds were identified by mass spectroscopy by forming vapors of heated crystals from electrolytic cell, gas cell, gas discharge cell, and plasma torch cell hydrino hydride reactors. In all cases, hydrino hydride ion peaks were also observed by XPS of the crystals used for mass spectroscopy that were isolated from each hydrino hydride reactor. For example, the XPS of the crystals isolated from the electrolytic cell hydride reactor having the mass spectrum shown in FIGS. 25A-25D is shown in FIG. 17. The XPS of the crystals isolated from the electrolytic cell hydride reactor by a similar procedure as the crystals having the mass spectrum shown in FIG. 24 is shown in FIG. 19.

### 13.2.1 Sample Collection and Preparation

A reaction for preparing hydrino hydride ion-containing compounds is given by Eq. (8). Hydrino atoms which react to form hydrino hydride ions may be produced by 1.) an electrolytic cell hydride reactor, 2.) a gas cell hydrino hydride reactor, 3.) a gas discharge cell hydrino hydride reactor, or 4.) a plasma torch cell hydrino hydride reactor. Each of these reactors was used to prepare crystal samples for mass spectroscopy. The produced hydrino hydride compound was collected directly, or was purified from solution by precipitation and recrystallization. In the case of one electrolytic sample, the K₂CO₃ electrolyte was made 1M in LiNO₃ and acidified with HNO₃ before crystals were precipitated. In two other electrolytic samples, the K₂CO₃ electrolyte was acidified with HNO₃ before crystals were precipitated on a crystallization dish.

### 13.2.1.1 Electrolytic Sample

Hydrino hydride compounds were prepared during the electrolysis of an aqueous solution of K₂CO₃ corresponding to the transition catalyst K⁺/K⁺. The cell description is given in the Crystal Samples from an Electrolytic Cell Section. The cell assembly is shown in FIG. 2.

Crystal samples were obtained from the electrolyte as follows:

1.) A control electrolytic cell that was identical to the experimental cell of 3 and 4 below except that Na₂CO₃ replaced K₂CO₃ was operated at Idaho National Engineering Laboratory (INEL) for 6 months. The Na₂CO₃ electrolyte was concentrated by evaporation until crystals formed. The crystals were analyzed at BlackLight Power, Inc. by mass spectroscopy.

2.) A further control comprised the K₂CO₃ used as the electrolyte of the INEL K₂CO₃ electrolytic cell (Alfa K₂CO₃ 99±%).

3.) A crystal sample was prepared by: 1.) adding LiNO₃ to the K₂CO₃ electrolyte from the BLP Electrolytic Cell to a final concentration of 1 M; 2.) acidifying the solution with HNO₃, and 3.) concentrating the acidified solution until yellow-white crystals formed on standing at room temperature. XPS and mass spectra were obtained. XPS (XPS sample #5), TOFSIMS (TOFSIMS sample #6), and TGA/DTA (TGA/DTA sample #2) of similar samples were performed.

4.) A crystal sample was prepared by filtering the K₂CO₃ electrolyte from the BLP Electrolytic Cell with a Whatman 110 mm filter paper (Cat. No. 1450 110). In addition to mass spectroscopy, XPS (XPS sample #4) and TOFSIMS (TOFSIMS sample #5) were also performed.

5.) and 6.) Two crystal samples were prepared from the electrolyte of the Thermacore Electrolytic Cell by 1.) acidifying 400 cc of the KiCO₃ electrolyte with HNO₃, 2.) concentrating the acidified solution to a volume of 10 cc, 3.) placing the concentrated solution on a crystallization dish, and 4.) allowing crystals to form slowly upon standing at room temperature. Yellow-white crystals formed on the outer edge of the crystallization dish. In addition to mass spectroscopy, XPS (XPS sample #10), XRD (XRD samples #3A and #3B), TOFSIMS (TOFSIMS sample #3), and FTIR (FTIR sample #4) were also performed.

### 13.2.2.2 Gas Cell Sample

Hydrino hydride compounds were prepared in a vapor phase gas cell with a tungsten filament and KI as the catalyst according to Eqs. (3-5) and the reduction to hydrino hydride ion (Eq. (8)) occurred in the gas phase. RbI was also used as a catalyst because the second ionization energy of rubidium is 27.28 eV. In this case, the catalysis reaction is

$$\begin{matrix}27.28 eV + {Rb}^{+} + H [ \frac{{a}_{H}}{p} ] \to {Rb}^{2 +} + {e}^{-} + H [ \frac{{a}_{H}}{( p + 1 )} ] + [ {( p + 1 )}^{2} - {p}^{2} ] \times 13.6 eV & ( 58 ) \\ {Rb}^{2 +} + {e}^{-} \to {Rb}^{+} + 27.28 eV & ( 59 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 60 )$$

The high temperature experimental gas cell shown in FIG. 4 was used to produce hydrino hydride compounds. Hydrino atoms were formed by hydrogen catalysis using potassium or rubidium ions and hydrogen atoms in the gas phase. The cell was rinsed with deionized water following a reaction. The rinse was filtered, and hydrino hydride compound crystals were precipitated by concentration.

The experimental gas cell hydrino hydride reactor shown in FIG. 4 comprised a quartz cell in the form of a quartz tube 2 five hundred (500) millimeters in length and fifty (50) millimeters in diameter. The quartz cell formed a reaction vessel. One end of the cell was necked down and attached to a fifty (50) cubic centimeter catalyst reservoir 3. The other end of the cell was fitted with a Conflat style high vacuum flange that was mated to a Pyrex cap 5 with an identical Conflat style flange. A high vacuum seal was maintained with a Viton O-ring and stainless steel clamp. The Pyrex cap 5 included five glass-to-metal tubes for the attachment of a gas inlet line 25 and gas outlet line 21, two inlets 22 and 24 for electrical leads 6, and a port 23 for a lifting rod 26. One end of the pair of electrical leads was connected to a tungsten filament 1, The other end was connected to a Sorensen DCS 80-13 power supply 9 controlled by a custom built constant power controller. Lifting rod 26 was adapted to lift a quartz plug 4 separating the catalyst reservoir 3 from the reaction vessel of cell 2.

H₂.gas was supplied to the cell through the inlet 25 from a compressed gas cylinder of ultra high purity hydrogen 11 controlled by hydrogen control valve 13. Helium gas was supplied to the cell through the same inlet 25 from a compressed gas cylinder of ultrahigh purity helium 12 controlled by helium control valve 15. The flow of helium and hydrogen to the cell is further controlled by mass flow controller 10, mass flow controller valve 30, inlet valve 29, and mass flow controller bypass valve 31. Valve 31 was closed during filling of the cell. Excess gas was removed through the gas outlet 21 by a molecular drag pump 8 capable of reaching pressures of 10⁻⁴ torr controlled by vacuum pump valve 27 and outlet valve 28. Pressures were measured by a 0-1000 torr Baratron pressure gauge and a 0-100 torr Baratron pressure gauge 7. The filament 1 was 0.381 millimeters in diameter and two hundred (200) centimeters in length. The filament was suspended on a ceramic support to maintain its shape when heated. The filament was resistively heated using power supply 9. The power supply was capable of delivering a constant power to the filament. The catalyst reservoir 3 was heated independently using a band heater 20, also powered by a constant power supply. The entire quartz cell was enclosed inside an insulation package comprised of Zicar AL-30 insulation 14. Several K type thermocouples were placed in the insulation to measure key temperatures of the cell and insulation. The thermocouples were read with a multichannel computer data acquisition system.

The cell was operated under flow conditions with a total pressure of less than two (2) torr of hydrogen or control helium via mass flow controller 10. The filament was heated to a temperature of approximately 1000-1400° C. as calculated by its resistance. This created a “hot zone” within the quartz tube as well as atomization of the hydrogen gas. The catalyst reservoir was heated to a temperature of 700° C. to establish the vapor pressure of the catalyst. The quartz plug 4 separating the catalyst reservoir 3 from the reaction vessel 2 was removed using the lifting rod 26 which was slid about 2 cm through, the port 23. This introduced the vaporized catalyst into the “hot zone” containing the atomic hydrogen, and allowed the catalytic reaction to occur.

As described above, a number of thermocouples were positioned to measure the linear temperature gradient in the outside insulation. The gradient was measured for several known input powers over the experimental range with the catalyst valve closed. Helium supplied from the tank 12 and controlled by the valves 15, 29, 30, and 31, and flow controller 10 was flowed through the cell during the calibration where the helium pressure and flow rates were identical to those of hydrogen in the experimental cases. The thermal gradient was determined to be linearly proportional to input power. Comparing an experimental gradient (catalyst valve open/hydrogen flowing) to the calibration gradient allowed the determination of the requisite power to generate that gradient. In this way, calorimetry was performed on the cell to measure the heat output with a known input power. The data was recorded with a Macintosh based computer data acquisition system (PowerComputing PowerCenter Pro 180) and a National Instruments, Inc. NI-DAQ PCI-MIO-16XE-50 Data Acquisition Board.

Enthalpy of catalysis from the gas energy cell having a gaseous transition catalyst (K⁺/K⁺) was observed with low pressure hydrogen in the presence of potassium iodide (KI) which was volatilized at the operating temperature of the cell. The enthalpy of formation of increased binding energy hydrogen compounds resulted in a steady state power of about 15 watts that was observed from the quartz reaction vessel containing about 200 mtorr of KI when hydrogen was flowed over the hot tungsten filament. However, no excess enthalpy was observed when helium was flowed over the hot tungsten filament or when hydrogen was flowed over the hot tungsten filament with no KI present in the cell. In a separate experiment RbI replaced KI as the gaseous transition catalyst (Rb⁺).

In another embodiment, the experimental gas cell hydrino hydride reactor shown in FIG. 4 comprised a Ni fiber mat (30.2 g, Fibrex from National Standard) inserted into the inside the quartz cell 2. The Ni mat was used as the H₂ dissociator which replaced the tungsten filament 1. The cell 2 and the catalyst reservoir 3 were each independently encased by split type clam shell furnaces (The Mellen Company) which replaced the Zicar AL-30 insulation 14 and were capable of operating up to 1200° C. The cell and catalyst reservoir were heated independently with their heaters to independently control the catalyst vapor pressure and the reaction temperature. The H₂ pressure was maintained at 2 torr at a flow rate of

$$\frac{0.5 {cm}^{3}}{min} .$$

The Ni mat was maintained at 900° C., and the KI catalyst was maintained at 700° C. for 100 h.

The following crystal samples were obtained from the cell cap or the cell:

1.) and 2.) Crystal samples from two KI catalysis run were prepared by 1.) rinsing the hydrino hydride compounds from the cap of the cell where they were preferentially cryopumped, 2.) filtering the solution to remove water insoluble compounds such as metal, 3.) concentrating the solution until a precipitate just formed with the solution at 50° C., 4.) allowing yellowish-reddish-brown crystals to form on standing at room temperature, and 5.) filtering and drying the crystals before the XPS and mass spectra were obtained.

3A.) and 3B.) Crystal samples were prepared by rinsing a dark colored band of crystals from the top of the cell that were cryopumped there during operation of the cell. The crystals were filtered and dried before the mass spectrum was obtained.

4.) A crystal sample was prepared by 1.) rinsing the KI catalyst and hydrino hydride compounds from the cell with sufficient water that all water soluble compounds dissolved, 2.) filtering the solution to remove water insoluble compounds such as metal, 3.) concentrating the solution until a precipitate just formed with the solution at 50° C., 4.) allowing white crystals to form on standing at room temperature, and 5.) filtering and drying the crystals before the XPS and mass spectra were obtained. The crystals isolated from the cell and used for mass ma spectroscopy studies were recrystallized in distilled water to obtain high purity crystals for XPS.

5.) A crystal sample from a RbI catalysis run was prepared by 1.) rinsing the hydrino hydride compounds from the cap of the cell where they Were preferentially cryopumped, 2.) filtering the solution to remove water insoluble compounds such as metal, 3.) concentrating the solution until a precipitate just formed with the solution at 50° C., 4.) allowing yellowish crystals to form on standing at room temperature, and 5.) filtering and drying the crystals before the XPS and mass spectra were obtained.

### 13.2.2.3 Gas Discharge Cell Sample

Hydrino hydride compounds can be synthesized in a hydrogen gas discharge cell wherein transition catalyst is present in the vapor phase. The transition reaction occurs in the gas phase with a catalyst that is volatilized from the electrodes by the hot plasma current. Gas phase hydrogen atoms are generated with the discharge.

Experimental discharge apparatus of FIG. 6 comprises a gas discharge cell 507 (Sargent-Welch Scientific Co. Cat. No. S 68755 25 watts, 115 VAC, 50 60 Hz), was utilized to generate hydrino hydride compounds. A hydrogen supply 580 supplied hydrogen gas to a hydrogen supply line valve 550, through a hydrogen supply line 544. A common hydrogen supply line/vacuum line 542 connected valve 550 to gas discharge cell 507 and supplied hydrogen to the cell. Line 542 branched to a vacuum pump 570 via a vacuum line 543 and a vacuum line valve 560. The apparatus further contained a pressure gage 540 for monitoring the pressure in line 542. A sampling line 545 from line 542 provided gas to a sampling port 530 via a sampling line valve 535. The lines 542, 543, 544, and 545 comprise stainless steel tubing hermetically joined using Swagelok connectors.

With the hydrogen supply line valve 550 and the sampling line valve 535 closed and the vacuum line valve 560 open, the vacuum pump 570, the vacuum line 543, and common hydrogen supply line/vacuum line 542 were used to obtain a vacuum in the discharge chamber 500. With the sampling line valve 535 and the vacuum line valve 560 closed and the hydrogen supply line valve 550 open, the gas discharge cell 507 was filled with hydrogen at a controlled pressure using the hydrogen supply 580, the hydrogen supply line 544, and the common hydrogen supply line/vacuum line 542. With the hydrogen supply line valve 550 and the vacuum line valve 560 closed and the sampling line valve 535 open, the sampling port 530 and the sampling line 545 were used to obtain a gas sample for study by methods such as gas chromatography and mass spectroscopy.

The gas discharge cell 507 comprised a 10″ flint glass (½″ ID) vessel 501 defining a vessel chamber 500. The chamber contained a hollow cathode 510 and an anode 520 for generating an arc discharge in low pressure hydrogen. The cell electrodes (½″ height and ¼″ diameter), comprising the cathode and anode, were connected to a power supply 590 with stainless steel lead wires penetrating the top and bottom ends of the gas discharge cell. The cell was operated at a hydrogen pressure range of 10 millitorr to 100 torr and a current under 10 mA. During hydrino hydride compound synthesis, the anode 520 and cathode 510 were coated with a potassium salt such as a potassium halide catalyst (e.g. KI). The catalyst was introduced inside the gas discharge cell 507 by disconnecting the cell from the common hydrogen supply line/vacuum line 542 and wetting the electrodes with a saturated water or alcohol catalyst solution. The solvent was removed by drying the cell chamber 500 in an oven, by connecting the gas discharge cell 507 to the common hydrogen supply line/vacuum line 542 shown in FIG. 6, and pulling a vacuum on the gas discharge cell 507.

The synthesis of hydrino hydride compounds using the apparatus of FIG. 6 comprised the following steps: (1) putting the catalyst solution inside the gas discharge cell 507 and drying it to form a catalyst coating on the electrodes 510 and 520; (2) vacuuming the gas discharge cell at 10-30 mtorr for several hours to remove any contaminant gases and residual solvent; and (3) filling the gas discharge cell with a few mtorr to 100 torr hydrogen and carrying out an arc discharge for at least 0.5 hour.

Samples were prepared from the preceding apparatus by 1.) rinsing the catalyst from the cell with sufficient water that all water soluble compounds dissolved, 2.) filtering the solution to remove water insoluble compounds such as metal, 3.) concentrating the solution until a precipitate just formed with the solution at 50° C., 4.) allowing crystals to form on standing at room temperature, and 4.) filtering and drying the crystals before the XPS and mass spectra were obtained.

### 13.2.2.4 Plasma Torch Sample

Hydrino hydride compounds were synthesized using an experimental plasma torch cell hydride reactor according to FIG. 7, using KI as the catalyst 714. The catalyst was contained in a catalyst reservoir 716. The hydrogen catalysis reaction to form hydrino (Eqs. (3-5)) and the reduction to hydrino hydride ion (Eq. (8)) occurred in the gas phase. The catalyst was aerosolized into the hot plasma.

During operation, hydrogen flowed from the hydrogen supply 738 to the catalyst reservoir 716 via passage 742 and passage 725 wherein the flow of hydrogen was controlled by hydrogen flow controller 744 and valve 746. Argon plasma gas flowed from the plasma gas supply 712 directly to the plasma torch via passage 732 and 726 and to the catalyst reservoir 716 via passage 732 and 725 wherein the flow of plasma gas was controlled by plasma gas flow controller 734 and valve 736. The mixture of plasma gas and hydrogen supplied to the torch via passage 726 and to the catalyst reservoir 716 via passage 725 was controlled by the hydrogen-plasma-gas mixer and mixture flow regulator 721. The hydrogen and plasma gas mixture served as a carrier gas for catalyst particles which were dispersed into the gas stream as fine particles by mechanical agitation. The mechanical agitator comprised the magnetic stirring bar 718 and the magnetic stirring motor 720. The aerosolized catalyst and hydrogen gas of the mixture flowed into the plasma torch 702 and became gaseous hydrogen atoms and vaporized catalyst ions (K⁺ ions from KI) in the plasma 704. The plasma was powered by microwave generator 724 (Astex Model S15001I). The microwaves were tuned by the tunable microwave cavity 722.

The amount of gaseous catalyst was controlled by controlling the rate that catalyst was aerosolized with the mechanical agitator and the carrier gas flow rate where the carrier gas was a hydrogen/argon gas mixture. The amount of gaseous hydrogen atoms was controlled by controlling the hydrogen flow rate and the ratio of hydrogen to plasma gas in the mixture. The hydrogen flow rate, the plasma gas flow rate, and the mixture directly to the torch and the mixture to the catalyst reservoir were controlled with flow rate controllers 734 and 744, valves 736 and 746, and hydrogen-plasma-gas mixer and mixture flow regulator 721. The aerosol flow rates were 0.8 standard liters per minute (slm) hydrogen and 0.15 slm argon. The argon plasma flow rate was 5 slm. The catalysis rate was also controlled by controlling the temperature of the plasma with the microwave generator 724. The forward input power was 1000 W, the reflected power was 10-20 W.

Hydrino atoms and hydrino hydride ions were produced in the plasma 704. Hydrino hydride compounds were cryopumped onto the manifold 706, and flowed into the trap 708 through passage 748. A flow to the trap 708 was effected by a pressure gradient controlled by the vacuum pump 710, vacuum line 750, and vacuum valve 752.

Hydrino hydride compound samples were collected directly from the manifold and from the hydrino hydride compound trap.

### 13.2.2 Mass Spectroscopy

Mass spectroscopy was performed by BlackLight Power, Inc. on the crystals from the electrolytic cell, the gas cell, the gas discharge cell, and the plasma torch cell hydrino hydride reactors. A Dycor System 1000 Quadrapole Mass Spectrometer Model #D200MP with a HOVAC Dri-2 Turbo 60 Vacuum System was used. One end of a 4 mm ID fritted capillary tube containing about 5 mg of the sample was sealed with a 0.25 in. Swagelock union and plug (Swagelock Co., Solon, Ohio). The other end was connected directly to the sampling port of a Dycor System 1000 Quadrapole Mass Spectrometer (Model D200MP, Ametek, Inc., Pittsburgh, Pa.). The mass spectrometer was maintained at a constant temperature of 115° C. by heating tape. The sampling port and valve were maintained at 125° C. with heating tape. The capillary was heated with a Nichrome wire heater wrapped around the capillary. The mass spectrum was obtained at the ionization energy of 70 eV (except were indicated) at different sample temperatures in the region m/e=0-220. Or, a high resolution scan was performed over the region m/e=0-110. Following obtaining the mass spectra of the crystals, the mass spectrum of hydrogen (m/e=2 and (m/e=1), water (m/e=18, m/e=2, and (m/e=1), carbon dioxide (m/e=44 and m/e=12), and hydrocarbon fragment CH₃⁺ (m/e=15), and carbon (m/e=12) were recorded as a function of time.

### 13.2.3 Results and Discussion

In all samples, the only usual peaks detected in the mass range m/e=1 to 220 were consistent with trace air contamination. Peak identifications were compared to the elemental composition. X-ray photoelectron spectroscopy (XPS) was performed on all of the mass spectroscopy samples to identify hydrino hydride ion peaks and to determine the elemental composition. In all cases, hydrino hydride ion peaks were observed. The crystals of electrolytic cell samples #3, #5, and #6, and gas cell samples #1, #2, and #5 had a yellow color. The yellow color may be due to the continuum absorption of H⁻(n=1/2) in the near UV, 407 nm continuum. In the case of gas cell samples #1, #2, and #5, this assignment was supported by the XPS results which showed a large peak at the binding energy of H⁻(n=1/2), 3 eV (TABLE 1).

XPS was also used to determine the elemental composition of each sample. In addition to potassium, some of the samples produced using a potassium catalyst also contained detectable sodium. The sample from the plasma torch contained SiO₂ and Al from the quartz and the alumina of the plasma torch.

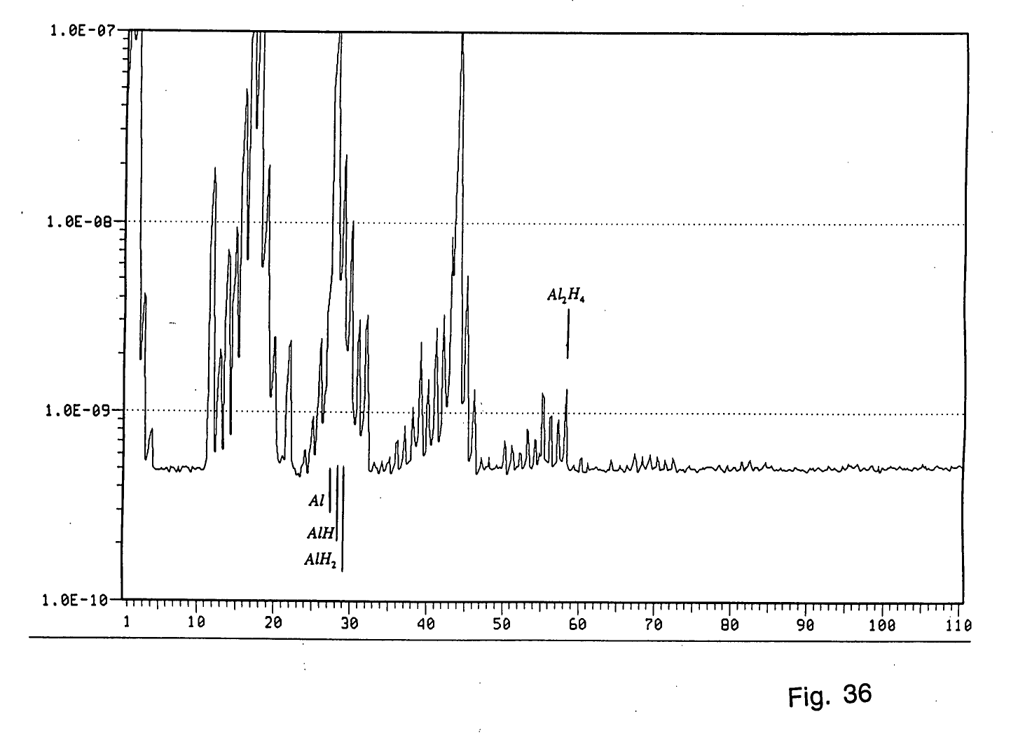

Similar mass spectra where obtained for all of the samples from catalysis runs except as discussed below for the plasma torch sample. A discussion of the assignment of the fragments appears below for some samples such as gas cell samples #1 and #2 that is representative of the types of compounds observed from the electrolytic cell, gas cell, gas discharge cell, and plasma torch cell hydrino hydride reactors as given in TABLE 4. In addition, the exceptional compounds produced in the plasma torch cell hydrino hydride rector are labeled in FIG. 36.

The mass spectrum (m/e=0-110) of the vapors from the crystals from the electrolyte of the Na₂CO₃ electrolytic cell (electrolytic cell sample #1) was recorded with a sample heater temperature of 225° C. The only usual peaks detected were consistent with trace air contamination. No unusual peaks were observed.

The mass spectrum (m/e=0-110) of the vapors from the K₂CO₃ used in the K₂CO₃ electrolytic cell hydrino hydride reactor (electrolytic cell sample #2) was recorded with a sample heater temperature of 225° C. The only usual peaks detected were consistent with trace air contamination. No unusual peaks were observed.

The mass spectrum (m/e=0-110) of the vapors from the crystals from the electrolyte of the K₂CO₃ electrolytic cell hydrino hydride reactor that was made 1 M in LiNO₃ and acidified with HNO₃ (electrolytic cell sample #3) with a sample heater temperature of 200° C. is shown in FIG. 24. The parent peak assignments of major component hydrino hydride compounds followed by the corresponding m/e of the fragment peaks appear in TABLE 4. The spectrum included peaks of increasing mass as a function of temperature up to the highest mass observed, m/e=96, at a temperature of 200° C. and greater.

TABLE 4
The hydrino hydride compounds assigned as parent peaks
with the corresponding m/e of the fragment peaks of the mass
spectrum (m/e = 0-200) of the crystals from the electrolytic
cell, gas cell, gas discharge cell, and plasma torch cell hydrino
hydride reactors.

| Hydrino Hydride | m/e of Parent Peak with |
|---|---|
| Compound | Corresponding Fragments |
| H₄⁺(1/p) | 4 |
| NaH(1/p) | 24-23 |
| Na⁺H⁻(1/p)H⁺H⁻(1/p) | 26-23 |
| Na⁺H⁻(1/p)H₃⁺H⁻(1/p) | 28-23 |
| SiH(1/p)₂ | 30-28 |
| SiH(1/p)₄ | 32-28 |
| SiH₆ | 34-28 |
| SiH₈ | 36-28 |
| KH(1/p) | 40-39 |
| K⁺H⁻(1/p)H⁺H⁻(1/p) | 42-39; 40-39 |
| K⁺H⁻(1/p)H₃⁺H⁻(1/p) | 44-39; 43-39; 41-39; 42-39; 40-39; 22 |
| Na₂(H(1/p))₂ | 48-46; 26-24 |
| SiOH₆ | 50-44, 51 |
| NaSiH₆ | 57-51; 58; 34-28; 24-23 |
| Si₂H(1/p)₄ | 60-56; 30-28 |
| H(1/p)Na₂OH | 64-63; 40-39; 24-23 |
| Si₂H₈ | 64-56; 36-28 |
| SiO₂H₆ | 66-60; 67; 50-44 |
| KSiH₆ | 73-67; 74; 32-28; 43-39; 41-39; 42-39; 40-39 |
| Si₂H(1/p)₆O | 78-72; 48-44; 36-28 |
| K₂(H(1/p))₂ | 80-78; 43-39; 41-39; 42-39; 40-39 |
| K₂H(1/p)₃ | 81-78; 43-39; 41-39; 42-39; 40-39 |
| K₂H(1/p)₄ | 82-78; 43-39; 41-39; 42-39; 40-39 |
| K₂H(1/p)₅ | 83-78; 43-39; 41-39; 42-39; 40-39 |
| NaSiO₂H₆ | 89-83; 90, 60; 50-44 |
| Si₃H(1/p)₈ | 92-84; 32-28 |
| H(1/p)K₂OH | 96-95; 56-55; 40-39 |
| Si₃H₁₂ | 96-92; 64-56; 36-28 |
| Si₃H₁₀O | 110-100; 78-72; 48-44; 36-28 |
| Si₄H₁₆ | 128-112; 96-92; 64-56; 36-28 |
| Si₄H₁₄O | 142-128; 110-100; 78-72; 64-56; 48-44; 36-28 |
| Si₆H₂₄ | 192-168; 128-112; 96-92; 64-56; 36-28 |

The mass spectrum (m/e=0-110) of the vapors from the crystals filtered from the electrolyte of the K₂CO₃ electrolytic cell hydrino hydride reactor (electrolytic cell sample #4) with a sample heater temperature of 185° C. is shown in FIG. 25A. The mass spectrum (m/e=0-110) electrolytic cell sample #4 with a sample heater temperature of 225° C. is shown in FIG. 25B. The parent peak assignments of major component hydrino hydride compounds followed by the corresponding m/e of the fragment peaks appear in TABLE 4. The mass spectrum (m/e=0-200) of electrolytic cell sample #4 with a sample heater temperature of 234° C. with the assignments of major component hydrino hydride silane compounds and silane fragment peaks is shown in FIG. 25C. The mass spectrum (m/e=0-200) of electrolytic cell sample #4 with a sample heater temperature of 249° C. with the assignments of major component hydrino hydride silane and siloxane compounds and silane fragment peaks is shown in FIG. 25D. Shown in both FIG. 25C and FIG. 25D is the hydrino hydride compound NaSiO₂H₆ (m/e=89) that has given rise to SiO₂ (m/e=60) (disilane Si₂H₄ is shown as a fragment from the other silanes indicated which also comprises the m/e=60 peak) and fragment SiOH₆ (m/e=50). A structure for NaSiO₂H₆ (m/e=89) is

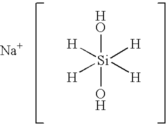

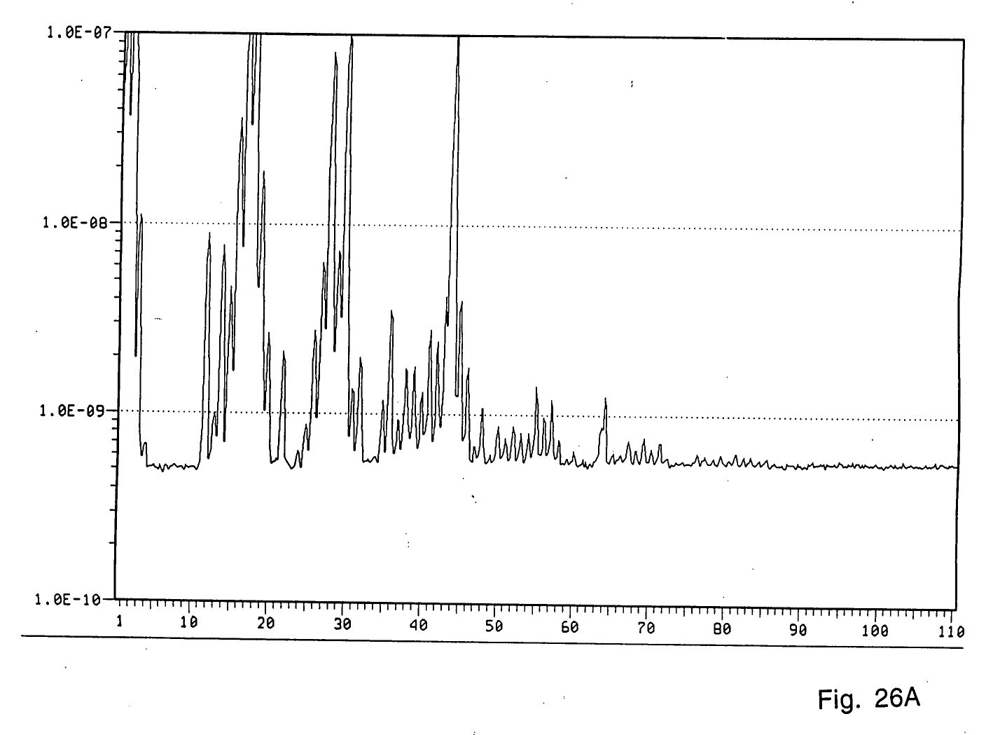

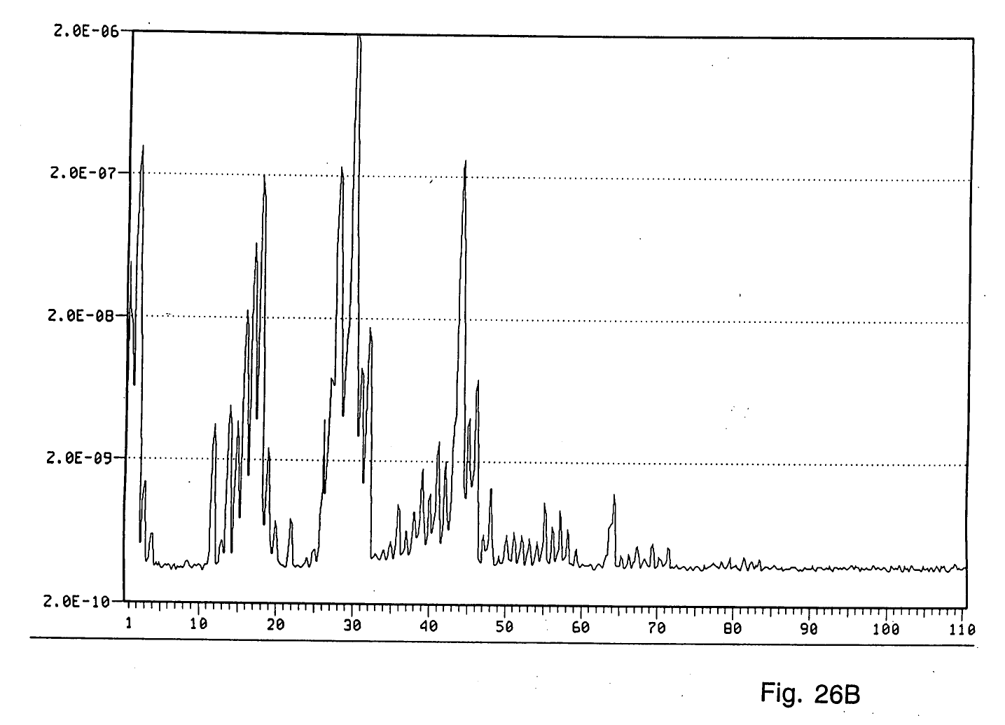

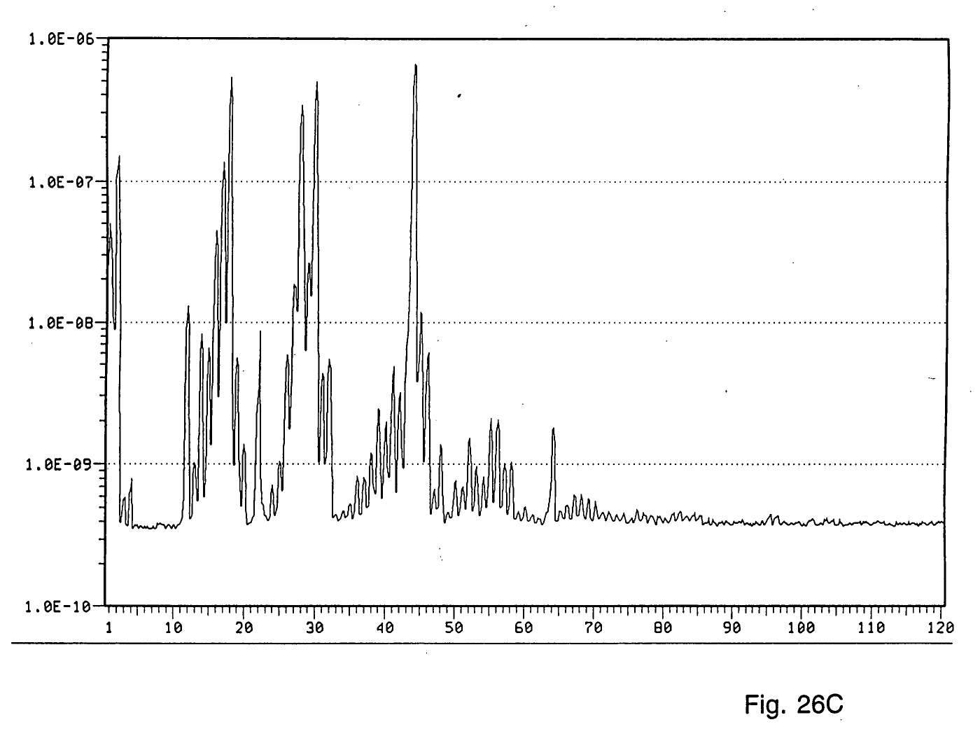

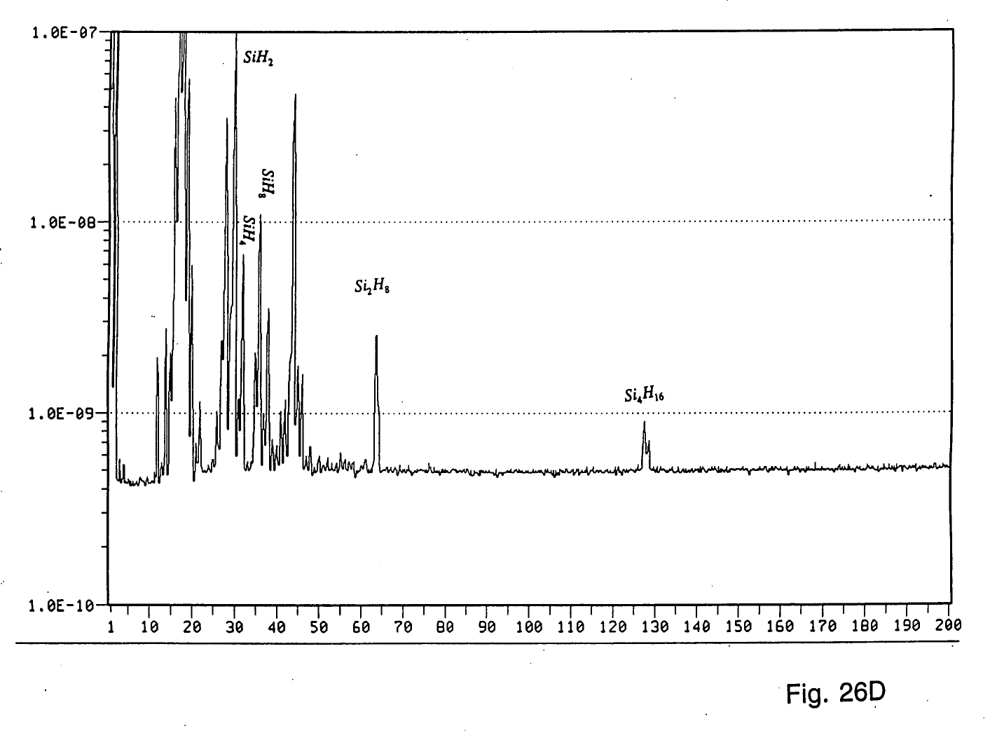

The mass spectrum (m/e=0-110) of the vapors from the yellow-white crystals that formed on the outer edge of a crystallization dish from the acidified electrolyte of the K₂CO₃ Thermacore Electrolytic Cell (electrolytic cell sample #5) with a sample heater temperature of 220° C. is shown in FIG. 26A and with a sample heater temperature of 275° C. is shown in FIG. 26B. The mass spectrum (m/e=0-110) of the vapors from electrolytic cell sample #6 with a sample heater temperature of 212° C. is shown in FIG. 26C. The parent peak assignments of major component hydrino hydride compounds followed by the corresponding m/e of the fragment peaks appear in TABLE 4. The mass spectrum (m/e=0-200) of electrolytic cell sample #6 with a sample heater temperature of 147° C. with the assignments of major component hydrino hydride silane compounds and silane fragment peaks is shown in FIG. 26D.

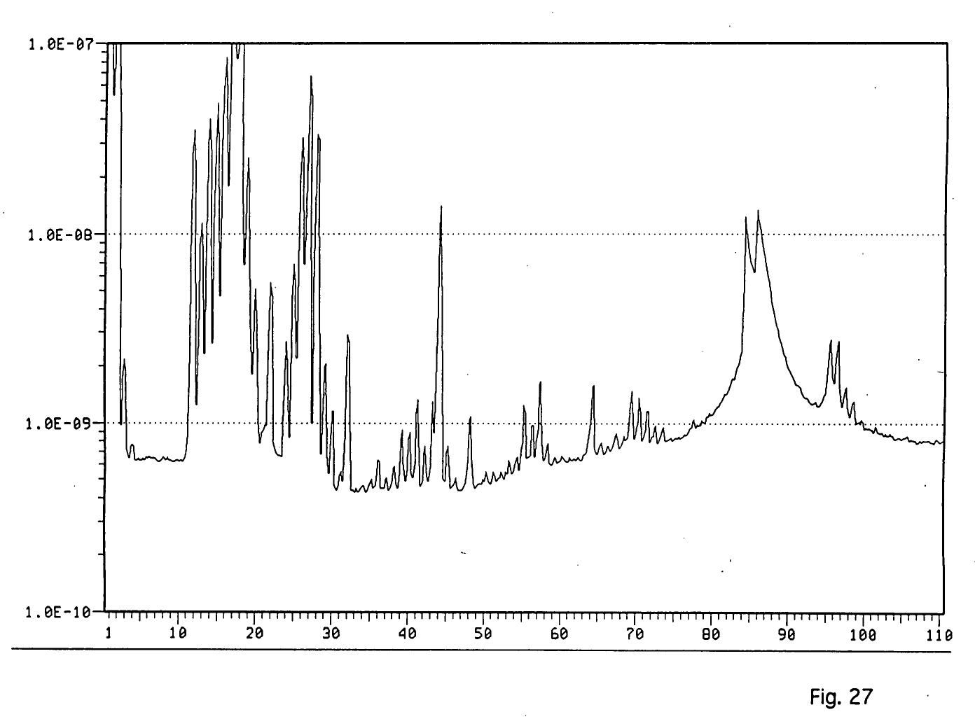

FIG. 27 shows the mass spectrum (m/e=0-110) of the vapors obtained from the cryopumped crystals isolated from the 40° C. cap of a gas cell hydrino hydride reactor comprising a KI catalyst, stainless steel filament leads, and a W filament (gas cell sample #1). The sample was dynamically heated from 90° C. to 120° C. while the scan was being obtained in the mass range m/e=75-100. The parent peak assignments of major component hydrino hydride compounds followed by the corresponding m/e of the fragment peaks appear in TABLE 4.

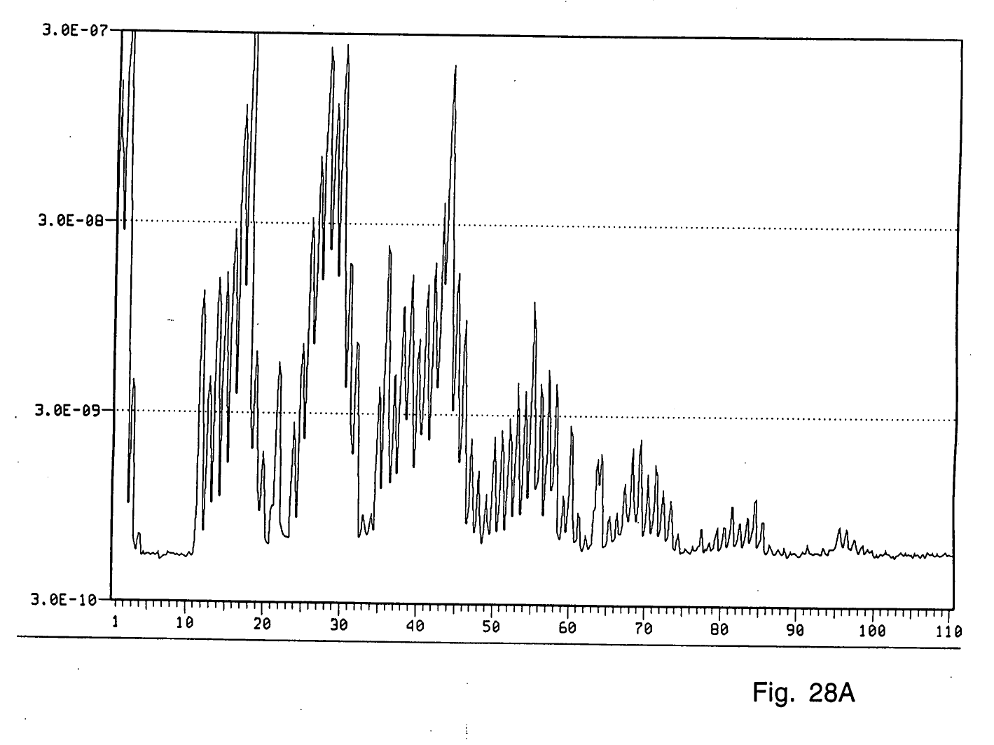

The hydrino hydride compound NaSiO₂H₆ (m/e=89) with series m/e=90-83 including the M+1 peak and the hydrino hydride compound HK₂OH (m/e=96) with fragment K₂OH (m/e=95) appeared in abundance with dynamic heating. Shown in FIG. 28A is the mass spectrum (m/e=0-110) of the sample shown in FIG. 27 with the succeeding repeat scan where the total time of each scan was 75 seconds. Thus, it took about the time interval 30 to 75 seconds after heating to rescan the region m/e=24-60. The sample temperature was 120° C. Shown in FIG. 28B is the mass spectrum (m/e=0-110) of the sample shown in FIG. 27 scanned 4 minutes later with a sample temperature of 200° C. The parent peak assignments of major component hydrino hydride compounds followed by the corresponding m/e of the fragment peaks appear in TABLE 4.

Comparing FIGS. 28A-28B to FIG. 27 shows that the hydrino hydride silicate compound NaSiO₂H₆ (m/e=89) with series m/e=90-83 including the M+1 peak gave rise to the fragments SiO₂ (m/e=60), SiO₂H₆ with series m/e=66-60, and SiOH₆ with series m/e=51-44 including the M+1 peak. The siloxane Si₂H₆O(m/e=78) was observed. The observed hydrino hydride silane compounds were the M+1 peak of Si₃H₁₂ m/e=96, Si₃H₈ (m/e=92), NaSiH₆ with series m/e=58-51 including the M+1 peak, KSiH₆ with series m/e=74-67 including the M+1 peak, and S₂H₈ with series m/e=64-56. The silane compounds gave rise to the silane peaks of Si₂H₂H₄ (m/e=60), SiH₈ (m/e=36), SiH₆ (m/e=34), SiH₄ (m/e=32), and SiH₂ (m/e=30).

Also present at the higher temperature was the hydrino hydride compound HK₂OH (m/e=96) with fragment K₂OH (m/e=95) that gave rise to KOH(m/e=56), a substantial KO(m/e=55) peak, and KH2 (m/e=41) with fragments KH (m/e=40) and K (m/e=39). In addition, the following potassium hydrino hydride compounds were observed: KH₅ (m/e=44) with fragments series (m/e=44-39) including KH₂ (m/e=41), KH(m/e=40), and K (m/e=39); the doubly ionized peak K⁺ H₅⁺ at (m/e=22); the doubly ionized peak K⁺H₃⁺ at (m/e=21); and K₂H(1/p)ₙ n=1 to 5 with fragment and compound series (m/e=83-78).

The following sodium hydrino hydride compounds that appear in FIGS. 28A-28B were observed at the higher temperature: HNa₂OH (m/e=64) with fragments Na₂OH (m/e=63), NaOH (m/e=40), NaO(m/e=39), and NaH (m/e=24); Na₂H₂ (m/e=48) with fragments Na₂H(m/e=47), Na (m/e=46), NaH₂ (m/e=25), and NaH(m/e=24); and NaH₃ (m/e=26) with fragments NaH₂ (m/e=25) and NaH (m/e=24).

The mass spectrum (m/e=0-200) was obtained of gas cell sample #1 with a sample heater temperature of 243° C. Major peaks were observed that were assigned to silane and siloxane hydrino hydride compounds. Present were the disilane hydrino hydride compound analogue Si₂H₈ (m/e=64) with siloxane, Si₂H₆O (m/e=78), the trisilane hydrino hydride compound analogue Si₃H₁₂ (m/e=96) with a siloxane, Si₃H₁₀O (m/e=110), and the tetrasilane hydrino hydride compound Si₄H₁₆ (m/e=128). Also, the low mass silane peaks were seen: Si₂H₄ (m/e=60), SiH₈ (m/e=36), SiH₄ (m/e=32), and SiH₂ (m/e=30).

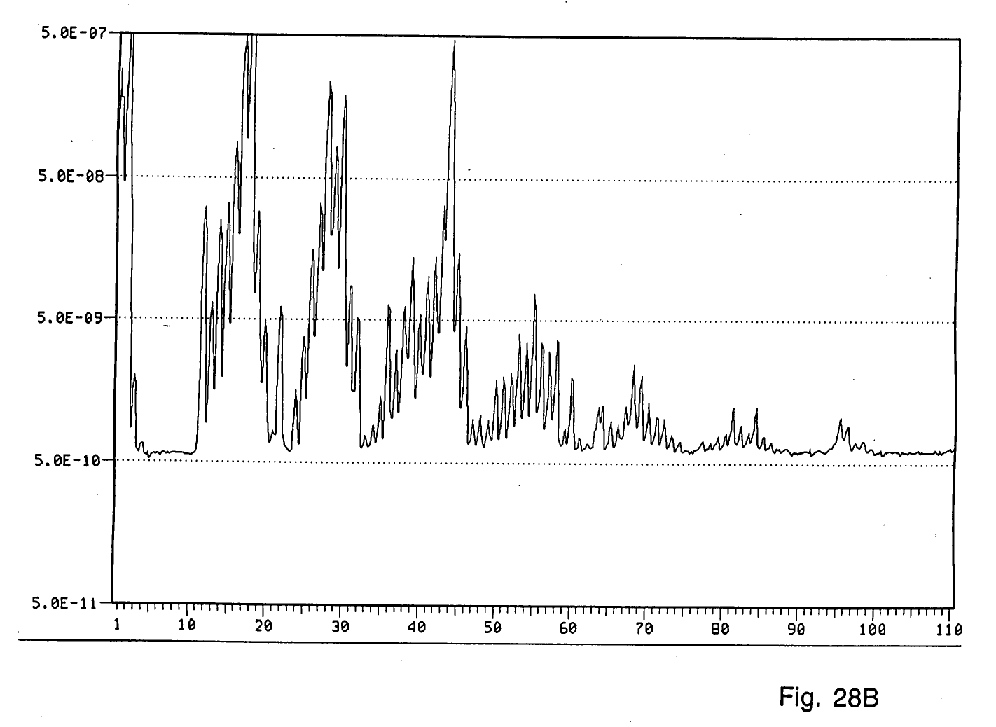

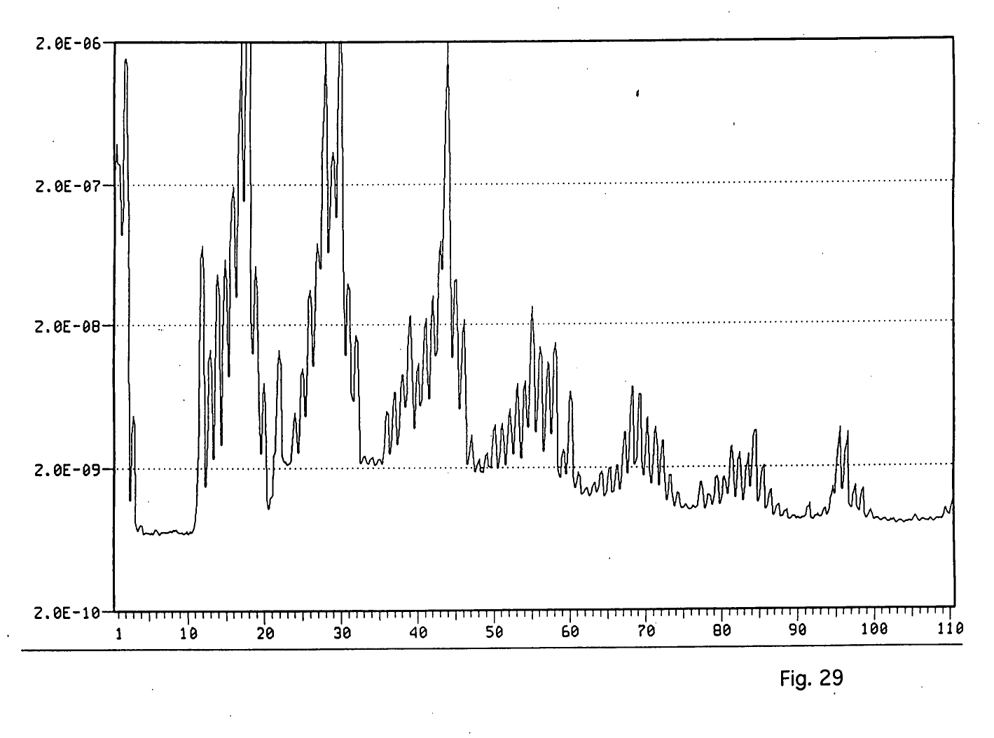

Shown in FIG. 29 is the mass spectrum (m/e=0-110) of the vapors from the cryopumped crystals isolated from the 40° C. cap of a gas cell hydrino hydride reactor comprising a KI catalyst, stainless steel filament leads, and a W filament (gas cell sample #2) with a sample temperature of 225° C. The parent peak assignments of major component hydrino hydride compounds followed by the corresponding m/e of the fragment peaks appear in TABLE 4.

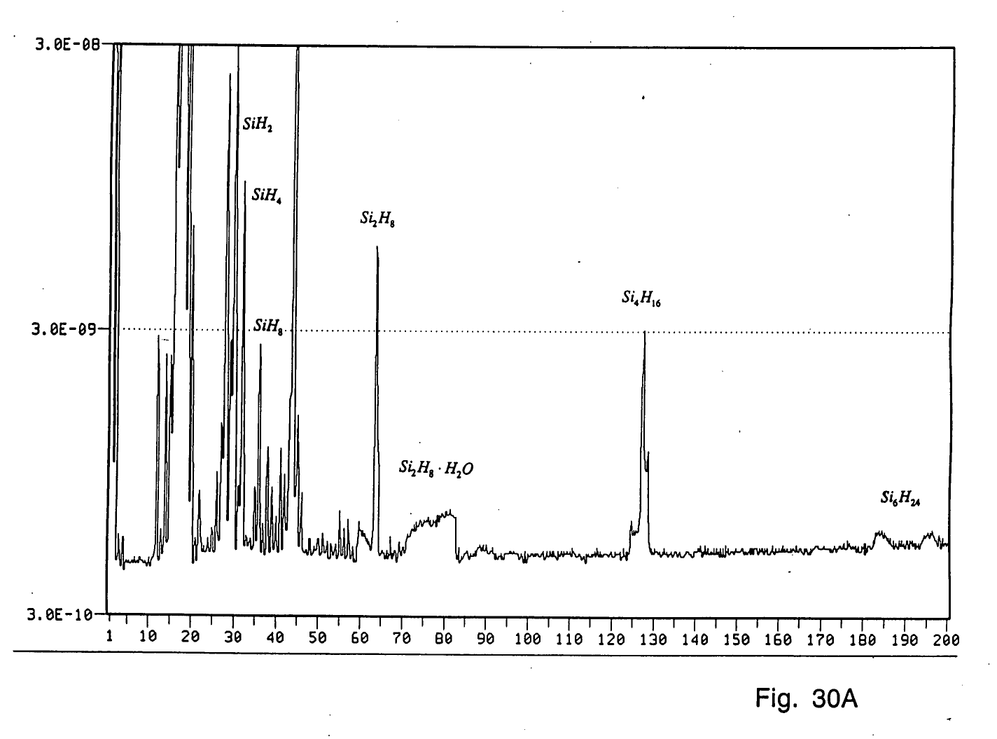

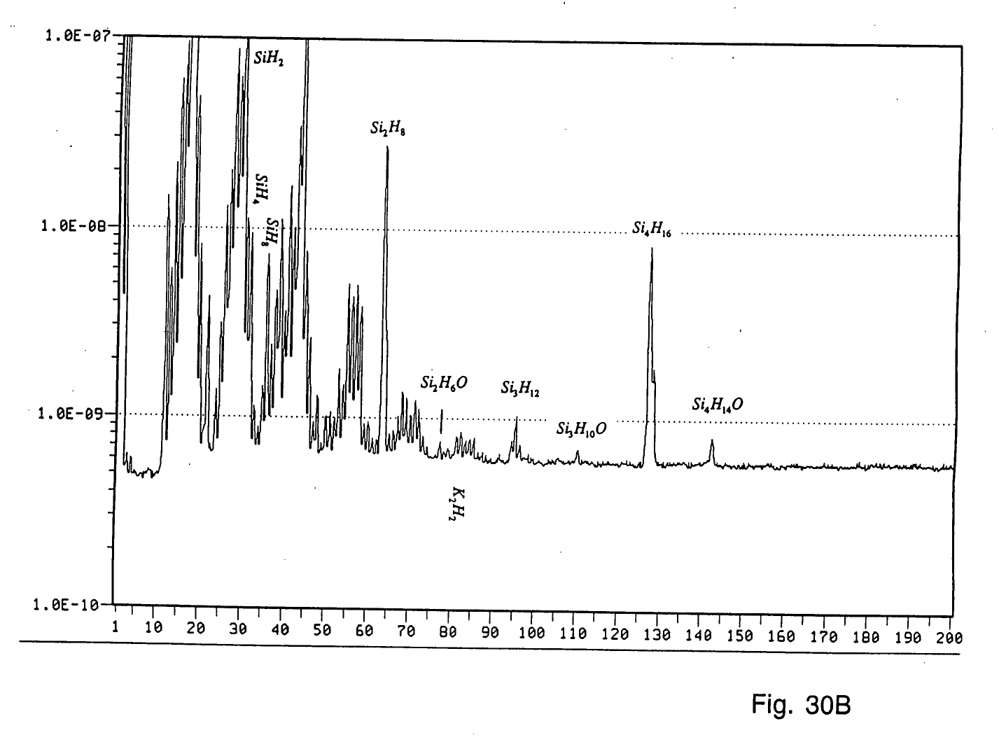

The mass spectrum (m/e=0-200) of the vapors from the crystals prepared from a dark colored band at the top of a gas cell hydrino hydride reactor comprising a KI catalyst, stainless steel filament leads, and a W filament with a sample heater temperature of 253° C. (gas cell sample #3A) and with a sample heater temperature of 216° C. (gas cell sample #3B) is shown, in FIG. 30A and FIG. 30B, respectively. The assignments of major component hydrino hydride compounds and silane fragment peaks are indicated. The parent peak assignments of typical major component hydrino hydride compounds followed by the corresponding m/e of the fragment peaks appear in TABLE 4.

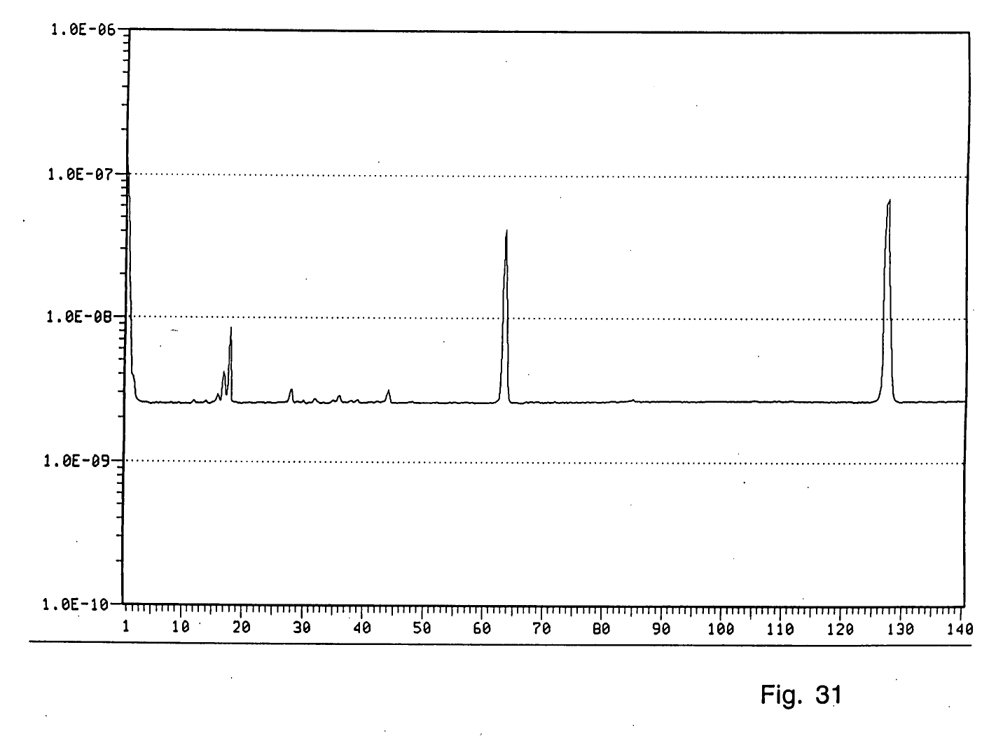

The spectrum of gas cell sample #3A shown in FIG. 30A has major peaks at about m/e=64 and m/e=128. Iodine has peaks at these positions; thus, the mass spectrum of iodine crystals was obtained under identical conditions. Iodine was eliminated as an assignment to the peaks based on the lack of a match of the iodine mass spectrum shown in FIG. 31 with the spectrum of gas cell sample #3A shown in FIG. 30A. For example, the doubly ionized atomic iodine peak at m/e=64 compared to the singly ionized peak at m/e=128 has the opposite height ratio as that of the corresponding peaks of the mass spectra of gas cell sample #3A. The latter spectrum also possess other peaks such as silane peaks not observed in the iodine spectrum. The peaks of FIG. 30A at m/e=64 and m/e=128 are assigned to silane hydrino hydride compounds. The stoichiometry is unique in that the chemical formulae for normal silanes is the same as that of alkanes; whereas, the formulae for hydrino hydride silanes is SiₙH₄ₙ which is indicative of a unique bridged hydrogen bonding. Only the ordinary silanes SiH₄ and S₂H₄ are indefinitely stable at 25° C. The higher ordinary silanes decompose giving hydrogen and mono- and disilane, possibly indicating SiH₂ as an intermediate. Also, ordinary silane compounds react violently with oxygen [F. A. Cotton, G. Wilkinson, Advanced Inorganic Chemistry, Fourth Edition, John Wiley & Sons, New York, pp. 383-384]. It is extraordinary the present sample was filtered from an aqueous solution in air. The sample contains water as indicated by the water family at (m/e=16-18), and the disilane hydrino hydride compound analogue Si₂H₈ has bound water whereby the resulting compound Si₂H₈H₂O successively losses all of the H′s in the series (m/e=82-72) to give Si₂O (m/e=72). Si₄H₁₆ (m/e=128), the tetrasilane hydrino hydride compound, and Si₆H₂₄ (m/e=192), the hexasilane hydrino hydride compound, are also seen with corresponding fragment peaks. Also, the low mass silane fragment peaks are seen: SiH₈ (m/e=36), SiH₄ (m/e=32), and SiH₂ (m/e=30). The spectrum of gas cell sample #3B shown in FIG. 30B also has major peaks at about m/e=64 and m/e=128 which are assigned to silane hydrino hydride compounds. Present are the disilane hydrino hydride compound analogue Si₂H₈ (m/e=64) with siloxane, Si₂H₆O(m/e=78), the trisilane hydrino hydride compound analogue Si₃H₁₂ (m/e=96) with siloxane, Si₃H₁₀O (m/e=110), and the tetrasilane hydrino hydride compound Si₄H₁₆ (m/e=128) with siloxane, Si₄H₁₄O (m/e=142). Also, the low mass silane fragment peaks are seen: SiH₈ (m/e=36), SiH₄ (m/e=32), and SiH₂ (m/e=30).

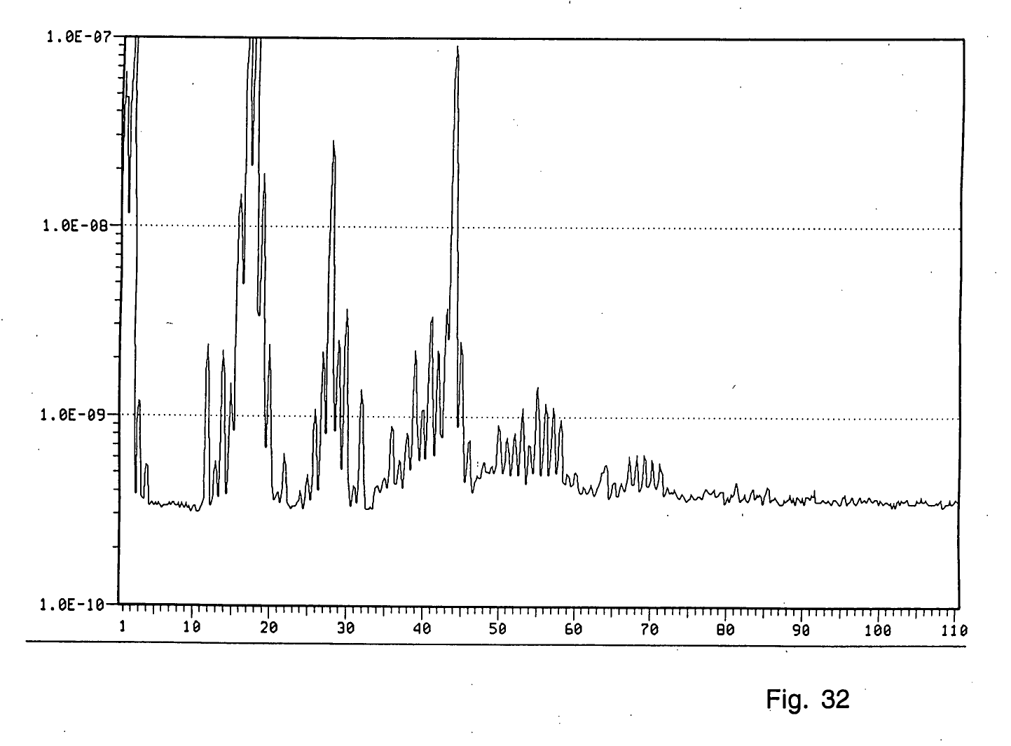

The mass spectrum (m/e=0-110) of the vapors from the crystals from the body of a gas cell hydrino hydride reactor comprising a KI catalyst, stainless steel filament leads, and a W filament (gas cell sample #4) with a sample heater temperature of 226° C. is shown in FIG. 32. The parent peak assignments of major component hydrino hydride compounds followed by the corresponding m/e of the fragment peaks appear in TABLE 4.

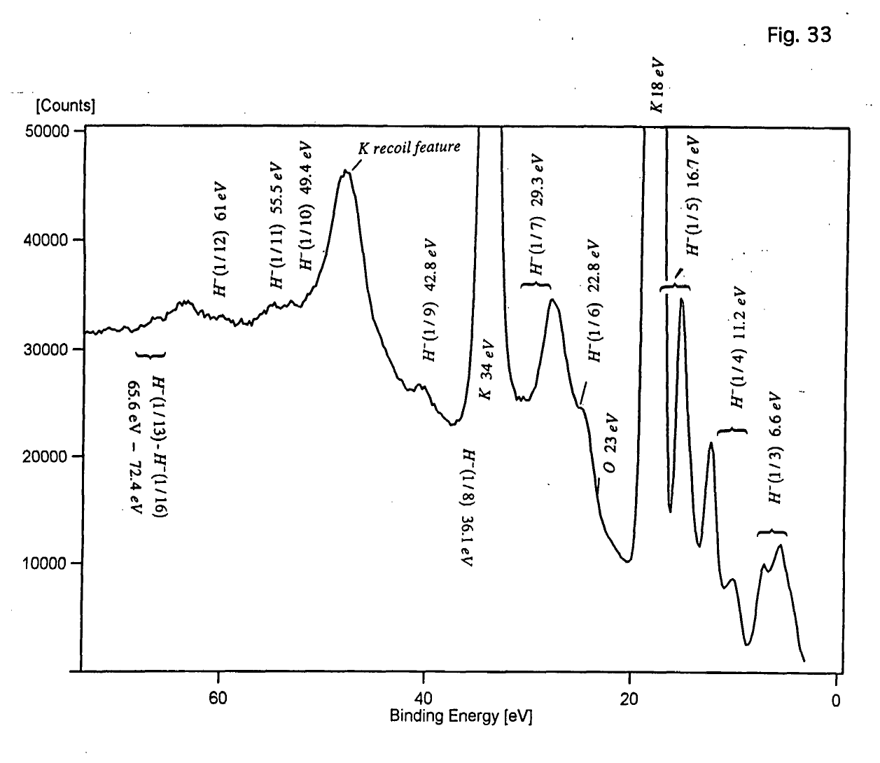

The 0 to 75 eV binding energy region of a high resolution X-ray Photoelectron Spectrum (XPS) of recrystallized crystals prepared from the gas cell hydrino hydride reactor comprising a KI catalyst, stainless steel filament leads, and a W filament (gas cell sample #4) corresponding to the mass spectrum shown in FIG. 32 is shown in FIG. 33. The survey scan showed that the recrystallized crystals were that of a pure potassium compound. Isolation of pure hydrino hydride compounds from the gas cell is the means of eliminating impurities from the XPS sample which concomitantly eliminates impurities as an alternative assignment to the hydrino hydride ion peaks. No impurities are present in the survey scan which can be assigned to peaks in the low binding energy region. With the exception of potassium at 18 and 34 eV, and oxygen at 23 eV, no other peaks in the low binding energy region can be assigned to known elements. Accordingly, any other peaks in this region must be due to novel compositions. The hydrino hydride ion peaks H⁻(n=1/p) for p=3 to p=16, the potassium peaks, K, and the oxygen peak, O, are identified in FIG. 33. The agreement with the results for the crystals isolated from the electrolytic cells summarized in FIG. 22 are excellent.

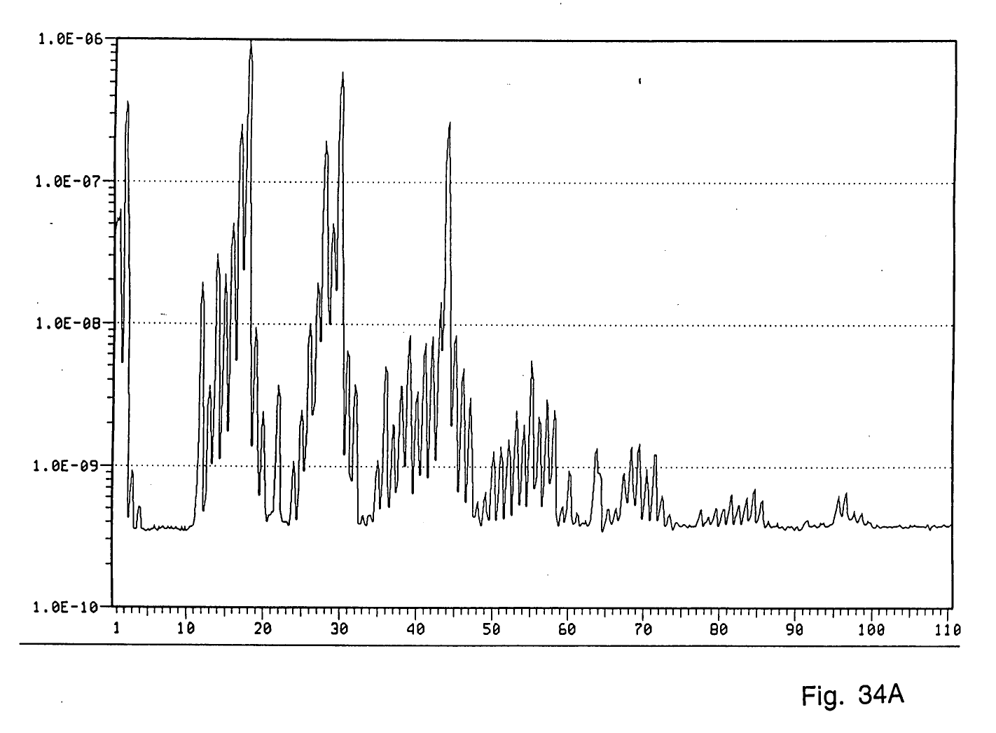

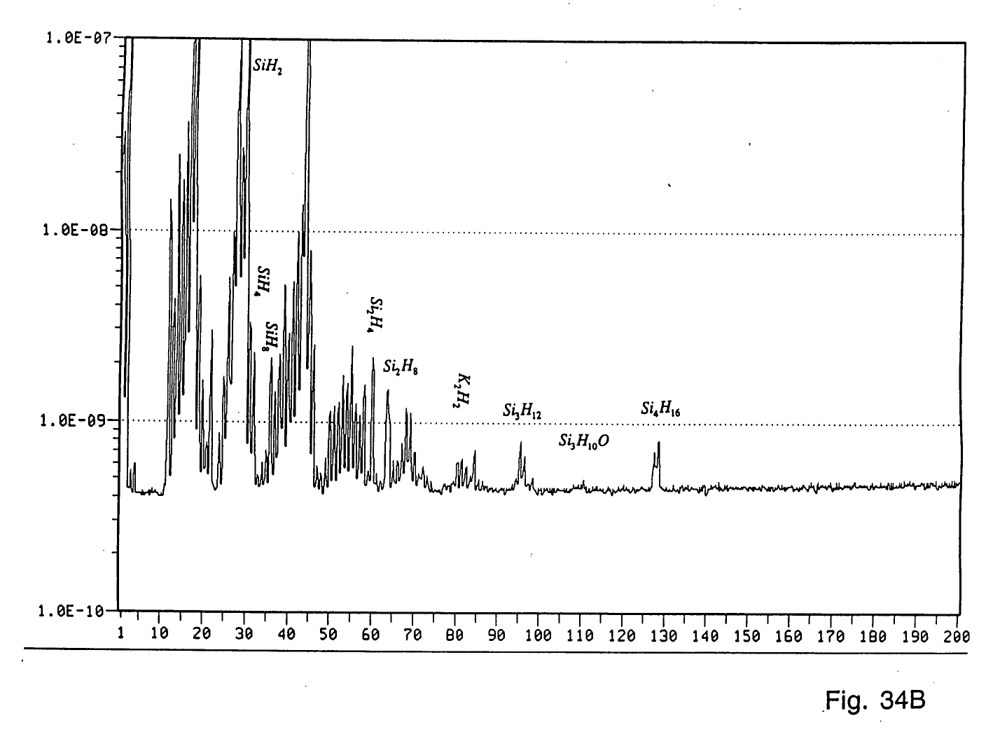

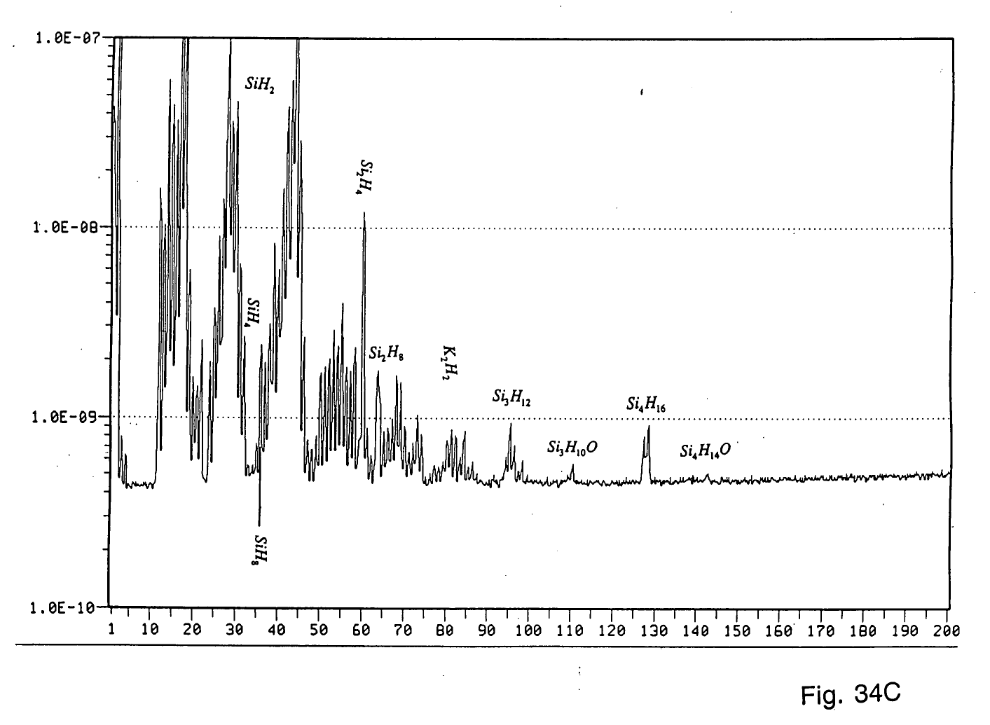

The mass spectrum (m/e=0-110) of the vapors from the cryopumped crystals isolated from the 40° C. cap of a gas cell hydrino hydride reactor comprising a RbI catalyst, stainless steel filament leads, and a W filament (gas cell sample # 5) with a sample temperature of 205° C. is shown in FIG. 34A. The parent peak assignments of major component hydrino hydride compounds followed by the corresponding m/e of the fragment peaks appear in TABLE 4. The mass spectrum (m/e=0-200) of gas cell sample # 5 with a sample temperature of 201° C. and with a sample temperature of 235° C. is shown in FIGS. 34B and FIG. 34C, respectively. The assignments of major component hydrino hydride silane and siloxane compounds and silane fragments peaks are indicated.

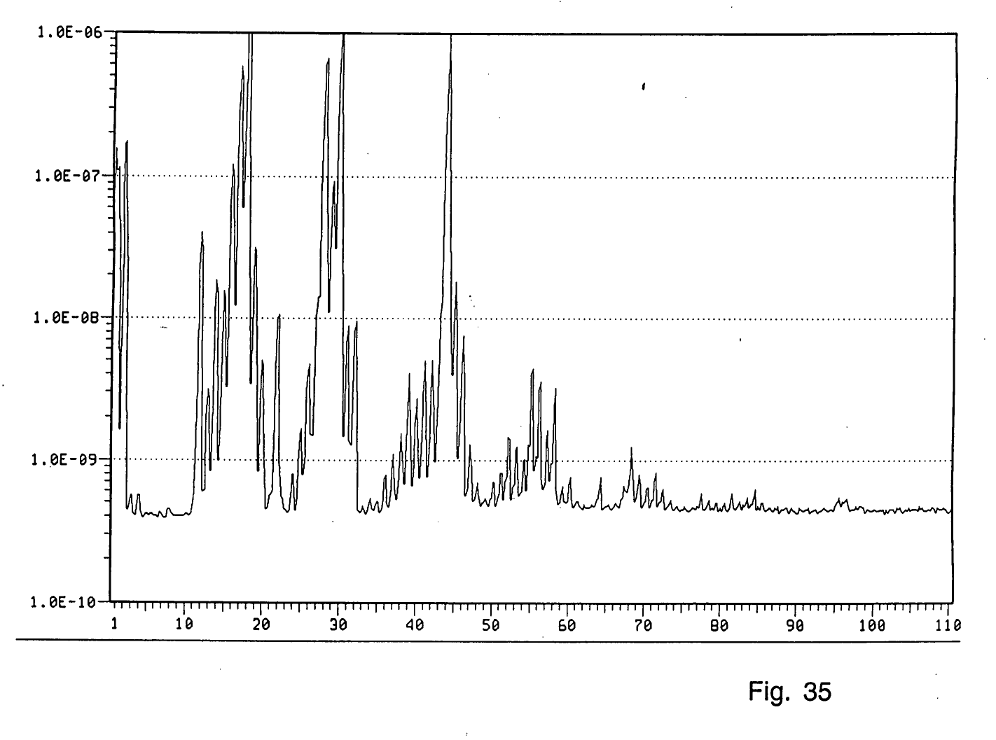

The mass spectrum (m/e=0-110) of the vapors from the crystals from a gas discharge cell hydrino hydride reactor comprising a KI catalyst and a Ni electrodes with a sample heater temperature of 225° C. is shown in FIG. 35. The parent peak assignments of major component hydrino hydride compounds followed by the corresponding m/e of the fragment peaks appear in TABLE 4. No crystal were obtained w when NaI replaced KI.

The mass spectrum (m/e=0-110) of the vapors from the crystals from a plasma torch cell hydrino hydride reactor with a sample heater temperature of 250° C. is shown in FIG. 36 with the assignments of major component aluminum hydrino hydride compounds and fragment peaks. The parent peak assignments of other common major component hydrino hydride compounds followed by the corresponding m/e of the fragment peaks appear in TABLE 4.

An exceptional shoulder was present on the m/e=28 peak due to the hydrino hydride compound AlH₂ (m/e=29) with fragments AlH (m/e=28) and Al (m/e=27). The aluminum hydrino hydride compound is also present as the dimer, A4H₄ with series (m/e=58-54). No hydrino hydride compound peaks were observed when NaI replaced KI.

The presence of NaSiO₂H₆ is consistent with the elemental analysis by XPS which indicated that the plasma torch sample was predominantly SiO₂ as shown in TABLE 8. The source is the quartz of the torch that was etched during operation. Quartz etching was also observed during the operation of the gas cell hydrino hydride reactor.

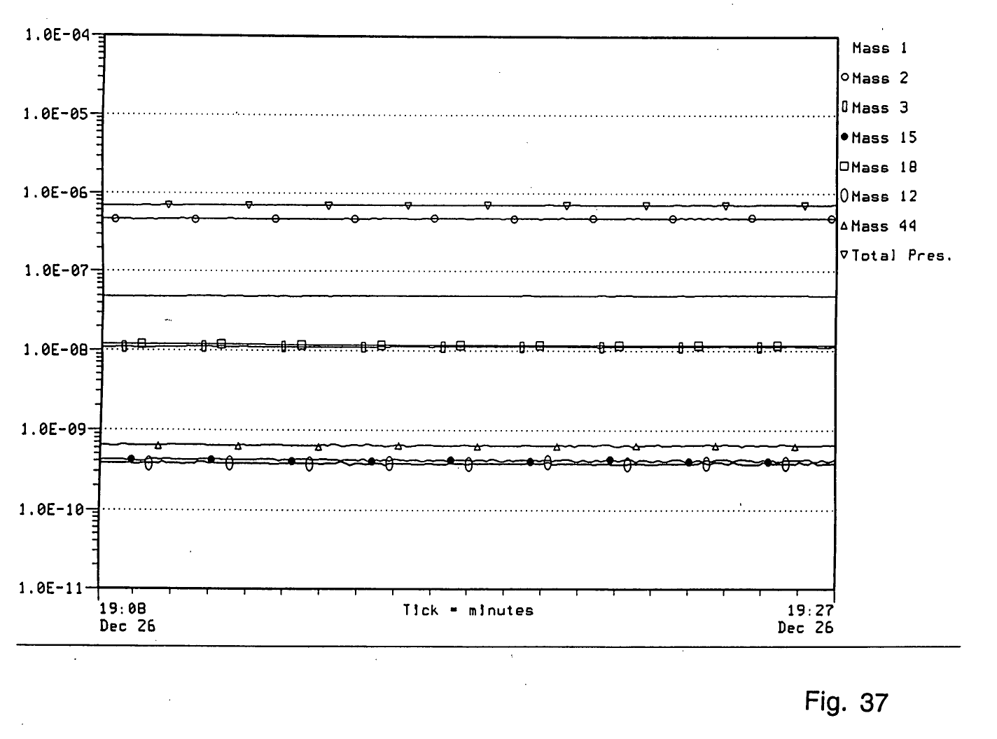

The mass spectrum as a function of time of hydrogen (m/e=2 and (m/e=1), water (m/e=18, m/e=2, and (m/e=1), carbon dioxide (m/e=44 and m/e=12), and hydrocarbon fragment CH₃ (m/e=15), and carbon (m/e=12) obtained following recording the mass spectra of the crystals from the electrolytic cell, the gas cell, the gas discharge cell, and the plasma torch cell hydrino hydride reactors is shown in FIG. 37. The spectra is that of hydrogen where the intensity of the ion current of m/e=2 and m/e=1 is higher than that of m/e=18; even though, no hydrogen was injected into the spectrometer. The source is not consistent with hydrocarbons. The source is assigned to increased binding energy hydrogen compounds given in the Additional Increased Binding Energy Hydrogen Section. The ionization energy was increased from IP=70 eV to IP=150 eV. The m/e=2 and m/e=18 ion currents increased while the m/e=1 ion current decreased indicating that a more stable hydrogen-type molecular ion (dihydrino molecular ion) was formed. The dihydrino molecular ion reacts with the dihydrino molecule to form H₄⁺(1/p) (Eq. (32)). H₄⁺(1/p) serves as a signature for the presence of dihydrino molecules and molecular ions including those formed by fragmentation of increased binding energy hydrogen compounds in a mass spectrometer as demonstrated in FIG. 26D (electrolytic cell with K₂CO₃ catalyst), FIG. 30A (gas cell with KI catalyst), FIGS. 34B and 34C (gas cell with RbI catalyst), and FIG. 35 (gas discharge cell with KI catalyst).

### 13.3 Identification of the Dihydrino Molecule by Mass Spectroscopy

The first ionization energy, IP₁, of the dihydrino molecule

$${H}_{2}^{*} [ 2 {c}^{′} = \frac{\sqrt{2} {a}_{o}}{2} ] \to {{H}_{2}^{*} [ 2 {c}^{′} = {a}_{o} ]}^{+} + {e}^{-} \qquad ( 61 )$$

is IP₁=62.27 eV (p=2 in Eq. (29)); whereas, the first ionization energy or ordinary molecular hydrogen is 15.46 eV. Thus, the possibility of using mass spectroscopy to discriminate

$${H}_{2} [ 2 {c}^{′} = \sqrt{2} {a}_{o} ] from {H}_{2}^{*} [ 2 {c}^{′} = \frac{{a}_{o}}{\sqrt{2}} ]$$

on the basis of the large difference between the ionization energies of the two species was explored. The dihydrino was identified by mass spectroscopy as a species with a mass to charge ratio of two (m/e=2) that has a higher ionization potential than that of normal hydrogen by recording the ion current as a function of the electron gun energy.

### 13.3.1 Sample Collection and Preparation

### 13.3.1.1 Hollow Cathode Electrolytic Samples

Hydrogen gas was collected in an evacuated hollow nickel cathode of an aqueous potassium carbonate electrolytic cell and an aqueous sodium carbonate electrolytic cell. Each cathode was sealed at one end and was on-line to the mass spectrometer at the other end.

Electrolysis was performed with either aqueous sodium or potassium carbonate in a 350 ml vacuum jacketed dewar (Pope Scientific, Inc., Menomonee Falls, Wis.) with a platinum basket anode and a 170 cm long nickel tubing cathode (Ni 200 tubing, 0.0625 in. O.D., 0.0420 in. I.D., with a nominal wall thickness of 0.010 in., MicroGroup, Inc., Medway, Mass.). The cathode was coiled into a 3.0 cm long helix with a 2.0 cm diameter. One end of the cathode was sealed above the electrolyte with a 0.0625 in. Swagelock union and plug (Swagelock Co., Solon, Ohio). The other end was connected directly to a needle valve on the sampling port of a Dycor System 1000 Quadrapole Mass Spectrometer (Model D200MP, Ametek, Inc., Pittsburgh, Pa.).

### 13.3.1.2 Control Hydrogen Sample

The control hydrogen gas was ultrahigh purity (MG Industries).

13.3.1.3 Electrolytic Gasses from Recombiner

During the electrolysis of aqueous potassium carbonate, MIT Lincoln Laboratories observed long duration excess power of 1-5 watts with output/input ratios over 10 in some cases with respect to the cell input power reduced by the enthalpy of the generated gas [Haldeman, C. W., Savoye, G. W., Iseler, G. W., Clark, H. R., MIT Lincoln Laboratories Excess Energy Cell Final report ACC Project 174 (3), Apr. 25, 1995]. In these cases, the output was 1.5 to 4 times the integrated volt-ampere power input. Faraday efficiency was measured volumetrically by direct water displacement. Electrolytic gases were passed through a copper oxide recombiner and a Burrell absorption tube analyzer multiple times until the processed gas volume remained unchanged. The processed gases were sent to BlackLight Power Corporation, Malvern, Pa. and were analyzed by mass spectroscopy.

### 13.3.1.4 Gas Cell Sample

Pennsylvania State University Chemical Engineering Department determined the heat production associated with hydrino formation with a Calvet calorimeter. The instrument used to measure the heat of reaction comprised a cylindrical heat flux calorimeter (International Thermal Instrument Co., Model CA-100-1). The cylindrical calorimeter walls contained a thermopile structure composed of two sets of thermoelectric junctions. One set of junctions was in thermal contact with the internal calorimeter wall, at temperature Tᵢ, and the second set of thermal junctions was in thermal contact with the external calorimeter wall at Tₑ which is held constant by a forced convection oven. When heat was generated in the calorimeter cell, the calorimeter radially transferred a constant fraction of this heat into the surrounding heat sink. As heat flowed a temperature gradient, (Tᵢ-Tₑ), was established between the two sets of thermopile junctions. This temperature gradient generated a voltage which was compared to the linear voltage versus power calibration curve to give the power of reaction. The calorimeter was calibrated with a precision resistor and a fixed current source at power levels representative of the power of reaction of the catalyst runs. The calibration constant of the Calvet calorimeter was not sensitive to the flow of hydrogen over the range of conditions of the tests. To avoid corrosion, a cylindrical reactor, machined from 304 stainless steel to fit inside the calorimeter, was used to contain the reaction. To maintain an isothermal reaction system and improve baseline stability, the calorimeter was placed inside a commercial forced convection oven that was be operated at 250° C. Also, the calorimeter and reactor were enclosed within a cubic insulated box, constructed of Durok (United States Gypsum Co.) and fiberglass, to further dampen thermal oscillations in the oven. A more complete description of the instrument and methods are given by Phillips [Bradford, M. C., Phillips, J., Klanchar, Rev. Sci. Instrum., 66, (1), January, (1995), pp. 171-175].

The 20 cm³ Calvet cell contained a heated coiled section of 0.25 mm platinum wire filament approximately 18 cm in length and 200 mg of KNO₃ powder in a quartz boat fitted inside the filament coil that was heated by the filament.

The calorimetry tests yielded exceptional results [Phillips, J., Smith, J., Kurtz, S., “Report On Calorimetric Investigations Of Gas-Phase Catalyzed Hydrino Formation” Final report for Period October-December 1996”, Jan. 1, 1997]. In three separate trials, between 10 and 20 K Joules were generated at a rate of 0.5 Watts, upon admission of approximately 10⁻³ moles of hydrogen to the cell. This is equivalent to the generation of 10⁷ J/mole of hydrogen, as compared to 2.5×10⁵ J/mole of hydrogen anticipated for standard hydrogen combustion. Thus, the total heats generated appear to be 100 times too large to be explained by conventional chemistry, but the results are completely consistent with the catalysis of hydrogen. Catalysis occurred when molecular hydrogen was dissociated by the hot platinum filament and the atomic hydrogen contacted the gaseous K⁺/K⁺ catalyst from the KNO₃ powder in the quartz boat that was heated and volatilized by the filament.

Following the calorimetry test, the gasses from the Calvet cell were collected in an evacuated stainless steel sample bottle and shipped to BlackLight Power Corporation, Malvern, Pa. where they were analyzed by mass spectroscopy.

### 13.3.2 Mass Spectroscopy

The mass spectroscopy was performed with a Dycor System 1000 Quadrapole Mass Spectrometer Model #D200MP with a HOVAC Dri-2 Turbo 60 Vacuum System. The ionization energy was calibrated to within ±1 eV.

Mass spectra of gases permeant to a nickel tubing cathode sealed at one end and on-line to the mass spectrometer at the other were taken for potassium carbonate electrolysis cells and sodium carbonate electrolysis cells. The intensity of the m/e=1 and m/e=2 peaks were recorded while varying the ionization potential (IP) of the mass spectrometer. The pressure of the sample gas in the mass spectrometer was kept the same for each experiment by adjusting the needle value of the mass spectrometer. The entire range of masses through m/e=200 was measured at IP=70 eV following the determinations at m/e=1 and m/e=2.

### 13.3.3 Results and Discussion

The results of the mass spectroscopic analysis (m/e=2) of the potassium carbonate run and the sodium carbonate run with varying ionization potential of gasses from the seal nickel tubing cathode on-line with the mass spectrometer appear in TABLES 5 and 6, respectively. For the sodium carbonate control, the signal intensity is essentially constant with IP. Whereas, in the case of the gasses from the potassium carbonate electrolytic cell, the m/e=2 signal increases significantly when the ionization energy is increased from 30 eV to 70 eV. A species with a much higher ionization potential than molecular hydrogen, somewhere between 30-70 eV, is present. The higher ionizing mass two species is assigned to the dihydrino molecule,

$${H}_{2}^{*} [ 2 {c}^{′} = \frac{{a}_{o}}{\sqrt{2}} ] .$$

TABLE 5
Partial pressures at m/e = 2 with ionization energies of −30 eV
and −70 eV of gases permeant to a Ni tubing cathode during electrolysis
of aqueous K₂CO₃.

| | Run Number | | | | | | | |
|---|---|---|---|---|---|---|---|---|
| IP | 1 | 2 | 3 | 4 | 5 | 6 | 7 | 8 |
| −30 eV | 1.2E−09 | 2.9E−08 | 7.3E−08 | 2.3E−08 | 3.5E−08 | 3.1E−08 | 9.4E−08 | 3.4E−08 |
| −70 eV | 6.4E−09 | 9.6E−08 | 2.0E−07 | 1.1E−07 | 1.6E−07 | 1.3E−07 | 4.0E−07 | 1.2E−07 |

TABLE 6
Partial pressures at m/e = 2 with ionization energies of −30 eV
and −70 eV of gases permeant to a Ni tubing cathode during
electrolysis of aqueous Na₂CO₃.

| | Run Number | | |
|---|---|---|---|
| IP | 1 | 2 | 3 |
| −30 eV | 1.1E−08 | 6.7E−08 | 1.6E−08 |
| −70 eV | 9.4E−09 | 5.0E−08 | 1.7E−08 |

The mass spectrum (m/e=0-50) of the gasses from the Ni tubing cathode of the K₂CO₃ electrolytic cell on-line with the mass spectrometer is shown in FIG. 38. No peaks were observed outside this range. As the ionization energy was increased from 30 eV to 70 eV a m/e=4 peak was observed. The m/e=4 was not observed in the case that Na₂CO₃ replaced K₂CO₃ or in the case of the mass spectrum of high purity hydrogen gas. The only known element which gives an m/e=4 peak was helium which was not present in the electrolytic cell, and the cathode was on-line to the mass spectrometer which was under high vacuum. Helium is further excluded by the absence of a m/e=5 peak which is always present with helium hydrogen mixtures, but is not observed in the in FIG. 38. From the data, hydrinos are produced in nickel hydride according to Eq. (35). The dihydrino molecule has a higher diffusion rate in nickel than hydrogen. Dihydrino gives rise to a m/e=4 mass spectroscopic peak. The reaction follows from Eq. (32).

$${H}_{2}^{*} [ 2 {c}^{′} = \frac{\sqrt{2} {a}_{o}}{p} ] + {{H}_{2}^{*} [ 2 {c}^{′} = \frac{2 {a}_{o}}{p} ]}^{+} \to {H}_{4}^{+} ( 1 / p ) \qquad ( 62 )$$

H₄⁺ (1/p) serves as a signature for the presence of dihydrino molecules.

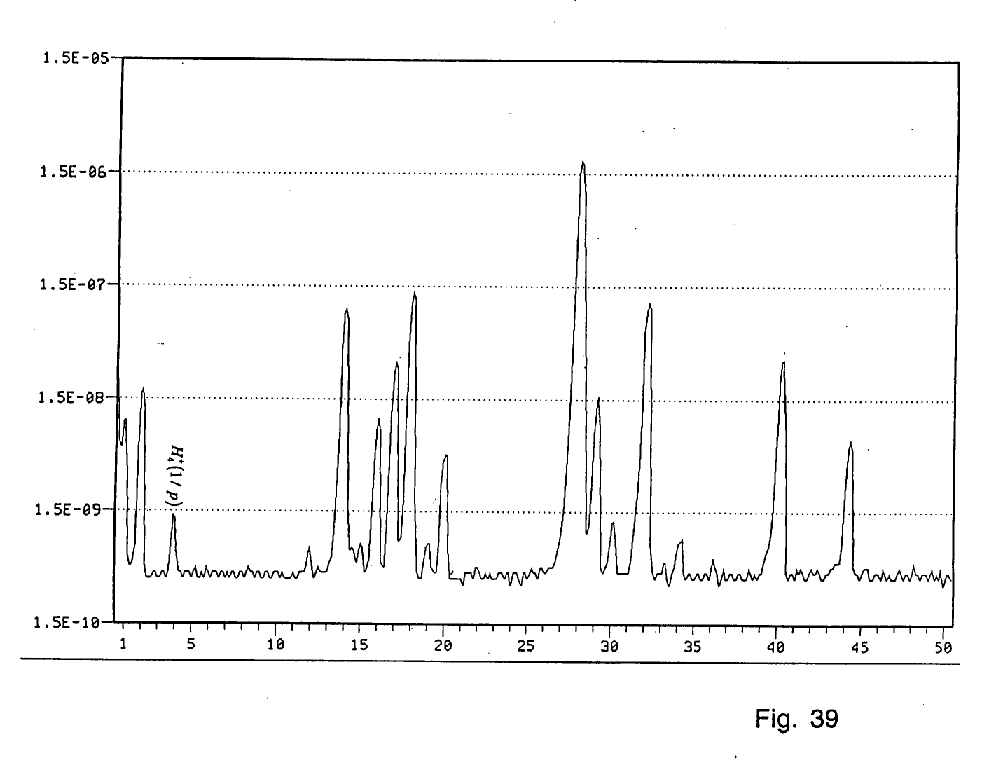

The mass spectrum (m/e=0-50) of the MIT sample comprising nonrecombinable gas from a K₂CO₃ electrolytic cell is shown in FIG. 39. As the ionization energy was increased from 30 eV to 70 eV a m/e=4 peak was observed that was assigned to H₄⁺(1/p). The peak serves as a signature for the presence of dihydrino molecules.

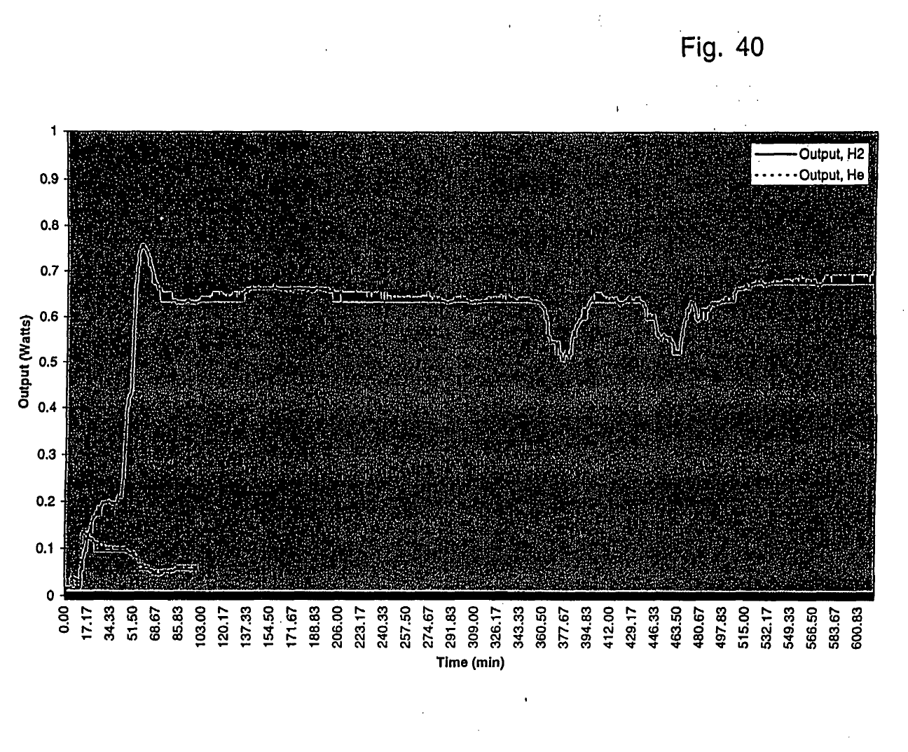

The output power versus time during the catalysis of hydrogen and the response to helium in a Calvet cell containing a heated platinum filament and KNO₃ powder in a quartz boat that was heated by the filament is shown in FIG. 40. During the time interval shown 2.2×10⁵ J of energy was produced by hydrogen; whereas the response of the calorimeter to helium (shown offset) was trace positive followed by trace negative, and equilibration to null response. The energy released if all of the hydrogen present in the closed cell under went combustion is equivalent to the area under the power curve between two time increments (ΔT=17 mins). Combustion is the most exothermic ordinary reaction possible. The 10⁻³ moles of hydrogen added to the 20 cm³ Calvet cell generated 2×10⁸ J/mole of hydrogen, as compared to 2.5×10⁵ J/mole of hydrogen anticipated for standard hydrogen combustion. The large enthalpy which can not be explained by conventional chemistry, is assigned to the catalysis of hydrogen.

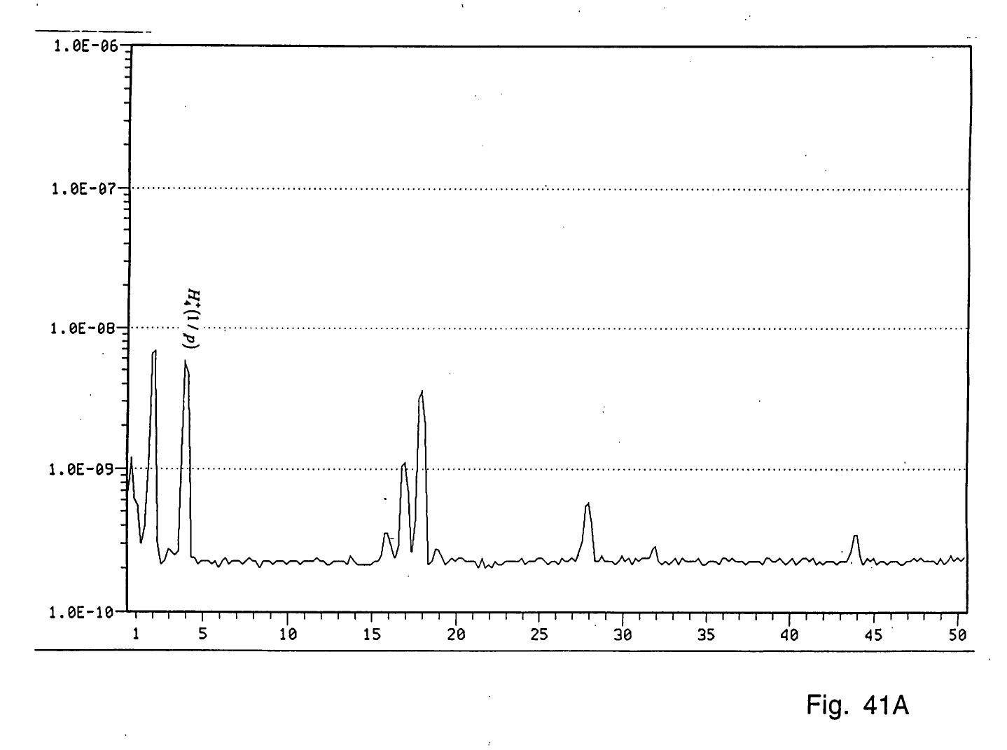

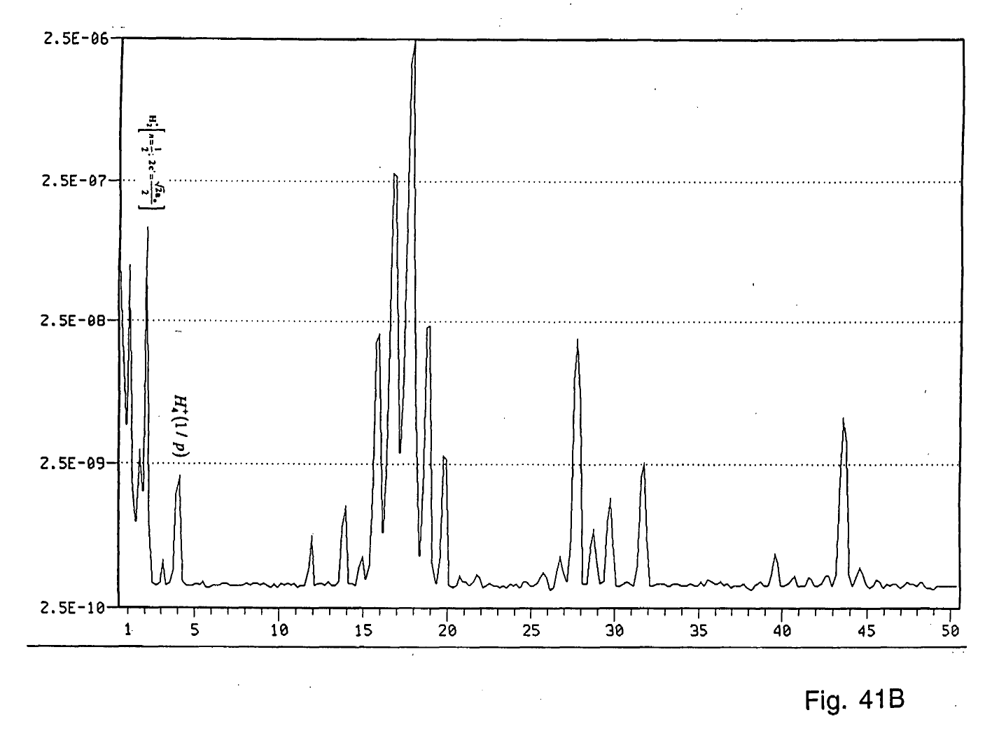

The mass spectrum (m/e=0-50) of the gasses from the Pennsylvania State University Calvet cell following the catalysis of hydrogen that were collected in an evacuated stainless steel sample bottle is shown in FIG. 41A. As the ionization energy was increased from 30 eV to 70 eV a m/e=4 peak was observed that was assigned to H₄⁺(1/p). The peak serves as a signature for the presence of dihydrino molecules. As the pressure was reduced by pumping, the m/e=2 peak split as shown in FIG. 41B. In this case, the response of the m/e=2 peak to ionization potential was significantly increased. Sample was introduced, and the ion current was observed to increased from 2×10⁻¹⁰ to 1×10⁻⁸ as the ionization potential was changed from 30 eV to 70 eV. The split m/e=2 peak and the significant response of the ion current to ionization potential are further signatures for dihydrino.

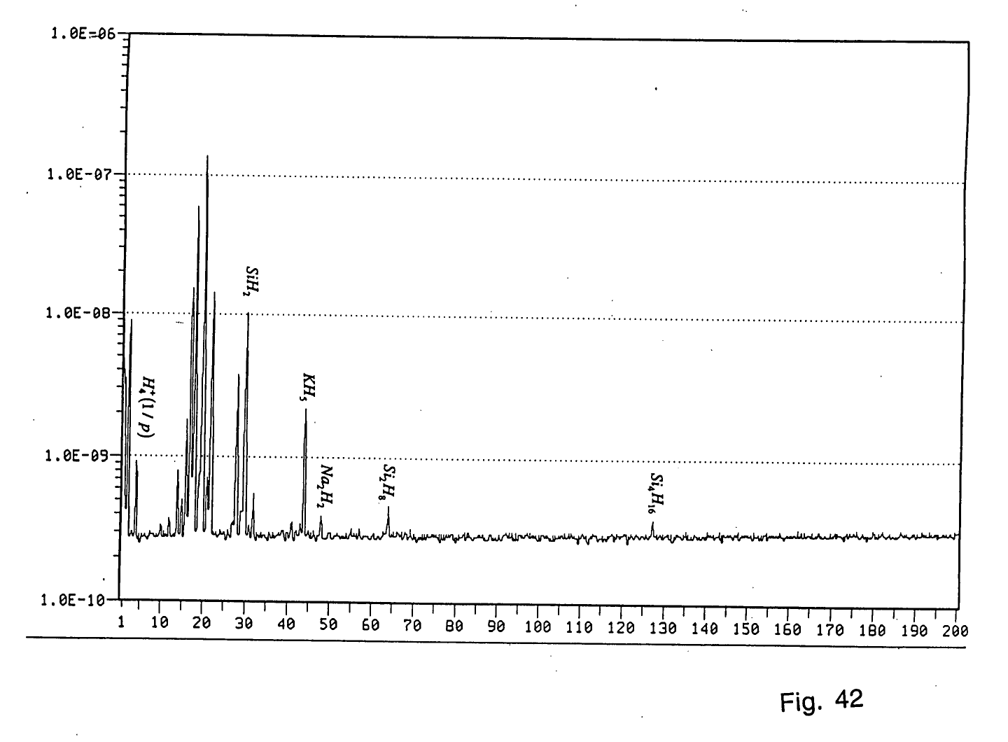

The mass spectrum (m/e=0-200) of the gasses from the Pennsylvania State University Calvet cell following the catalysis of hydrogen that were collected in an evacuated stainless steel sample bottle is shown in FIG. 42. Several hydrino hydride compounds were identified as indicated in FIG. 42. The production of dihydrino and hydrino hydride compounds confirms the assignment of the enthalphy to the catalysis of hydrogen.

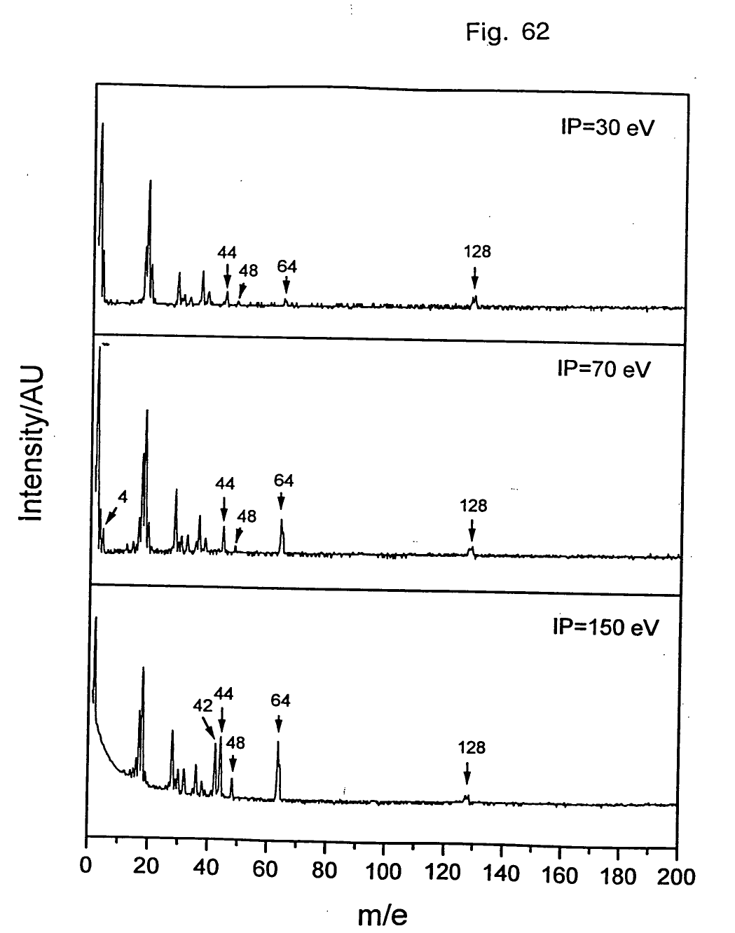

The m/e=4 peak that was assigned to H₄⁺(1/p) was also observed during mass spectroscopic analysis of hydrino hydride compounds as given in the Identification of Hydrino Hydride Compounds by Mass Spectroscopy Section and the Identification of Hydrino Hydride Compounds by Time-Of-Flight-Secondary-Ion-Mass-Spectroscopy (TOFSIMS) Section (e.g. FIG. 62). The m/e=4 peak was further observed during mass spectroscopy following gas chromatographic analysis of samples comprising dihydrino as given in the Identification of Hydrino Hydride Compounds and Dihydrino by Gas Chromatography with Calorimetry of the Decomposition of Hydrino Hydride Compounds Section.

13.4 Identification of Hydrino Hydride Compounds and Dihydrino by Gas Chromatography with Calorimetry of the Decomposition of Hydrino Hydride Compounds

Increased binding energy hydrogen compounds are given in the Additional Increased Binding Energy Compounds Section. It was observed that NiO formed and precipitated out over time from the filtered electrolyte (Whatman 110 mm filter paper (Cat. No. 1450 110)) of the K₂CO₃ electrolytic cell described in the Identification of Hydrinos, Dihydrinos, and Hydrino Hydride Ions by XPS (X-ray Photoelectron Spectroscopy) Section. The XPS contains nickel as shown in FIG. 18, and the crystals isolated from the electrolyte of the K₂CO₃ electrolytic cell contained compounds such as NiHₙ (where n is an integer) as given in the Identification of Hydrino Hydride Compounds by Time-Of-Flight-Secondary-Ion-Mass-Spectroscopy (TOFSIMS) Section. Since Ni(OH)₂ and NiCO₃ are extremely insoluble in a solution with a measured pH of 9.85, the source of the NiO from a soluble nickel compound is likely the decomposition of compounds such as NiHₙ to NiO. This was tested by adding an equal atomic percent LiNO₃ and acidifying the electrolyte with HNO₃ to form potassium nitrate. The solution was dried and heated to a melt at 120° C. whereby NiO formed. The solidified melt was dissolved in H₂O, and the NiO was removed by filtration. The solution was concentrated until crystals just appeared at 50° C. White crystals formed from the solution standing at room temperature. The crystals were obtained by filtration. The crystals were recrystallized with distilled water, and mass spectroscopy was performed by the method given in the Identification of Hydrino Hydride Compounds by Mass Spectroscopy Section. The mass ranges m/e=1 to 220 and m/e=1 to 120 were scanned. The mass spectrum was equivalent to that of the crystals from the electrolyte of the K₂CO₃ electrolytic cell that was made 1 M in LiNO₃ and acidified with HNO₃ (mass spectroscopy electrolytic cell sample #3 shown in FIG. 24 with parent peak identifications shown in TABLE 4) except that the following new hydrino hydride compound peaks were present: Si₃H₁₀O (m/e=10), S₂H₈, (m/e=64), SiH₈ (m/e=36), and SiH₂ (m/e=30). In addition, X-ray diffraction of these crystals showed peaks that could not be assigned to known compounds as given in the Identification of Hydrino Hydride Compounds by XRD Section (XRD sample #4). TOFSIMS was also performed. The results where similar to those of TOFSIMS sample #6 shown in TABLES 20 and 21.

Aluminum analogues of NiHₙ n=integer are produced in the plasma torch as shown in FIG. 36. These are expected to decomposed under appropriate conditions, and hydrogen may be released from these hydrogen containing hydrino hydride compounds. The ortho and para forms of molecular hydrogen can readily be separated by chromatography at low temperatures which with its characteristic retention time is a definitive means of identifying the presence of hydrogen in a sample. The possibility of releasing dihydrino molecules by thermally decomposing hydrino hydride compounds with identification by gas chromatography was explored.

Dihydrino molecules may be synthesized according to Eq. (37) by the reaction of a proton with a hydrino atom. A gas discharge cell hydrino hydride reactor is a source of ionized hydrogen atoms (protons) and a source of hydrino atoms. The catalysis of hydrogen atoms occurs in the gas phase with a catalyst that is volatilized from the electrodes by the hot plasma current. Gas phase hydrogen atoms are also generated with the discharge. Thus, the possibility of synthesizing dihydrino in a gas discharge cell with identification by gas chromatography was explored.

Increased binding energy hydrogen has an internuclear distance which is fractional

$$( \frac{1}{integer} )$$

compared with that of normal hydrogen. The ortho and para forms of molecular hydrogen can readily be separated by chromatography at low temperatures. The possibility of using gas chromatography at cryogenic temperatures to discriminate ortho and para

$${H}_{2} [ 2 {c}^{′} = \sqrt{2} {a}_{o} ]$$

from ortho and para

$${H}_{2}^{*} [ 2 {c}^{′} = \frac{\sqrt{2} {a}_{o}}{p} ] ,$$

respectively, as well as other dihydrino molecules on the basis of the difference in sizes of hydrogen versus dihydrino was explored.

### 13.4.1 Gas Chromatography Methods

Gas samples were analyzed with a Hewlett Packard 5890 Series II gas chromatograph equipped with a thermal conductivity detector and a 60 meter, 0.32 mm ID fused silica Rt-Alumina PLOT column (Restek, Bellefonte, Pa.). The column was conditioned at 200° C. for 18-72 hours before each series of runs. Samples were run at −196° C. using Ne as the carrier gas. The 60 meter column was run with the carrier gas at 3.4 psi with the following flow rates: carrier −2.0 ml/min., auxiliary −3.4 ml/min., and reference −3.5 ml/min., for a total flow rate of 8.9 ml/min. The split rate was 10.0 m/min.

### 13.4.1.1 Control Sample

The control hydrogen gas was ultrahigh purity (MG Industries).

### 13.4.1.2 Plasma Torch Sample

Hydrino hydride compounds were generated in the plasma torch hydrino hydride reactor with a KI catalyst by the method described in the Plasma Torch Sample Section. A 10 mg sample was placed in a 4 mm ID by 25 mm long quartz tube that was sealed at one end and connected at the open end with Swagelock™ fittings to a T that was connected to a Welch Duo Seal model 1402 mechanical vacuum pump and a septum port. The apparatus was evacuated to between 25 and 50 millitorr. Hydrogen was generated by thermally decomposing hydrino hydride compounds. The heating was performed in the evacuated quartz chamber containing the sample with an external Nichrome wire heater. The sample was heated in 100° C. increments by varying the transformer voltage of the Nichrome heater. Gas released from the sample was collected with a 500 μl gas tight syringe through the septum port and immediately injected into the gas chromatograph.

### 13.4.1.3 Coated Cathode Sample

Dihydrino molecules were generated in an evacuated chamber via thermally decomposing hydrino hydride compounds. The source of hydrino hydride compounds was the coating from a 0.5 mm diameter nickel wire from the K₂CO₃ electrolytic cell that produced 6.3×10⁸ J of enthalpy of formation of increased binding energy hydrogen compounds (BLP Electrolytic Cell). The wire was dried and heated to about 800° C. The heating was performed in an evacuated quartz chamber by passing a current through the cathode. Samples were taken and analyzed by gas chromatography.

A 60 meter long nickel wire cathode from a potassium carbonate electrolytic cell was coiled around a 7 mm OD, 30 cm long hollow quartz tube and inserted into a 40 cm long, 12 mm OD quartz tube. The larger quartz tube was sealed at both ends with Swagelock™ fittings and connected to a Welch Duo Seal model 1402 mechanical vacuum pump with a stainless steel Nupro™ “H” series bellows valve. A thermocouple vacuum gauge tube and rubber septum were installed on the apparatus side of the pump. The nickel wire cathode was connected to leads through the Swagelock™ fittings to a 220V AC transformer. The apparatus containing the nickel wire was evacuated to between 25 and 50 millitorr. The wire was heated to a range of temperatures by varying the transformer voltage. Gas released from the heated wire was collected with a 500 μl gas tight syringe through the installed septum port and immediately injected into the gas chromatograph. White crystals of increased binding energy hydrogen compounds which did not thermally decompose were cryopumped to the cool ends of the evacuated tube. This represents a method of the present invention to purify these compounds.

The mass spectrum (m/e=0-50) of the gasses from the heated nickel wire cathode was obtained following the recording of the gas chromatograph.

### 13.4.1.4 Gas Discharge Cell Sample

The hydrogen catalysis to form hydrino occurred in the gas phase with the catalyst KI that was volatilized from the electrodes by the hot plasma current. Gas phase hydrogen atoms were generated with the discharge. Dihydrino molecules were synthesized using the gas discharge cell described in the Gas Discharge Cell Sample Section by: (1) putting the catalyst solution inside the lamp and drying it to form a coating on the electrodes; (2) vacuuming the system at 10-30 mtorr for several hours to remove contaminant gases and residual solvent; (3) filling the discharge tube with a few torr hydrogen and carrying out an arc discharge for at least 0.5 hour. The chromatographic column was submerged in liquid nitrogen and connected to the thermal conductivity detector of the gas chromatograph. The gases flowed through a 100% CuO recombiner and were analyzed by the on-line gas chromatography using a three way valve.

The mass spectrum (m/e=0-50) of the gasses from the KI discharge tube on-line with the mass spectrometer was obtained following the recording of the gas chromatograph.

### 13.4.2 Adiabatic Calorimetry Methods

The enthalpy of the decomposition reaction of the coated cathode sample was measured with an adiabatic calorimeter comprising the decomposition apparatus described above that was suspended in an insulated vessel containing 12 liters of distilled water. The temperature rise of the water was used to determine the enthalpy of the decomposition reaction. The water was stabilized for one hour at room temperature before each experiment. Continuous paddle stirring was set at a predetermined rpm to eliminate temperature gradients in the water without input of measurable energy. The temperature of the water was measured by two type K thermocouples. The cold junction temperature was utilized to monitor room temperature changes. Data points were taken every tenth of a second, averaged every ten seconds, and recorded with a computer DAS. The experiment was run with a wire temperature of 800° C. determined by a resistance measurement that was confirmed by optical pyrometry. For the control cases, 600 watts of electrical input power was typically necessary to maintain the wire at this temperature. The input power to the filament was recorded over time with a Clarke Hess volt-amp-watt meter with analog output to the computer DAS. The power balance for the calorimeter was:

0=Pᵢₙₚᵤₜ−(mCₚdT/dt+Pₗₒₛₛ−P_{D}) (63)

where Pᵢₙₚᵤₜ was the input power measured by the watt meter, m was the mass of the water (12,000 g), Cp is the specific heat of water (4.184 J/g ° C.), dT/dt was the rate of change in water temperature, Pₗₒₛₛ was the power loss of the water reservoir to the surroundings (deviation from adiabatic) which was measured to be negligible over the temperature range of the tests, and P_{D} was the power released from the hydrino hydride compound decomposition reaction.

The rise in temperature was plotted versus the total input enthalpy. Using 12,000 grams as the mass of the water and using the specific heat of water of 4.184 J/g ° C., the theoretical slope was 0.020° C./kJ. The experiment involved an unrinsed 60 meter long nickel wire cathode from the K₂CO₃ electrolytic cell that produced 6.3×10⁸ J of enthalpy of formation of increased binding energy hydrogen compounds (BLP Electrolytic Cell). Controls comprised hydrogen gas hydrided nickel wire (NI 200 0.0197″, HTN36NOAG1, A1 Wire Tech, Inc.), and cathode wires from an identical Na₂CO₃ electrolytic cell.

### 13.4.3 Enthalpy of the Decomposition Reaction of Hydrino Hydride Compounds and Gas Chromatography Results

### 13.4.3.1 Enthalpy Measurement Results

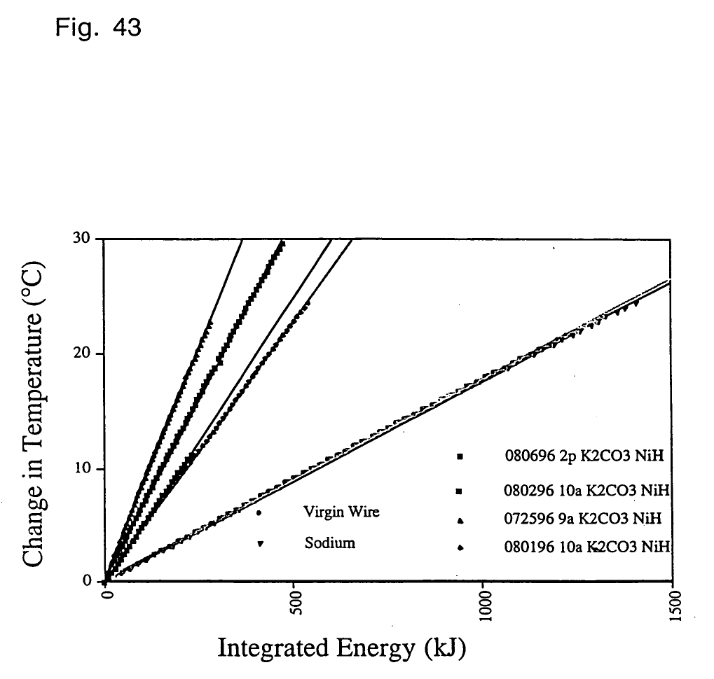

The results of the measurement of the enthalpy of the decomposition reaction of hydrino hydride compounds measured with the adiabatic calorimeter are shown in FIG. 43 and TABLE 7. The wires from the Na₂CO₃ electrolytic cell and the hydrided virgin nickel wires produced slopes of water temperature rise versus integrated input enthalpy that were identical to the theoretical slope (0.020° C./kJ). Each wire cathode from the K₂CO₃ cell produced a result that deviated substantially from the theoretical slope, and much less input power was necessary to maintain the wire at 800° C. as shown in TABLE 7. The results indicate that the decomposition reaction of hydrino hydride compounds is very exothermic. In the best case, the enthalpy was 1 MJ(25° C.×12,000 g×4.184 J/g° C.-250 kJ) released over 30 minutes (25° C.×12,000 g×4.184 J/g° C. 693 W).

TABLE 7
The results of the measurement of the enthalpy of the
decomposition reaction of hydrino hydride compounds using an adiabatic
calorimeter with virgin nickel wires and cathodes from a Na₂CO₃
electrolytic cell and the K₂CO₃ electrolytic cell that produced 6.3 × 10⁸ J
of enthalpy of formation of increased binding energy hydrogen compounds
(BLP Electrolytic Cell).

| | | | |
|---|---|---|---|
| | | | Average |
| | Input Power | Slope | Slope |
| trial | (W) | (° C./kJ) | (° C./kJ) |

Virgin Wire Control

| | | | |
|---|---|---|---|
| 1 | 151 | 0.017 | |
| 2 | 345 | 0.018 | |
| 3 | 452 | 0.017 | |
| 4 | 100 | 0.017 | 0.017 |

Sodium Carbonate Control

| | | | |
|---|---|---|---|
| 1 | 354 | 0.020 | |
| 2 | 272 | 0.016 | |
| 3 | 288 | 0.017 | |
| 4a | 100 | 0.017 | |
| 4b | 100 | 0.018 | 0.018 |

Potassium Carbonate

| | | | Average | Output | |
|---|---|---|---|---|---|
| | Input Power | Slope | Slope | Power | P_{D} |
| trial | (W) | (° C./kJ) | (° C./kJ) | (W) | (W) |
| 1a | 152 | 0.082 | | 693 | 541 |
| 1b | 172 | 0.074 | | 706 | 534 |
| 2 | 186 | 0.045 | | 464 | 278 |
| 3 | 182 | 0.050 | | 503 | 321 |
| 4 | 138 | 0.081 | | 622 | 484 |
| 5a | 103 | 0.062 | | 357 | 254 |
| 5b | 92 | 0.064 | | 327 | 235 |
| 5c | 99 | 0.094 | | 517 | 418 |
| | | | 0.066 | | |

### 13.4.3.2 Gas Chromatography Results

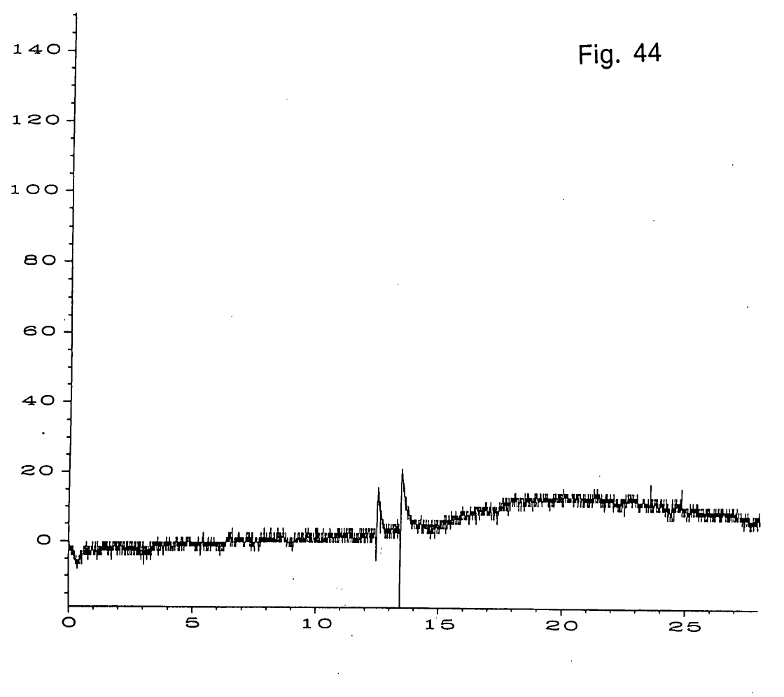

The gas chromatograph of the normal hydrogen gave the retention time for para hydrogen and ortho hydrogen as 12.5 minutes and 13.5 minutes, respectively. For the plasma torch sample collected from the hydrino hydride compound trap (filter paper), the gas chromatographic analysis of gasses released by heating in 100° C. increments in the temperature range 100° C. to 900° C. showed no hydrogen release at any temperature. For the plasma torch sample collected from the torch manifold, the gas chromatographic analysis of gasses released by heating in 100° C. increments in the temperature range 100° C. to 900° C. showed hydrogen release at 400° C. and 500° C. The gas chromatograph of the gases released from the sample collected from the plasma torch manifold when the sample was heated to 400° C. is shown in FIG. 44. The elemental analysis of the plasma torch samples were determined by EDS and XPS. The concentration of elements detected by XPS in atomic percent is shown in TABLE 8.

TABLE 8
Concentration of Elements Detected by XPS (in Atomic %).

| Sample | Na | I | O | C | Cl | Si | Al | K | Mg | K/I |
|---|---|---|---|---|---|---|---|---|---|---|
| Manifold | 1.1 | 0.4 | 61.3 | 6.4 | 0.5 | 28.2 | 0.1 | 2.0 | 0.1 | 5 |
| Filter Paper | 0.2 | 2.3 | 60.0 | 6.0 | 0.1 | 28.5 | 0.1 | 2.8 | 0.1 | 1.2 |
| KI | 3.4 | 23.1 | 8.8 | 34.3 | 1.7 | 0.0 | 0.0 | 28.6 | 0.1 | 1.2 |

The XPS of the sample collected from the torch manifold was remarkable in that the potassium to iodide ratio was five; whereas, the ratio was 1.2 for KI and 1.2 for sample collected from the hydrino hydride compound trap (filter paper). The EDS and XPS of the sample collected from the torch manifold indicated an elemental composition of predominantly SiO₂ and KI with small amounts of aluminum, silicon, sodium, and magnesium. The mass spectrum of the sample collected from the torch manifold is shown in FIG. 36 which demonstrates hydrino hydride compounds consistent with the elemental composition. None of the elements identified are known to store and release hydrogen in the temperature range of 400-500° C. These data indicate that the crystals from the plasma torch contain hydrogen and are fundamentally different from previously known compounds. These results without convention explanation correspond to and identify increased binding energy hydrogen compounds according to the present invention.

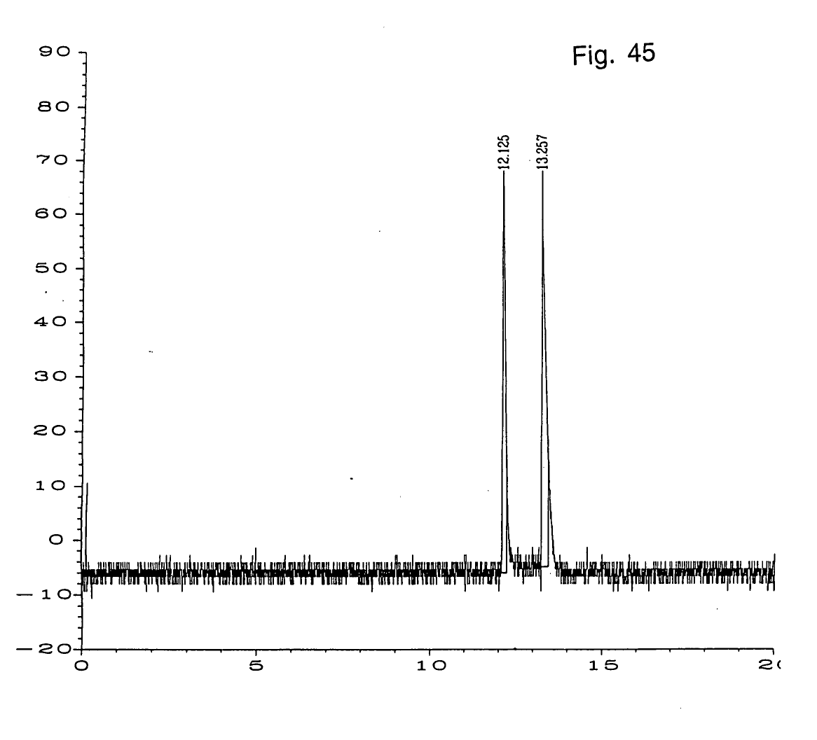

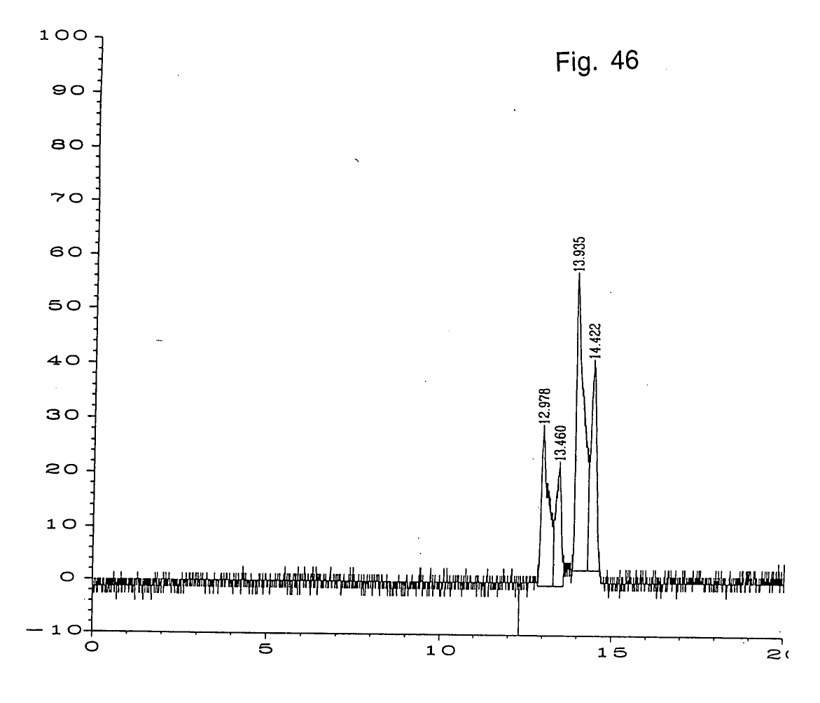

The gas chromatographic analysis (60 meter column) of high purity hydrogen is shown in FIG. 45. The results of the gas chromatographic analysis of the heated nickel wire cathode appear in FIG. 46. The results indicate that a new form of hydrogen molecule was detected based on the presence of peaks with migration times comparable but distinctly different from those of the normal hydrogen peaks. The mass spectrum (m/e=0-50) of the gasses from the heated nickel wire cathode was obtained following the recording of the gas chromatograph. As the ionization energy was increased from 30 eV to 70 eV a m/e=4 peak was observed that was equivalent to that shown in FIG. 41A. Helium was not observed in the gas chromatograph. The m/e=4 peak was assigned to H₄⁺(1/p). The reaction follows from Eq. (32). H₄⁺(1/p) serves as a signature for the presence of dihydrino molecules.

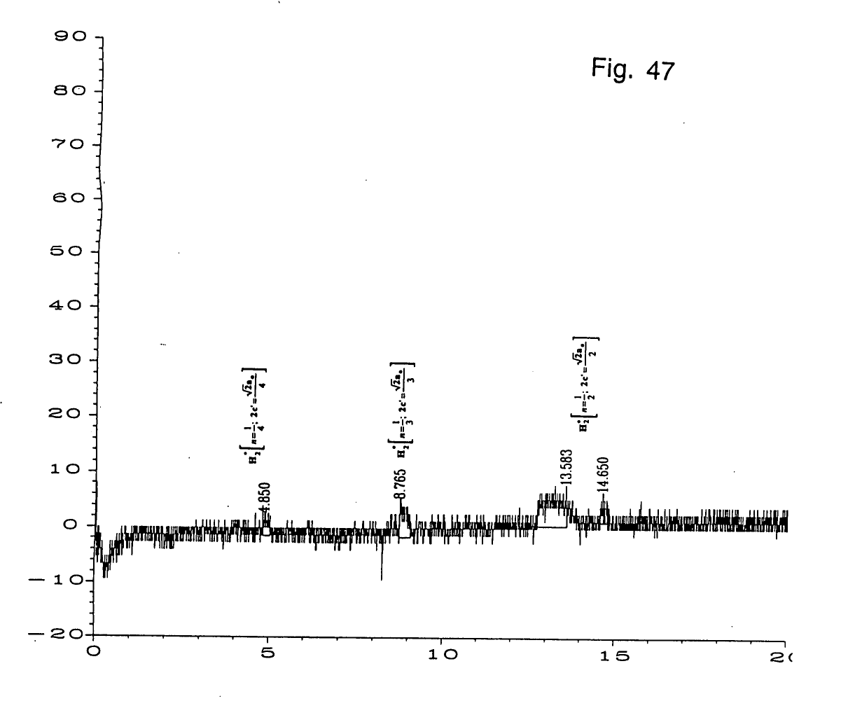

FIG. 47 shows peaks assigned to

$${H}_{2}^{*} [ 2 {c}^{′} = \frac{\sqrt{2} {a}_{o}}{2} ] , {H}_{2}^{*} [ 2 {c}^{′} = \frac{\sqrt{2} {a}_{o}}{3} ] , and {H}_{2}^{*} [ 2 {c}^{′} = \frac{\sqrt{2} {a}_{o}}{3} ] .$$

The results indicate that new forms of hydrogen molecules were detected based on the presence of peaks that did not react with the recombiner with migration times distinctly different from those of the normal hydrogen peaks. Control hydrogen run (FIG. 45) before and after the result shown in FIG. 47 showed no peaks due to recombination by the 100% CuO recombiner. The mass spectrum (m/e=0-50) of the gasses from the KI discharge tube on-line with the mass spectrometer was obtained following the recording of the gas chromatograph. As the ionization energy was increased from 30 eV to 70 eV a m/e=4 peak was observed that was equivalent to that shown in FIG. 41A. The reaction follows from Eq. (32). H₄⁺(1/p) serves as a signature for the presence of dihydrino molecules. As the pressure was reduced by pumping, the m/e=2 peak split equivalent to that shown in FIG. 41B. In this case, the response of the m/e=2 peak to ionization potential was significantly increased. The split m/e=2 peak and the significant response of the ion current to ionization potential are further signatures for dihydrino.

### 13.4.4 Discussion

The results of the calorimetry of the decomposition reaction of increased binding energy hydrogen compounds can not be explained by conventional chemistry. In addition to novel reactivity, other tests confirm increased binding energy hydrogen compounds. The cathode of the K₂CO₃ BLP Electrolytic Cell described in the Crystal Samples from an Electrolytic Cell Section was removed from the cell without rinsing and stored in a plastic bag for one year. White-green crystals were collected physically from the nickel wire. Elemental analysis, XPS, mass spectroscopy, and XRD were performed. The elemental analysis is discussed in the Identification of Hydrino Hydride Compounds by Mass Spectroscopy Section. The results were consistent with the reaction given by Eqs. (55-57). The XPS results indicated the presence of hydrino hydride ions. The mass spectrum was similar to that of mass spectroscopy electrolytic cell sample #3 shown in FIG. 24. Hydrino a −15 hydride compounds were observed. Peaks were observed in the X-ray diffraction pattern which could not be assigned to any known compound as shown in the Identification of Hydrino Hydride Compounds by XRD (X-ray Diffraction Spectroscopy) Section (XRD sample #1A). Heat that could not be explained by conventional chemistry and dihydrino were observed by thermal decomposition with calorimetry and gas chromatography studies, respectively, as shown herein.

In addition, the material on the cathode of the K₂CO₃ Thermacore Electrolytic Cell also showed novel thermal decomposition chemistry as well as new spectroscopic features such as novel Raman peaks (Raman sample #1). Samples from the K₂CO₃ electrolyte such as that from the Thermacore Electrolytic Cell showed novel features over a broad range of spectroscopic characterizations (XPS (XPS sample #6), XRD (XRD sample #2), TOFSIMS (TOFSIMS sample #1), FTIR (FTIR sample #1), NMR (NMR sample #1), and ESITOFMS (ESITOFMS sample #2). Novel reactivity was observed of the electrolyte sample treated with HNO₃. The yellow-white crystals that formed on the outer edge of a crystallization dish from the acidified electrolyte of the K₂CO₃ Thermacore Electrolytic Cell reacted with sulfur dioxide to form sulfide compounds including magnesium sulfide. The reaction was identified by XPS. This sample also showed novel features over a broad range of spectroscopic characterizations (mass spectroscopy (mass spectroscopy electrolytic cell samples #5 and #6), XRD (XRD samples #3A and #3B), TOFSIMS (TOFSIMS sample #3), and FTIR (FTIR sample #4)).

The results from XPS, TOFSIMS, and mass spectroscopy studies identify that crystals from the BLP and Thermacore cathodes as well as crystal from the electrolytes may react with sulfur dioxide in air to form sulfides. The reaction may be silane oxidation to form a corresponding hydrino hydride siloxane with sulfur dioxide reduction to sulfide. Two silicon-silicon bridging hydrogen species of the silane may be replaced with an oxygen atom. A similar reaction occurs with ordinary silanes [F. A. Cotton, G. Wilkinson, Advanced Inorganic Chemistry, Fourth Edition, John Wiley & Sons, New York, pp. 385-386].

As a further example of novel reactivity, the nickel wire from the cathode of the Thermacore Electrolytic Cell was reacted with a 0.6 M K₂CO₃/3% H₂O₂ solution. The reaction was violent and strongly exothermic. These results without convention explanation correspond to and identify increased binding energy hydrogen compounds according to the present invention. The latter result also confirms the application of increased binding energy hydrogen compounds as solid fuels.

### 13.5 Identification of Hydrino Hydride Compounds by XRD (X-Ray Diffraction Spectroscopy)

XRD measures the scattering of X-rays by crystal atoms, producing a diffraction pattern that yields information about the structure of the crystal. Known compounds can be identified by their characteristic diffraction pattern. XRD was used to identify the composition of an ionic hydrogen spillover catalytic material: 40% by weight potassium nitrate (KNO₃) on Grafoil with 5% by weight 1%-Pt-on-graphitic carbon before and after hydrogen was supplied to the catalyst, as described at pages 57-62 of PCT/US96/07949. Calorimetry was performed when hydrogen was supplied to test for catalysis as evidenced by the enthalpy balance. The new product of the reaction was studied using XRD. XRD was also obtained on crystals grown on the stored cathode and isolated from the electrolyte of the K₂CO₃ electrolytic cell described in the Crystal Samples from an Electrolytic Cell Section.

### 13.5.1 Experimental Methods

### 13.5.1.1 Spillover Catalyst Sample

Catalysis was confirmed by calorimetry. The enthalpy released by catalysis (heat of formation) was determined from flowing hydrogen in the presence of ionic hydrogen spillover catalytic material: 40% by weight potassium nitrate (KNO₃) on Grafoil with 5% by weight 1%-Pt-on-graphitic carbon by heat measurement, i.e., thermopile conversion of heat into an electrical output signal or Calvet calorimetry. Steady state enthalpy of reaction of greater than 1.5 W was observed with flowing hydrogen over 20 cc of catalyst. However, no enthalpy was observed with flowing helium over the catalyst mixture. Enthalpy rates were reproducibly observed which were higher than that expected from reacting of all the hydrogen entering the cell to water, and the total energy balance observed was over 8 times greater than that expected if all the catalytic material in the cell were converted to the lowest energy state by “known” chemical reactions. Following the run, the catalytic material was removed from the cell and was exposed to air. XRD was performed before and after the run.

### 13.2.1.2 Electrolytic Cell Samples

Hydrino hydride compounds were prepared during the electrolysis of an aqueous solution of K₂CO₃ corresponding to the transition catalyst K⁺/K⁺. The cell description is given in the Crystal Samples from an Electrolytic Cell Section. The cell assembly is shown in FIG. 2. The crystals were obtained from the cathode or from the electrolyte:

Sample #1A. The cathode of the K₂CO₃ BLP Electrolytic Cell was removed from the cell without rinsing and stored in a plastic bag for one year. White-green crystals were collected physically from the nickel wire. Elemental analysis, XPS, mass spectroscopy, and XRD were performed.

Sample #1B. The cathode of a K₂CO₃ electrolytic cell run at Idaho National Engineering Laboratories (INEL) for 6 months that was identical to that of Sample #1A was placed in 28 liters of 0.6M K₂CO₃/10% H₂O₂. A violent exothermic reaction occurred which caused the solution to boil for over one hour. An aliquot of the solution was concentrated ten fold with a rotary evaporator at 50° C. A precipitate formed on standing at room temperature. The crystals were filtered, and XRD was performed.

Samples #2. The sample was prepared by concentrating the K₂CO₃ electrolyte from the Thermacore Electrolytic Cell until yellow-white crystals just formed. Elemental analysis, XPS, mass spectroscopy, TOFSIMS, FTIR, NMR, and XRD were performed as described in the corresponding sections.

Sample #3A and #3B. Each sample was prepared from the crystals of sample #2 by 1.) acidifying the K₂CO₃ electrolyte of the Thermacore Electrolytic Cell with HNO₃, 2.) concentrating the acidified solution to a volume of 10 cc, 3.) placing the concentrated solution on a crystallization dish, and 4.) allowing crystals to form slowly upon standing at room temperature. Yellow-white crystals formed on the outer edge of the crystallization dish (the yellow color may be due to the continuum absorption of H⁻(n=1/2) in the near UV, 407 nm continuum). These crystals comprised Sample #3A. Clear needles formed in the center. These crystals comprised Sample #3B. The crystals were separated carefully, but some contamination of Sample #3B with Sample #3A crystals probably occurred to a minor extent. XPS (XPS sample #10), mass spectra (mass spectroscopy electrolytic cell samples #5 and #6), TOFSIMS spectra (TOFSIMS samples #3A and #3B), and FTIR spectrum (FRIR sample #4) were also obtained.

Sample #4. The K₂CO₃ BLP Electrolytic Cell was made 1 M in LiNO₃ and acidified with HNO₃. The solution was dried and heated to a melt at 120° C. whereby NiO formed. The solidified melt was dissolved in H₂O, and the NiO was removed by filtration. The solution was concentrated until crystals just appeared at 50° C. White crystals formed from the solution standing at room temperature. The crystals were obtained by filtration, and further purified from KNO₃ by recrystallizing with distilled water.

### 13.5.1.3 Gas Cell Sample.

Sample #5. Hydrino hydride compounds were prepared in a vapor phase gas cell with a tungsten filament and KI as the catalyst. The high temperature gas cell shown in FIG. 4 was used to produce hydrino hydride compounds wherein hydrino atoms are formed from the catalysis of hydrogen using potassium ions and hydrogen atoms in the gas phase as described for the Gas Cell Sample of the Identification of Hydrino Hydride Compounds by Mass Spectroscopy Section. The sample was prepared by 1.) rinsing the hydrino hydride compounds from the cap of the cell where it was preferentially cryopumped with sufficient water that all water soluble compounds dissolved, 2.) filtering the solution to remove water insoluble compounds such as metal, 3.) concentrating the solution until a precipitate just formed with the solution at 50° C., 4.) allowing yellowish-reddish-brown crystals to form on standing at room temperature, 4.) filtering and drying the crystals before XPS, mass spectra, and XRD were obtained.

### 13.5.2 Results and Discussion

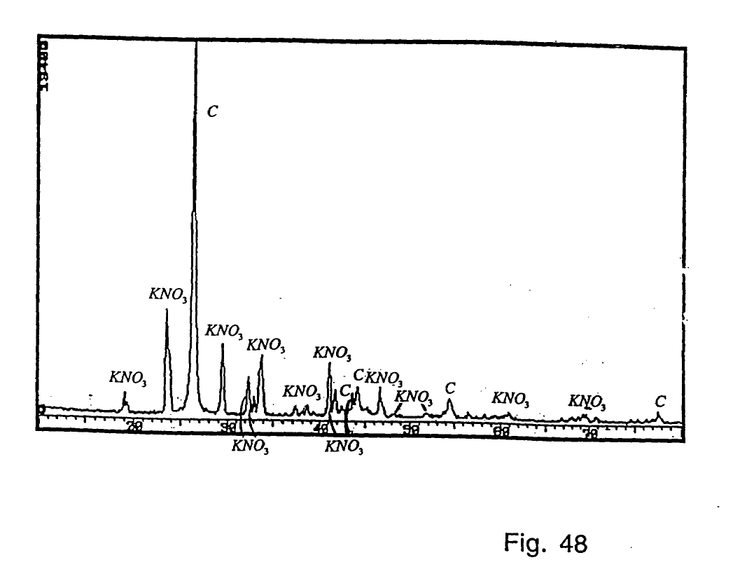

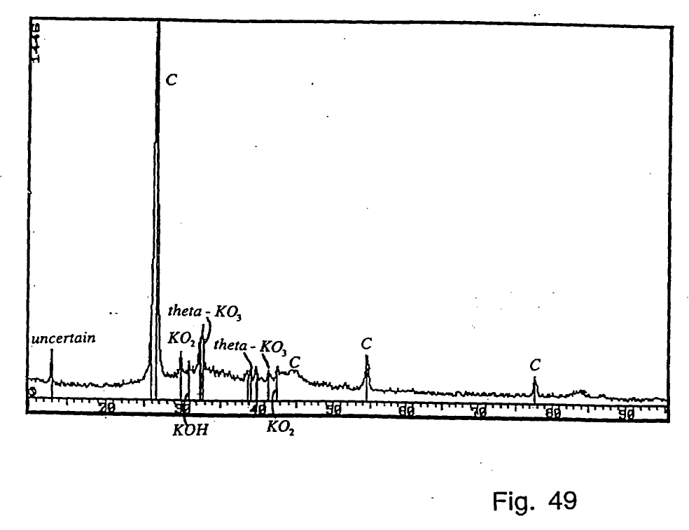

The XRD patterns of the spillover catalyst samples were obtained at Pennsylvania State University. The XRD pattern before supplying hydrogen to the spillover catalyst is shown in FIG. 48. All the peaks are identifiable and correspond to the starting catalyst material. The XRD pattern following the catalysis of hydrogen is shown in FIG. 49. The identified peaks correspond to the known reaction products of potassium metal with oxygen as well as the known peaks of carbon. In addition, a novel, unidentified peak was reproducibly observed. The novel peak without identifying assignment at 13° 2Θ corresponds and identifies potassium hydrino hydride, and according to the present invention.

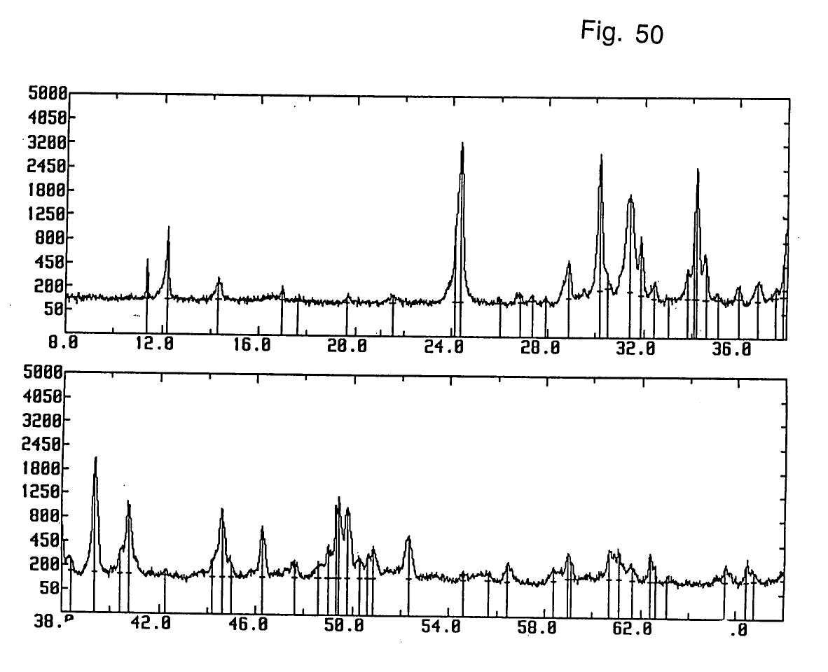

The XRD pattern of the crystals from the stored nickel cathode of the K₂CO₃ electrolytic cell hydrino hydride reactor (sample #1A) was obtained at IC Laboratories and is shown in FIG. 50. The identifiable peaks corresponded to KHCO₃. In addition, the spectrum contained a number of peaks that did not match the pattern of any of the 50,000 known compounds in the data base. The 2-theta and d-spacings of the unidentified XRD peaks of the crystals from the cathode of the K₂CO₃ electrolytic cell hydrino hydride reactor are given in TABLE 9. The novel peaks without identifying assignment given in TABLE 9 corresponds and identifies hydrino hydride compounds, according to the present invention.

In addition, the elemental analysis of the crystals was obtained at Galbraith Laboratories. It was consistent with the sample comprising KHCO₃, but the atomic hydrogen percentage was 30% in excess. The mass spectrum was similar to that of mass spectroscopy electrolytic cell sample #3 shown in FIG. 24. The XPS contained hydrino hydride ion peaks H⁻(n=1/p) for p=2 to p=16 that were partially masked by the dominant spectrum of KHCO₃. These results are consistent with the production of KHCO₃ and hydrino hydride compounds from K₂CO₃ by the formation of hydrinos by the K₂CO₃ electrolytic cell hydrino hydride reactor and the reaction of hydrinos with water (Eqs. (55-57).

TABLE 9
The 2-theta and d-spacings of the unidentified XRD peaks of
the crystals from the cathode of the K₂CO₃ electrolytic cell hydrino
hydride reactor (sample #1A).

| | 2-Theta | d |
|---|---|---|
| Peak Number | (Deg) | (Å) |
| 1 | 11.36 | 7.7860 |
| 3 | 14.30 | 6.1939 |
| 4 | 16.96 | 5.2295 |
| 5 | 17.62 | 5.0322 |
| 6 | 19.65 | 4.5168 |
| 7 | 21.51 | 4.1303 |
| 10 | 26.04 | 3.4226 |
| 11 | 26.83 | 3.3230 |
| 12 | 27.34 | 3.2621 |
| 13 | 27.92 | 3.1957 |
| 19 | 32.43 | 2.7612 |
| 26 | 35.98 | 2.4961 |
| 27 | 36.79 | 2.4433 |
| 33 | 40.41 | 2.2319 |
| 36 | 44.18 | 2.0502 |
| 39 | 46.28 | 1.9618 |
| 40 | 47.60 | 1.9104 |

For sample #1B, the XRD pattern corresponded to identifiable peaks of KHCO₃. In addition, the spectrum contained unidentified peaks at 2-theta values and d-spacings given in TABLE 10. The novel peaks of TABLE 10 without identifying assignment correspond to and identify hydrino hydride compounds that where isolated from the cathode via a reaction with 0.6M K₂CO₃/10% H₂O₂, according to the present invention.

TABLE 10
The 2-theta and d-spacings of the unidentified XRD peaks of
the crystals isolated following reaction of the cathode of the INEL
K₂CO₃ electrolytic cell with 0.6M K₂CO₃/10% H₂O₂
(sample #1B).

| 2-Theta | d |
|---|---|
| (Deg) | (Å) |
| 12.9 | 6.852 |
| 30.5 | 2.930 |
| 35.9 | 2.501 |

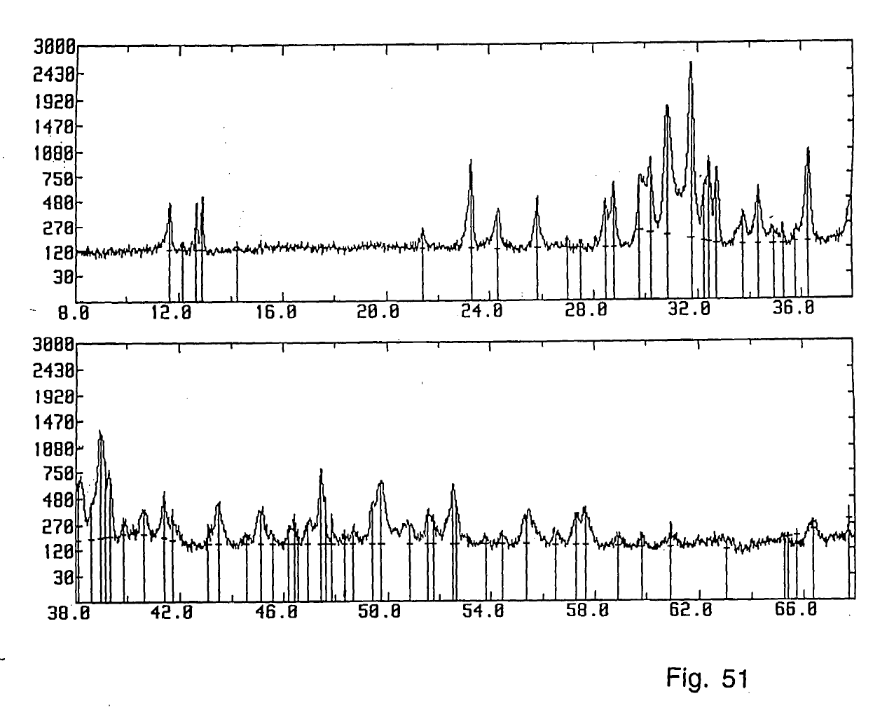

The XRD pattern of the crystals prepared by concentrating the electrolyte from the K₂CO₃ Thermacore Electrolytic Cell until a precipitate just formed (sample #2) was obtained at IC Laboratories and is shown in FIG. 51. The identifiable peaks corresponded to a mixture of K₄H₂(CO₃)₃.1.5H₂O and K₂CO₃.1.5H₂O. In addition, the spectrum contained a number of peaks that did not match the pattern of any of the 50,000 known compounds in the data base. The 2-theta and d-spacings of the unidentified XRD peaks of the crystals from the cathode of the K₂CO₃ electrolytic cell hydrino hydride reactor are given in TABLE 11. The novel peaks without identifying assignment given in TABLE 11 correspond to and identify hydrino hydride compounds, according to the present invention.

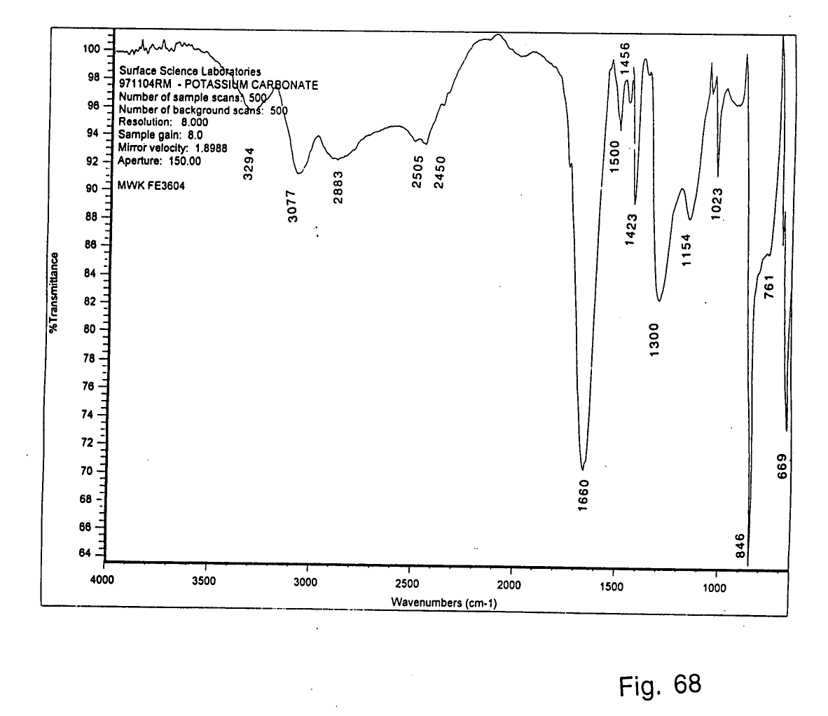

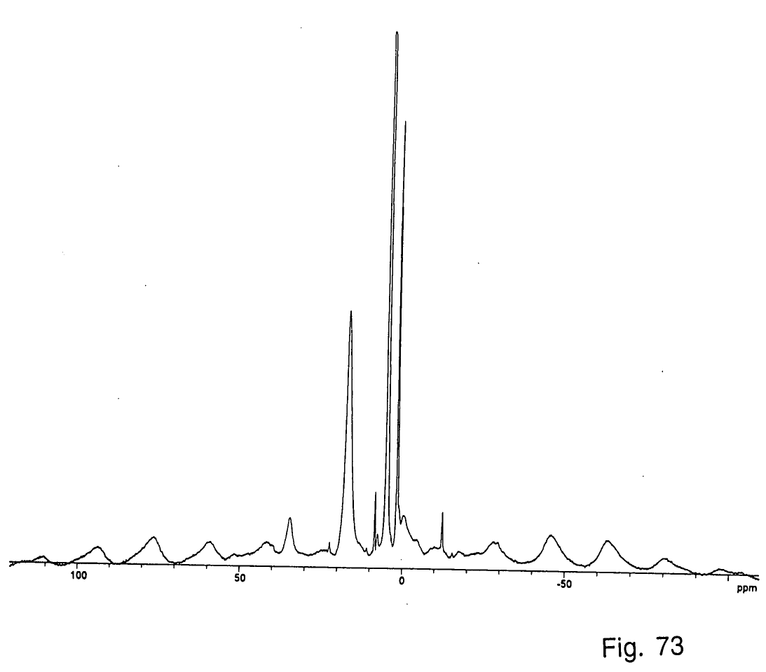

In addition, the elemental analysis of the crystals was obtained at Galbraith Laboratories. It was consistent with the sample comprising a mixture of K₄H₂(CO₃)₃.1.5H₂O and K₂CO₃.1.5H₂O, but the atomic hydrogen percentage was in excess even if the compound were considered 100% K₄H₂(CO₃)₃.1.5H₂O. The XPS (FIG. 21), TOFSIMS (TABLES 13 and 14), FTIR (FIG. 68), and NMR (FIG. 73) were consistent with hydrino hydride compounds.

TABLE 11
The 2-theta and d-spacings of the unidentified XRD peaks of
the crystals from K₂CO₃ electrolytic cell hydrino hydride
reactor (sample #2).

| | 2-Theta | d |
|---|---|---|
| Peak Number | (Deg) | (Å) |
| 2 | 12.15 | 7.2876 |
| 4 | 12.91 | 6.8574 |
| 8 | 24.31 | 3.6614 |
| 12 | 28.46 | 3.1362 |
| 15 | 30.20 | 2.9594 |
| 31 | 39.34 | 2.2906 |
| 33 | 40.63 | 2.2206 |
| 36 | 43.10 | 2.0991 |
| 40 | 45.57 | 1.9905 |
| 42 | 46.40 | 1.9570 |
| 46 | 47.59 | 1.9141 |
| 47 | 47.86 | 1.9006 |
| 52 | 50.85 | 1.7958 |
| 54 | 51.75 | 1.7665 |
| 56 | 52.65 | 1.7386 |
| 57 | 53.81 | 1.7037 |
| 58 | 54.46 | 1.6850 |
| 60 | 56.49 | 1.6292 |
| 63 | 58.88 | 1.5685 |
| 65 | 60.93 | 1.5207 |
| 66 | 63.04 | 1.4747 |

For sample #3A, the XRD pattern corresponded to identifiable peaks of KNO₃. In addition, the spectrum contained unidentified peaks at 2-theta values and d-spacings given in TABLE 12. The novel peaks of TABLE 12 without identifying assignment correspond to and identify hydrino hydride compounds, according to the present invention. The assignment of the compounds containing hydrino hydride ions was confirmed by the XPS of these crystals shown in FIG. 21.

TABLE 12
The 2-theta and d-spacings of the unidentified XRD peaks of
the yellow-white crystals that formed on the outer edge of a
crystallization dish from the acidified electrolyte of the K₂CO₃
Thermacore Electrolytic Cell (sample #3A).

| 2-Theta | d |
|---|---|
| (Deg) | (Å) |
| 20.2 | 4.396 |
| 22.0 | 4.033 |
| 24.4 | 3.642 |
| 26.3 | 3.391 |
| 27.6 | 3.232 |
| 30.9 | 2.894 |
| 31.8 | 2.795 |
| 39.0 | 2.307 |
| 42.6 | 2.124 |
| 48.0 | 1.897 |

For sample #3B, the XRD pattern corresponded to identifiable peaks of KNO₃. In addition, the spectrum contained very small unidentified peaks at 2-theta values of 20.2 and 22.0 which were attributed to minor contamination with crystals of sample #3A. In addition to the peaks of KNO₃, the XPS spectra of samples #3A and #3B contained the same peaks as those assigned to hydrino hydride ions in FIG. 19. However, their intensity was significantly greater in the case of the XPS spectrum of sample #3A as compared to the spectrum of sample #3B.

For sample #4, the XRD pattern corresponded to identifiable peaks of KNO₃. In addition, the spectrum contained unidentified peaks at a 2-theta value of 40.3 and d-spacing of 2.237 and at a 2-theta value of 62.5 and d-spacing of 1.485. The novel peaks without identifying assignment correspond to and identify hydrino hydride compounds, according to the present invention. The assignment of hydrino hydride compounds was confirmed by the XPS. The spectrum obtained of these crystals had the same hydrino hydride ions XPS peaks as that shown in FIG. 19. Also, mass spectroscopy was performed by the method given in the Identification of Hydrino Hydride Compounds by Mass Spectroscopy Section. The mass ranges m/e=1 to 220 and m/e=1 to 120 were scanned. The mass spectrum was equivalent to that to that of mass spectroscopy electrolytic cell sample #3 shown in FIG. 2 with parent peak identifications shown in TABLE 4 except that the following new hydrino hydride compound peaks were present: Si₃H₁₀O (m/e=110), Si₂H₈ (m/e=64), SiH₈(m/e=36), and SiH₂ (m/e=30).

For sample #5, the XRD spectrum contained a broad peak with a maximum at a 2-theta value of 21.291 and d-spacing of 4.1699 and one sharp intense peak at a 2-theta value of 29.479 and d-spacing of 3.0277. The novel peaks without identifying assignment correspond to and identify hydrino hydride compounds, according to the present invention. The assignment of compounds containing hydrino hydride ions was confirmed by XPS. The origin of the yellowish-reddish-brown color of the crystals is assigned to the continuum absorption of H⁻(n=1/2) in the near UV, 407 nm continuum. This assignment is supported by the XPS results which showed a large peak at the binding energy of H⁻(n=1/2), 3 eV (TABLE 1). Also, mass spectroscopy was performed as given in the Identification of Hydrino Hydride Compounds by Mass Spectroscopy Section. Mass spectra appear in FIGS. 28A-28B and 29, and the peak assignments are given in TABLE 4. Hydrino hydride compounds were observed.

### 13.6 Identification of Hydrino, Hydrino Hydride Compounds, and Dihydrino Molecular Ion Formation by Extreme Ultraviolet Spectroscopy

The catalysis of hydrogen was detected by the extreme ultraviolet (EUV) emission (912 Å) from transitions of hydrogen atoms to form hydrino. The principle reactions of interest are given by Eqs. (3-5). The corresponding extreme UV photon is:

$$H [ \frac{{a}_{H}}{1} ] {\to }^{{K}^{′} / {K}^{+}} H [ \frac{{a}_{H}}{2} ] + 912 Å \qquad ( 64 )$$

Hydrinos can act as a catalyst because the excitation and/or ionization energies are m×27.2 eV (Eq. (2)). For example, the equation for the absorption of 27.21 eV, m=1 in Eq. (2), during the catalysis of

$$H [ \frac{{a}_{H}}{2} ]$$

by the hydrino

$$H [ \frac{{a}_{H}}{2} ]$$

that is ionized is

$$\begin{matrix}27.21 eV + H [ \frac{{a}_{H}}{2} ] + H [ \frac{{a}_{H}}{2} ] \to {H}^{+} + {e}^{-} + H [ \frac{{a}_{H}}{3} ] + [ {3}^{2} - {2}^{2} ] X 13.6 eV - 27.21 eV & ( 65 ) \\ {H}^{+} + {e}^{-} \to H [ \frac{{a}_{H}}{1} ] + 13.6 eV & ( 66 )\end{matrix}$$

And, the overall reaction is

$$H [ \frac{{a}_{H}}{2} ] + H [ \frac{{a}_{H}}{2} ] \to H [ \frac{{a}_{H}}{1} ] + H [ \frac{{a}_{H}}{3} ] + [ {3}^{2} - {2}^{2} - 4 ] X13 .6 eV + 13.6 eV \qquad ( 67 )$$

The corresponding extreme UV photon is:

$$H [ \frac{{a}_{H}}{2} ] {\to }^{H [ \frac{{a}_{H}}{2} ]} H [ \frac{{a}_{H}}{3} ] + 912 Å \qquad ( 68 )$$

The same transition can also be catalyzed by potassium ions

$$H [ \frac{{a}_{H}}{2} ] {\to }^{{K}^{+} / {K}^{+}} H [ \frac{{a}_{H}}{3} ] + 912 Å \qquad ( 69 )$$

The reaction of a proton with the hydrino atom to form the dihydrino molecular ion H₂^{+[}2c′=aₒ]⁺ according to the first stage of the reaction given by Eq. (37) was detected by EUV spectroscopy. The corresponding extreme UV photon corresponding to the reaction of hydrino atom

$$H ( \frac{1}{p} )$$

with a proton is:

$$H [ \frac{{a}_{H}}{p} ] + {H}^{+} \to {{H}_{2}^{*} [ 2 {c}^{′} = \frac{2 {a}_{o}}{p} ]}^{+} + hv ( 120 nm ) \qquad ( 70 )$$

The emission of the dihydrino molecular ion may be split due to coupling with rotational transitions. The rotational wavelength including vibration given in the Vibration of Hydrogen-Type Molecular Ions Section of '96 Mills GUT is

$$λ = \frac{169}{{n}^{2} [ J + 1 ]} μ m \qquad ( 71 )$$

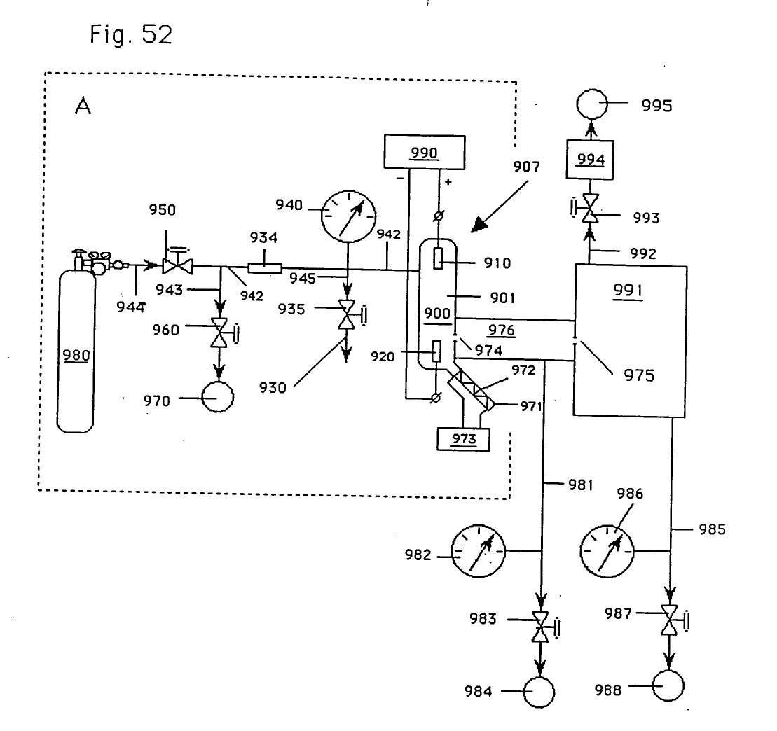

The hydrino hydride compounds with transitions in the regions of the hydrino hydride ion binding energies given in TABLE 1 and the corresponding continua were also detected by EUV spectroscopy. The reactions occurred in a gas discharge cell shown in FIG. 52. Due to the extremely short wavelength of the radiation to be detected, “transparent” optics do not exist. Therefore, a windowless arrangement was used wherein the sample or source of the studied species was connected to the same vacuum vessel as the grating and detectors of the UV spectrometer. Windowless EUV spectroscopy was performed with an extreme ultraviolet spectrometer that was mated with the cell by a differentially pumped connecting section that had a pin hole light inlet and outlet. The cell was operated under hydrogen flow conditions while maintaining a constant hydrogen pressure with a mass flow controller. The apparatus used to study the extreme UV spectra of the gaseous reactions is shown in FIG. 52. It contains four major components: gas discharge cell 907, UV spectrometer 991, mass spectrometer 994, and connector 976 which was differentially pumped.

### 13.6.1 Experimental Methods

The schematic of the gas discharge cell light source, the extreme ultraviolet (EUV) spectrometer for windowless EUV spectroscopy, and the mass spectrometer used to observe hydrino, hydrino hydride ion, increased binding energy hydrogen compound, and dihydrino molecular ion formations and transitions is shown in FIG. 52. The elements of the segment of the apparatus of FIG. 52 marked “A”, correspond in structure and function to the like-numbered 500-series elements of —FIG. 6. The construction of the FIG. 6 device is described in the Gas Discharge Cell Section, above. The apparatus of FIG. 52 contained the following modifications.

The apparatus of FIG. 52 further contained a hydrogen mass flow controller 934 which maintained the hydrogen pressure in cell 907 with differential pumping at 2 torr. The gas discharge cell 907 of FIG. 52 further comprised a catalyst reservoir 971 for KNO₃ or KI catalyst sat that was vaporized from the catalyst reservoir by heating with the catalyst heater 972 using heater power supply 973.

The apparatus of FIG. 52 further included a mass spectrometer apparatus 995 which was a Dycor System 1000 Quadrapole Mass Spectrometer Model #D200MP with a HOVAC Dri-2 Turbo 60 Vacuum System connected to an EUV spectrometer 991 by line 992 and valve 993. The EUV spectrometer 991 was a McPherson extreme UV region spectrometer, Model 234/302VM (0.2 meter vacuum ultraviolet spectrometer) with a 7070 VUV channel electron multiplier. The scan interval was 0.01 nm, the inlet and outlet slit were 30-50 μM, and the detector voltage was 2400 volts. EUV spectrometer 991 was connected to a turbomolecular pump 988 by line 985 and valve 987. The spectrometer was continuously evacuated to 10⁻⁵-10⁻⁶ torr by the turbomolecular pump 988 wherein the pressure was read by cold cathode pressure gauge 986. The EUV spectrometer was connected to the gas discharge cell light source 907 by connector 976 which provided a light path through the 2 mm diameter pin hole inlet 974 and the 2 mm diameter pin hole outlet 975 to the aperture of the EUV spectrometer. The connector 976 was differentially pumped to 10⁻⁴ torr by a turbomolecular pump 988 wherein the pressure was read by cold cathode pressure gauge 982. The turbomolecular pump 984 connected to the connector 976 by line 981 and valve 983.

In the case of KNO₃, the catalyst reservoir temperature was 450-500° C. In the case of KI catalyst, the catalyst reservoir temperature was 700-800° C. The cathode 920 and anode 910 were nickel. In one run, the cathode 920 was nickel foam metal coated with KI catalyst. For other experiments, 1.) the cathode was a hollow copper cathode coated with KI catalyst, and the conducting cell 901 was the anode, 2.) the cathode was a ⅛ inch diameter stainless steel tube hollow cathode, the conducting cell 901 was the anode, and KI catalyst was vaporized directly into the center of the cathode by heating the catalyst reservoir to 700-800° C., or 3.) the cathode and anode were nickel and the KI catalyst was vaporized from the KI coated cell walls by the plasma discharge.

The vapor phase transition reaction was continuously carried out in gas discharge cell 907 such that a flux of extreme UV emission was produced therein. The cell was operated under flow conditions with a total pressure of 1-2 torr controlled by mass flow controller 934 where the hydrogen was supplied from the tank 980 through the valve. 950. The 2 torr pressure under which cell 907 was operated significantly exceeded the pressure acceptable to run the UV spectrometer 991; thus, the connector 976 with differential pumping served as “window” from the cell 907 to the spectrometer 991. The hydrogen that flowed through light path inlet pin hole 974 was continuously pumped away by pumps 984 and 988. The catalyst was partially vaporized by heating the catalyst reservoir 971, or it was vaporized from the cathode 920 by the plasma discharge. Hydrogen atoms were produced by the plasma discharge. Hydrogen catalysis occurred in the gas phase with the contact of catalyst ions with hydrogen atoms. The catalysis followed by disproportionation of atomic hydrinos resulted in the emission of photons directly, or emission occurred by subsequent reactions to form dihydrino molecular ions and by formation of hydrino hydride ions and compounds. Further emission occurred due to excitation of increased binding energy hydrogen species and compounds by the plasma.

### 13.6.2 Results and Discussion

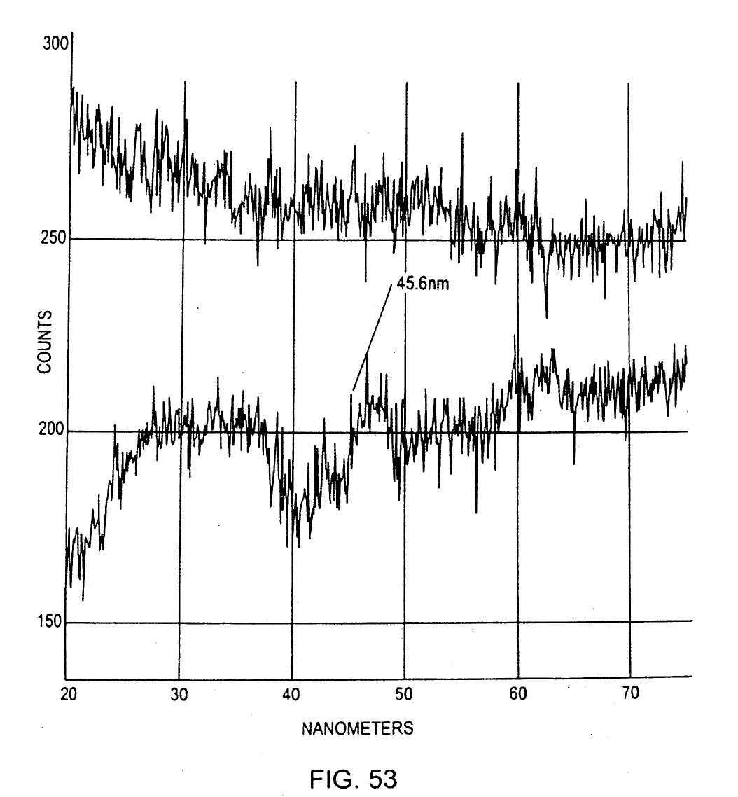

The EUV spectrum (20-75 nm) recorded of hydrogen alone and hydrogen catalysis with KNO₃ catalyst vaporized from the catalyst reservoir by heating is shown in FIG. 53. The broad peak at 45.6 nm with the presence of catalyst is assigned to the potassium electron recombination reaction given by Eq. (4). The predicted wavelength is 45.6 nm which is agreement with that observed. The broad nature of the peak is typical of the predicted continuum transition associated with the electron transfer reaction. The broad peak at 20-40 nm is assigned to the continuum spectra of compounds comprising hydrino hydride ions H⁻(1/8)—H⁻(1/12), and the broad peak at 54-0.65 nm is assigned to the continuum spectra of compounds comprising hydrino hydride ion H⁻(1/6).

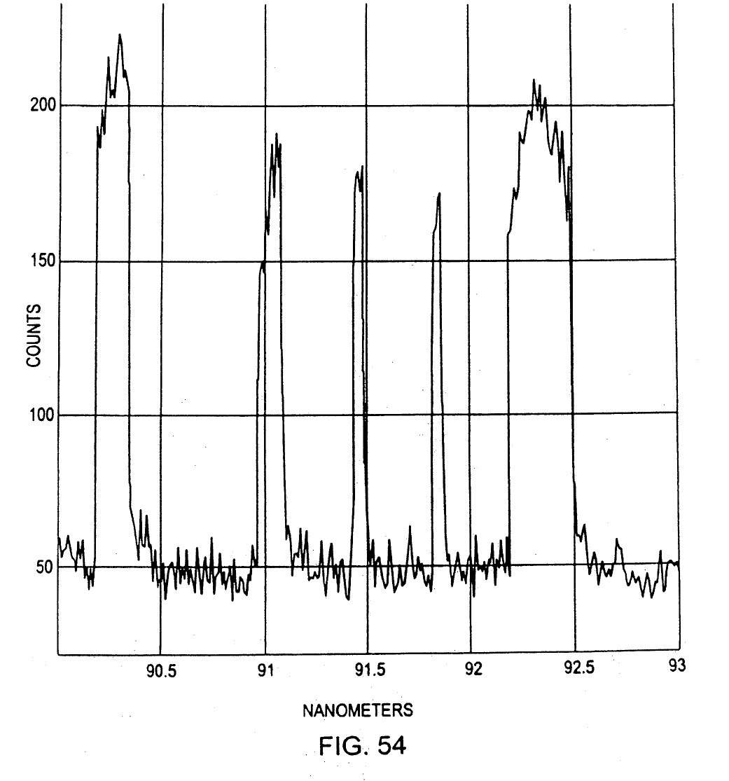

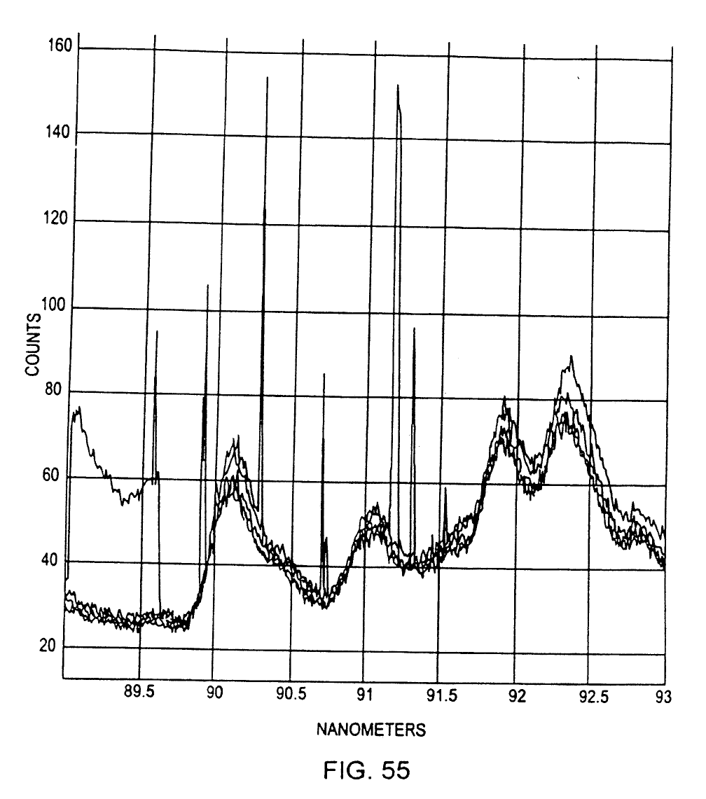

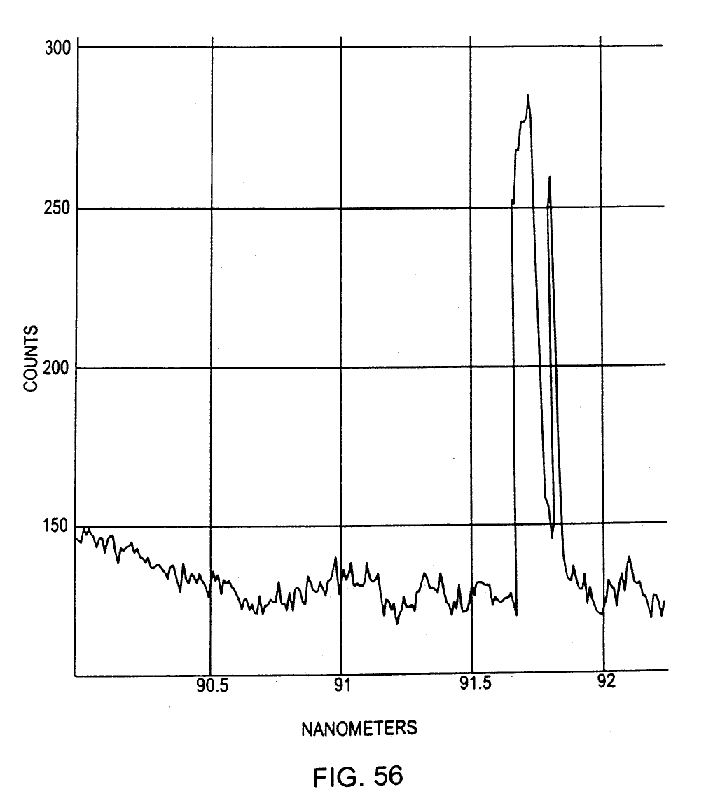

The EUV spectrum (90-93 nm) recorded of hydrogen catalysis with KI catalyst vaporized the nickel foam metal cathode by the plasma discharge is shown in FIG. 54. The EUV spectrum (89-93 nm) recorded of hydrogen catalysis with a five way stainless steel cross gas discharge cell that served as the anode, a stainless steel hollow cathode, and KI catalyst that was vaporized directly into the plasma of the hollow cathode from the catalyst reservoir by heating which is superimposed on four control (no catalyst) runs is shown in FIG. 55. Several peaks are observed which are not present in the spectrum of hydrogen alone as shown in FIG. 53. These peaks are assigned to the catalysis of hydrogen by K⁺/K⁺ (Eqs. (3-5); Eq. (64)) wherein the line splitting of about 600 cm⁻¹ is assigned to vibrational coupling with gaseous KI dimers which comprise the catalyst [S. Datz, W. T. Smith, E. H. Taylor, The Journal of Chemical Physics, Vol. 34, No. 2, (1961), pp. 558-564]. The splitting of the 91.75 nm line corresponding to hydrogen catalysis by vibrational coupling is demonstrated by comparing the spectrum shown in FIG. 54 with the EUV spectrum (90-92.2 nm) recorded of hydrogen catalysis with KI catalyst vaporized from the hollow copper cathode by the plasma discharge shown in FIG. 56. With sufficient vibrational energy provided by the catalysis of hydrogen, the dimer is predicted to dissociate. The feature broad feature at 89 nm of FIG. 55 may represent the KI dimer dissociation energy of 0.34 eV. Vibrational excitation occurs during catalysis according to Eq. (3) to give shorter wavelength emission for the reaction given by Eq. (64) or longer wavelength emission in the case that the transition simultaneously excites a vibrational mode of the KI dimer. Rotational coupling as well as vibrational coupling is also seen in FIG. 55.

In addition to the line spectra shown in FIGS. 54, 55, and 56, the catalysis of hydrogen was predicted to release energy through excitation of normal hydrogen which could be observed via EUV spectroscopy by eliminating the contribution due to the discharge. The catalysis reaction requires hydrogen atoms and gaseous catalyst which are provided by the discharge. The time constant to turn off the plasma was measured with an oscilloscope to be less than 100 μsec. The half-life of hydrogen atoms is of a different time scale, about one second [N. V. Sidgwick, The Chemical Elements and Their Compounds, Volume I, Oxford, Clarendon Press, (1950), p. 17.], and the half-life of hydrogen atoms from the stainless steel cathode following termination of the discharge power is much longer (seconds to minutes). The catalyst pressure was constant. To eliminate the background emission directly caused by the plasma, the discharge was gated with an off time of 10 milliseconds up to 5 seconds and an on time of 10 milliseconds to 10 seconds. The gas discharge cell comprised a five way stainless steel cross that served as the anode with a stainless steel hollow cathode. The KI catalyst was vaporized directly into the plasma of the hollow cathode from the catalyst reservoir by heating.

The EUV spectrum was obtained which was similar to that shown in FIG. 55. During the gated EUV scan at about 92 nm, the dark counts (gated plasma turned off) with no catalyst were 20±2; whereas, the counts in the catalyst case were about 70. Thus, the energy released by catalysis of hydrogen, disproportionation, and hydrino hydride ion and compound reactions appears as line emission and emission due to the excitation of normal hydrogen. The half-life for hydrino chemistry that excited hydrogen emission was determined by recording the decay in the emission over time after the power supply was switched off. The half-life with the stainless steel hollow cathode with constant catalyst vapor pressure was determined to be about five to 10 seconds.

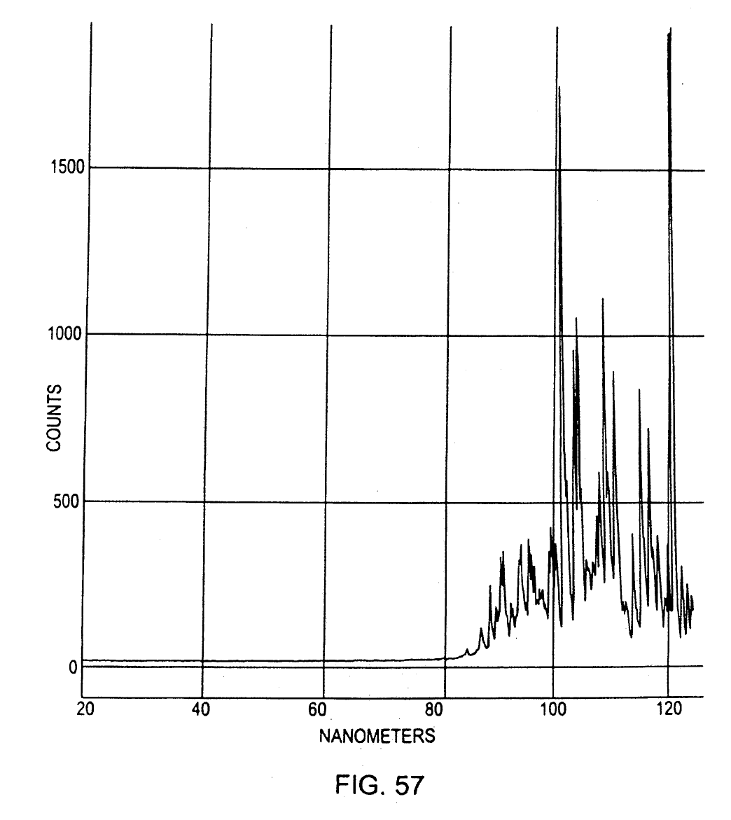

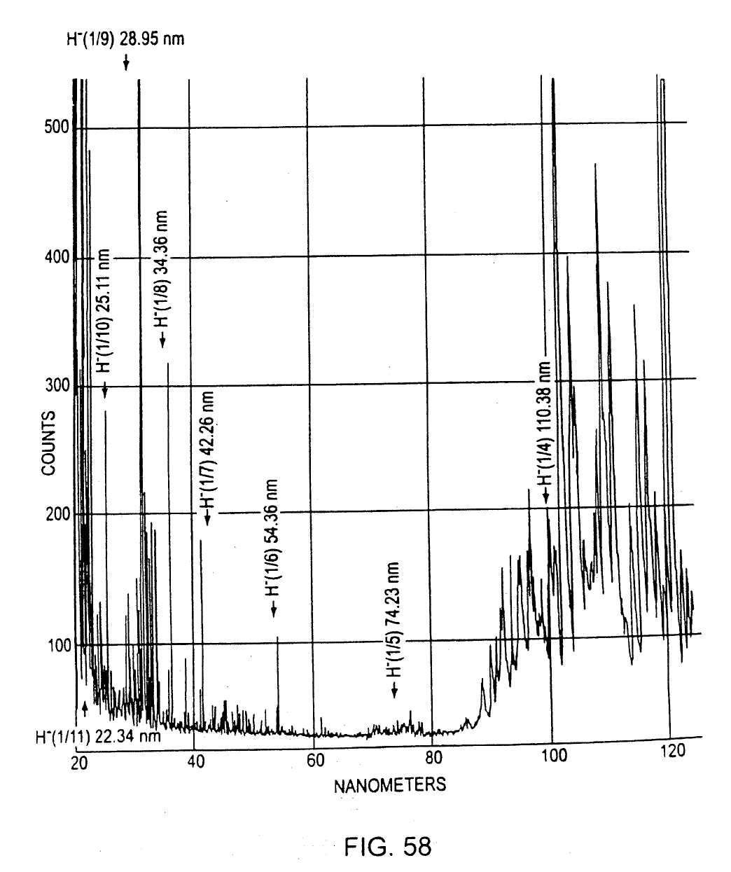

The EUV spectrum (20-120 nm) recorded of normal hydrogen and hydrino hydride compounds that were excited by a plasma discharge is shown in FIG. 57 and FIG. 58, respectively. The position of the hydrino hydride binding energies in free space are shown in FIG. 58. Under the low temperature conditions of the discharge, the hydrino hydride ions bonded to one or more cations to form neutral hydrino hydride compounds which were excited by the plasma discharge to emit the observed spectrum. The gas discharge cell comprised a five way stainless steel cross that served as the anode with a hollow stainless steel cathode. In the case of the reaction to form hydrino hydride compounds, the KI catalyst was vaporized directly into the plasma of the hollow cathode from the catalyst reservoir by heating. Compared to a discharge of standard hydrogen shown in FIG. 57, the spectrum of hydrino hydride compounds with hydrogen shown in FIG. 58 has an additional feature at λ=110.4 nm as well as other features at shorter wavelengths (λ<80 nm) that are not present in the spectrum of a discharge of standard hydrogen. These features occur in the region of hydrino hydride ion binding energies given in TABLE 1 and indicated in FIG. 58. A series of emission features were observed in the region the calculated free hydrino hydride ion binding energy for H⁻(1/4) 110.38 nm to H⁻(1/11) 22.34 nm. The observed features occur at slightly shorter wavelengths than that of each free ion indicated in FIG. 58. This is consistent with the formation of stable compounds. The line intensities increase with shorter wavelength which is consistent with the formation of the most stable hydrino hydride ion and corresponding compounds over time. The EUV peaks can not be assigned to hydrogen, and the energies match those assigned to hydrino hydride compounds given in the Identification of Hydrinos, Dihydrinos, and Hydrino Hydride Ions by XPS (X-ray Photoelectron Spectroscopy) Section. Thus, these EUV peaks are assigned to the spectra of compounds comprising hydrino hydride ions H⁻(1/4)−H⁻(1/11) having transitions in the regions of the binding energies of the hydrino hydride ions shown in TABLE 1.

The mass spectrum (m/e=0-100) of the gaseous hydrino hydride compounds was recorded alternatively with the EUV spectrum. The mass spectrum (m/e=0-110) of the vapors from the crystals from a gas discharge cell hydrino hydride reactor comprising a KI catalyst and a Ni electrodes with a sample heater temperature of 225° C. shown in FIG. 35 with parent peak identifications shown in TABLE 4 are representative of the results. A significant m/e=4 peak was observed in the mass spectrum that was not present in controls comprising discharge with hydrogen alone. The 584 Å emission of helium was not observed in the EUV spectrum. The m/e=4 peak was assigned to H₄⁺(1/p) which serves as a signature for the presence of dihydrino molecules.

The XPS and mass spectroscopy results given in the Identification of Hydrinos, Dihydrinos, and Hydrino Hydride Ions by XPS (X-ray Photoelectron Spectroscopy) Section and the Identification of Hydrino Hydride Compounds by Mass Spectroscopy Section, respectively, and the EUV spectroscopy and mass spectroscopy results given herein confirm hydrino hydride compounds.

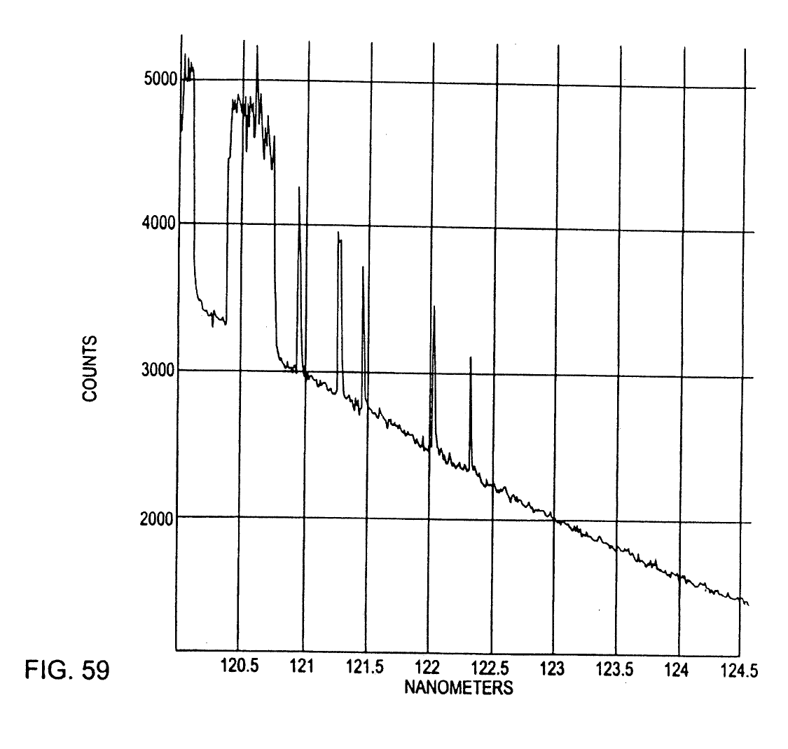

The EUV spectrum (120-124.5 nm) recorded of hydrogen catalysis to form hydrino that reacted with discharge plasma protons is shown in FIG. 59. The KI catalyst was vaporized from the walls of the quartz cell by the plasma discharge at nickel electrodes. The peaks are assigned to the emission due to the reaction given by Eq. (70). The 0.03 eV(42 μm) splitting of the EUV emission lines is assigned to the J+1 to J rotational transitions of H₂^{+[}2c′=aₒ]⁺ given by Eq. (71) wherein the transitional energy of the reactants may excite a rotational mode whereby the rotational energy is emitted with the reaction energy to cause a shift to shorter wavelengths, or the molecular ion may form in an excited rotational level with a shift of the emission to longer wavelengths. The agreement of the predicted rotational energy splitting and the position of the peaks is excellent.

### 13.7 Identification of Hydrino Hydride Compounds by Time-Of-Flight-Secondary-Ion-Mass-Spectroscopy (TOFSIMS)

Time-Of-Flight-Secondary-Ion-Mass-Spectroscopy (TOFSIMS) is a method to determine the mass spectrum over a large dynamic range of mass to charge ratios (e.g. m/e=1-600) with extremely high precision (e.g. ±0.005 amu). The analyte is bombarded with charged ions which ionizes the compounds present to form molecular ions in vacuum. The mass is then determined with a high resolution time-of-flight analyzer.

### 13.7.1 Sample Collection and Preparation

A reaction for preparing hydrino hydride ion-containing compounds is given by Eq. (8). Hydrino atoms which react to form hydrino hydride ions may be produced by an electrolytic cell hydride reactor and a gas cell hydrino hydride reactor which were used to prepare crystal samples for TOFSIMS. The hydrino hydride compounds were collected directly in both cases, or they were purified from solution in the case of the electrolytic cell. For one sample, the K₂CO₃ electrolyte was acidified with HNO₃ before crystals were precipitated on a crystallization dish. In another sample, the K₂CO₃ electrolyte was acidified with HNO₃ before crystals were precipitated.

Sample #1. The sample was prepared by concentrating the K₂CO₃ electrolyte from the Thermacore Electrolytic Cell until yellow-white crystals just formed. XPS was also obtained at Lehigh University by mounting the sample on a polyethylene support. The XPS (XPS sample #6), XRD spectra (XRD sample #2), FTIR spectrum (FTIR sample #1), NMR (NMR sample #1), and ESITOFMS spectra (ESITOFMS sample #2) were also obtained.

Sample #2. A reference comprised 99.999% KHCO₃.

Sample #3. The sample was prepared by 1.) acidifying 400 cc of the K₂CO₃ electrolyte of the Thermacore Electrolytic Cell with HNO₃, 2.) concentrating the acidified solution to a volume of 10 cc, 3.) placing the concentrated solution on a crystallization dish, and 4.) allowing crystals to form slowly upon standing at room temperature. Yellow-white crystals formed on the outer edge of the crystallization dish. XPS (XPS sample #10), mass spectra (mass spectroscopy electrolytic cell samples #5 and #6), XRD spectra (XRD samples #3A and #3B), and FIIR spectrum (FrIR sample #4) were also obtained.

Sample #4. A reference comprised 99.999% KNO₃.

Sample #5. The sample was prepared by filtering the K₂CO₃ BLP Electrolytic Cell with a Whatman 110 mm filter paper (Cat. No. 1450 110) to obtain white crystals. XPS (XPS sample #4) and mass spectra (mass spectroscopy electrolytic cell sample #4) were also obtained.

Sample #6. The sample was prepared by acidifying the K₂CO₃ electrolyte from the BLP Electrolytic Cell with HNO₃, and concentrating the acidified solution until yellow-white crystals formed on standing at room temperature. XPS (XPS sample #5), the mass spectroscopy of a similar sample (mass spectroscopy electrolytic cell sample #3), and TGA/DTA (TGA/DTA sample #2) was also performed.

Sample #7. A reference comprised 99.999% Na₂CO₃.

Sample #8. The sample was prepared by concentrating 300 cc of the K₂CO₃ electrolyte from the BLP Electrolytic Cell using a rotary evaporator at 50° C. until a precipitate just formed. The volume was about 50 cc. Additional electrolyte was added while heating at 50° C. until the crystals disappeared. Crystals were then grown over three weeks by allowing the saturated solution to stand in a sealed round bottom flask for three weeks at 25° C. The yield was 1 g. XPS (XPS sample #7), ³⁹K NMR (³⁹K NMR sample #1), Raman spectroscopy (Raman sample #4); and ESITOFMS (ESITOFMS sample #3) were also obtained.

Sample #9. The sample was prepared by collecting a red/orange band of crystals that were cryopumped to the top of the gas cell hydrino hydride reactor at about 100° C. comprising a KI catalyst and a nickel fiber mat dissociator that was heated to 800° C. by external Mellen-heaters. The ESITOFMS spectrum (ESITOFMS sample #3) spectrum was also obtained as given in the ESITOFMS section.

Sample #10. The sample was prepared by collecting a yellow band of crystals that were cryopumped to the top of the gas cell hydrino hydride reactor at about 120° C. comprising a KI catalyst and a nickel fiber mat dissociator that was heated to 0.800° C. by external Mellen heaters.

Sample #11. The sample was prepared by acidifying 100 cc of the K₂CO₃ electrolyte from the BLP Electrolytic Cell with H₂SO₄. The solution was allowed to stand open for three months at room temperature in, a 250 ml beaker. Fine white crystals formed on the walls of the beaker by a mechanism equivalent to thin layer chromatography involving atmospheric water vapor as the moving phase and the Pyrex silica of the beaker as the stationary phase. The crystals were collected, and TOFSIMS was performed. XPS (XPS sample #8) was also performed.

Sample #12. The cathode of a K₂CO₃ electrolytic cell run at Idaho National Engineering Laboratories (INEL) for 6 months that was identical to that of described in the Crystal Samples from an Electrolytic Cell Section was placed in 28 liters of 0.6M K₂CO₃/10% H₂O₂. 200 cc of the solution was acidified with HNO₃. The solution was allowed to stand open for three months at room temperature in a 250 ml beaker. White nodular crystals formed on the walls of the beaker by a mechanism equivalent to thin layer chromatography involving atmospheric water vapor as the moving phase and the Pyrex silica of the beaker as the stationary phase. The crystals were collected, and TOFSIMS was performed. XPS (XPS sample #9) was also performed.

Sample #13. The sample was prepared from the cryopumped crystals isolated from the cap of a gas cell hydrino hydride reactor comprising a KI catalyst, stainless steel filament leads, and a W filament. XPS (XPS sample #14) was also performed.

### 13.7.2 Time-of-Flight-Secondary-Ion-Mass-Spectroscopy (TOFSIMS)

Samples were sent to Charles Evans East for TOFSIMS analysis. The powder samples were sprinkled onto the surface of double-sided adhesive tapes. The instrument was a Physical Electronics, PHI-Evans TFS-2000. The primary ion beam was a ⁶⁹Ga⁺ liquid metal ion gun with a primary beam voltage of 15 kV bunched. The nominal analysis regions were (12 μm)², (18 μm)², and (25 μm)². Charge neutralization was active. The post acceleration voltage was 8000 V. The contrast diaphragm was zero. No energy slit was applied. The gun aperture was 4. The samples were analyzed without sputtering. Then, the samples were sputter cleaned for 30 s to remove hydrocarbons with a 40 μm raster prior to repeat analysis. The positive and negative SIMS spectra were acquired for three (3) locations on each sample. Mass spectra are plotted as the number of secondary ions detected (Y-axis) versus the mass-to-charge ratio of the ions (X-axis).

### 13.7.3×PS to Confirm Time-Of-Flight-Secondary-Ion-Mass-Spectroscopy (TOFSIMS)

XPS was performed to confirm the TOFSIMS data. Samples were prepared and run as described in the Crystal Samples from an Electrolytic Cell of the Identification of Hydrinos, Dihydrinos, and Hydrino Hydride Ions by XPS (X-ray Photoelectron Spectroscopy) Section. The samples were:

XPS Sample #10. The sample was prepared by 1.) acidifying 400 cc of the K₂CO₃ electrolyte of the Thermacore Electrolytic Cell with HNO₃, 2.) concentrating the acidified solution to a volume of 10 cc, 3.) placing the concentrated solution on a crystallization dish, and 4.) allowing crystals to form slowly upon standing at room temperature. Yellow-white crystals formed on the outer edge of the crystallization dish. XPS was performed by mounting the sample on a polyethylene support. The identical TOFSIMS sample was TOFSIMS sample #3.

XPS Sample #11. The sample was prepared by acidifying the K₂CO₃ electrolyte from the BLP Electrolytic Cell with HI, and concentrating the acidified solution to 3 M. White crystals formed on standing at room temperature for one week. The XPS survey spectrum was obtained by mounting the sample on a polyethylene support.

XPS Sample #12. The sample was prepared by 1.) acidifying the K₂CO₃ electrolyte from the BLP Electrolytic Cell with HNO₃, 2.) heating the acidified solution to dryness at 85° C., 3.) further heating the dried solid 35 to 170° C. to form a melt which reacted with NiO as a product, 4.) dissolving the products in water, 5.) filtering the solution to remove NiO, 6.) allowing crystals to form on standing at room temperature, and 7.) recrystallizing the crystals. The XPS was obtained by mounting the sample on a polyethylene support.

XPS Sample #13. The sample was prepared from the cryopumped crystals isolated from the 40° C. cap of a gas cell hydrino hydride reactor comprising a Kr catalyst, stainless steel filament leads, and a W filament which was prepared by 1.) rinsing the hydrino hydride compounds from the cap of the cell where they were preferentially cryopumped, 2.) filtering the solution to remove water insoluble compounds such as metal, 3.) concentrating the solution until a precipitate just formed with the solution at 50° C., 4.) allowing yellowish-reddish-brown crystals to form on standing at room temperature, and 5.) filtering and drying the crystals before the XPS and mass spectra (gas cell sample #1) were obtained.

XPS Sample #14 comprised TOFSIMS sample #13.

XPS Sample #15 comprised 99.99% pure Kr.

### 13.7.4 Results and Discussion

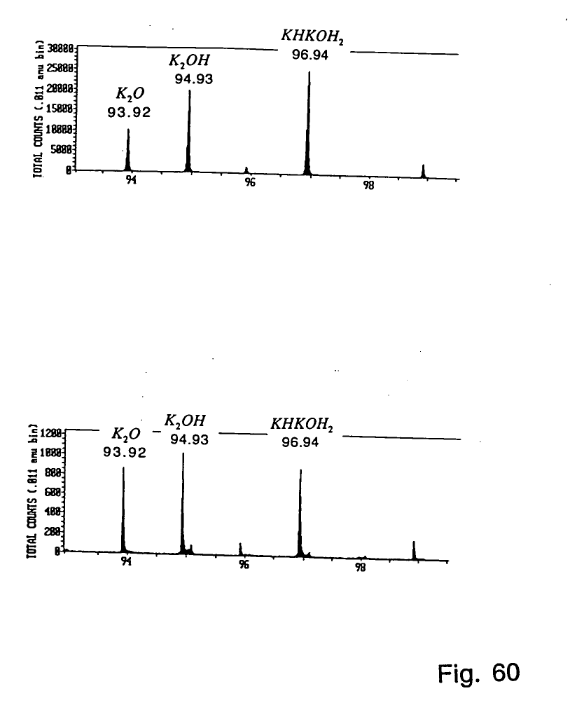

In the case that an M+2 peak was assigned as a potassium hydrino hydride compound in TABLES 13-16 and 18-33, the intensity of the M+2 ⁴¹K peak significantly exceeded the intensity predicted for the corresponding ⁴¹K peak, and the mass was correct. For example, the intensity of the peak assigned to KHKOH₂ was about equal to or greater than the intensity of the peak assigned to K₂OH as shown in FIG. 60 for TOFSIMS sample #8 and TOFSIMS sample #10.

For any compound or fragment peak given in TABLES 13-16 and 18-33 containing an element with more than one isotope, only the lighter isotope is given (except in the case of chromium where identifications were with ⁵²Cr). In each case, it is implicit that the peak corresponding to the other isotopes(s) was also observed with an intensity corresponding to about the correct natural abundance (e.g. ⁵⁸Ni, ⁶⁰Ni, and ⁶¹Ni; ⁶³Cu and ⁶⁵Cu; ⁵¹Cr, ⁵²Cr, ⁵³Cr; and ⁵⁴Cr; ⁶⁴Zn, ⁶⁶Zn, ⁶⁷Z, and ⁶⁸Zn; and ⁹²Mo, ⁹⁴Mo, ⁹⁵Mo, ⁹⁶Mo, ⁹⁷Mo, ⁹⁸Mo, and ¹⁰⁰Mo).

In the case of potassium, the ³⁹K potassium hydrino hydride compound peak was observed at an intensity relative to corresponding ⁴¹K peak which greatly exceeded the natural abundance. In some cases such as ³⁹ KH₂⁺ and K₃H₂N₃, the ⁴¹K peak was not present or a metastable neutral was present. For example, in the case of ³⁹ KH₂⁺, the corresponding ⁴¹K peak was not present. But, a peak was observed at m/e=41.36 which may account for the missing ions indicating that the ⁴¹K species (⁴¹KH₂⁺) was a neutral metastable.

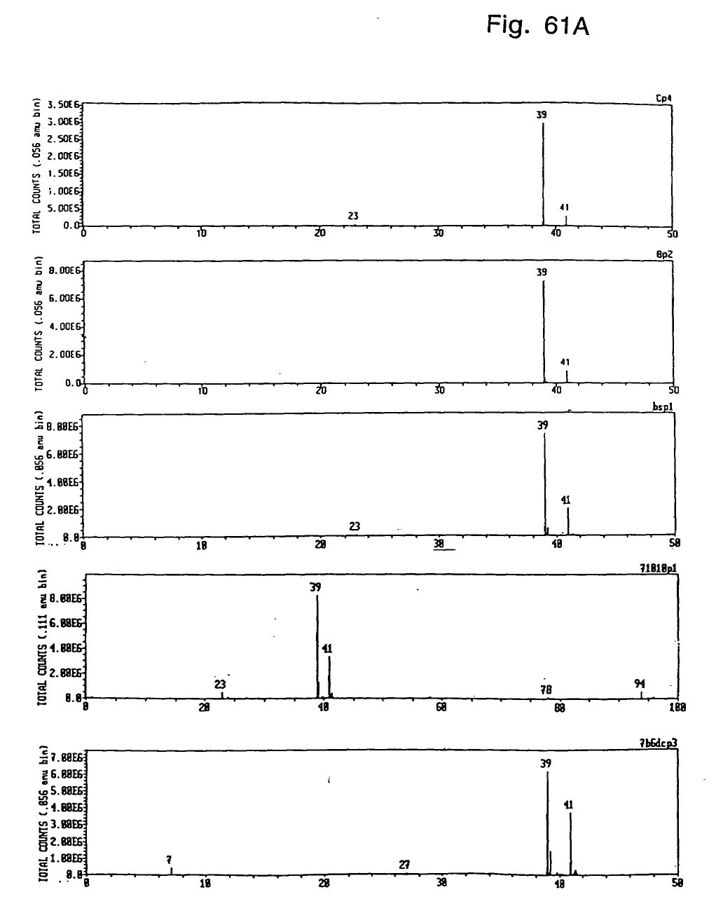

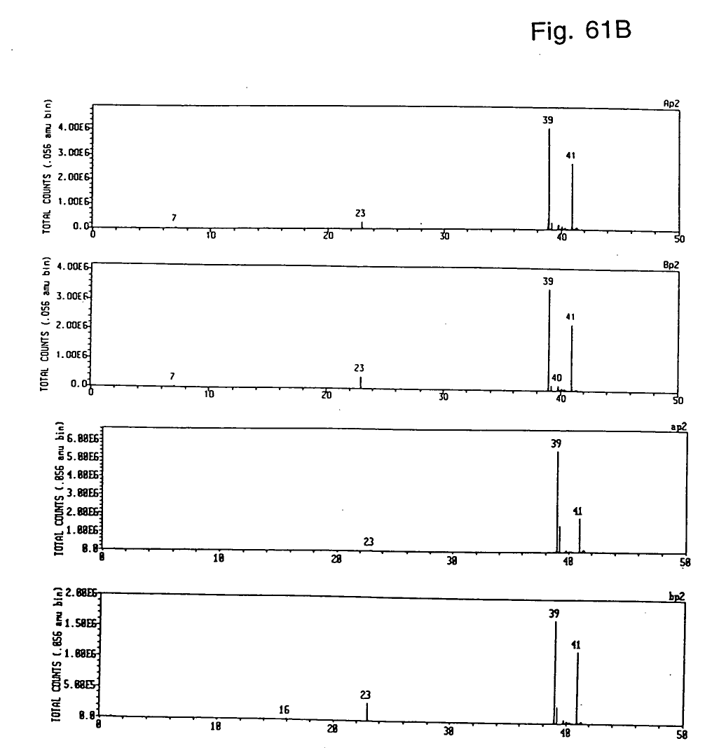

A more likely alternative explanation is that ³⁹K and ⁴¹K undergo exchange, and for certain hydrino hydride compounds, the bond energy of the ³⁹K hydrino hydride compound exceeds that of the ⁴¹K compound by substantially more than the thermal energy. The stacked TOFSIMS spectra m/e=0-50 in the order from bottom to top of TOFSIMS sample #2, #4, #1, #6, and #8 are shown in FIG. 61A, and the stacked TOFSIMS spectra m/e=0-50 in the order from bottom to top of TOFSIMS sample #9, #10, #11, and #12 are shown in FIG. 61B. The top two spectra of FIG. 61A are controls which show the natural ³⁹K/⁴¹K ratio. The remaining spectra of FIGS. 61A and 61B demonstrate the presence of ³⁹ KH₂⁺ in the absence of ⁴¹KH₂⁺.

The selectivity of hydrino atoms and hydride ions to form bonds with specific isotopes based on a differential in bond energy provides the explanation of the experimental observation of the presence of 31 KH₂⁺ in the absence of ⁴¹KH₂⁺ in the TOFSIMS spectra of crystals from both electrolytic and gas cell hydrino hydride reactors which were purified by several different methods. A known molecule which exhibits a differential in bond energy due to orbital-nuclear coupling is ortho and para hydrogen. At absolute zero, the bond energy of para-H₂ is 103.239 kcal/mole; whereas, the bond energy of ortho-H₂ is 102.900 kcal/mole. In the case of deuterium, the bond energy of para-D₂ is 104.877 kcal/mole, and the bond energy of ortho-D₂ is 105. 048 kcal/mole [H. W. Wooley, R. B. Scott, F. G. Brickwedde, J. Res. Nat. Bur. Standards, Vol. 41, (1948), p. 379]. Comparing deuterium to hydrogen, the bond energies of deuterium are greater due to the greater mass of deuterium which effects the bond energy by altering the zero order vibrational energy as given in '96 Mills GUT. The bond energies indicate that the effect of orbital-nuclear coupling on bonding is comparable to the effect of doubling the mass, and the orbital-nuclear coupling contribution to the bond energy is greater in the case of hydrogen. The latter result is due to the differences in magnetic moments and nuclear spin quantum numbers of the hydrogen isotopes. For hydrogen, the nuclear spin quantum number is I=1/2, and the nuclear magnetic moment is μp=2.79268μ_{N} where μ_{N} is the nuclear magneton. For deuterium, I=1, and μ_{D}=0.857387μ_{N}. The difference in bond energies of para versus ortho hydrogen is 0.339 kcal/mole or 0.015 eV. The thermal energy of an ideal gas at room temperature given by 3/2 kT is 0.038 eV where k is the Boltzmann constant and T is the absolute temperature. Thus, at room temperature, orbital-nuclear coupling is inconsequential. However, the orbital-nuclear coupling force is a function of the inverse electron-nuclear distance to the fourth power and its effect on the total energy of the molecule becomes substantial as the bond length decreases.

The internuclear distance 2c′ of dihydrino molecule

$${H}_{2}^{*} [ n = \frac{1}{p} ]$$

is

$$2 {c}^{′} = \frac{\sqrt{2} {a}_{o}}{p}$$

which is 1/p times that of ordinary hydrogen. The effect of orbital-nuclear coupling interactions on bonding at elevated temperature is observed via the relationship of fractional quantum number to the para to ortho ratio of dihydrino molecules. Only para

$${H}_{2}^{*} [ n = \frac{1}{3} ; 2 {c}^{′} = \frac{\sqrt{2} {a}_{o}}{3} ] and {H}_{2}^{*} [ n = \frac{1}{4} ; 2 {c}^{′} = \frac{\sqrt{2} {a}_{o}}{4} ]$$

are observed in the case of dihydrino formed via a hydrogen discharge with the catalyst (KI) where the reaction gasses flowed through a 100% CuO recombiner and were sampled by an on-line gas chromatograph as shown in FIG. 47. Thus, for p>3, the effect of orbital-nuclear coupling on bond energy exceeds thermal energy such that the Boltzmann distribution results in only para.

The same effect is predicted for potassium isotopes. For ³⁹K, the nuclear spin quantum number is I=3/2, and the nuclear magnetic moment is μ=0.39097μ_{N}. For ⁴¹K, I=3/2, and μ=^{0.21459}μ_{N} [Robert C. Weast, CRC Handbook of Chemistry and Physics, 58 Edition, CRC Press, West Palm Beach, Fla., (1977), p. E-69]. The masses of the potassium isotopes are essentially the same; however, the nuclear magnetic moment of ³⁹K is about twice that of ⁴¹K. Thus, in the case that an increased binding energy hydrogen species including a hydrino hydride ion forms a bond with potassium, the ³⁹K compound is favored energetically. Bond formation is effected by orbital-nuclear coupling which could be substantial and strongly dependent of the bond length which is a function of the fractional quantum number of the increased binding energy hydrogen species. As a comparison, the magnetic energy to flip the orientation of the proton's magnetic moment, μ_{P}, from parallel to antiparallel to the direction of the magnetic flux Bₛ due to electron spin and the magnetic flux Bₒ due to the orbital angular momentum of the electron where the radius of the hydrino atom is

$$\frac{{a}_{H}}{n}$$

is shown in '96 Mills GUT [Mills, R., The Grand Unified Theory of Classical Quantum Mechanics, September 1996 Edition, provided by BlackLight Power, Inc., Great Valley Corporate Center, 41 Great Valley Parkway, Malvern, Pa. 19355, pp. 100-101]. The total energy of the transition from parallel to antiparallel alignment, ΔEₜₒₜₐₗ^{S/N O/N}, is given as

$$\begin{matrix}Δ {E}_{total}^{S / NO / N} = \frac{{ne}^{2}}{8 {πɛ}_{o}} [ \frac{1}{{r}_{1 -}} - \frac{1}{{s}_{1 +}} ] - ( \sqrt{l ( l + 1 )} + \sqrt{\frac{3}{4}} ) 2 {μ}_{P} \frac{{n}^{3} {μ}_{0} e}{{m}_{e} {a}_{H}^{3}} & ( 72 ) \\ {r}_{1 \underline{+}} = \frac{{a}_{H} + \sqrt{{a}_{H}^{2} \underline{+} \frac{6 {μ}_{o} e ( \sqrt{l ( l + 1 )} + \sqrt{\frac{3}{4}} ) {μ}_{P} {a}_{o}}{ℏ}}}{2 n} & ( 73 )\end{matrix}$$

where r₁₊ corresponds to parallel alignment of the magnetic moments of the electron and proton, r₁₋ corresponds to antiparallel alignment of the magnetic moments of the electron and proton, α_{H} is the Bohr radius of the hydrogen atom, and αₒ is the Bohr radius. In increasing from a fractional quantum number of n=1, l=0 to n=5, l=4, the energy increases by a factor of over 2500. As a comparison, the minimum electron-nuclear distance in the ordinary hydrogen molecule is

$$( 1 - \frac{\sqrt{2}}{2} ) {a}_{0} = 0.29 {a}_{0} .$$

With n=3; l=2 to give a comparable electron-nuclear distance and with two electrons and two protons Eqs. (72) and (73) provide an estimate of the orbital-nuclear coupling energy of ordinary molecular hydrogen of about 0.01 eV which is consistent with the observed value. Thus, in the case of a potassium compound containing at least one increased binding energy hydrogen species with a sufficiently short internuclear distance, the differential in bond energy exceeds thermal energies, and compound becomes enriched in the ³⁹K isotope. In the case of hydrino hydride compounds KHₙ, the selectivity of hydrino atoms and hydride ions to form bonds with ³⁹K based on a differential in bond energy provides the explanation of the experimental observation of the presence of ³⁹KH₂⁺ in the absence of ⁴¹KH₂⁺ in the TOFSIMS spectra given in FIGS. 61A and 61B.

The hydrino hydride compounds (m/e) assigned as parent peaks or the corresponding fragments (m/e) of the positive Time Of Flight Secondary Ion Mass Spectroscopy (TOFSIMS) of sample #1 taken in the static mode appear in TABLE 13.

TABLE 13
The hydrino hydride compounds (m/e) assigned as parent peaks or the
corresponding fragments (m/e) of the positive Time Of Flight
Secondary Ion Mass Spectroscopy (TOFSIMS) of sample #1 taken
in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.98 | 40.97936 | 0.0006 |
| Ni | 58 | 57.93 | 57.9353 | 0.005 |
| NiH | 59 | 58.94 | 58.943125 | 0.003 |
| NiH₄ | 62 | 61.96 | 61.9666 | 0.007 |
| K₂H₃ | 81 | 80.95 | 80.950895 | 0.001 |
| KNO₂ | 85 | 84.955 | 84.9566 | 0.002 |
| KHKOH₂ | 97 | 96.94 | 96.945805 | 0.005 |
| K₃H₃ | 120 | 119.91 | 119.914605 | 0.005 |
| K₃H₄ | 121 | 120.92 | 120.92243 | 0.002 |
| K₃OH₄ | 137 | 136.92 | 136.91734 | 0.003 |
| K₃O₂H | 150 | 149.89 | 149.8888 | 0.001 |
| K₃O₂H₂ | 151 | 150.90 | 150.8966 | 0.003 |
| K₃C₂O | 157 | 156.88 | 156.88604 | 0.006 |
| K₄H₃ | 159 | 158.87 | 158.8783 | 0.008 |
| K[KH KHCO₂] | 163 | 163.89 | 162.8966 | 0.007 |
| Silanes/Siloxanes | | | | |
| Si₅H₉O | 165 | 164.95 | 164.949985 | 0 |
| Si₅H₁₁O | 167 | 166.97 | 166.965635 | 0.004 |
| Si₆H₂₅O | 209 | 209.05 | 209.052 | 0.002 |
| Si₆H₂₇O | 211 | 211.07 | 211.06776 | 0.002 |
| Si₆H₂₁O₂ | 221 | 221.0166 | 221.015725 | 0.0000875 |
| Si₆H₂₅O₂ | 225 | 225.05 | 225.047025 | 0.003 |
| NaSi₇H₃₀ | 249 | 249.0520 | 249.063 | 0.010 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{1.2 \times {10}^{6}}{4.7 \times {10}^{6}} = 23 \% , nat . ab . ratio = \frac{6.88}{93.1} = 7.4 \% ) .$

The positive ion spectrum was dominated by K⁺, and Na⁺ was also present. Other peaks containing potassium included KC⁺, KₓO_{y}⁺, KₓOH⁺, KCO⁺, K₂⁺, and a series of peaks with an interval of 138 corresponding to K[K₂CO₃]ₙ⁺ m/e=(39+138n). The metals indicated were in trace amounts.

The peak NaSi₇H₃₀ (m/e=249) given in TABLE 13 can give rise to the fragments NaSiH₆ (m/e=57) and Si₆H₂₄ (m/e=192). These fragments and similar compounds are shown in the Identification of Hydrino Hydride Compounds by Mass Spectroscopy Section.

NaSi₇H₃₀(m/e=249)→NaSiH₆(m/e=57)+Si₆H₂₄(m/e=192) (74)

A general structure for the Si₅H₁₁O (m/e=167) peak of TABLE 13 is

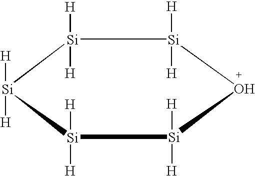

The observation by TOFSIMS of KNO₂ is further confirmed by the presence of nitrate and nitrite nitrogen in the XPS. (The corresponding samples are XPS sample #6 and XPS sample #7 summarized in TABLE 17.)

Nitrate and nitrite fragments were also observed in the negative TOFSIMS of sample #1. No nitrogen was observed in the XPS of crystals from an identical cell operated at Idaho National Engineering Laboratory for 6 months wherein Na₂CO₃ replaced K₂CO₃.

The hydrino hydride compounds (m/e) assigned as parent peaks or the corresponding fragments (m/e) of the negative Time Of Flight Secondary Ion Mass Spectroscopy (TOFSIMS) of sample #1 taken in the static mode appear in TABLE 14.

TABLE 14
The hydrino hydride compounds (m/e) assigned as parent
peaks or the corresponding fragments (m/e) of the negative
Time Of Flight Secondary Ion Mass Spectroscopy (TOFSIMS)
of sample #1 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH | 24 | 23.99 | 23.997625 | 0.008 |
| NaH₂ | 25 | 25.01 | 25.00545 | 0.004 |
| NaH₃ | 26 | 26.015 | 26.013275 | 0.002 |
| KH | 40 | 39.97 | 39.971535 | 0.0015 |
| KH₂ | 41 | 40.98 | 40.97936 | 0.0006 |
| KH₃ | 42 | 41.99 | 41.987185 | 0.0028 |
| KH₆ | 45 | 45.01 | 45.01066 | 0.0007 |
| NO₂ | 46 | 45.9938 | 45.99289 | 0.0009 |
| Na₂H₂ | 48 | 48.00 | 47.99525 | 0.005 |
| NO₃ | 62 | 61.98 | 61.9878 | 0.008 |
| NaHNaOH | 64 | 63.99 | 63.99016 | 0 |
| KNO₂ | 85 | 84.955 | 84.9566 | 0.002 |
| KH₄KOH | 99 | 98.95 | 98.961455 | 0.011 |
| KNO₃ | 101 | 100.95 | 100.95151 | 0.0015 |
| Silanes/Siloxanes | | | | |
| Si | 28 | 27.97 | 27.97693 | 0.007 |
| SiH | 29 | 28.98 | 28.984755 | 0.005 |
| KSiH₄ | 71 | 70.97 | 70.97194 | 0.002 |
| KSiH₅ | 72 | 71.975 | 71.979765 | 0.005 |
| KSiH₆ | 73 | 72.99 | 72.98759 | 0.002 |
| Si₆H₂₁O | 205 | 205.03 | 205.0208 | 0.009 |

The negative ion spectrum was dominated by the oxygen peak. Other significant peaks were OH—, HCOQ, and COQ. The chloride peaks were also present with very small peaks of the other halogens. According to the results presented by Charles Evans of the negative spectra of both sample #1 and sample #3 (See TABLE 14 and TABLE 16), “The peak at 205 m/z remains unassigned.” The m/e=205 peak is herein assigned to Si₆H₂₁O(m/e_{observed}=205.03; m/e_{theoretical}=205.0208) which is the m/e=221 peak observed in the positive spectrum minus oxygen,

Si₆H₂₁O₂(m/e=221)—O(m/e=16) Si₆H₂₁O(m/e=205) (75)

The hydrino hydride compounds (m/e) assigned as parent peaks or the corresponding fragments (m/e) of the positive Time Of Flight Secondary Ion Mass Spectroscopy (TOFSIMS) of sample #3 taken in the static mode appear in TABLE 15.

TABLE 15
The hydrino hydride compounds (m/e) assigned as parent
peaks or the corresponding fragments (m/e) of the positive
Time Of Flight Secondary Ion Mass Spectroscopy (TOFSIMS)
of sample #3 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| Ni | 58 | 57.93 | 57.9353 | 0.005 |
| NiH | 59 | 58.94 | 58.943125 | 0.003 |
| Cu | 63 | 62.93 | 62.9293 | 0.001 |
| Zn | 64 | 63.93 | 63.9291 | 0.001 |
| ZnH | 65 | 64.94 | 64.936925 | 0.003 |
| ZnH₃ | 67 | 66.95 | 66.952575 | 0.003 |
| KCO | 67 | 66.9615 | 66.95862 | 0.002 |
| KHKOH₂ | 97 | 96.94 | 96.945805 | 0.005 |
| K₃H₄O | 137 | 136.93 | 136.91734 | 0.013 |
| K₂HCO₃ | 139 | 138.93 | 138.919975 | 0.010 |
| K₃O₂H | 150 | 149.89 | 149.8888 | 0.001 |
| K₃CO₂ | 161 | 160.8893 | 160.881 | 0.008 |
| [K⁺138n]⁺ n = 1 | 177 | 176.8792 | 176.87586 | 0.003 |
| K[K₂CO₃] | | | | |
| K₃C₂O₃ | 189 | 188.87 | 188.87586 | 0.006 |
| K₃C₂O₄ | 205 | 204.8822 | 204.87077 | 0.011 |
| K₃CO₅ | 209 | 208.87 | 208.86568 | 0.004 |
| K₅CO₄ | 271 | 270.8107 | 270.7982 | 0.012 |
| K₅CO₅ | 287 | 286.80 | 286.7931 | 0.007 |
| [K⁺138n]⁺ n = 2 | 315 | 314.7879 | 314.7880 | 0.0001 |
| K[K₂CO₃]₂ | | | | |

The positive ion spectrum of sample #3 was similar to the positive ion spectrum of sample #1. The spectrum was dominated by K⁺, and Na⁺ was also present. Other peaks containing potassium included KC⁺, KₓO_{y}⁺, KₓH⁺, KCO⁺, and K₂⁺. Common fragments lost were C(m/e=12.0000), O(m/e=15.99491), CO(m/e=27.99491), and CO₂ (m/e=43.98982). The metals indicated were in trace amounts. The KₓOH⁺/KₓO⁺ratio was higher in the spectrum of sample #1, while the Na⁺/KₓO⁺ ratio was higher the spectrum of sample #3. The spectrum of sample #3 also contained K₂NO₂+ and K₂NO₃⁺ while the spectrum of sample #1 contained KNO₂⁺. The series of peaks with an interval of 138 were also observed at 39, 177, and 315 ([K⁺138n]⁺), but their intensities were lower in sample #3. The [K⁺138 n]⁺ series of fragment peaks is assigned to hydrino hydride bridged potassium bicarbonate compounds having a general formula such as [KHCO₃H⁻(1/p)K⁺]ₙ n=1, 2, 3, 4, . . . and potassium carbonate compounds having a general formula such as K[K₂CO₃]ₙ⁺ H⁻(1/p) n=1, 2, 3, 4, . . . . General structural formulas are

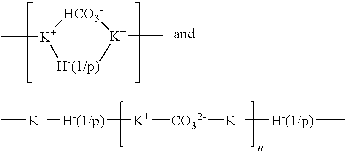

Positive ion peaks comprising K⁺ bound to multimers: of potassium carbonate were also formed in vacuum with Ga⁺ bombardment of the reference KHCO₃, sample #2. However, the data support the identification of stable compounds comprising potassium carbonate multimers formed by bonding with hydrino hydride ions. TOFSIMS sample #3 was prepared from TOFSIMS sample #1 by acidifying it with HNO₃ to pH=2 and boiling it to dryness. Ordinarily no K₂CO₃ would be present—the sample would be 100% KVO₃. The TOFSIMS spectrum of sample #3 was that of a combination of the spectrum of sample #1 as well as the spectrum of the fragments of the compound formed by the displacement of carbonate by nitrate. A general structural formula for the reaction is

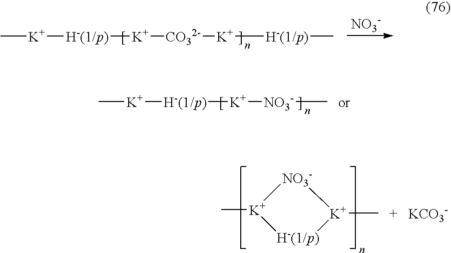

The observation by TOFSIMS of hydrino hydride bridged potassium carbonate compounds having the general formulae

K[K₂CO₃]ₙ⁺ H⁻(1/p) n=1, 2, 3, 4, . . . is further confirmed by the presence of carbonate carbon (C 1s≈289.5 eV) in the XPS of crystals isolated from a K₂CO₃ electrolytic cell wherein the samples were acidified with HNO₃. (The XPS results of interest are XPS sample #5 (TOFSIMS sample #6) and XPS sample #10 (TOFSIMS sample #3) summarized in TABLE 17.) During acidification of the K₂CO₃ electrolyte to prepare sample #6, the pH repetitively increased from 3 to 9 at which time additional acid was added with carbon dioxide release. A reaction consistent with this observation is the displacement reaction of NO₃⁻ for CO₃²⁻ as given by Eq. (76). The novel nonreactive potassium carbonate compound observed by TOFSIMS without identifying assignment to conventional chemistry corresponds and identifies hydrino hydride compounds, according to the present invention.

The hydrino hydride compounds (m/e) assigned as parent peaks or the corresponding fragments (m/e) of the negative Time Of Flight Secondary Ion Mass Spectroscopy (TOFSIMS) of sample #3 taken in the static mode appear in TABLE 16.

TABLE 16
The hydrino hydride compounds (m/e) assigned as parent
peaks or the corresponding fragments (m/e) of the negative
Time Of Flight Secondary Ion Mass Spectroscopy (TOFSIMS)
of sample #3 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH | 24 | 23.99 | 23.997625 | 0.008 |
| NaH₂ | 25 | 25.01 | 25.00545 | 0.004 |
| NaH₃ | 26 | 26.015 | 26.013275 | 0.002 |
| KH | 40 | 39.97 | 39.971535 | 0.0015 |
| KH₂ | 41 | 40.98 | 40.97936 | 0.0006 |
| KH₃ | 42 | 41.99 | 41.987185 | 0.0028 |
| HCO₂ | 45 | 45.00 | 44.997645 | 0.007 |
| Na₂H₂ | 48 | 48.00 | 47.99525 | 0.005 |
| Mg₂H₄ | 52 | 52.00 | 52.00138 | 0.001 |
| Mg₂H₅ | 53 | 53.01 | 53.009205 | 0.0008 |
| NaHNaOH | 64 | 63.99 | 63.99016 | 0 |
| K₂H₂ | 80 | 79.942 | 79.94307 | 0.001 |
| KH₄KOH | 99 | 98.96 | 98.961455 | 0.001 |
| Silanes/Siloxanes | | | | |
| Si₃H₁₂ | 96 | 96.02 | 96.02469 | 0.0047 |
| Si₃H₁₃ | 97 | 97.03 | 97.032515 | 0.0025 |
| NaSi₃H₁₄ | 121 | 121.03 | 121.03014 | 0.0001 |
| Si₄H₁₅O | 143 | 143.025 | 143.0200 | 0.005 |
| Si₆H₂₁O | 205 | 205.03 | 205.0208 | 0.009 |

The negative ion spectrum was dominated by the oxygen peaks as was the case for the negative spectrum of sample #1. However, instead of the halogen peaks, the NO₂⁻ and NO₃⁻ peaks were observed in the spectrum of sample #3. Furthermore, other peaks which were much more intense in the spectra of sample #3 were KN_{y}O_{z}⁻ (KNO₃⁻, KNO₄⁻, KN₂O₄⁻, KN₂O₅⁻, and KN₂O₆⁻).

Silane peaks were also observed. The NaSi₃H₁₄ (m/e=121) peak given in TABLE 16 can give rise to the fragments NaSiH₆ (m/e=57) and Si₂H₈ (m/e=64). These fragments and similar compounds are shown in the Identification of Hydrino Hydride Compounds by Mass Spectroscopy Section.

NaSi₃H₁₄(m/e=121)→NaSiH₆(m/e=57)+Si₂H₈(m/e=64) (77)

Mass spectroscopy and TOFSIMS are complementary. The former method as implemented herein detects the volatile hydrino hydride compounds. TOFSIMS operates in an ultrahigh vacuum whereby the volatile compounds are pumped away, but the nonvolatile compounds are detected. The TOFSIMS of sample #3 corresponds to the mass spectrum of electrolytic cell sample #5 and electrolytic cell sample #6. The mass spectrum (m/e=0-110) of the vapors from the yellow-white crystals that formed on the outer edge of a crystallization dish from the acidified electrolyte of the K₂CO₃ Thermacore Electrolytic Cell (electrolytic cell sample #5) with a sample heater temperature of 220° C. is shown in FIG. 26A and with a sample heater temperature of 275° C. is shown in FIG. 26B. The mass spectrum (m/e=0-110) of the vapors from electrolytic cell sample #6 with a sample heater temperature of 212° C. is shown in FIG. 26C. The parent peak assignments of major component hydrino hydride compounds followed by the corresponding m/e of the fragment peaks appear in TABLE 4. The mass spectrum (m/e=0-200) of the vapors from electrolytic cell sample #6 with a sample heater temperature of 147° C. with the assignments of major component hydrino hydride silane compounds and silane fragment peaks is shown in FIG. 26D. Silane hydrino hydride compounds were also observed and confirmed by TOFSIMS as shown in TABLES 15 and 16.

The confirmation can be further extended by varying the ionization potential of the mass spectrometer. For example, the TOFSIMS identifies the hydrino hydride compound KH₃ (m/e=42) as shown in TABLES 14 and 16. A (m/e=44) peak assigned to KH₅ that gives rise to KH₃ (m/e=42) by increasing the ionization energy is observed for the mass spectrum (m/e=0-200) of the vapors from the crystals prepared from cap of a gas cell hydrino hydride reactor comprising a KI catalyst, stainless steel filament leads, and a W filament with a sample heater temperature of 157° C. (The sample was prepared as described in under Gas Cell Samples of the Identification of Hydrino Hydride Compounds by Mass Spectroscopy Section.) The mass spectra with varying ionization potential (IP=30 eV, IP=70 eV, IP=150 eV) appear in FIG. 62. The silane Si₂H₄ is assigned to the m/e=0.64 peak and the silane Si₄H₁₆ is assigned to the m/e=128 peak. The sodium hydrino hydride Na₂H₂ is assigned to the m/e=48 peak. A structure is

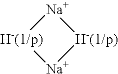

The corresponding potassium hydrino hydride compound K₂H₂ is observed by TOFSIMS as given in TABLE 16 and by mass spectroscopy as shown in FIGS. 30A, 30B, 25C, 25D, 26D, 34B, and 34C. A structure is

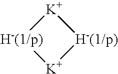

All of the peaks shown in FIG. 62 corresponding to hydrino hydride compounds increased with ionization potential. As the ionization energy was increased from 70 eV to 150 eV the (m/e=44) peak increased in intensity, and a large m/e=42 peak was observed. Carbon dioxide has a (m/e=44) peak, but it does not have a m/e=42 peak. The (m/e=44) peak was assigned to KH₅. The m/e=42 peak was assigned to KH₃ produced by the following fragmentation reaction of KH₅ at the higher ionization energy

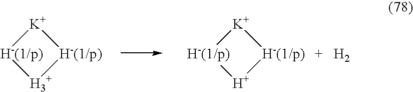

The m/e=42 peak which is not present at IP=70 eV but is present at IP=150 eV and the (m/e=44) peak which is present at IP=70 eV and IP=150 eV is a signature and identifies KH₅ and KH₃.

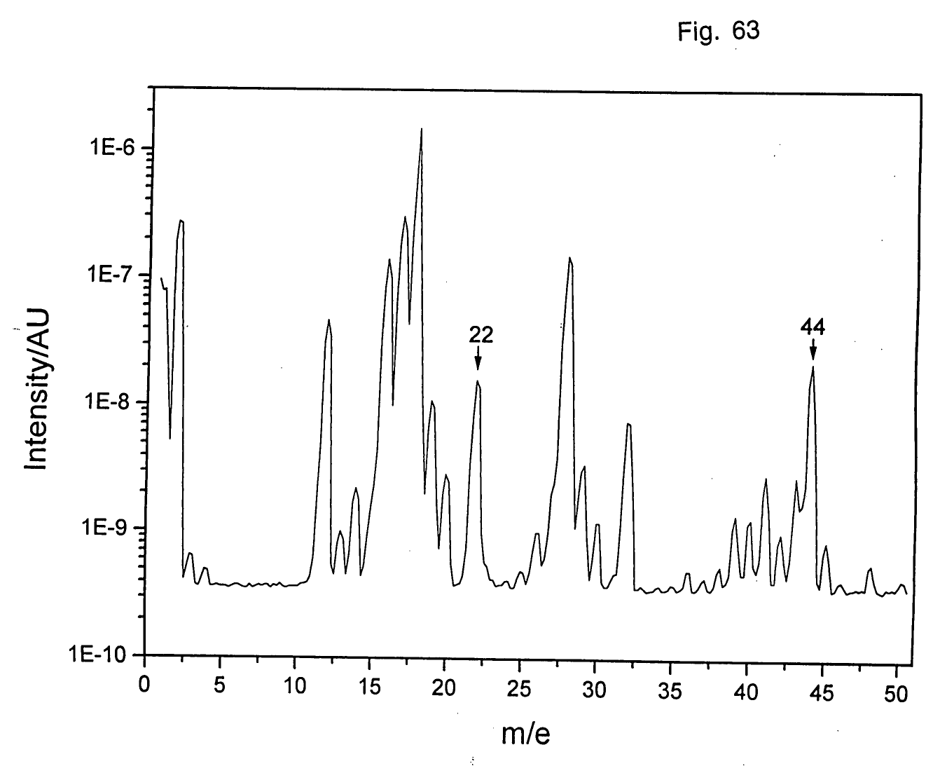

Shown in FIG. 63 is the mass spectrum (m/e=0-50) of the vapors from the crystals prepared by concentrating 300 cc of the K₂CO₃ electrolyte from the BLP Electrolytic Cell using a rotary evaporator at 50° C. until a precipitate just formed (XPS sample #7; TOFSIMS sample #8) with a sample heater temperature of 100° C. As the ionization energy was increased from 30 eV to 70 eV, a (m/e=22) peak was observed that was the same intensity as an observed (m/e=44) peak. Carbon dioxide gives rise to a (m/e=44) peak and a (m/e=22) peak corresponding to doubly ionized CO₂ (m/e=44). However, the (m/e=22) peak of carbon dioxide is about 0.52% of the (m/e=44) peak [Data taken on UTI-100C-02 quadrapole residual gas analyzer with V_{EE}=70 V, V_{IE}=15 V, V_{FO}=−20 V, I_{E}=2.5 mA, and resolution potentiometer=5.00 by U the Technology Inc., 325 N. Mathida Ave., Sunnyvale, Calif. 94086]. Thus, the (m/e=22) peak is not carbon dioxide. The (m/e=44) peak was assigned to KH₅. The (m/e=22) peak was assigned to doubly ionized KH₅ produced by the following fragmentation reaction of KH₅ at the higher ionization energy

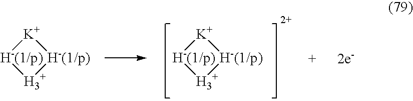

In the case that the hydrino hydride compound comprises two or more hydrino hydride ions H⁻(1/p) with low quantum number p, an exceptional-branching ratio is possible whereby the doubly ionized ion peak is of similar magnitude as the singly ionized ion peak. This is due to the relatively low binding energy of the second electron that is ionized. The data indicates that in the case that the hydrino hydride compound KH₅ fragments to KH₃ as given by Eq. (78), KH₅ comprises two hydrino hydride ions H⁻(1/p) with high quantum number p. The ionization energies are high as given in TABLE 1; thus, fragmentation is favored over double ionization. The m/e=42 peak which is not present at IP=70 eV but is present at IP=150 eV and the (m/e=44) peak which is present at IP=70 eV and IP=150 eV as well as the exceptional intensity of the doubly ionized (m/e=44) peak is a signature and identifies hydrino hydride compound KH₅ of the present invention.

As the ionization energy was increased from 30 eV to 70 eV a m/e=4 peak was observed. The reaction follows from Eq. (32).

$${H}_{2}^{*} [ 2 {c}^{′} = \frac{\sqrt{2} {a}_{o}}{p} ] + {{H}_{2}^{*} [ 2 {c}^{′} = \frac{2 {a}_{o}}{p} ]}^{+} \to {H}_{4}^{+} ( 1 / p ) \qquad ( 80 )$$

H₄⁺(1/p) serves as a signature for the presence of dihydrino molecules and molecular ions including those formed by fragmentation of increased binding energy hydrogen compounds in a mass spectrometer. As demonstrated by the correlation of peaks and signatures, TOFSIMS and MS taken together provide redoubtable support of the assignments given herein.

TOFSIMS has the ability to further confirm the structure by providing a unique signature for metastable ions. In the case of the each positive spectra and each reference spectra, broad features are observed in the mass region m/e=23-24 and in the mass region m/e=39-41. These features are indicative of the formation of metastable ions from neutrals which contain and fragment to Na⁺ and K⁺, respectively The intensities of the metastable ion peaks vary significantly, between the hydrino hydride ion containing samples and the reference samples. The results indicate that hydrino hydride compounds form different neutrals than the neutrals formed during TOFSIMS in the reference case.

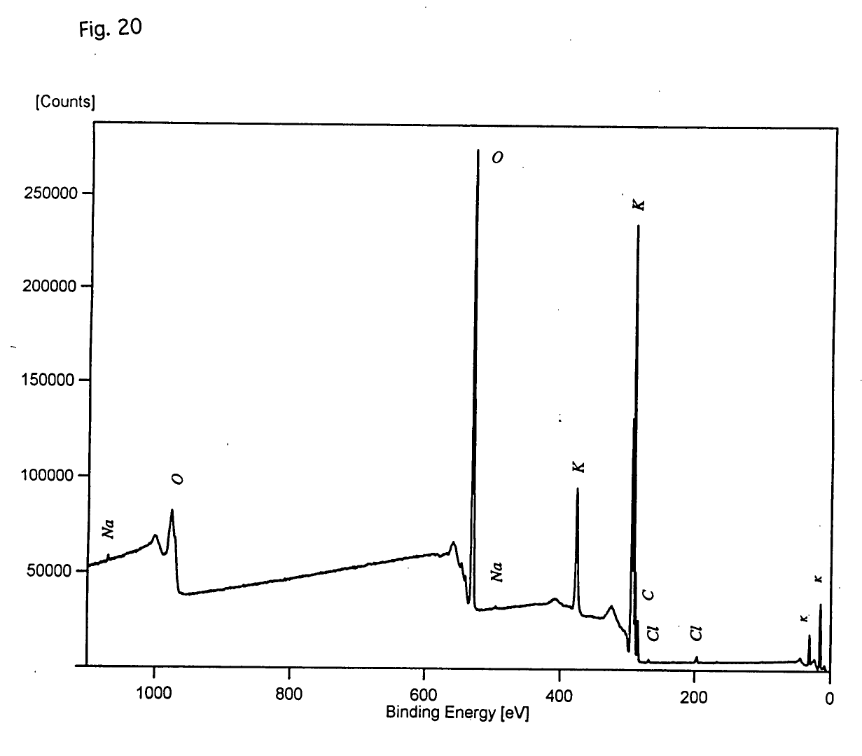

In addition to showing the hydrino hydride ion peaks, XPS also confirms the TOFSIMS data. For example, the TOFSIMS sample #1 also corresponds to the XPS sample #6. The hydrino hydride ion peaks H⁻(n=1/p) for p=2 to p=16 are identified in FIG. 21. The survey spectrum shown in FIG. 20 shows that two forms of carbon are present due to the presence of two C 1 s peaks. The peaks are assigned to ordinary potassium carbonate and polymeric hydrino-hydride-bridged potassium carbonate.

TOFSIMS sample #3 is similar to XPS sample #5. The survey spectrum shown in FIG. 18 shows that two forms of nitrogen are present due to the presence of two N 1 s peaks as well as the presence of two forms of carbon due to the presence of two C 1 s peaks. The nitrogen peaks are assigned to ordinary potassium nitrate and polymeric hydrino-hydride-bridged potassium nitrate. The carbon peaks are assigned to ordinary potassium carbonate and polymeric hydrino-hydride-bridged potassium carbonate.

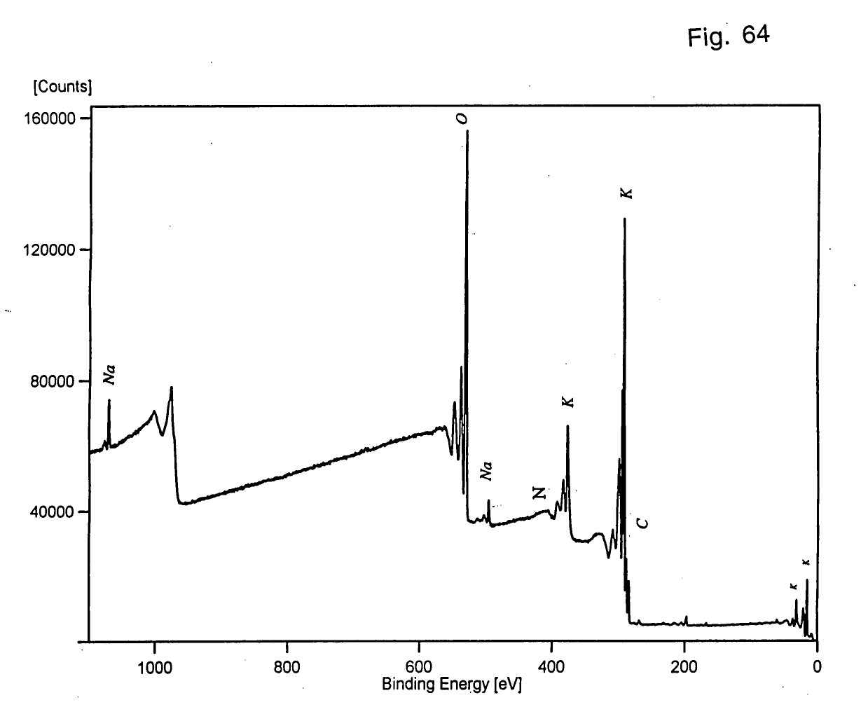

XPS was performed to confirm the TOFSIMS data. The splitting of the principle or Auger peaks of the survey spectrum of XPS samples #4-#7; #10-#13 indicative of two forms of bonding involving the atom of each split peak are shown in TABLE 17. The selected survey spectra with the corresponding FIGURES of the 0-70 eV region high resolution spectra (#/#) are given. The 0-70 eV region high resolution spectra contain hydrino hydride ion peaks. And, several of the shifts of the peaks of elements which comprise hydrino hydride compounds given in TABLE 17 and shown in the survey spectra are greater than those of known compounds. For example, the XPS spectrum of XPS sample #7 which appears in FIG. 64 shows extraordinary potassium, sodium, and oxygen peak shifts. The results shown in FIG. 64 are not due to uniform or differential charging. The oxygen KLL Auger peaks superimpose those of the XPS survey spectrum of XPS sample #6, and the number of lines, their relative intensities and the peak shifts varies. The spectrum is not a superposition of repeated survey spectra that are identical except that they are shifted and scaled by a constant factor; thus, uniform charging is ruled out. Differential charging is eliminated because the carbon and oxygen peaks have a normal peak shape. The range of binding energies from the literature [C. D. Wagner, W. M. Riggs, L. E. Davis, J. F. Moulder, G. E. Mulilenberg (Editor), Handbook of X-ray Photoelectron Spectroscopy, Perkin-Elmer Corp., Eden Prairie, Minn., (1997).] (minimum to maximum, min-max) for the peaks of interest are given in the final row of TABLE 17. The peaks shifted to an extent that they are without identifying assignment correspond to and identify compounds containing hydrino hydride ion, according to the present invention. For example, the positive and negative TOFSIMS spectra (TOFSIMS sample #8) given in TABLES 22 and 23 showed large peaks which were identified as KHKOH and KHKOH₂. The extraordinary shifts of the K 3 p, K 3 s, K 2 p₃, K 2 p₁, and K 2 s XPS peaks and the 01 s XPS peak shown in FIG. 64 are assigned to these compounds. The TOFSIMS and XPS results support the assignment of bridged or linear potassium hydrino hydride and potassium hydrino hydroxide compounds. As a further example, the NaKL₂₃Li₃ peak was significantly shifted to both higher and lower binding energies consistent with bonding involving electron donating and electron withdrawing groups such as NaSiH₆ and Na₂H₂, respectively. These compounds are given herein by TOFSIMS. TOFSIMS and XPS taken together provide redoubtable support of hydrino hydride compounds as assigned herein.

TABLE 17
The binding energies of XPS peaks of hydrino hydride compounds.

| | | | | | Na | | | | | | |
|---|---|---|---|---|---|---|---|---|---|---|---|
| | | C 1s | N 1s | O 1s | KL₂₃L₂₃ | Na 1s | K 3p | K 3s | K 2p₃ | K 2p₁ | K 2s |
| XPS # | FIG # | (eV) | (eV) | (eV) | (eV) | (eV) | (eV) | (eV) | (eV) | (eV) | (eV) |
| 4 | 16 | 284.2 | 403.2 | 532.1 | 496.2 | 1070.9 | — | — | — | — | — |
| | 17 | 285.7 | 407.0 | 535.7 | 501.4 | 1077.5 | | | | | |
| | | 287.4 | | 563.8 | 523.1 | | | | | | |
| | | 288.7 | | | | | | | | | |
| 5 | 18 | 284.2 | 402.5 | 532.2 | 496.2 | 1070.4 | 16.6 | 32.5 | 292.1 | 295.0 | 376.9 |
| | 19 | | 406.5 | 540.6 | | | | | | | |
| 6 | 20 | 284.2 | ~390 | 530.7 | 496.5 | 1070.0 | 16.0 | 32.0 | 291.8 | 294.6 | 376.6 |
| | 21 | 288.8 | very | | 503.8 | 1076.5 | | | 300.5 | 303.2 | |
| | | | broad | | | | | | | | |
| 7 | 56 | 284.4 | 393.1 | 530.4 | 495.9 | 1070.4 | 16.2 | 32.1 | 291.8 | 294.7 | 376.6 |
| | 22 | 288.5 | | 537.5 | 503.2 | 1076.3 | 21.7 | 37.9 | 299.5 | 309.4 | 383.6 |
| | | | | 547.8 | 512.2 | | | | | | |
| 8 | | 284.2 | 398.9 | 531.8 | 496.9 | 1070.9 | 16.7 | 32.5 | 292.3 | 295.1 | 376.9 |
| | | 288.1 | 402.8 | | 501.7 | | | | | | 385.4 |
| | | | 406.7 | | | | | | | | broad |
| 9 | | 284.3 | — | 530.3 | 485.0 | 1072.9 | 16.9 | 32.8 | 292.5 | 295.3 | 377.2 |
| | | | | | 493.5 | broad | | | | | |
| 10 | | 284.3 | 397.2 | 532.3 | 485.4 | 1070.1 | 16.6 | 32.7 | 292.5 | 295.3 | 377.2 |
| | | 287.9 | 399.3 | 541.1 | 495.9 | 1077.8 | | | 298.9 | 302.2 | |
| | | | 402.8 | 545.1 | | | | | | | |
| | | | 407.1 | 547.8 | | | | | | | |
| | | | 413.5 | | | | | | | | |
| | | | 416.8 | | | | | | | | |
| 11 | | 284.2 | 399.5 | 530.7 | 474.8 | 1072.5 | 16.6 | 32.5 | 292.3 | 295.2 | 377.1 |
| | | 285.9 | 406.5 | | 498.0 | broad | | | | | |
| Min | | 280.5 | 398 | 529 | | 1070.4 | | | 292 | | |
| Max | | 293 | 407.5 | 535 | | 1072.8 | | | 293.2 | | |

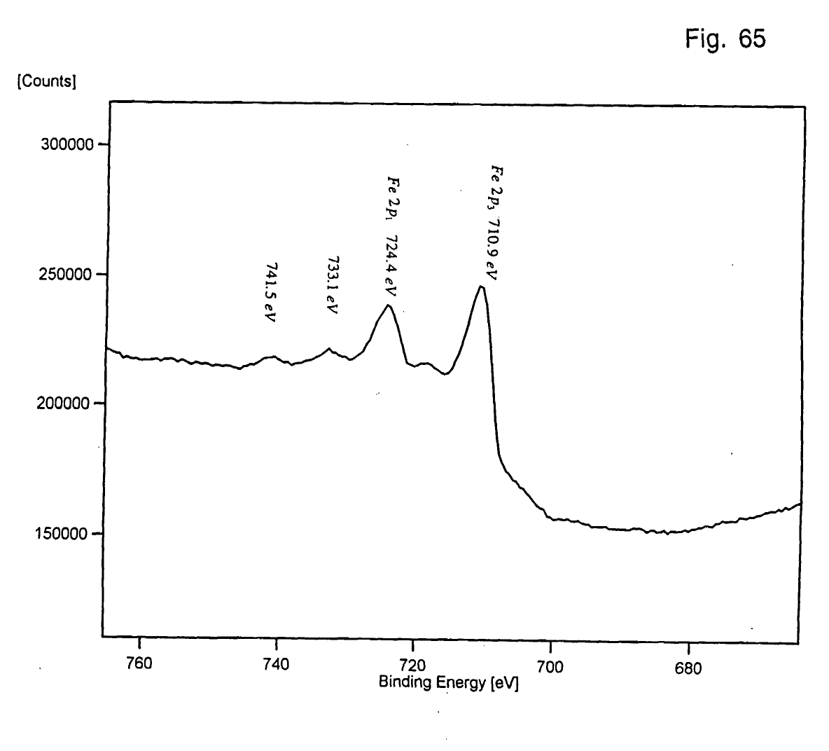

The 675 eV to 765 eV binding energy region of an X-ray Photoelectron Spectrum (XPS) of the cryopumped crystals isolated from the 40° C. cap of a gas cell hydrino hydride reactor comprising a KI catalyst, stainless steel filament leads, and a W filament (XPS sample #13) with Fe 2 p₃ and Fe 2 p₁ peaks identified are shown in FIG. 65. The Fe 2 p₃ and Fe 2ₚ, peaks of XPS sample #13 are shifted 20 eV; whereas, the maximum known is 14 eV. The presence of iron hydrino hydride was confirmed by Mossbauer spectroscopy run at Northeastern University at liquid nitrogen temperature. The major signals of the spectrum was consistent with the quadrapole doublet of high-spin-iron (III) assigned to Fe₂O₃. In addition, a second compound was observed in the Mossbauer spectrum which produced hyperfine splitting at +0.8 mm/sec, +0.49 mm/sec, 0.35 mm/sec, and −0.78 mm/sec which was assigned to iron hydrino hydride.

As a further example of extreme shifts of transition metal XPS peaks, the Ni 2 p₃ and Ni 2 p, peaks of XPS sample #5 comprised two sets of peaks. The binding energies of the first set was Ni 2 p₃=855.8 eV and Ni 2 p₁=862.3 eV corresponding to NiO and Ni(OH)₂. The binding energies of the second extraordinary set peaks of comparable intensity was Ni 2 p₃=873.4 eV and Ni 2 p₁=880.8 eV. The maximum Ni 2 p₃ shift given is 861 eV corresponding to K₂NiF₆. The corresponding metal hydrino hydride peaks (MHₙ where M is a metal and H is an increased binding energy hydrogen species) observed by TOFSIMS (TOFSIMS sample #6) are given in TABLE 20.

As an example of extreme shifts of halide XPS peaks, the I 3 d₅ and I 3 d₃ peaks of XPS sample #11 comprised two sets of peaks. The binding energies of the first set was I 3 d₅=618.9 eV and I 3 d₃=630.6 eV corresponding to KI. The binding energies of the second extraordinary set peaks was I 3 d₅=644.8 eV and I 3 d₃=655.4 eV. The maximum I 3 d₅ shift given is 624.2 eV corresponding to KIO₄. A general structure for an alkali metal-halide hydrino hydride compound is

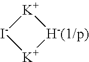

The novel shifted XPS peaks without identifying assignment correspond to and identify hydrino hydride ion-containing compounds according to the present invention.

X-ray diffraction (XRD) was also performed on TOFSIMS sample #3. The corresponding XRD sample was sample #3A. Peaks without identifying assignment were observed as given in TABLE 12.

Fourier transform infrared spectroscopy (FTIR) was performed. TOFSIMS sample #1 corresponds to FTIR sample #1. Peaks assigned to hydrino hydride compounds were observed at 3294, 3077, 2883, 2505, 2450, 1660, 1500, 1456, 1423, 1300, 1154, 1023, 846, 761, and 669 cm⁻¹. TOFSIMS sample #3 corresponds to FTIR sample #4. Peaks assigned to hydrino hydride compounds were observed at 2362 cm⁻¹ and 2336 cm⁻¹.

The hydrino hydride compounds (m/e) assigned as parent peaks or the corresponding fragments (m/e) of the positive Time Of Flight Secondary Ion Mass Spectroscopy (TOFSIMS) of sample #5 taken in the static mode appear in TABLE 18.

TABLE 18
The hydrino hydride compounds (m/e) assigned as parent
peaks or the corresponding fragments (m/e) of the positive
Time Of Flight Secondary Ion Mass Spectroscopy (TOFSIMS)
of sample #5 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| NaH | 24 | 23.99 | 23.997625 | 0.008 |
| NaH₂ | 25 | 25.01 | 25.00545 | 0.004 |
| NaH₃ | 26 | 26.015 | 26.013275 | 0.002 |
| NaH₄ | 27 | 27.02 | 27.0211 | 0.001 |
| Al | 27 | 26.98 | 26.98153 | 0.001 |
| AlH | 28 | 27.98 | 27.989355 | 0.009 |
| AlH₂ | 29 | 29.00 | 28.99718 | 0.003 |
| NaH₅ | 28 | 28.03 | 28.028925 | 0.001 |
| NO₂ | 46 | 45.99 | 45.99289 | 0.003 |
| NaNO | 53 | 52.99 | 52.98778 | 0.002 |
| Fe | 56 | 55.93 | 55.9349 | 0.005 |
| FeH | 57 | 56.94 | 56.942725 | 0.003 |
| FeH₄ | 60 | 59.97 | 59.9662 | 0.004 |
| Na₂O | 62 | 61.97 | 61.97451 | 0.004 |
| Na₂OH | 63 | 62.98 | 62.982335 | 0.002 |
| NaHNaOH | 64 | 63.99 | 63.99016 | 0.0002 |
| NaH₂NaOH | 65 | 64.99 | 64.99785 | 0.008 |
| K₂H₃ | 81 | 80.95 | 80.950895 | 0.001 |
| Na₃O | 85 | 84.96 | 84.96431 | 0.004 |
| Na₃OH | 86 | 85.97 | 85.972135 | 0.002 |
| Na₃OH₂ | 87 | 86.98 | 86.97996 | 0 |
| Na₃OH₃ | 88 | 87.98 | 87.987785 | 0.008 |
| Na₃OH₄ | 89 | 89.00 | 88.99561 | 0.004 |
| KH₃O₃ | 90 | 89.97 | 89.971915 | 0.002 |
| KH₃O₃H | 91 | 90.975 | 90.97974 | 0.005 |
| Na₃O₂H | 102 | 101.97 | 101.967045 | 0.003 |
| Na₃O₂H₂ | 103 | 102.97 | 102.97487 | 0.005 |
| Na₃O₃H | 118 | 117.96 | 117.961955 | 0.002 |
| Na₄O₂H | 125 | 124.955 | 124.956845 | 0.002 |
| Na₃NO₃ | 131 | 130.95 | 130.9572 | 0.007 |
| Na₃NO₃H | 132 | 131.96 | 131.965025 | 0.005 |
| KH₄KHKOH₂ | 140 | 139.94 | 139.940815 | 0.001 |
| KH₅KHKOH₂ | 141 | 140.94 | 140.94864 | 0.009 |
| Na₅O₂H | 148 | 147.95 | 147.946645 | 0.003 |
| Na₅O₃H | 164 | 163.94 | 163.941595 | 0.002 |
| Na₅O₃H₂ | 165 | 164.95 | 164.94938 | 0.001 |
| K₂N₃O₃H₂ | 170 | 169.94 | 169.93701 | 0.003 |
| Na₅N₂O₂H₂ | 177 | 176.955 | 176.95552 | 0.0005 |
| Na₆O₃H | 187 | 186.93 | 186.931355 | 0.001 |
| Na₅N₂O₃H₂ | 193 | 192.95 | 192.95552 | 0.006 |

The major peaks observed in the positive ion spectrum both before and after sputtering were Na⁺, Naₓ(NO₃)_{y}⁺, NaₓO_{y}⁺, and NaₓN_{y}O_{z}⁺. The sodium peak dominated the potassium peak. The count for the positive TOFSIMS spectra for Na (m/e=22.9898) and K(m/e=38.96371) was 3×10⁶ and 3000, respectively. No carbonate principle peaks or fragments were observed. The metals indicated were in trace amounts.

The hydrino hydride compounds (m/e) assigned as parent peaks or the corresponding fragments (m/e) of the negative Time Of Flight Secondary Ion Mass Spectroscopy (TOFSIMS) of sample #5 taken in the static mode appear in TABLE 19.

TABLE 19
The hydrino hydride compounds (m/e) assigned as parent
peaks or the corresponding fragments (m/e) of the negative
Time Of Flight Secondary Ion Mass Spectroscopy (TOFSIMS)
of sample #5 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH₃ | 26 | 26.015 | 26.013275 | 0.002 |
| KH₃ | 42 | 41.99 | 41.987185 | 0.0028 |
| Na₂H₂ | 48 | 48.00 | 47.99525 | 0.005 |
| Na₂H₃ | 49 | 49.00 | 49.003075 | 0.003 |
| K₂ClH₂ | 115 | 114.91 | 114.91192 | 0.002 |
| Silanes/Siloxanes | | | | |
| NaSi | 51 | 50.97 | 50.96673 | 0.003 |
| NaSiH | 52 | 51.97 | 51.974555 | 0.004 |
| NaSiH₂ | 53 | 52.975 | 52.98238 | 0.007 |
| NaSiH₃ | 54 | 53.98 | 53.990205 | 0.010 |
| NaSiH₄ | 55 | 55.00 | 54.99803 | 0.002 |
| NaSiH₆ | 57 | 57.02 | 57.01368 | 0.006 |
| NaSiH₇ | 58 | 58.02 | 58.021505 | 0.002 |
| NaSiH₈ | 59 | 59.02 | 59.02933 | 0.009 |
| KSiH₄ | 71 | 70.97 | 70.97194 | 0.002 |
| KSiH₅ | 72 | 71.975 | 71.979765 | 0.005 |
| KSiH₆ | 73 | 72.99 | 72.98759 | 0.002 |
| Si₃H₉ | 93 | 93.00 | 93.001215 | 0.001 |
| Si₃H₁₇ | 101 | 101.06 | 101.063815 | 0.004 |
| Si₃H₁₈ | 102 | 102.07 | 102.07164 | 0.001 |
| Si₃H₁₇O | 117 | 117.05 | 117.058725 | 0.007 |
| Si₃H₁₇O₂ | 133 | 133.05 | 133.053635 | 0.004 |
| Si₄H₁₅O | 143 | 143.02 | 143.020005 | 0 |
| Si₆H₂₁O | 205 | 205.03 | 205.0208 | 0.009 |

The major peaks observed in the negative ion spectrum both before and after sputtering were a large nitrite peak, the nitrate peak, the halogen peaks, NaₓO_{y}⁻, and NaₓN_{y}O_{z}⁻. No carbonate principle peaks or fragments were observed.

The positive and negative TOFSIMS is consistent with the majority compound and fragments comprising NaNO₂>NaNO₃. The compound was filtered from an initially 0.57 M K₂CO₃ electrolyte. The solubility of NaOH is 42^{0° C.} g/100 cc (10.5 M). The solubility of NaNO₂ is 81.51^{15° C.} g/100 cc (11.8 M), and the solubility of NaNO₃ is 92.1^{25° C.} g/100 cc(10.8M). Whereas, the solubility of K₂CO₃ is 112^{25° C.} g/100 cc(8.1M), and the solubility of KHCO₃ is 22.4^{cold water} g/100 cc (2.2 M) [R. C. Weast, Editor, CRC Handbook of Chemistry and Physics, 58th Edition, CRC Press, (1977), pp., B-143 and B-161]. Thus, NaNO₂ and NaNO₃ as the precipitate is unexpected. The solubility result supports the assignment of bridged hydrino hydride nitrite and nitrate compounds that are less soluble than KHCO₃.

The observation by TOFSIMS that the majority compound and fragments contains NaNO₂>NaNO₃ is further confirmed by the presence of nitrite and nitrate nitrogen in the XPS (XPS sample #4 summarized in TABLE 17). The XPS Na 1 s peak and the N 1 s peak as nitrite (403.2 eV) greater than nitrate (407.0 eV) confirm the majority species as NaNO₂>NaNO₃. The TOFSIMS and XPS results support the assignment of bridged or linear hydrino hydride nitrite and nitrate compounds and bridged or linear hydrino hydride hydroxide and oxide compounds. General structures for the sodium nitrate hydrino hydride compounds are given by substitution of sodium for potassium in the structures given for Eq. (76). General structures for the hydroxide hydrino hydride compounds are

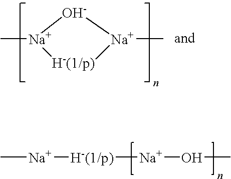

No nitrogen was observed in the XPS of crystals from an identical cell operated at Idaho National Engineering Laboratory for 6 months wherein Na₂CO₃ replaced K₂CO₃. The mass spectrum also showed no peaks other those of air contamination (electrolytic cell mass spectroscopy sample #1). The source of nitrate and nitrite is assigned to a reaction product of atmospheric nitrogen oxide with hydrino hydride compounds. Hydrino hydride compounds were also observed to react with sulfur dioxide from the atmosphere.

Silanes were also observed. The Si₃H₁₇ (m/e=101) peak given in TABLE 19 can be formed by the loss of a silicon atom from the peak M+1 of Si₄H₁₆ (m/e=128). These fragments and similar compounds are shown in the Identification of Hydrino Hydride Compounds by Mass Spectroscopy Section.

Si₄H₁₇(m/e=129)→Si(m/e=28)+S₃H₁₇(m/e=101) (81)

The hydrino hydride compounds (m/e) assigned as parent peaks or the corresponding fragments (m/e) of the positive Time Of Flight Secondary Ion Mass Spectroscopy (TOFSIMS) of sample #6 taken in the static mode appear in TABLE 20.

TABLE 20
The hydrino hydride compounds (m/e) assigned as parent peaks or the
corresponding fragments (m/e) of the positive Time Of Flight
Secondary Ion Mass Spectroscopy (TOFSIMS) of sample #6 taken in
the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH | 24 | 23.99 | 23.997625 | 0.008 |
| KH₂^{a} | 41 | 40.98 | 40.97936 | 0.0006 |
| KOH₂ | 57 | 56.97 | 56.97427 | 0.004 |
| Ni | 58 | 57.93 | 57.9353 | 0.005 |
| NiH | 59 | 58.94 | 58.943125 | 0.003 |
| NiH₄ | 62 | 61.96 | 61.9666 | 0.007 |
| Cu | 63 | 62.93 | 62.9293 | 0.001 |
| CuH | 64 | 63.94 | 63.93777 | 0.002 |
| CuH₂ | 65 | 63.945 | 64.94545 | 0.0005 |
| KCO | 67 | 66.9615 | 66.95862 | 0.002 |
| K₂O | 94 | 93.93 | 93.92233 | 0.008 |
| K₂OH | 95 | 94.93 | 94.930155 | 0.0001 |
| KHKOH | 96 | 95.93 | 95.93798 | 0.008 |
| KHKOH₂ | 97 | 96.945 | 96.945805 | 0.0008 |
| K₂O₂H₃ | 113 | 112.935 | 112.940715 | 0.006 |
| K₃H₄O | 137 | 136.93 | 136.91734 | 0.013 |
| K₂HCO₃ | 139 | 138.92 | 138.919975 | 0 |
| K₂NO₃ | 140 | 139.91 | 139.91522 | 0.005 |
| K₃NOH₂ | 149 | 148.905 | 148.90476 | 0.0002 |
| K₃NOH₃ | 150 | 149.91 | 149.912585 | 0.002 |
| K₃CO₂ | 161 | 160.8893 | 160.881 | 0.008 |
| K₂C₂O₄ | 166 | 165.90 | 165.90706 | 0.007 |
| K₂H₂C₂O₄ | 168 | 167.92 | 167.92271 | 0.002 |
| [K⁺138n]⁺ n = 1 | 177 | 176.8792 | 176.87586 | 0.003 |
| K[K₂CO₃] | | | | |
| K₃C₂NO₂ | 187 | 186.875 | 186.88402 | 0.005 |
| K₃HC₂NO₂ | 188 | 187.885 | 187.891845 | 0.007 |
| K₃C₂O₃ | 189 | 188.87 | 188.87586 | 0.006 |
| K₃NO₄ | 195 | 194.88 | 194.87384 | 0.006 |
| K₃HNO₄ | 196 | 195.89 | 195.881665 | 0.008 |
| K₃H₂NO₄ | 197 | 196.90 | 196.88949 | 0.010 |
| K₃H₃NO₄ | 198 | 197.90 | 197.8973 | 0.003 |
| K₄NO₂H₂ | 204 | 203.86 | 203.86338 | 0.003 |
| K₄NO₂H₃ | 205 | 204.87 | 204.871205 | 0.001 |
| K₄NO₃H₂ | 220 | 219.855 | 219.85829 | 0.003 |
| K₅NOH₂ | 227 | 226.83 | 226.83218 | 0.002 |
| K₄NO₄H | 235 | 234.84 | 234.845375 | 0.005 |
| K₃N₃O₅H₂ | 241 | 240.90 | 240.89054 | 0.0005 |
| K₅NO₂H₂ | 243 | 242.826 | 242.82709 | 0.001 |
| K₅NO₃H₂ | 259 | 258.82 | 258.822 | 0.002 |
| K₅N₂O₃H₂ | 273 | 272.825 | 272.82507 | 0 |
| K₂H(KNO₃)₂ | 281 | 280.83 | 280.838265 | 0.008 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{4.2 \times {10}^{6}}{8.5 \times {10}^{6}} = 49.4 \% , nat . ab . ratio = \frac{6.88}{93.1} = 7.4 \% ) .$

The positive ion spectrum obtained prior to sputtering was dominated by K⁺. The peaks of KOHₓ⁺, KₓO_{y}⁺, and KₓN_{y}O_{z}⁺, were observed. The KₓN_{y}O_{z}⁺≧140 m/z corresponded to [K₂O+n·KNO₃]⁺, [K₂O₂+n·KNO₃]⁺, [K+n·KNO₃]⁺, and [KNO₂+n·KNO₃]⁺. The dominant peaks after sputtering were Kₓ⁺ and KₓO_{y}⁺. The intensity of the nitrate peaks decreased after sputtering. Nickel and nickel hydride peaks were substantial. Copper and copper hydrides indicated were in trace amounts.

The hydrino hydride compounds (m/e) assigned as parent peaks or the corresponding fragments (m/e) of the negative Time Of Flight Secondary Ion Mass Spectroscopy (TOFSIMS) of sample #6 taken in the static mode appear in TABLE 21.

TABLE 21
The hydrino hydride compounds (m/e) assigned as parent
peaks or the corresponding fragments (m/e) of the negative
Time Of Flight Secondary Ion Mass Spectroscopy
(TOFSIMS) of sample #6 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH₃ | 26 | 26.015 | 26.013275 | 0.002 |
| KH₄ | 43 | 43.00 | 42.99501 | 0.005 |
| KC | 52 | 50.96 | 50.96371 | 0.004 |
| KO | 55 | 54.96 | 54.95862 | 0.001 |
| KOH | 56 | 55.97 | 55.966445 | 0.003 |
| NaHNaOH | 64 | 63.99 | 63.99016 | 0 |
| KO₂ | 71 | 70.95 | 70.95353 | 0.003 |
| KO₂H | 72 | 71.96 | 71.961355 | 0.001 |
| K₂H₂ | 80 | 79.942 | 79.94307 | 0.001 |
| KCO₂ | 83 | 82.95 | 82.95353 | 0.003 |
| K₂C | 90 | 89.93 | 89.935245 | 0.005 |
| K₂CH | 91 | 90.94 | 90.94307 | 0.003 |
| K₂OH | 95 | 94.93 | 94.930155 | 0 |
| KHKOH | 96 | 95.93 | 95.93798 | 0.008 |
| K₂OH₃ | 97 | 96.935 | 96.945805 | 0.010 |
| K₂OH₄ | 98 | 97.95 | 97.95363 | 0.004 |
| K₂OH₅ | 99 | 98.96 | 98.961455 | 0.001 |
| KHNO₃ | 102 | 101.95 | 101.959335 | 0.009 |
| KH₂NO₃ | 103 | 102.96 | 102.966716 | 0.007 |
| K₂O₂H | 111 | 110.92 | 110.925065 | 0.005 |
| K₃OH₃ | 136 | 135.91 | 135.909515 | 0.0005 |
| Silanes/Siloxanes | | | | |
| NaSi₃H₁₄ | 121 | 121.03 | 121.03014 | 0.0001 |

The negative ion spectrum prior to sputtering contained strong nitrate peaks (NO₂⁻ and NO₃⁻) and oxygen peaks (O⁻ and OH⁻). Other elements included CₓK_{y}⁻, F⁻, and Cl⁻. KNO₃⁻ and KNO₄⁻ were also observed. Several series of peaks in the spectrum corresponded to [n·KNO₃+KNO₄]⁻, [n·KO₃+NO₂]⁻, and [n·KNO₃+NO₃]⁻. The spectrum after sputtering was dominated by the oxygen peaks and the nitrate peaks. CₓK_{y}⁻; F⁻, and Cl⁻ were observed as well as KNO₃⁻, KNO₄⁻, KN₂O₄⁻, and KN₂O₅⁻. The intensity of the peaks of [n·KNO₃+NO₃]⁻ decreased after sputtering.

Hydrino hydride compounds were also observed by XPS and mass spectroscopy that confirmed the TOFSIMS results. The XPS spectra shown in FIG. 16 and FIG. 17 and the mass spectra shown in FIGS. 25A-25D with the assignments given in TABLE 4 correspond to TOFSIMS sample #5. The XPS spectra shown in FIG. 18 and FIG. 19 and the mass spectra shown in FIG. 24 with the assignments given in TABLE 4 correspond to TOFSIMS sample #6.

The positive and negative TOFSIMS is consistent with the majority compound and fragments comprising KNO₃>KNO₂. The observation by TOFSIMS that the majority compound and fragments contains KNO₃>KNO₂ is further confirmed by the presence of nitrite and nitrate nitrogen in the XPS (XPS sample #5 summarized in TABLE 17). The K 3 p, K 3 s, K 2 p₃, K 2 p₁, and K 2 s XPS peaks and the N is XPS peak as nitrate (406.5 eV) greater than nitrite (402.5 eV) confirm the majority species as KNO₃>KNO₂. The TOFSIMS and —XPS results support the assignment of bridged or linear hydrino hydride nitrite and nitrate compounds and bridged or linear hydrino hydride hydroxide and oxide compounds.

During acidification of the K₂CO₃ electrolyte to prepare sample #6, the pH repetitively increased from 3 to 9 at which time additional-acid was added with carbon dioxide release. The increase in pH (release of base by the titration reactant) was dependent on the temperature and concentration of the solution. A reaction consistent with this observation is the displacement reaction of NO₃⁻ for CO₃²⁻ as given by Eq. (76). The K[K₂CO₃] peak indicates the stability of the bridged potassium carbonate hydrino hydride compound which was also present in the case of TOFSIMS sample #3.

The hydrino hydride compounds (m/e) assigned as parent peaks or the corresponding fragments (m/e) of the positive Time Of Flight Secondary Ion Mass Spectroscopy (TOFSIMS) of sample #8 taken in the static mode appear in TABLE 22.

TABLE 22
The hydrino hydride compounds (m/e) assigned as parent peaks or the
corresponding fragments (m/e) of the positive Time Of Flight
Secondary Ion Mass Spectroscopy (TOFSIMS) of sample #8 taken in
the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH | 24 | 23.99 | 23.997625 | 0.008 |
| NaH₂ | 25 | 25.01 | 25.00545 | 0.004 |
| NaH₃ | 26 | 26.015 | 26.013275 | 0.002 |
| Al | 27 | 26.98 | 26.98153 | 0.001 |
| AlH | 28 | 27.98 | 27.989355 | 0.009 |
| AlH₂ | 29 | 29.00 | 28.99718 | 0.003 |
| KH | 40 | 39.97 | 39.971535 | 0.0015 |
| KH₂^{a} | 41 | 40.98 | 40.97936 | 0.0006 |
| KOH₂ | 57 | 56.97 | 56.97427 | 0.004 |
| KOH₃ | 58 | 57.98 | 57.98202 | 0.002 |
| KOH₄ | 59 | 58.98 | 58.9898992 | 0.010 |
| Cu | 63 | 62.93 | 62.9293 | 0.001 |
| CuH | 64 | 63.94 | 63.937625 | 0.002 |
| CuH₄ | 67 | 66.96 | 66.9611 | 0.001 |
| KHKOH | 96 | 95.93 | 95.93798 | 0.008 |
| KHKOH₂ | 97 | 96.94 | 96.945805 | 0.006 |
| KHKNO₃ | 141 | 140.92 | 140.923045 | 0.003 |
| K₂O₄H₃ | 145 | 144.93 | 144.930535 | 0.0005 |
| K₃O₂H | 150 | 149.89 | 149.8888 | 0.001 |
| K₃O₂H₂ | 151 | 150.8965 | 150.8966 | 0.0001 |
| K₃O₂H₃ | 152 | 151.90 | 151.904425 | 0.004 |
| K₃O₂H₄ | 153 | 152.905 | 152.91225 | 0.007 |
| K₂CO₄H | 155 | 154.90 | 154.914885 | 0.010 |
| K₃C₂O | 157 | 156.88 | 156.88604 | 0.006 |
| K₄H₃ | 159 | 158.87 | 158.8783 | 0.008 |
| K₃H₂CO₂ | 163 | 162.89 | 162.8966 | 0.007 |
| K₄CH | 169 | 168.86 | 168.862665 | 0.002 |
| K₃C₂O₂ | 173 | 172.88 | 172.88095 | 0.001 |
| Silanes/Siloxanes | | | | |
| NaSi₅H₂₂O | 201 | 201.04 | 201.04151 | 0.001 |
| NaSi₅H₂₄O | 203 | 203.06 | 203.05716 | 0.003 |
| NaSi₅H₂₆O | 205 | 205.07 | 205.07281 | 0.003 |
| Si₆H₂₅O | 209 | 209.06 | 209.052 | 0.008 |
| Si₆H₂₇O | 211 | 211.07 | 211.06776 | 0.002 |
| Si₆H₂₈O | 212 | 212.07 | 212.07559 | 0.006 |
| Si₆H₂₉O | 213 | 213.08 | 213.083465 | 0.003 |
| NaSi₆H₂₄ | 215 | 215.05 | 215.03918 | 0.011 |
| NaSi₆H₂₆ | 217 | 217.06 | 217.05483 | 0.005 |
| NaSi₆H₂₈O | 235 | 235.07 | 235.06539 | 0.004 |
| NaSi₆H₃₀O | 237 | 237.08 | 237.08104 | 0.001 |
| NaSi₆H₃₀O₂ | 253 | 253.08 | 253.07595 | 0.004 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{4.3 \times {10}^{6}}{7.7 \times {10}^{6}} = 55.8 \% , nat . ab . ratio = \frac{6.88}{93.1} = 7.4 \% ) .$

The positive ion spectrum was dominated by K⁺, and Na⁺ was also present. Other peaks containing potassium included KC⁺, KₓO_{y}⁺, KₓOH⁺, KCO⁺, K₂⁺, and a series of peaks with an interval of 138 corresponding to K[K₂CO₃]ₙ⁺=(39+138 n).

The hydrino hydride compounds (m/e) assigned as parent peaks or the corresponding fragments (m/e) of the negative Time Of Flight Secondary Ion Mass Spectroscopy (TOFSIMS) of sample #8 taken in the static mode appear in TABLE 23.

TABLE 23
The hydrino hydride compounds (m/e) assigned as parent
peaks or the corresponding fragments (m/e) of the negative
Time Of Flight Secondary Ion Mass Spectroscopy
(TOFSIMS) of sample #8 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH | 24 | 23.99 | 23.997625 | 0.008 |
| NaH₂ | 25 | 25.01 | 25.00545 | 0.004 |
| NaH₃ | 26 | 26.015 | 26.013275 | 0.002 |
| KH₂ | 41 | 40.98 | 40.97936 | 0.0006 |
| KH₃ | 42 | 41.99 | 41.987185 | 0.0028 |
| K₂H₂ | 80 | 79.942 | 79.94307 | 0.001 |
| KHKOH | 96 | 95.94 | 95.93798 | 0.002 |
| KHKOH₂ | 97 | 96.94 | 96.945805 | 0.006 |
| KN₂O₃H | 116 | 115.96 | 115.962405 | 0.002 |
| KN₂O₃H₂ | 117 | 116.97 | 116.97023 | 0.0002 |
| K₂ClH₂ | 115 | 114.91 | 114.91192 | 0.002 |
| K₂ClH₃ | 116 | 115.92 | 115.919745 | 0.000 |
| K₃OH | 134 | 133.89 | 133.893865 | 0.004 |
| K₃OH₂ | 135 | 134.90 | 134.90169 | 0.002 |
| K₃OH₃ | 136 | 135.91 | 135.909515 | 0.0005 |
| K₃O₂H₂ | 151 | 150.89 | 150.8966 | 0.007 |
| K₂N₂O₃H | 155 | 154.92 | 154.926115 | 0.006 |
| K₂O₅H | 159 | 158.91 | 158.909795 | 0.0002 |
| K₂O₅H₃ | 161 | 160.93 | 160.925445 | 0.005 |
| K₃O₄H₂ | 183 | 182.88 | 182.88942 | 0.009 |
| K₄NOH | 187 | 186.855 | 186.860645 | 0.006 |
| K₄NOH₃ | 189 | 188.87 | 188.876295 | 0.006 |
| K₃N₂O₃H₄ | 197 | 196.91 | 196.9133 | 0.003 |
| K₃CO₅H₂ | 211 | 210.88 | 210.88133 | 0.001 |
| K₃CO₅H₄ | 213 | 212.90 | 212.89698 | 0.003 |
| Silanes/Siloxanes | | | | |
| NaSi₅H₂₂O | 201 | 201.04 | 201.04151 | 0.001 |
| Si₆H₁₉O | 203 | 203.005 | 203.005165 | 0.0002 |
| Si₆H₂₁O | 205 | 205.03 | 205.0208 | 0.009 |
| Si₆H₂₈O | 212 | 212.07 | 212.07559 | 0.006 |
| Si₆H₂₉O | 213 | 213.08 | 213.083465 | 0.003 |
| Si₆H₂₃O₂ | 223 | 223.04 | 223.031375 | 0.009 |
| NaSi₅H₁₂O₃ | 223 | 222.96 | 222.95308 | 0.007 |
| NaSi₅H₁₃O₃ | 224 | 223.96 | 223.96095 | 0.001 |
| NaSi₇H₃₁ | 250 | 250.08 | 250.070885 | 0.009 |

The negative ion spectrum was dominated by the oxygen peak. Other significant peaks were OH⁻, HCO₃⁻, and CO₃⁻. The chloride peaks were also present with very small peaks of the other halogens.

The peak NaSi₅H₂₂O (m/e=201) given in TABLE 23 can give rise to the fragments NaSiH₆ (m/e=57) and Si₄H₁₆ (m/e=128). These fragments and similar compounds are shown in the Identification of Hydrino Hydride Compounds by Mass Spectroscopy Section.

NaSi₅H₂₂O(m/e=201)→NaSiH₆(m/e=57)+Si₄H₁₆(m/e=128)+O(m/e=16) (82)

The hydrino hydride compounds (m/e) assigned as parent peaks or the corresponding fragments (m/e) of the positive Time Of Flight Secondary Ion Mass Spectroscopy (TOFSIMS) of sample #9 taken in the static mode appear in TABLE 24.

TABLE 24
The hydrino hydride compounds (m/e) assigned as parent peaks or the
corresponding fragments (m/e) of the positive Time Of Flight
Secondary Ion Mass Spectroscopy (TOFSIMS) of sample #9 taken in
the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.98 | 40.97936 | 0.0006 |
| Na₂H | 47 | 46.99 | 46.987425 | 0.002 |
| Ni | 58 | 57.93 | 57.9353 | 0.005 |
| NiH₄ | 62 | 61.96 | 61.9666 | 0.007 |
| Cu | 63 | 62.93 | 62.9293 | 0.001 |
| Zn | 64 | 62.93 | 62.9291 | 0.001 |
| K₂H | 79 | 78.940 | 78.935245 | 0.004 |
| K₂H₂ | 80 | 79.942 | 79.94307 | 0.001 |
| K₂H₃ | 81 | 80.95 | 80.950895 | 0.001 |
| KH KOH | 96 | 95.93 | 95.93798 | 0.008 |
| KH KOH₂ | 97 | 96.935 | 96.945805 | 0.010 |
| Ag | 107 | 106.90 | 106.90509 | 0.005 |
| K₂ClH₂ | 115 | 114.91 | 114.91192 | 0.002 |
| K₃H₃ | 120 | 119.91 | 119.914605 | 0.005 |
| K₃H₄ | 121 | 120.92 | 120.92243 | 0.002 |
| KIH | 167 | 166.87 | 166.871935 | 0.002 |
| ²⁰⁸PbH | 209 | 208.98 | 208.984425 | 0.004 |
| Silanes/Siloxanes | | | | |
| NaSi₃H₁₀O | 133 | 132.99 | 132.99375 | 0.004 |
| NaSi₃H₁₂O | 135 | 135.00 | 135.0094 | 0.009 |
| Na₂Si₂O₂H₂ | 136 | 135.94 | 135.93893 | 0.001 |
| Na₂Si₂O₂H₃ | 137 | 136.94 | 136.9490 | 0.009 |
| NaSi₄H₁₄ | 149 | 149.01 | 149.00707 | 0.003 |
| Si₅H₁₁ | 151 | 150.97 | 150.970725 | 0.001 |
| Si₆H₁₅O | 199 | 198.97 | 198.973865 | 0.004 |
| Si₆H₂₁O₂ | 221 | 221.02 | 221.015725 | 0.004 |
| NaSi₅H₁₃O₃ | 224 | 223.96 | 223.96095 | 0.001 |
| NaSi₅H₁₄O₃ | 225 | 224.97 | 224.96873 | 0.001 |
| NaSi₆H₂₈O | 235 | 235.06 | 235.06539 | 0.005 |
| NaSi₇H₁₉ | 238 | 237.98 | 237.976985 | 0.003 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{2.4 \times {10}^{6}}{3.6 \times {10}^{6}} = 66.7 \% , nat . ab . ratio = \frac{6.88}{93.1} = 7.4 \% ) .$

The positive ion spectra of TOFSIMS sample # 9 were nearly identical to those of TOFSIMS sample # 10 described below except that the spectra of TOFSIMS sample # 9 had essentially no Fe⁺ peaks.

The hydrino hydride compounds (m/e) assigned as parent peaks or the corresponding fragments (m/e) of the negative Time Of Flight Secondary Ion Mass Spectroscopy (TOFSIMS) of sample #9 taken in the static mode appear in TABLE 25.

TABLE 25
The hydrino hydride compounds (m/e) assigned as parent
peaks or the corresponding fragments (m/e) of the negative
Time Of Flight Secondary Ion Mass Spectroscopy
(TOFSIMS) of sample #9 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| KH₄ | 43 | 43.00 | 42.99501 | 0.005 |
| Na₂H₂ | 48 | 47.99 | 47.99525 | 0.005 |
| Na₂H₃ | 49 | 49.00 | 49.003075 | 0.003 |
| Cu | 63 | 62.93 | 62.9293 | 0.001 |
| NaHKH | 64 | 63.96 | 63.96916 | 0.009 |
| ZnO | 80 | 79.92 | 79.92401 | 0.004 |
| K₂ClH₂ | 115 | 114.91 | 114.91192 | 0.002 |
| HI | 128 | 127.91 | 127.908225 | 0.002 |
| NaIH | 151 | 150.90 | 150.898025 | 0.002 |
| KIH | 167 | 166.88 | 166.871935 | 0.008 |
| ²⁰⁸PbH | 209 | 208.98 | 208.984425 | 0.004 |

The negative ion spectra of TOFSIMS sample # 9 were nearly identical to those of TOFSIMS sample # 10 summarized below.

The hydrino hydride compounds (m/e) assigned as parent peaks or the corresponding fragments (m/e) of the positive Time Of Flight Secondary Ion Mass Spectroscopy (TOFSIMS) of sample #10 taken in the static mode appear in TABLE 26.

TABLE 26
The hydrino hydride compounds (m/e) assigned as parent peaks or the
corresponding fragments (m/e) of the positive Time Of Flight
Secondary Ion Mass Spectroscopy (TOFSIMS) of sample #10 taken
in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.98 | 40.97936 | 0.0006 |
| Na₂H | 47 | 46.99 | 46.987425 | 0.002 |
| Fe | 56 | 55.93 | 55.9349 | 0.005 |
| FeH | 57 | 56.94 | 56.942725 | 0.003 |
| Ni | 58 | 57.93 | 57.9353 | 0.005 |
| NiH₄ | 62 | 61.96 | 61.9666 | 0.007 |
| Cu | 63 | 62.93 | 62.9293 | 0.001 |
| Zn | 64 | 62.93 | 62.9291 | 0.001 |
| K₂H | 79 | 78.940 | 78.935245 | 0.004 |
| K₂H₂ | 80 | 79.942 | 79.94307 | 0.001 |
| K₂H₃ | 81 | 80.95 | 80.950895 | 0.001 |
| KH KOH | 96 | 95.93 | 95.93798 | 0.008 |
| KH KOH₂ | 97 | 96.935 | 96.945805 | 0.010 |
| Ag | 107 | 106.90 | 106.90509 | 0.005 |
| K₂ClH₂ | 115 | 114.91 | 114.91192 | 0.002 |
| K₃H₃ | 120 | 119.91 | 119.914605 | 0.005 |
| K₃H₄ | 121 | 120.92 | 120.92243 | 0.002 |
| KIH | 167 | 166.87 | 166.871935 | 0.002 |
| ²⁰⁸PbH | 209 | 208.98 | 208.984425 | 0.004 |
| Silanes/Siloxanes | | | | |
| NaSi₄H₁₄ | 149 | 149.01 | 149.00707 | 0.003 |
| Si₅H₁₁ | 151 | 150.97 | 150.970725 | 0.001 |
| Si₆H₁₅O | 199 | 198.97 | 198.973865 | 0.004 |
| Si₆H₂₁O₂ | 221 | 221.02 | 221.015725 | 0.004 |
| NaSi₅H₁₃O₃ | 224 | 223.96 | 223.96095 | 0.001 |
| NaSi₅H₁₄O₃ | 225 | 224.97 | 224.96873 | 0.001 |
| NaSi₆H₂₈O | 235 | 235.06 | 235.06539 | 0.005 |
| NaSi₇H₁₉ | 238 | 237.98 | 237.976985 | 0.003 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{2.8 \times {10}^{6}}{4.0 \times {10}^{6}} = 70.0 \% , nat . ab . ratio = \frac{6.88}{93.1} = 7.4 \% ) .$

The positive ion mode spectrum acquired prior to sputter cleaning showed the following relatively intense inorganic ions: Na⁺, K⁺, Fe⁺, Cu⁺, Zn⁺, K₂⁺, Ag⁺, K₂Cl⁺, KI⁺, KNaI⁺, Pb⁺, and K[KI]ₙ⁺. Other inorganic elements included Li, B, and Si. After sputter cleaning Ag⁺ and Pb⁺ were sharply reduced which indicated that silver and lead compounds were present only on the surface. In addition to the result that sample was cryopumped in the cell, this result indicates that the compounds are volatile.

The hydrino hydride compounds (m/e) assigned as parent peaks or the corresponding fragments (m/e) of the negative Time Of Flight Secondary Ion Mass Spectroscopy (TOFSIMS) of sample #10 taken in the static mode appear in TABLE 27.

TABLE 27
The hydrino hydride compounds (m/e) assigned as parent
peaks or the corresponding fragments (m/e) of the negative
Time Of Flight Secondary Ion Mass Spectroscopy
(TOFSIMS) of sample #10 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| KH₄ | 43 | 43.00 | 42.99501 | 0.005 |
| Na₂H₂ | 48 | 47.99 | 47.99525 | 0.005 |
| Na₂H₃ | 49 | 49.00 | 49.003075 | 0.003 |
| Cu | 63 | 62.93 | 62.9293 | 0.001 |
| NaHKH | 64 | 63.96 | 63.96916 | 0.009 |
| ZnO | 80 | 79.92 | 79.92401 | 0.004 |
| K₂ClH₂ | 115 | 114.91 | 114.91192 | 0.002 |
| HI | 128 | 127.91 | 127.908225 | 0.002 |
| NaIH | 151 | 150.90 | 150.898025 | 0.002 |
| KIH | 167 | 166.88 | 166.871935 | 0.008 |
| CuIH | 191 | 190.84 | 190.838025 | 0.002 |
| ²⁰⁸PbH | 209 | 208.98 | 208.984425 | 0.004 |
| Silanes/Siloxanes | | | | |
| Si₇H₂₇O | 239 | 239.05 | 239.044695 | 0.005 |

The negative mode ion spectrum acquired prior to sputter cleaning showed the following relatively intense inorganic ions: O⁻, OH⁻, F⁻, Cl⁻, I⁻, KI⁻, Pb⁻, I₂⁻, NaI₂⁻, CuI₂⁻, PbIₙ⁻, AgI₂⁻, KI₃⁻, CuKI₃⁻, AgKI₃⁻, [NaI₂+(KI)ₙ]⁻, and [I+(KI)ₙ]⁻. Bromide was also observed at relatively low intensity. After sputter cleaning, the spectrum was quite similar except that the silver containing ions were absent.

The hydrino hydride compounds (m/e) assigned as parent peaks or the corresponding fragments (m/e) of the positive Time Of Flight Secondary Ion Mass Spectroscopy (TOFSIMS) of sample #11 taken in the static mode appear in TABLE 28.

TABLE 28
The hydrino hydride compounds (m/e) assigned as parent peaks or the
corresponding fragments (m/e) of the positive Time Of Flight
Secondary Ion Mass Spectroscopy (TOFSIMS) of sample #11 taken
in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH₂ | 25 | 25.00 | 25.00545 | 0.005 |
| KH₂^{a} | 41 | 40.98 | 40.97936 | 0.0006 |
| Na₂H | 47 | 46.99 | 46.987425 | 0.003 |
| ⁶⁹GaOH₂ | 87 | 86.94 | 86.93626 | 0.004 |
| K₂O₂H | 111 | 110.925 | 110.925065 | 0.000 |
| K₂O₂H₂ | 112 | 111.93 | 111.93289 | 0.003 |
| Ga₂NaH₂ | 163 | 162.85 | 162.85685 | 0.007 |
| Ga₂KH₂ | 179 | 178.83 | 178.83076 | 0.000 |
| K(KH)₂K₂SO₃ | 277 | 276.79 | 276.791 | 0.001 |
| K₆O₂H₂ | 268 | 267.78 | 267.78773 | 0.008 |
| K(KH)₃K₂O₂ | 269 | 268.79 | 268.795555 | 0.006 |
| Silanes/Siloxanes | | | | |
| NaSi₇H₁₄O | 249 | 248.93 | 248.93277 | 0.003 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{1.3 \times {10}^{6}}{4 \times {10}^{6}} = 32.5 \% , nat . ab . ratio = \frac{6.88}{93.1} = 7.4 \% ) .$

The hydrino hydride compounds (m/e) assigned as parent peaks or the corresponding fragments (m/e) of the negative Time Of Flight Secondary Ion Mass Spectroscopy (TOFSIMS) of sample #11 taken in the static mode appear in TABLE 29.

TABLE 29
The hydrino hydride compounds (m/e) assigned as parent
peaks or the corresponding fragments (m/e) of the negative
Time Of Flight Secondary Ion Mass Spectroscopy
(TOFSIMS) of sample #11 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| KH₄ | 43 | 43.00 | 42.99501 | 0.005 |
| KH₅ | 44 | 44.00 | 44.002835 | 0.0028 |
| KOH₂ | 57 | 56.98 | 56.97427 | 0.006 |
| KH₂NO₃ | 103 | 102.97 | 102.966716 | 0.003 |
| KH₃SO₂ | 106 | 105.95 | 105.949075 | 0.001 |
| KH₄SO₂ | 107 | 106.96 | 106.9569 | 0.003 |
| K₃H | 118 | 117.90 | 117.898955 | 0.001 |
| K₃H₂ | 119 | 118.91 | 118.90678 | 0.003 |
| K₃O₂H₂ | 151 | 150.89 | 150.8966 | 0.007 |
| K₃O₂H₃ | 152 | 151.905 | 151.904425 | 0.001 |
| KH₃KSO₄ | 177 | 176.91 | 176.902605 | 0.007 |
| Silanes/Siloxanes | | | | |
| KH₂Si₃H₁₂ | 137 | 137.00 | 137.00405 | 0.004 |
| Si₄H₁₁O | 139 | 138.99 | 138.988705 | 0.001 |
| Si₄H₁₃O | 141 | 141.00 | 141.004355 | 0.004 |
| Si₄H₉O₂ | 153 | 152.98 | 152.967965 | 0.012 |
| Si₄H₁₁O₂ | 155 | 154.99 | 154.983615 | 0.006 |
| Si₅H₁₃O | 169 | 168.99 | 168.981285 | 0.009 |
| Si₅H₁₅O | 171 | 171.00 | 170.996935 | 0.003 |
| Si₈H₁₇O₂ | 273 | 272.94 | 272.938285 | 0.002 |
| Si₈H₁₉O₂ | 275 | 274.95 | 274.953935 | 0.004 |
| Si₈H₁₇O₃ | 289 | 288.93 | 288.933195 | 0.003 |
| Si₈H₁₉O₃ | 291 | 290.95 | 290.948845 | 0.001 |

The positive and negative spectra were dominated by ions characteristic of potassium sulfate. This was most evident in the high mass range where several ions increase by 174 m/z do to K₂SO₄. Other species observed were Li⁺, B⁺, Na⁺, Si⁺, Cl⁻, I⁻, PO₂⁻, and PO₃⁻. The hydrino hydride siloxane series SiₙH_{2n+2±1}Oₘ⁻ was observed in the negative spectra.

XRD (Cu Kα₁(λ=1.54059) was also performed on TOFSIMS sample #11. The XRD pattern corresponded to identifiable peaks of K₂SO₄. In addition, the spectrum contained unidentified intense peaks at a 2-theta values of 17.71, 18.49, 32.39, 39.18, 42.18, and 44.29. The novel peaks without identifying assignment correspond to and identify hydrino hydride compounds, according to the present invention.

The hydrino hydride compounds (m/e) assigned as parent peaks or the corresponding fragments (m/e) of the positive Time Of Flight Secondary Ion Mass Spectroscopy (TOFSIMS) of sample #12 taken in the static mode appear in TABLE 30.

TABLE 30
The hydrino hydride compounds (m/e) assigned as parent peaks or the
corresponding fragments (m/e) of the positive Time Of Flight
Secondary Ion Mass Spectroscopy (TOFSIMS) of sample #12 taken
in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH | 24 | 23.99 | 23.997625 | 0.008 |
| NaH₂ | 25 | 25.00 | 25.00545 | 0.005 |
| KH | 40 | 39.97 | 39.971535 | 0.0015 |
| KH₂^{a} | 41 | 40.98 | 40.97936 | 0.0006 |
| Na₂H | 47 | 46.98 | 46.987425 | 0.007 |
| Na₂H₂ | 48 | 47.99 | 47.99525 | 0.005 |
| Ni | 58 | 57.93 | 57.9353 | 0.005 |
| NiH | 59 | 58.94 | 58.943125 | 0.003 |
| NiH₄ | 62 | 61.96 | 61.9666 | 0.007 |
| K₂H | 79 | 78.94 | 78.935245 | 0.004 |
| K₂H₃ | 81 | 80.94 | 80.950895 | 0.011 |
| KH₂NO₂ | 87 | 86.97 | 86.97225 | 0.002 |
| KO₄H | 104 | 103.9479 | 103.951175 | 0.003 |
| KO₄H₂ | 105 | 104.95 | 104.959 | 0.009 |
| K₂O₂H | 111 | 110.925 | 110.925065 | 0.000 |
| K₃H₄ | 121 | 120.93 | 120.92243 | 0.008 |
| (KH)₂KNO₃ | 181 | 180.89 | 180.89458 | 0.005 |
| (KH)₂KNO₄ | 197 | 196.89 | 196.88949 | 0.001 |
| Silanes/Siloxanes | | | | |
| Si₆H₂₃O | 207 | 207.04 | 207.036465 | 0.0035 |
| NaSi₈H₁₈ | 265 | 264.94 | 264.94609 | 0.006 |
| NaSi₈H₂₄ | 271 | 270.99 | 270.99304 | 0.003 |
| NaSi₈H₁₈O | 281 | 280.94 | 280.941 | 0.001 |
| NaSi₈H₃₄ | 281 | 281.07 | 281.07129 | 0.001 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{0.82 \times {10}^{6}}{1.15 \times {10}^{6}} = 71.3 \% , nat . ab . ratio = \frac{6.88}{93.1} = 7.4 \% ) .$

The positive ion spectrum was dominated by K⁺, and Na⁺ was also present. Other peaks containing potassium included KₓH_{y}O_{z}⁺, KₓN_{y}O_{z}⁺, and K_{w}HₓP_{y}O_{z}⁺. Sputter cleaning caused a decrease in the intensity of phosphate peaks while it significantly increased the intensity of KₓH_{y}O_{z}⁺ ions and had resulted in a moderate increase in K_{z}N_{y}O_{z}⁺ ions. Other inorganic elements observed included Li, B, and Si.

The hydrino hydride compounds (m/e) assigned as parent peaks or the corresponding fragments (m/e) of the negative Time Of Flight Secondary Ion Mass Spectroscopy (TOFSIMS) of sample #12 taken in the static mode appear in TABLE 31.

TABLE 31
The hydrino hydride compounds (m/e) assigned as parent
peaks or the corresponding fragments (m/e) of the negative
Time Of Flight Secondary Ion Mass Spectroscopy
(TOFSIMS) of sample #12 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| KH₄ | 43 | 43.00 | 42.99501 | 0.005 |
| Silanes/Siloxanes | | | | |
| Si₄H₁₁O₂ | 155 | 154.99 | 154.983615 | 0.006 |
| Si₆H₁₉O | 203 | 203.00 | 203.005165 | 0.005 |

The negative ion spectra showed similar trends as the positive ion spectra with phosphates observed to be more intense before sputter cleaning. Other ions detected in the negative spectra were Cl⁻, and I⁻.

The hydrino hydride compounds (m/e) assigned as parent peaks or the corresponding fragments (m/e) of the positive Time Of Flight Secondary Ion Mass Spectroscopy (TOFSIMS) of sample #13 taken in the static mode appear in TABLE 32.

TABLE 32
The hydrino hydride compounds (m/e) assigned as parent peaks or the
corresponding fragments (m/e) of the positive Time Of Flight
Secondary Ion Mass Spectroscopy (TOFSIMS) of sample #13 taken
in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.98 | 40.97936 | 0.0006 |
| Al | 27 | 26.98 | 26.98153 | 0.002 |
| AlH | 28 | 27.99 | 27.989355 | 0.001 |
| AlH₂ | 29 | 29.00 | 28.99718 | 0.003 |
| AlH₃ | 30 | 30.01 | 30.005005 | 0.005 |
| Fe | 56 | 55.93 | 55.9349 | 0.005 |
| FeH | 57 | 56.94 | 56.942725 | 0.003 |
| Ni | 58 | 57.93 | 57.9353 | 0.005 |
| FeH₂ | 58 | 57.95 | 57.95055 | 0.000 |
| NiH | 59 | 58.94 | 58.943125 | 0.003 |
| Cu | 63 | 62.93 | 62.9293 | 0.001 |
| CuH | 64 | 63.94 | 63.93777 | 0.002 |
| CuH₂ | 65 | 64.945 | 64.94545 | 0.0005 |
| CuH₃ | 66 | 65.95 | 65.953275 | 0.003 |
| CuH₄ | 67 | 66.96 | 66.9611 | 0.001 |
| CrO | 68 | 67.93 | 67.93541 | 0.005 |
| CrOH₂ | 70 | 69.95 | 69.95106 | 0.001 |
| CrOH₃ | 71 | 70.96 | 70.958885 | 0.001 |
| NiO | 74 | 73.93 | 73.93021 | 0.000 |
| NiOH | 75 | 74.94 | 74.938035 | 0.002 |
| NiOH₂ | 76 | 75.95 | 75.94586 | 0.004 |
| NiOH₃ | 77 | 76.95 | 76.953685 | 0.004 |
| NiOH₄ | 78 | 77.96 | 77.96151 | 0.002 |
| NiOH₅ | 79 | 78.97 | 78.969335 | 0.001 |
| CuOH₃ | 82 | 81.945 | 81.948185 | 0.003 |
| CuOH₄ | 83 | 82.955 | 82.95601 | 0.001 |
| CrO₂H₂ | 86 | 85.945 | 85.94597 | 0.001 |
| ⁶⁹GaOH₂ | 87 | 86.94 | 86.93626 | 0.004 |
| Mo | 92 | 91.90 | 91.9063 | 0.006 |
| MoH | 93 | 92.91 | 92.914125 | 0.004 |
| MoO | 108 | 107.90 | 107.90121 | 0.001 |
| MoOH | 109 | 108.91 | 108.909035 | 0.001 |
| Cr₂O | 120 | 119.87 | 119.87591 | 0.006 |
| Cr₂OH | 121 | 120.88 | 120.883735 | 0.004 |
| Cr₂O₂H | 137 | 136.88 | 136.878645 | 0.001 |
| Cr₂O₂H₂ | 138 | 137.88 | 137.88647 | 0.006 |
| Silanes/Siloxanes | | | | |
| Si | 28 | 27.97 | 27.97693 | 0.007 |
| SiH | 29 | 28.98 | 28.984755 | 0.005 |
| SiOH | 45 | 44.98 | 44.979665 | 0.000 |
| SiOH₂ | 46 | 45.99 | 45.98749 | 0.003 |
| Si₄H₁₆ | 128 | 128.03 | 128.03292 | 0.003 |
| Si₄H₁₇ | 129 | 129.04 | 129.040745 | 0.001 |
| NaSiH₆Si₃H₈ | 149 | 149.01 | 149.00707 | 0.003 |
| Si₆H₁₅0 | 199 | 198.97 | 198.973865 | 0.004 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio\end{matrix}$
$( obs . = \frac{5302}{20041} = 26.5 \% , nat . ab . ratio = \frac{6.88}{93.1} = 7.4 \% ) .$

The positive ion spectrum was dominated by Cr⁺ then Na⁺. Al⁺, Fe⁺, Ni⁺, Cu⁺, Mo⁺, Si⁺, Li⁺, K⁺, and NOₓ⁺ was also present. Weaker observed ions that are not shown in TABLE 32 are MoₓO_{y}H_{z} and CrₓOₓH_{y}. Silane and siloxane fragments were observed which were present at essentially each m/e>150. Some representative silanes and siloxanes are given. Also observed were polydimethylsiloxane ions at m/e=73, 147, 207, 221, and 281. The compounds giving rise to these ions must have been produced in the hydrino hydride reactor or in subsequent reactions between reaction products since the sample was absent of any other source of these compounds. Sputter cleaning caused the silane, siloxane, polydimethylsiloxane, and NOₓ⁺ peaks to disappear.

The hydrino hydride compounds (m/e) assigned as parent peaks or the corresponding fragments (m/e) of the negative Time Of Flight Secondary Ion Mass Spectroscopy (TOFSIMS) of sample #13 taken in the static mode appear in TABLE 33.

TABLE 33
The hydrino hydride compounds (m/e) assigned as parent
peaks or the corresponding fragments (m/e) of the negative Time Of
Flight Secondary Ion Mass Spectroscopy (TOFSIMS) of sample #13 taken
in the static mode.

| | | | | Difference |
|---|---|---|---|---|
| | | | | Between |
| | Nominal | | | Observed |
| | Mass | | | and Calculated |
| | m/e | Observed m/e | Calculated m/e | m/e |
| Hydrino Hydride | | | | |
| Compound | | | | |
| or Fragment | | | | |
| KH₃ | 42 | 41.99 | 41.987185 | 0.0028 |
| KH₄ | 43 | 43.00 | 42.99501 | 0.005 |
| Na₂H₂ | 48 | 48.00 | 47.99525 | 0.005 |
| NaHNaOH | 64 | 64.00 | 63.99016 | 0.001 |
| Na₂OH₄ | 66 | 66.00 | 66.00581 | 0.006 |
| CrO | 68 | 67.93 | 67.93541 | 0.005 |
| CrO₂ | 84 | 83.93 | 83.93032 | 0.000 |
| CrO₂H | 85 | 84.94 | 84.938145 | 0.002 |
| CrO₂H₂ | 86 | 85.94 | 85.94597 | 0.006 |
| FeO₂ | 88 | 87.92 | 87.92472 | 0.005 |
| FeO₂H | 89 | 88.93 | 88.932545 | 0.002 |
| FeO₂H₂ | 90 | 89.94 | 89.94037 | 0.000 |
| KH₄KOH | 99 | 98.95 | 98.961455 | 0.011 |
| CrO₃ | 100 | 99.92 | 99.92523 | 0.005 |
| CrO₃H | 101 | 100.93 | 100.933055 | 0.003 |
| CrO₃H₂ | 102 | 101.935 | 101.94088 | 0.006 |
| MoO₃ | 140 | 139.89 | 139.89103 | 0.001 |
| MoO₃H | 141 | 140.89 | 140.898855 | 0.009 |
| MoO₄H | 157 | 156.89 | 156.88346 | 0.007 |
| CrI₂ | 306 | 305.74 | 305.7413 | 0.000 |
| CuI₂ | 317 | 316.73 | 316.7306 | 0.000 |
| CrI₃ | 433 | 432.64 | 432.6417 | 0.002 |
| FeI₃ | 437 | 436.64 | 436.6361 | 0.004 |
| Silanes/Siloxanes | | | | |
| Si | 28 | 27.97 | 27.97693 | 0.007 |
| SiH | 29 | 28.98 | 28.984755 | 0.005 |
| NaSiH₆ | 57 | 57.02 | 57.01368 | 0.006 |
| NaSiH₇ | 58 | 58.02 | 58.021505 | 0.002 |
| NaSiH₈ | 59 | 59.02 | 59.02933 | 0.009 |
| SiO₂ | 60 | 59.97 | 59.96675 | 0.003 |
| KSiH₆ | 73 | 72.99 | 72.98759 | 0.002 |
| SiO₃ | 76 | 75.96 | 75.96166 | 0.002 |
| SiO₃H | 77 | 76.97 | 76.969485 | 0.001 |
| SiO₃H₂ | 78 | 77.97 | 77.97731 | 0.007 |
| Si₈H₂₅ | 249 | 249.01 | 249.011065 | 0.001 |
| NaSi₇H₁₄O | 249 | 248.93 | 248.93277 | 0.003 |
| NaSi₇H₁₄O(NaSi₂H₆O) | 350 | 349.92 | 349.91829 | 0.002 |
| NaSi₇H₁₄O(NaSi₂H₆O)₂ | 451 | 450.9 | 450.90381 | 0.004 |

The negative mode ion spectrum showed the following inorganic ions: O⁻, OH⁻, F⁻ (trace), NOₓ⁻, S-containing ions (S⁻, SH⁻, SO₄⁻, HSO₄⁻), Cl⁻, I⁻, I₂⁻, and Mo-containing ions (trace) (MoO₃⁻ and HMoO₄⁻). Silane and siloxane fragments were observed which were present at essentially each m/e>150. The siloxane ions with the formula NaSi₇H₁₄O(NaSi₂H₆O)ₙ⁻ n=0 to 2 dominated the high mass range of the negative spectra. A structure for NaSi₇H₁₄O⁻ given in TABLE 33 is

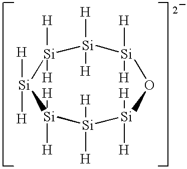

A fragment from sodium silane or siloxane ions given herein may account for the NaSiH₂⁻ peak of the Electrospray-Ionization-Time-Of-Flight-Mass-Spectrum of ESITOFMS sample #2 given in the corresponding section.

A very large KH₃⁺ peak (100,000 counts) was present which confirms that KH₃ is volatile since it was obtained via cryopumping of the reaction products of the gas cell hydrino hydride reactor. This m/e=42 peak confirms the m/e=42 peak observed as a function of ionization potential of the mass spectrometer for a similar gas cell sample as shown in FIG. 62. A different ion of KHₙ, KH₅²⁺ m/e=22, is observed in the case of an electrolytic cell sample as shown in FIG. 63. Both results are described in the Identification of Hydrino Hydride Compounds by Time-Of-Flight-Secondary-Ion-Mass-Spectroscopy (TOFSIMS) Section.

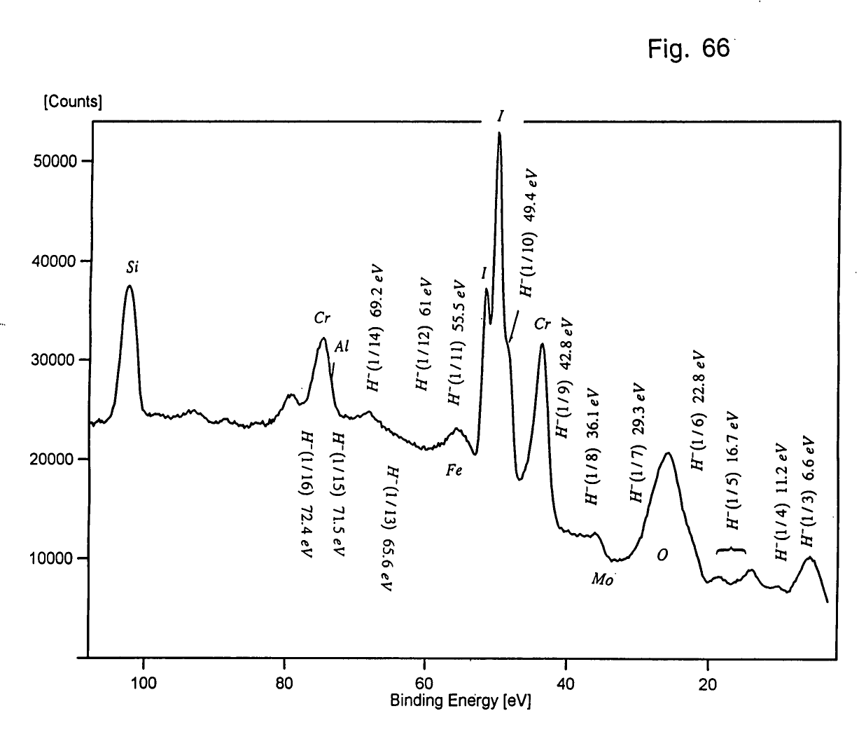

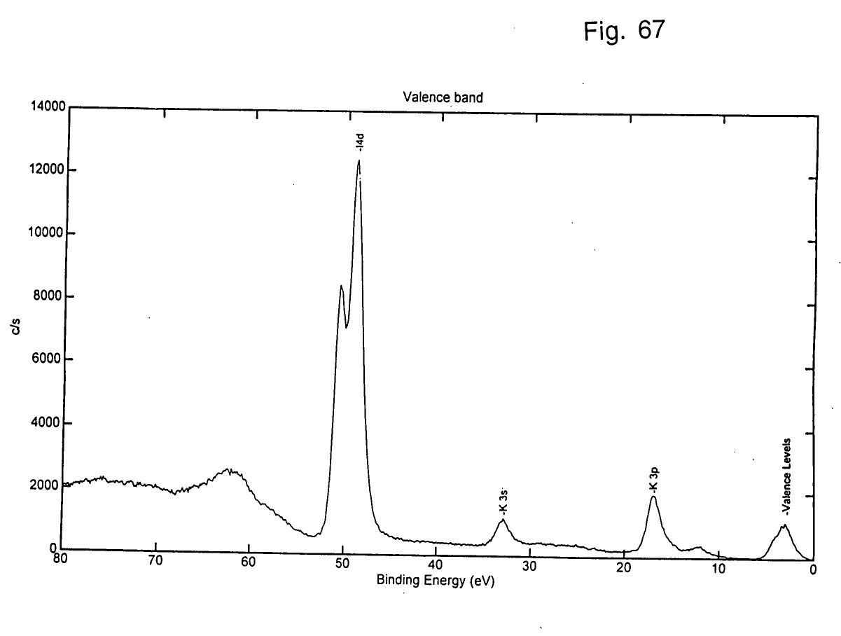

The 0 to 110 eV binding energy region of an X-ray Photoelectron Spectrum (XPS) of TOFSIMS sample #13 (XPS sample #14) is shown in FIG. 66. The 0 eV to 80 eV binding energy region of an X-ray Photoelectron Spectrum (XPS) of KI (XPS sample #15) is shown in FIG. 67. Comparing FIG. 66 to FIG. 67, hydrino hydride ion peaks H⁻(n=1/p) for p=3 to p=16 were observed. The XPS survey spectrum of (XPS sample #14) was consistent with silicon, oxygen, iodine, sulfur, aluminum, and chromium. Small molybdenum, copper, nickel, and iron peaks were also seen. The other elements seen by TOFSIMS were below the detection limit of XPS. No potassium peaks were observed at the XPS detection limit.

The XPS silicon peak confirms the hydrino hydride silane and siloxane compounds observed in the TOFSIMS spectra. XPS further confirms the TOFSIMS spectra that the major components were metal hydrino hydrides such as chromium hydrino hydride. The presence of metal with hydrino hydride and oxide ions indicates that the metal hydrino hydride may become oxidized over time. The observed metals (as metal hydrino hydrides) were cryopumped at a temperature at which these metals alone have no volatility. Furthermore, for each major primary element of the sample, a shoulder or unusual XPS peak of the primary element was found at the binding energy of a hydrino hydride ion as shown in FIG. 66. This may be due to bonding of a hydrino hydride ion to a primary element to form a compounds such as MHZₙ, where M is a metal and n is an integer as given in TABLE 32. As a further example, a shift of the potassium 3 p and oxygen 2 s of XPS sample #7 shown in FIGS. 22 and 64 to the position of the hydrino hydride ion H⁻(1/6) at binding energy (22.8 eV) may be due to the presence of KHKOH which is seen in the TOFSIMS spectrum (TOFSIMS sample #8) shown in FIG. 60. XPS and TOFSIMS confirm the presence of hydrino hydride compounds. The present TOFSIMS data was particularly compelling due the presence of the isotope peaks of the metal hydrino hydrides.

### 13.8 Identification of Hydrino Hydride Compounds by Fourier Transform Infrared (FTIR) Spectroscopy

Infrared spectroscopy measures the vibrational frequencies of the bound atoms or ions of a compound. The technique is based on the fact that bonds and groups of bonds vibrate at characteristic frequencies. When exposed to infrared radiation, a compound selectively absorbs infrared frequencies that match those of allowed vibrational modes. Therefore, the infrared absorption spectrum of a compound reveals which vibrations, and thus which functional groups, are present in the structure. Thus, novel vibrational frequencies that do not match the functional groups of known possible compounds in a sample are signatures for increased binding energy hydrogen compounds.

### 13.8.1 Sample Collection and Preparation

A reaction for preparing hydrino hydride ion-containing compounds is given by Eq. (8). Hydrino atoms which react to form hydrino hydride ions may be produced by an electrolytic cell hydride reactor which was used to prepare crystal samples for FTIR spectroscopy. The hydrino hydride compounds were collected directly or they were purified from solution wherein the K₂CO₃ electrolyte was acidified with HNO₃ before crystals were precipitated on a crystallization dish.

Sample #1. The sample was prepared by concentrating the K₂CO₃ electrolyte from the Thermacore Electrolytic Cell until yellow-white crystals just formed. The XPS (XPS sample #6), XRD spectra (XRD sample #2), TOFSIMS spectra (TOFSIMS sample #1), NMR (NMR sample #1), and ESITOFMS spectra (ESITOFMS sample #2) were also obtained.

Sample #2. A reference comprised 99.999% KHCO₃.

Sample #3. A reference comprised 99.999%. K₂CO₃.

Sample #4. The sample was prepared by 1.) acidifying 400 cc of the K₂CO₃ electrolyte of the Thermacore Electrolytic Cell with HNO₃, 2.) concentrating the acidified solution to a volume of 10 cc, 3.) placing the concentrated solution on a crystallization dish, and 4.) allowing crystals to form slowly upon standing at room temperature. Yellow-white crystals formed on the outer edge of the crystallization dish. XPS (XPS sample #10), mass spectra (mass spectroscopy electrolytic cell samples #5 and #6), XRD spectra (XRD samples #3A and #3B), and TOFSIMS (TOFSIMS sample #3) were also obtained.

Sample #5. A reference comprised 99.999% KVO₃.

### 13.8.2 Fourier Transform Infrared (FTIR) Spectroscopy

Samples were sent to Surface Science Laboratories, Mountain View Calif. for FTIR analysis. A sample of each material was transferred to an infrared transmitting substrate and analyzed by FTIR spectroscopy using a Nicolet Magna 550 FTIR Spectrometer with a NicPlan FTIR microscope. The number of sample scans was 500. The number of background scans was 500. The resolution was 8.000. The sample gain was 4.0. The mirror velocity was 1.8988. The aperture was 150.00.

### 13.8.3 Results and Discussion

The FTIR spectra of potassium bicarbonate (sample #2) and potassium carbonate (sample #3) were compared with that of sample #1. A spectrum of a mixture of the bicarbonate and the carbonate was produced by digitally adding the two reference spectra. The two standards alone and the mixed standards were compared with that of sample #1. From the comparison, it was determined that sample #1 contained potassium carbonate but did not contain potassium bicarbonate. The second component could be a bicarbonate other than potassium bicarbonate. The spectrum of potassium carbonate was digitally subtracted from the spectrum of sample #1. The subtracted spectrum appears in FIG. 68. Several bands were observed including bands in the 1400-1600 cm⁻¹ region. Some organic nitrogen compounds (e.g. acrylamides, pyrrolidinones) have strong bands in the region 1660 cm⁻¹. However, the lack of any detectable C—H bands and the bands in the 700 to 1100 cm⁻¹ region indicate an inorganic material. Peaks assigned hydrino hydride compounds were observed at 3294, 3077, 2883, 1100 cm⁻¹, 2450, 1660, 1500, 1456, 1423, 1300, 1154, 1023, 846, 761, and 669 cm⁻¹. The novel peaks without identifying assignment correspond to and identify hydrino hydride compounds according to the present invention. The FTIR results were confirmed by XPS (XPS sample #6), TOFSIMS (TOFSIMS sample #1), and NMR (NMR sample #1) as described in the corresponding sections.

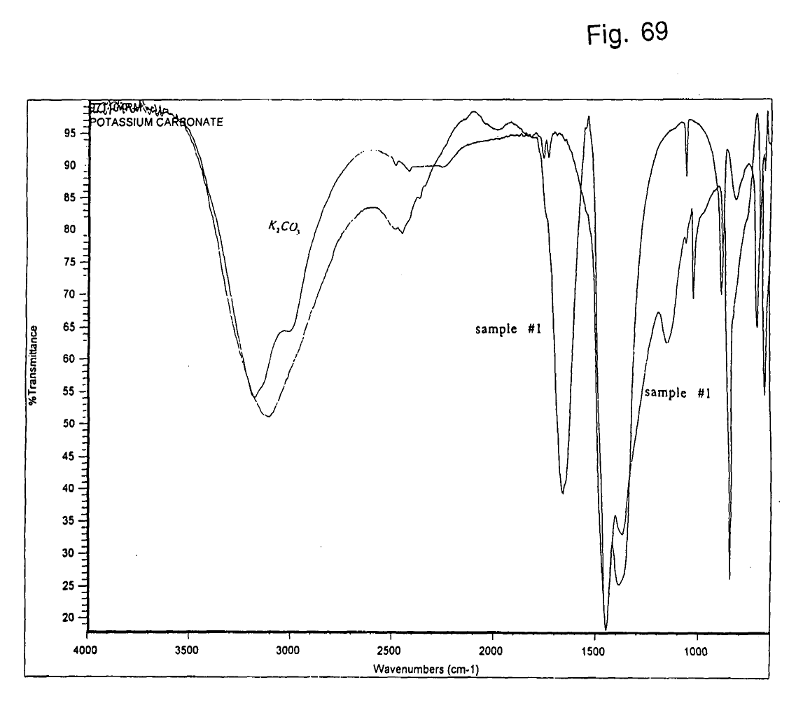

The overlap FTIR spectrum of sample #1 and the FTIR spectrum of the reference potassium carbonate appears in FIG. 69. In the '700 to 2500 cm⁻¹ region, the peaks of sample #1 closely resemble those of potassium carbonate, but they are shifts about 50 cm⁻¹ to lower frequencies. The shifts are similar to those observed by replacing potassium (K₂CO₃) with rubidium (Rb₂CO₃) as demonstrated by comparing their IR spectra [M. H. Brooker, J. B. Bates, Spectrochimica Acata, Vol. 30A, (194), pp. 2211-2220.]. The shifts of sample #1 are assigned to hydrino hydride compounds having the same functional groups as potassium carbonate bound in a bridged structure containing hydrino hydride ion. A structure is

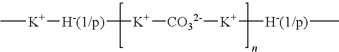

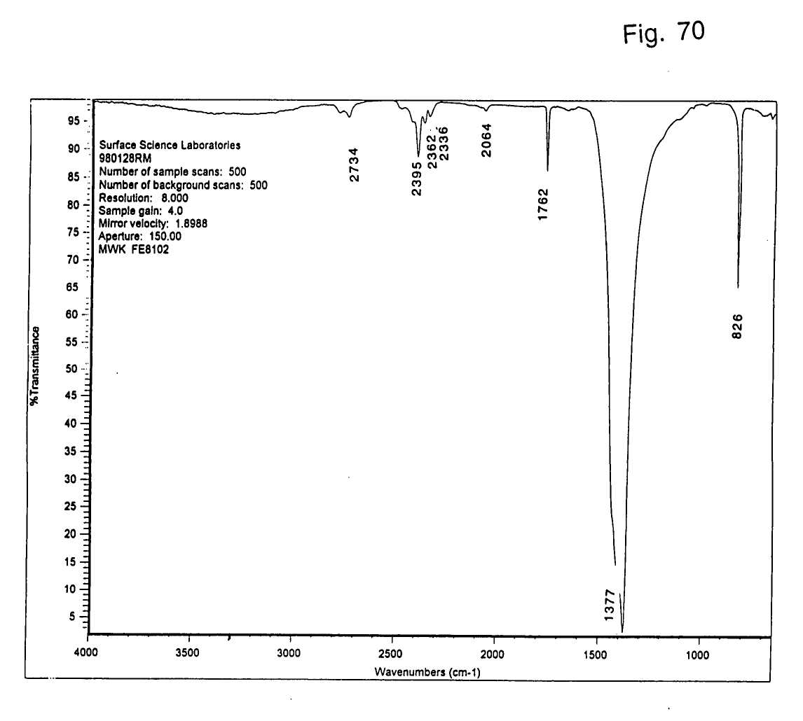

The FTIR spectrum of sample #4 appears in FIG. 70. The frequencies of the infrared bands of KNO₃ appear in TABLE 34 [K. Buijs, C. J. H. Schutte, Spectrochim. Acta, (1962) Vol. 18, pp. 307-313.]. The infrared spectral bands of sample #4 match those of KNO₃ identifying a major component of sample #4 as KNO₃ with two exceptions. Peaks assigned to hydrino hydride compounds were observed at 2362 cm⁻¹ and 2336 cm⁻¹. The novel peaks were confirmed by overlaying the FTIR spectrum of the reference comprising 99.999% KNO₃ (sample #5) with the FTIR spectrum of the sample. #4. The peaks were only present in the FTIR spectrum of sample #4. The novel peaks without identifying assignment correspond to and identify hydrino hydride compounds, according to the present invention. The FTIR results were confirmed by XPS (XPS sample #10), mass spectroscopy (mass spectroscopy electrolytic cell samples #5 and #6), TOFSIMS (TOFSIMS sample #3), and XRD (XRD samples #3A and #3B) as described in the corresponding sections.

TABLE 34
The frequencies of the infrared bands of KNO₃.

| Frequency | |
|---|---|
| (cm⁻¹) | Relative Intensity |
| 715 | vvw. |
| 811 | vvw. |
| 826 | s. sp. |
| 1052 | vvw. sp. |
| 1383 | vvs. |
| 1767 | m. sp. |
| 1873 | vvw. |
| 2066 | w. sp. |
| 2092 | vw. sh. |
| 2151 | vvw. |
| 2404 | m. sp. |
| 2421 | m. sh. |
| 2469 | w. |
| 2740 | w. sp. |
| 2778 | w. sp. |

### 13.9 Identification of Hydrino Hydride Compounds by Raman Spectroscopy

Raman spectroscopy Measures the vibrational frequencies of the bound atoms or ions of a compound. The vibrational frequencies are a function of the bond strength and the mass of the bound species. Since the hydrino and hydrino hydride ion are each equivalent in mass to the hydrogen atom, novel peaks relative to the spectrum of hydrogen bound to the a given species such as nickel are indicative of different bond strengths. A different bond strength can only arise if the binding energy of the electrons of hydrogen species is different from the known binding energies. Thus, these novel vibrational frequencies are signatures for increased binding energy hydrogen compounds.

### 13.9.1 Sample Collection and Preparation

A reaction for preparing hydrino hydride ion-containing compounds is given by Eq. (8). Hydrino atoms which react to form hydrino hydride ions may be produced by a K₂CO₃ electrolytic cell hydride reactor. The cathode was coated with hydrino hydride compounds during operation, and a nickel wire from the cathode was used as the sample for Raman spectroscopy. Controls comprised a control cathode wire from an identical Na₂CO₃ electrolytic cell and a sample of the same nickel wire used in the K₂CO₃ electrolytic cell. An additional sample was obtained from the electrolyte of a K₂CO₃ electrolytic cell.

### 13.9.1.1 Nickel Wire Samples.

Sample #1. Raman spectroscopy was performed on a nickel wire that was removed from the cathode of the K₂CO₃ Thermacore Electrolytic Cell that was rinsed with distilled water and dried.

Sample #2. Raman spectroscopy was performed on a nickel wire that was removed from the cathode of a control Na₂CO₃ electrolytic cell operated by BlackLight Power, Inc. that was rinsed with distilled water and dried. The cell produced no enthalpy of formation of increased binding energy hydrogen compounds during two years of operation and was identical to the cell described in the Crystal Samples from an Electrolytic Cell Section except that Na₂CO₃ replaced K₂CO₃ as the electrolyte.

Sample #3. Raman spectroscopy was performed on the same nickel wire (NI 200 0.0197″, HTN36NOAG1, Al Wire Tech, Inc.) that was used in the electrolytic cells of sample #1 and sample #2.

### 13.9.1.2 Crystal Sample.

Sample #4. The sample was prepared by concentrating 300 cc of the K₂CO₃ electrolyte from the BLP Electrolytic Cell using a rotary evaporator at 50° C. until a precipitate just formed. The volume was about 50 cc. Additional electrolyte was added while heating at 50° C. until the crystals disappeared. Crystals were then grown over three weeks by allowing the saturated solution to stand in a sealed round bottom flask for three weeks at 25-C. The yield was 1 g. XPS (XPS sample #7), TOFSIMS (TOFSIMS sample #8), ³⁹K NMR (39K NMR sample #1), and ESITOFMS (ESITOFMS sample #3) were also performed.

### 13.9.2 Raman Spectroscopy

Experimental and control samples were analyzed blindly by the Environmental Catalysis and Materials Laboratory of Virginia Tech.

Raman spectra were obtained with a Spex 500 M spectrometer coupled with a liquid nitrogen cooled CCD (charge coupled device) detector (Spectrum One, Spex). An Ar⁺ laser (Model 95, Lexel) with the light wavelength of 514.5 nm was used as the excitation source, and a holographic filter (SuperNotch Plus, Kaiser) was employed to effectively reject the elastic scattering from the sample. The spectra were taken at ambient conditions and the samples were placed in capillary glass tubes (0.8-1.1 mm OD, 90 mm length, Kimble) on a capillary sample holder (Model 1492, Spex). Spectra of the powder samples were acquired using the following condition: the laser power at the sample was 10 mW, the slit width of the monochromator was 20 mm which corresponds to a resolution of 3 cm⁻¹, the detector exposure time was 10 s, and 30 scans were averaged. The wires were directly placed on the same sample holder. Since the Raman scattering from the wires were significantly weaker, the acquisition conditions for their spectra were: the laser power at, the sample was 100 mW, the slit width of the monochromator was 50 mm which corresponds to a resolution of 6 cm⁻¹, the detector exposure time was −30 s, and 60 scans were averaged.

### 13.9.3 Results and Discussion

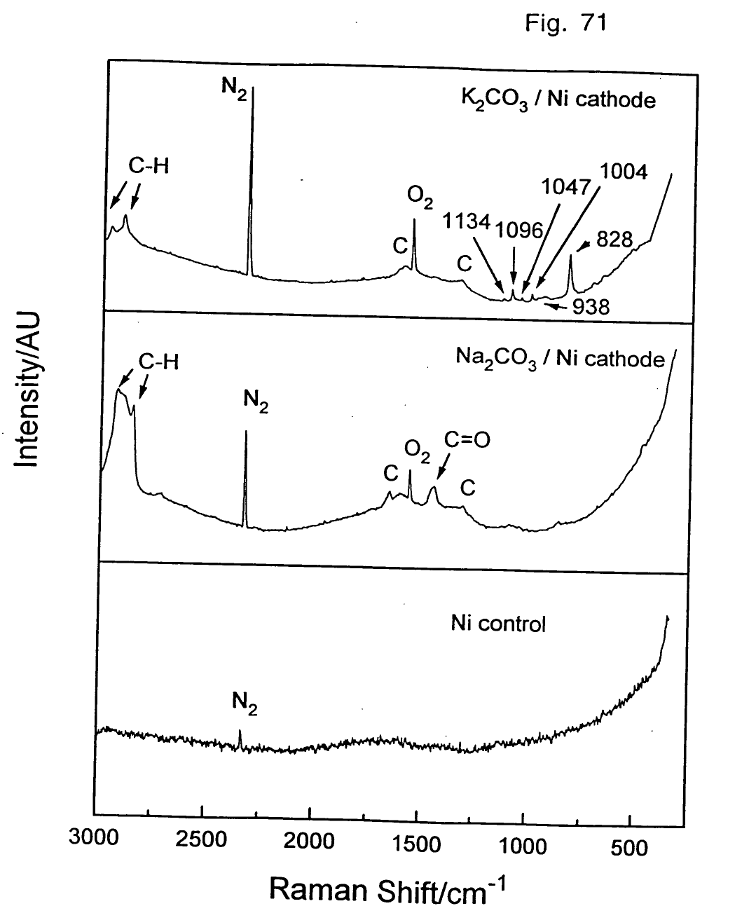

Shown in FIG. 71 The stacked Raman spectrum of 1.) a nickel wire that was removed from the cathode of the K₂CO₃ Thermacore Electrolytic Cell that was rinsed with distilled water and dried, 2.) a nickel wire that was removed from the cathode of a control Na₂CO₃ electrolytic cell operated by BlackLight Power, Inc. that was rinsed with distilled water and dried, and 3.) the same nickel wire (NI 200 0.0197″, HTN36NOAG1, A1 Wire Tech, Inc.) that was used in the electrolytic cells of sample #2 and sample #3. The identifiable peaks of each spectrum are indicated. In addition, sample #1 (cathode of the K₂CO₃ electrolytic cell) contained a number of unidentified peaks at 1134 cm⁻¹, 1096 cm⁻¹, 1047 cm⁻¹, 1004 cm⁻¹, and 828 cm⁻¹. The peaks do not correspond to the known Raman peaks of K₂CO₃ or KHCO₃ [I. a. Gegen, G. A. Newman, Spectrochimica Acta, Vol. 49A, No. 5/6, (1993), pp. 859-887.] which are shown in TABLE 35 and TABLE 36, respectively. The unidentified Raman peaks of the crystals from the cathode of the K₂CO₃ electrolytic cell hydrino hydride reactor are in the region of bridged and terminal metal-hydrogen bonds. The novel peaks without identifying assignment correspond to and identify hydrino hydride compounds, according to the present invention.

TABLE 35
The frequencies of the Raman bands of K₂CO₃.

| Frequency | |
|---|---|
| (cm⁻¹) | Relative Intensity |
| 132 | m |
| 182 | m |
| 235 | w |
| 675 | vw |
| 700 | vw |
| 1059 | s |
| 1372 | vw |
| 1420 | vw |
| 1438 | vw |

TABLE 36
The frequencies of the Raman bands of KHCO₃.

| Frequency | |
|---|---|
| (cm⁻¹) | Relative Intensity |
| 79 | s |
| 106 | s |
| 137 | m |
| 183 | m |
| 635 | m |
| 675 | m |
| 1028 | s |
| 1278 | m, b |

In addition to Raman spectroscopy, X-ray diffraction (XRD), calorimetry, and gas chromatography experiments were performed as given in the corresponding sections. The corresponding XRD sample was sample #1. The 2-theta and d-spacings of the unidentified XRD peaks of the crystals from the cathode of the K₂CO₃ electrolytic cell hydrino hydride reactor (XRD sample #1A) are given in TABLE 5 and FIG. 50. The results of the measurement of the enthalpy of the decomposition reaction of hydrino hydride compounds measured with the adiabatic calorimeter are shown in FIG. 43 and TABLE 8. The results indicate that the decomposition reaction of hydrino hydride compounds is very exothermic. In the best case, the enthalpy was 1 MJ released over 30 minutes. The gas chromatographic analysis (60 meter column) of high purity hydrogen is shown in FIG. 45. The results of the gas chromatographic analysis of the heated nickel wire cathode of the K₂CO₃ cell appear in FIG. 46. The results indicate that a new form of hydrogen molecule was detected based on the presence of peaks with migration times comparable but distinctly different from those of the normal hydrogen peaks.

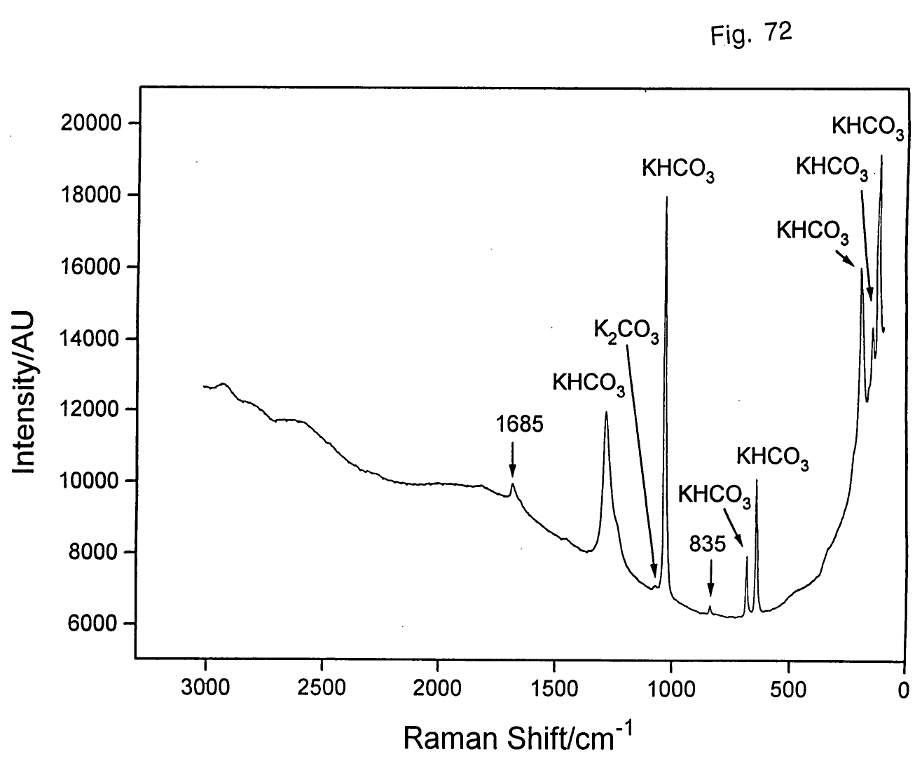

The Raman spectrum of sample #4 appears in FIG. 72. In addition to the known peaks of KHCO₃ and a small peak assignable to K₂CO₃, unidentified peaks at 1685 cm⁻¹ and 835 cm⁻¹ are present. The unidentified Raman peak at 1685 cm⁻¹ is in the region of N—H bonds. FTIR sample #1 also contains unidentified bands in the 1400-1600 cm⁻¹ region. Raman sample #4 and FTIR sample #1 do not contain N—H bonds by XPS studies. The N 1 s XPS peak of the former is at 393.6 eV and the N 1 s XPS peak of the later is a very broad peak at about 390 eV. Whereas, the N 1 s XPS peak of compounds containing an N—H bond is seen at about 399 eV, and the lowest energy N is XPS peak for any known compound is about 397 eV.

The 835 cm⁻¹ peak of Raman sample #4 is in the region of bridged and terminal metal-hydrogen bonds which are also indicated in Raman sample #1. The novel peaks without identifying assignment correspond to and identify hydrino hydride compounds, according to the present invention.

### 13.10 Identification of Hydrino Hydride Compounds by Proton Nuclear Magnetic Resonance (NMR) Spectroscopy

NMR can distinguish whether a proton of a compound is present as a proton, H₃, a hydrogen atom, or a hydride ion. In the later case, NMR can further determine whether the hydride ion is a hydrino hydride ion and can determine the fractional quantum state of the hydrino hydride ion. The proton gyromagnetic ratio γₚ/2π is

γₚ/2π=42.57602 MHz T⁻¹ (83)

The NMR frequency f is the product of the proton gyromagnetic ratio given by Eq. (83) and the magnetic flux B.

f=γₚ/2πB=42.57602 MHz T⁻¹B (84)

A typical flux for a superconducting NMR magnet is 6.357 T. According to Eq. (84) this corresponds to a radio frequency (RF) of 270.6557591 MHz. With a constant magnetic field, the frequency is scanned to yield the spectrum. Or, in an example of a common type of NMR spectrometer, the radiofrequency is held constant at 270.6196 MHz, the applied magnetic field

$${H}_{0} ( {H}_{0} = \frac{B}{{μ}_{0}} )$$

is varied over a small range, and the frequency of energy absorption is recorded at the various valves for H₀. Or, the field is varied with an RF pulse. The spectrum is typically scanned and displayed as a function of increasing H₀. The protons that absorb energy at a lower H₀ give rise to a downfield absorption peak; whereas, the protons that absorb energy at a higher H₀ give rise to an upfield absorption peak. The electrons of the compound of a sample influence the field at the nucleus such that it deviates slightly from the applied value. For the case that the chemical environment has no NMR effect, the value of H₀ at resonance with the radiofrequency held constant at 270.6196 MHz is

$$\frac{2 π f}{{μ}_{0} {γ}_{p}} = \frac{( 2 π ) ( 270.6196 MHz )}{{μ}_{0} 42.57602 MHz {T}^{- 1}} = {H}_{0} \qquad ( 85 )$$

In the case that the chemical environment has a NMR effect, a different value of H₀ is required for resonance. This chemical shift is proportional to the electronic magnetic flux change at the nucleus due to the applied field which in the case of each hydrino hydride ion is a function of its radius. The change in the magnetic moment, Δm, of each electron of the hydride ion due to an applied magnetic flux B is [Purcell, E., Electricity and Magnetism; McGraw-Hill, New York, (1965), pp. 370-389.]

$$Δ m = \frac{{e}^{2} {r}_{1}^{2} B}{4 {m}_{e}} \qquad ( 86 )$$

The change in magnetic flux ΔB at the nucleus due to the change in magnetic moment, Δm, of each electron follows from Eq. (1.100) of Mills [Mills, R., The Grand Unified Theory of Classical Quantum Mechanics, September 1996 Edition (“'96 Mills GULT”)].

$$Δ B = {μ}_{0} \frac{Δ m}{{r}_{n}^{3}} ( {i}_{r} cos θ - {i}_{θ} sin θ ) for r < {r}_{n} \qquad ( 87 )$$

where μ₀ is the permeability of vacuum. It follows from Eqs. (86-87) that the diamagnetic flux (flux opposite to the applied field) at the nucleus is inversely proportional to the radius. For resonance to occur, ΔH₀, the change in applied field from that given by Eq. (85), must compensate by an equal and opposite amount as the field due to the electrons of the hydrino hydride ion. According to Eq. (21), the ratio of the radius of the hydrino hydride ion H⁻(1/p) to that of the hydride ion H⁻(1/1) is the reciprocal of an integer. It follows from Eqs. (85-87) that compared to a proton with a no chemical shift, the ratio of ΔH₀ for resonance of the proton of the hydrino hydride ion H⁻(1/p) to that of the hydride ion H⁻(1/1) is a positive integer (i.e. the absorption peak of the hydrino hydride ion occurs at a valve of ΔH₀ that is a multiple of p times the value of ΔH₀ that is resonant for the hydride ion compared to that of a proton with no shift where p is an integer). However, hydride ions are not present as independent ions in condensed matter. Hydrino hydride ions form neutral compounds with alkali and other cations which contribute a significant downfield NMR shift to give an NMR signal in a range detectable by an ordinary proton NMR spectrometer. In addition, ordinary hydrogen may have an extraordinary chemical shift due to the presence of one or more increased binding energy hydrogen species of a compound comprising ordinary and increased binding energy hydrogen species. Thus, the possibility of using proton NMR was explored to identify hydrino hydride ions and increased binding energy hydrogen compounds by their novel chemical shifts.

### 13.10.1 Sample Collection and Preparation

A reaction for preparing hydrino hydride ion-containing compounds is given by Eq. (8). Hydrino atoms which react to form hydrino hydride ions may be produced by an electrolytic cell hydride reactor which was used to prepare crystal samples for NMR spectroscopy.

Sample #1. The sample was prepared by concentrating the K₂CO₃ electrolyte from the Thermacore Electrolytic Cell until yellow-white crystals just formed. XPS (XPS sample #6), XRD spectra (XRD sample #2), TOFSIMS (TOFSIMS sample #1), FTIR spectrum (FTIR sample #1), and ESITOFMS spectra (ESITOFMS sample #2) were also obtained.

Sample #2. A reference comprised 99.999% K₂CO₃.

Sample #3. A reference comprised 99% KHCO₃.

### 13.10.2 Proton Nuclear Magnetic Resonance (NMR) Spectroscopy

Samples were sent to Spectral Data Services, Champaign, Ill.

Magic-angle solid proton NMR was performed. The data were obtained on a custom built spectrometer operating with a Nicolet 1280 computer. Final pulse generation was from a tuned Henry radio amplifier. The ¹H NMR frequency was 270.6196 MHz. A 2 μsec pulse corresponding to a 15° pulse length and a 3 second recycle delay were used. The window was ±31 kHz. The spin speed was 4.5 kHz. The number of scans was 1000. Chemical shifts were referenced to external TMS. The offset was 1527.12 Hz. The magnetic flux was 6.357 T.

### 13.10.3 Results and Discussion

The NMR spectra of sample #1 is shown in FIG. 73. The peak assignments are given in TABLE 37. The NMR spectrum of the K₂CO₃ reference, sample #2, was extremely weak. It contained a water peak at 1.208 ppm, a peak at 5.604 ppm, and very broad weak peaks at 13.2 ppm, and 16.3 ppm. The NMR spectrum of the KHCO₃ reference, sample #3, contained a large peak at 4.745 with a small shoulder at 5.150 ppm, a broad peak at 13.203 ppm, and small peak at 1.2 ppm.

The hydrino hydride compound peaks shown in FIG. 73 and assigned in TABLE 37 were not present in the control. The NMR spectrum was observed to be reproducible, and the hydrino hydride compound peaks were observed to be present in the NMR spectra of a samples prepared from the K₂CO₃ cell by different methods (e.g. TOFSIMS sample #3). The peaks could not be assigned to hydrocarbons. Hydrocarbons were not present in sample #1 based on the TOFSIMS spectrum (TOFSIMS sample #1) and the FTIR spectrum (FTIR sample #1). The novel peaks without identifying assignment correspond to and identify hydrino hydride compounds, according to the present invention. The assignment of hydrino hydride compounds was confirmed by XPS (XPS sample #6), XRD spectra (XRD sample #2), TOFSIMS (TOFSIMS sample #1), FTIR spectrum (FTIR sample #1), and ESITOFMS spectra (ESITOFMS sample #2) described in the corresponding sections.

TABLE 37
The NMR peaks of sample #1 with their assignments.

| Peak | Shift | |
|---|---|---|
| Number | (ppm) | Assignment |
| 1 | +34.54 | side band of peak 3 |
| 2 | +22.27 | side band of peak 7 |
| 3 | +17.163 | hydrino hydride |
| | | compound |
| 4 | +10.91 | hydrino hydride |
| | | compound |
| 5 | +8.456 | hydrino hydride |
| | | compound |
| 6 | +7.50 | hydrino hydride |
| | | compound |
| 7 | +5.066 | H₂O |
| 8 | +1.830 | hydrino hydride |
| | | compound |
| 9 | −0.59 | side band of peak 3 |
| 10 | −12.05 | hydrino hydride |
| | | compound^{a} |
| 11 | −15.45 | hydrino hydride |
| | | compound |

^{a}small shoulder is observed on peak 10 which is the side band of peak 7

### 13.11 Identification of Hydrino Hydride Compounds by Electrospray-Ionization-Time-Of-Flight-Mass-Spectroscopy (ESITOFMS)

Electrospray-Ionization-Time-Of-Flight-Mass-Spectroscopy (ESITOFMS) is a method to determine the mass spectrum over a large dynamic range of mass to charge ratios (e.g. m/e=1-600) with extremely high precision (e.g. ±0.005 amu). Essentially the M+1 peak of each compound is observed without fragmentation. The analyte is dissolved in a carrier solution. The solution is pumped into and ionized in an electrospray chamber. The ions are accelerated by a pulsed voltage, and the mass of each ion is then determined with a high resolution time-of-flight analyzer.

### 13.11.1 Sample Collection and Preparation

A reaction for preparing hydrino hydride ion-containing compounds is given by Eq. (8). Hydrino atoms which react to form hydrino hydride ions may be produced by a gas cell hydride reactor which was used to prepare crystal samples for ESITOFMS. The hydrino hydride compounds were collected directly following cryopumping from the reaction chamber.

Sample #1. The sample was prepared by collecting a dark colored band of crystals from the top of the gas cell hydrino hydride reactor comprising a KI catalyst, stainless steel filament leads, and a W filament that were cryopumped there during operation of the cell. XPS was also performed at Lehigh University.

Sample #2. The sample was prepared by concentrating the K₂CO₃ w electrolyte from the Thermacore Electrolytic Cell until yellow-white crystals just formed. XPS was also obtained at Lehigh University by mounting the sample on a polyethylene support. In addition to ESITOFMS, XPS (XPS sample #6), XRD (XRD sample #2), TOFSIMS (TOFSIMS sample #1), FTIR (FTIR sample #1), and NMR (NMR sample #1), were also performed as described in the respective sections.

Sample #3. The sample was prepared by concentrating 300 cc of the K₂CO₃ electrolyte from the BLP Electrolytic Cell using a rotary evaporator at 50° C. until a precipitate just formed. The volume was about 50 cc. Additional electrolyte was added while heating at 50° C. until the crystals disappeared. Crystals were then grown over three weeks by allowing the saturated solution to stand in a sealed round bottom flask for three weeks at 25° C. The yield was 1 g. In addition to ESITOFMS, XPS (XPS sample #7), TOFSIMS (TOFSIMS sample #8), ³⁹K NMR (³⁹K NMR sample #1), and Raman spectroscopy (Raman sample #4) were also performed.

Sample #4. The sample was prepared by collecting a red/orange band of crystals that were cryopumped to the top of the gas cell hydrino hydride reactor at about 100° C. comprising a. KI catalyst and a nickel fiber mat dissociator that was heated to 800° C. by external Mellen heaters. The TOFSIMS spectrum (TOFSIMS sample #9) was also obtained as given in the TOFSIMS section.

Sample #5. The sample was prepared by collecting a yellow band of crystals that were cryopumped to the top of the gas cell hydrino hydride reactor at about 120° C. comprising a KI catalyst and a nickel fiber mat dissociator that was heated to 800° C. by external Mellen heaters. The TOFSIMS spectrum (TOFSIMS sample #10) was also obtained as given in the TOFSIMS section.

Sample #6. A reference comprised 99% K₂CO₃.

Sample #7. A reference comprised 99.99% KI.

### 13.11.2 Electrospray-Ionization-Time-Of-Flight-Mass-Spectroscopy (ESITOFMS)

Samples were sent to Perseptive Biosystems (Framingham, Mass.) for ESITOFMS analysis. The data was obtained on a Mariner ESI TOF system fitted with a standard electrospray interface. The samples were submitted via a loop injection system with a 5 μl loop at a flow rate of 20 μl/min. The solvent was water:acetonitrile (50:50) with 1% acetic acid. Mass spectra are plotted as the number of ions detected (Y-axis) versus the mass-to-charge ratio of the ions (X-axis).

### 13.13.3 Results and Discussion

In the case that an M+2 peak was assigned as a potassium hydrino hydride compound in TABLES 38-41, the intensity of the M+2 peak significantly exceeded the intensity predicted for the corresponding ⁴¹K peak, and the mass was correct. For example, the intensity of the peak assigned to KHKOH₂ was at least twice that predicted for the intensity of the ⁴¹K peak corresponding to K₂OH. In the case of ³⁹KH₂⁺, the ⁴¹K peak was not present and peaks corresponding to a metastable neutral were observed m/e=42.14 and m/e=42.23 which may account for the missing ions indicating that the ⁴¹K species (⁴¹KH₂⁺) was a neutral metastable. A more likely alternative explanation is that ³⁹K and ⁴¹K undergo exchange, and for certain hydrino hydride compounds, the bond energy of the ³⁹K hydrino hydride compound exceeds that of the ⁴¹K compound by substantially more than the thermal energy due to the larger nuclear magnetic moment of ³⁹K. The selectivity of hydrino atoms and hydride ions to form bonds with specific isotopes based on a differential in bond energy provides the explanation of the experimental observation of the presence of ³⁹ KH₂⁺ in the absence of ⁴¹KH₂⁺ in the TOFSIMS spectra presented and discussed in the corresponding section. Taken together ESITOFMS and TOFSIMS confirm the isotope selective bonding of increased binding energy hydrogen compounds.

The hydrino hydride compounds (m/e) assigned as parent peaks or the corresponding fragments (m/e) of the positive Electrospray-Ionization-Time-Of-Flight-Mass-Spectroscopy (ESITOFMS) of sample #1 appear in TABLE 38.

TABLE 38
The hydrino hydride compounds (m/e) assigned as parent
peaks or the corresponding fragments (m/e) of the positive
Electrospray-Ionization-Time-Of-Flight-Mass-Spectroscopy
(ESITOFMS) of sample #1.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| Si₄H₁₁O₂ | 155 | 154.985 | 154.983615 | 0.0014 |
| Si₄H₁₅O₂ | 159 | 159.0024 | 159.014915 | 0.0125 |
| NaSi₅H₂₃O | 202 | 202.0657 | 202.049335 | 0.016 |
| NaSi₅H₂₆O | 205 | 205.0713 | 205.07281 | 0.001 |
| Si₆H₂₇O | 211 | 211.0591 | 211.06776 | 0.0087 |
| Si₇H₂₅ | 221 | 221.0480 | 221.034135 | 0.014 |
| NaSi₈H₃₄ | 281 | 281.0676 | 281.07129 | 0.0037 |
| Si₉H₄₁ | 293 | 293.1152 | 293.113195 | 0.002 |

Silanes were observed. The S₉H₄₁ (m/e=293) peak given in TABLE 38 which is an M+1 peak can fragment to SiH₈ and S₈H₃₂ (m/e=256).

Si₉H₄₀(m/e=292)→SiH₈(m/e=36)+Si₈H₃₂(m/e=256) (88)

A large m/e=36 peak was observed in the quadrapole mass spectrum. The peak is assigned to SiH₈. Dihydrino peaks were observed in the XPS at 139.5 eV, corresponding to

$${H}_{2}^{*} [ n = \frac{1}{3} ; 2 {c}^{′} = \frac{\sqrt{2} {a}_{o}}{3} ]$$

139.5 eV and at 63 eV corresponding to

$${H}_{2}^{*} [ n = \frac{1}{2} ; 2 {c}^{′} = \frac{\sqrt{2} {a}_{o}}{2} ]$$

Silicon peaks were also observed. The dihydrino peaks are assigned to SiH₈ (e.g.

$${Si ( {H}_{2}^{*} [ n = \frac{1}{3} ; 2 {c}^{′} = \frac{\sqrt{2} {a}_{0}}{3} ] )}_{4} \text{).}$$

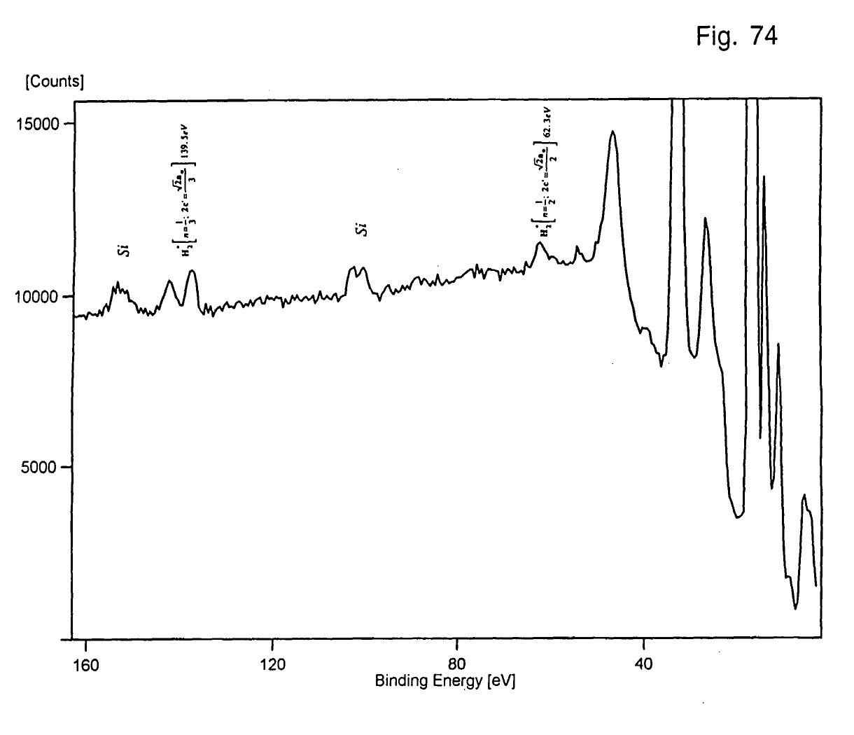

SiH₈ was also observed in the case of XPS sample #12. The 0-160 eV binding energy region of a survey X-ray Photoelectron Spectrum (XPS) of sample #12 with the primary elements and dihydrino peaks identified is shown in FIG. 74. The possibility of Pb or Zn as the source of the 139.5 eV peak was eliminated by TOFSIMS. No lead or zinc peaks were observed at the TOFSIMS detection limit which is orders of magnitude that of XPS. A NaSi₂H₁₄ (m/e=93) peak was observed in the TOFSIMS. This peak can give rise to the fragments NaSiH₆ (m/e=57) and SiH₈ (m/e=36). These fragments and similar compounds are shown in the Identification of Hydrino Hydride Compounds by Mass Spectroscopy Section.

NaS₂H₁₄(m/e=93)→NaSiH₆(m/e=57)+SiH₈(m/e=36) (89)

The hydrino hydride compounds (m/e) assigned as parent peaks or the corresponding fragments (m/e) of the positive Electrospray-Ionization-Time-Of-Flight-Mass-Spectroscopy (ESITOFMS) of sample #2 appear in TABLE 39.

TABLE 39
The hydrino hydride compounds (m/e) assigned as parent peaks or the
corresponding fragments (m/e) of the positive Electrospray-
Ionization-Time-Of-Flight-Mass-Spectroscopy (ESITOFMS)
of sample #2.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.9747 | 40.97936 | 0.005 |
| K₂OH | 95 | 94.9470 | 94.930155 | 0.017 |
| KHKOH₂ | 97 | 96.9458 | 96.945805 | 0.000 |
| KH KHCO₃ | 140 | 139.9307 | 139.9278 | 0.003 |
| Silanes/Siloxanes | | | | |
| NaSiH₆ | 57 | 56.9944 | 57.01368 | 0.019 |
| Na₂SiH₆ | 80 | 80.0087 | 80.00348 | 0.005 |
| Si₅H₁₁ | 151 | 150.9658 | 150.970725 | 0.005 |
| Si₅H₉O | 165 | 164.9414 | 164.949985 | 0.009 |
| NaSi₇H₁₂O | 247 | 246.8929 | 246.91712 | 0.024 |
| Si₉H₁₉O₂ | 303 | 302.9068 | 302.930865 | 0.024 |
| Si₁₂H₃₆O₁₂ | 564 | 563.9549 | 563.94378 | 0.011 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio \\ ( obs . = 25 \% , nat . ab . ratio = \frac{6.88}{93.1} = 7.4 \% ) .\end{matrix}$

The hydrino hydride compounds (m/e) assigned as parent peaks or the corresponding fragments (m/e) of the negative Electrospray-Ionization-Time-Of-Flight-Mass-Spectroscopy (ESITOFMS) of sample #2 appear in TABLE 40.

TABLE 40
The hydrino hydride compounds (m/e) assigned as parent
peaks or the corresponding fragments (m/e) of the negative
Electrospray-Ionization-Time-Of-Flight-Mass-Spectroscopy
(ESITOFMS) of sample #2.

| | | | | Difference |
|---|---|---|---|---|
| Hydrino Hydride | | | | Between |
| Compound | Nominal | | | Observed |
| or Fragment | Mass | Observed | Calculated | and Calculated |
| Silanes/Siloxanes | m/e | m/e | m/e | m/e |
| NaSiH₂ | 53 | 52.9800 | 52.98238 | 0.002 |

The results for the positive and negative Electrospray-Ionization-Time-Of-Flight-Mass-Spectroscopy (ESITOFMS) sample #2 that appear in TABLES 39 and 40 were representative of the results obtained for sample #3.

The hydrino hydride compounds (m/e) assigned as parent peaks or to, the corresponding fragments (m/e) of the positive Electrospray-Ionization-Time-Of-Flight-Mass-Spectroscopy (ESITOFMS) of sample #4 appear in TABLE 41.

TABLE 41
The hydrino hydride compounds (m/e) assigned as parent peaks or the
corresponding fragments (m/e) of the positive Electrospray-
Ionization-Time-Of-Flight-Mass-Spectroscopy (ESITOFMS) of
sample #4.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.9747 | 40.97936 | 0.005 |
| K₂OH | 95 | 94.9487 | 94.930155 | 0.019 |
| KHKOH₂ | 97 | 96.9459 | 96.945805 | 0.000 |
| IOH | 144 | 143.9205 | 143.903135 | 0.017 |
| IO₂H₂ | 161 | 160.9198 | 160.90587 | 0.014 |
| KIH₂ | 168 | 167.9368 | 167.87976 | 0.057 |
| K(KIO)KH | 261 | 260.8203 | 260.794265 | 0.026 |

$\begin{matrix}{}^{a} Interference of {}_{}^{39}{KH}{}_{2}^{+} from {}^{41} K was eliminated by comparing the \\ {}^{41} K \text{/} {}^{39} K ratio with the natural abundance ratio \\ ( obs . = 22 \% , nat . ab . ratio = \frac{6.88}{93.1} = 7.4 \% ) .\end{matrix}$

The results for the positive Electrospray-Ionization-Time-Of-Flight-Mass-Spectroscopy (ESITOFMS) sample #4 that appear in TABLE 41 were representative of the results obtained for sample #5.

The ESITOFMS spectra of experimental samples had a greater intensity potassium peak per weight than the starting material control samples. The increased weight percentage potassium is assigned to potassium hydrino hydride compound KHₙ n=1 to 5 (weight % K>88%) as a major component of the sample. The ⁴¹K peak of each ESITOFMS spectrum of an experimental sample was much greater than predicted from natural isotopic abundance. The inorganic m/e=41 peak was assigned to KH₂⁺. The ESITOFMS spectrum was obtained for a potassium carbonate control and a potassium iodide control where each was run at 10 times the weight of material as the experimental samples. The spectra showed the normal ⁴¹K/³⁹K ratio. Thus, saturation of the detector did not occur. As further confirmation the spectra were repeated with mass chromatograms on a series of dilutions (10×, 10×, and 1000×) of each experimental and control sample. The ⁴¹K/³⁹K ratio was constant as a function of dilution. The correspondence between ESITOFMS sample # (TABLE #) and the TOFSIMS sample # (TABLE #) appear in TABLE 42.

TABLE 42
The correspondence between ESITOFMS sample # (TABLE #)
and the TOFSIMS sample # (TABLE #).

| ESITOFMS | ESITOFMS | TOFSIMS | TOFSIMS |
|---|---|---|---|
| Sample # | TABLE # | Sample # | TABLE # |
| 2 | 39 & 40 | 1 | 13 & 14 |
| 3 | 39 & 40 | 8 | 22 & 23 |
| 4 | 41 | 9 | 24 & 25 |
| 5 | 41 | 10 | 26 & 27 |

Hydrino hydride compounds were identified by both techniques. ESITOFMS and TOFSIMS confirm and complement each other and taken together provide redoubtable support of hydrino hydride compounds as assigned herein such as KHₙ.

### 13.12 Identification of Hydrino Hydride Compounds by Thermogravimetric Analysis and Differential Thermal Analysis (TGA/DTA).

### Thermogravimetric Analysis

Thermogravimetric analysis is a method which determines the dynamic relationship between temperature and mass of a sample. The mass of the sample is recorded continuously as its temperature is linearly increased from ambient to a high temperature (e.g. 1000° C.). The resulting thermogram provides both qualitative and quantitative information. The derivative curve of the thermogram (derivative thermal analysis) gives additional information that is not detected in the thermogram by improving the sensitivity. Each compound has a unique thermogram and derivative curve. Novel rates of weight change as a function of time with a temperature ramp as compared to the control are signatures for increased binding energy hydrogen compounds.

### Differential Thermal Analysis

Differential thermal analysis is a method where the heat absorbed or emitted by a chemical system is observed by measuring the temperature difference between that system and an inert reference compound as the temperatures of both are increased at a constant rate. The plot obtained between the temperature/time and the difference temperature is called a differential thermogram. Various exothermic and endothermic processes can be inferred from the differential thermogram, and this can be used as a finger print of the compound under study. Differential thermal analysis can also be used to determine the purity of a compound (i.e. whether a mixture of compounds is present in the sample)

### 13.12.1 Sample Collection and Preparation

A reaction for preparing hydrino hydride ion-containing compounds is given by Eq. (8). Hydrino atoms which react to form hydrino hydride ions may be produced by a K₂CO₃ electrolytic cell hydride reactor which was used to prepare crystal samples for TGA/DTA. The hydrino hydride compounds were purified from solution wherein the K₂CO₃ electrolyte was acidified with HNO₃ before crystals were precipitated on a crystallization dish.

Sample #1. A reference comprised 99.999% KNO₃.

Sample #2. The sample was prepared by acidifying the K₂CO₃ electrolyte from the BLP Electrolytic Cell with HNO₃, and concentrating the acidified solution until yellow-white crystals formed on standing at room temperature. XPS (XPS sample #5), mass spectroscopy of a similar sample (mass spectroscopy electrolytic cell sample #3), TOFSIMS (TOFSIMS sample #6), and TGA/DTA (TGA/DTA sample #2) was also performed.

### 13.12.2 Thermal Gravimetric Analysis (TGA) and Differential Thermal Analysis (DTA)

Experimental and control samples were analyzed blindly by TA Instruments, New castle, DE. The instrument was a 2050TGA, V 5.3 B.

The module was a TGA 1000° C. A platinum pan was used to handle each sample of size 3.5-3.75 g. The method was TG-MS. The heating rate was 10° C./min. The carrier gas to the mass spectrometer (MS) was nitrogen gas at a rate of 100 ml/min. The sampling rate was 2.0 sec/pt.

### 13.12.3 Results and Discussion.

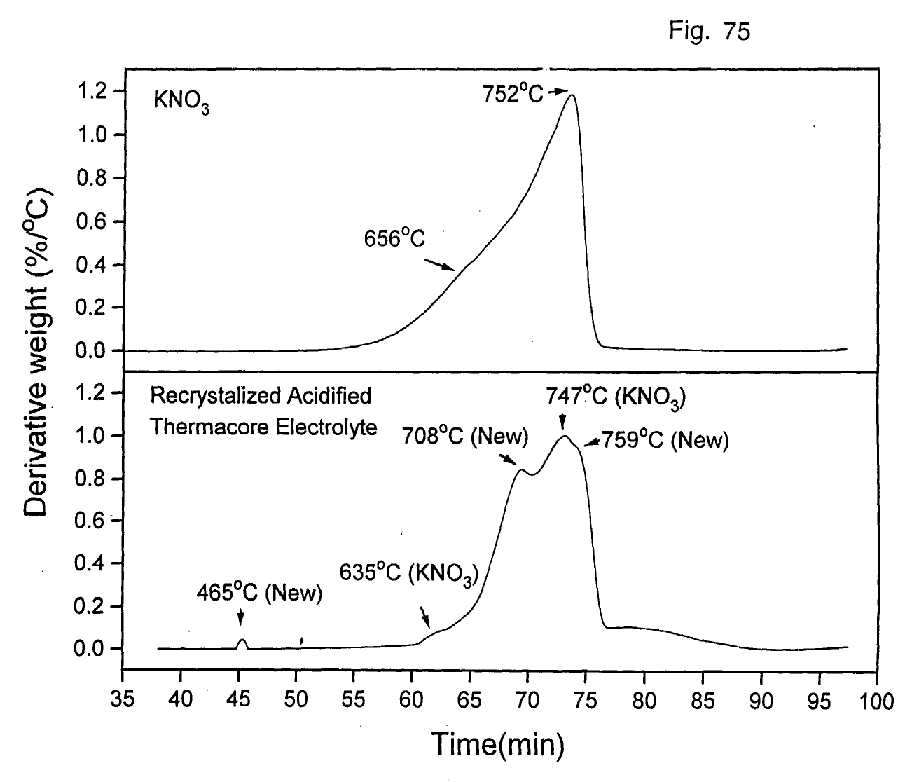

The stacked TGA results of 1.) the reference comprising 99.999% KNO₃ (TGA/DTA sample #1) 2.) crystals from the yellow-white crystals that formed on the outer edge of a crystallization dish from the acidified electrolyte of the K₂CO₃ Thermacore Electrolytic Cell (TGA/DTA sample #2) are shown in FIG. 75. The identifiable peaks of each TGA run are indicated. For the control, features were observed at 656° C. (65 mins.) and 752° C. (72.5 mins.). These feature were also observed for sample #2. In addition, sample #2 contained novel features at 465° C. (45.5 mins.), 708° C. (68 mins.), and 759° C. (75 mins.) which are indicated in FIG. 75.

The stacked DTA results of 1.) the reference (TGA/DTA sample #1)

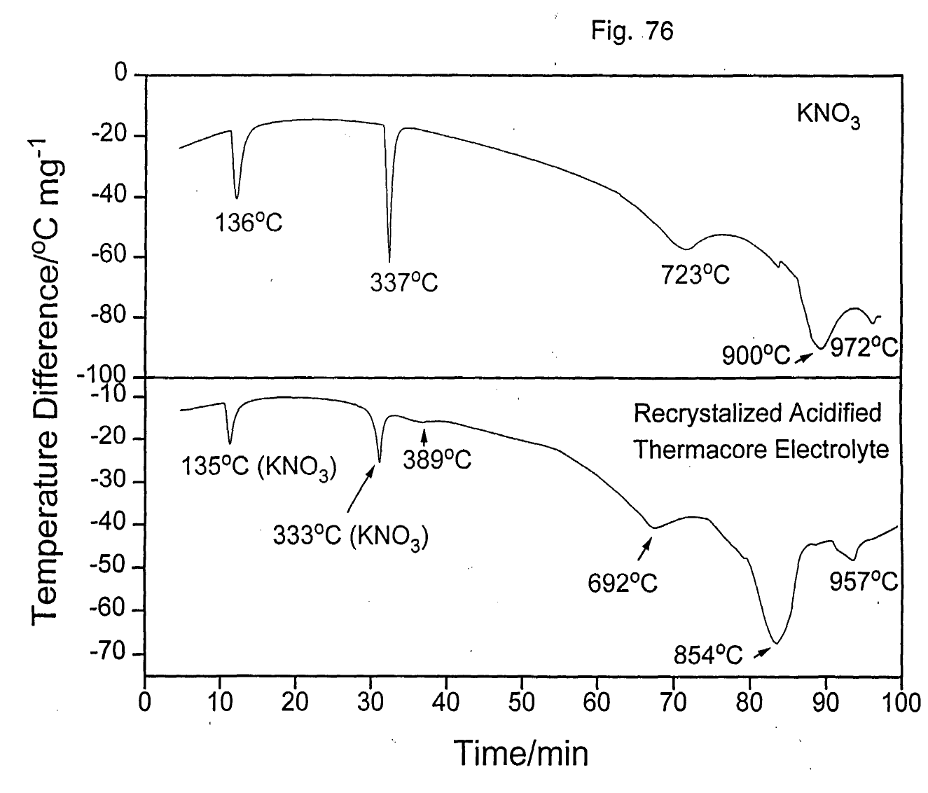

2.) TGA/DTA sample #2 are shown in FIG. 76. The identifiable peaks of each DTA run are indicated. For the control, features were observed at 136° C., 337 CC, 723° C., 900° C., and 972 CC. The 136° C. and 337 CC features were also observed for sample #2. However, for temperatures above 333 CC, a novel differential thermogram was observed for sample #2. Novel features appeared at 692 CC, 854° C., and 957 CC which are indicated in FIG. 76.

The novel TGA and DTA peaks without identifying assignment correspond to and identify hydrino hydride compounds, according to the present invention.

### 13.13 Identification of Hydrino Hydride Compounds by ³⁹K Nuclear Magnetic Resonance (NMR) Spectroscopy

³⁹K NMR can distinguish whether a new potassium compound is present as a component of a mixture with a known compound based on a different chemical shift of the new compound relative to that of the known. In the event that ³⁹K exchange occurs, a chemical shift of the ³⁹K NMR peak will be observed which is intermediate between that of the standard and the compound of interest. Hydrino hydride compounds have been observed by methods such as XPS, mass spectroscopy, and TOFSIMS as described in the corresponding sections. In the case of the electrolytic cell, the electrolyte was pure K₂CO₃. Thus, the possibility of using ³⁹K NMR was explored to identify potassium hydrino hydride formed during the operation of the electrolytic hydrino hydride reactor. Identification was based on a ³⁹K NMR chemical shift relative to that of the starting material K₂CO₃.

### 13.13.1 Sample Collection and Preparation

A reaction for preparing potassium hydrino hydride ion containing compounds is given by Eqs. (3-5) and Eq. (8). Hydrino atoms which react to form hydrino hydride ions may be produced by an K₂CO₃ electrolytic cell hydride reactor which was used to prepare crystal samples for ³⁹K NMR spectroscopy. The hydrino hydride compounds were collected directly.

Sample #1. The sample was prepared by concentrating 300 cc of the K₂CO₃ electrolyte from the BLP Electrolytic Cell using a rotary evaporator at 50° C. until a precipitate just formed. The volume was about 50 cc. Additional electrolyte was added while heating at 50° C. until the crystals disappeared. Crystals were then grown over three weeks by allowing the saturated solution to stand in a sealed round bottom flask for three weeks at 25° C. The yield was 1 g. XPS (XPS sample #7), TOFSIMS (TOFSIMS sample #8), Raman spectroscopy (Raman sample #4), and ESITOFMS (ESITOFMS sample #3) were also obtained.

Sample #2. A reference comprised 99.999% K₂CO₃.

### 13.13.2 ³⁹K Nuclear Magnetic Resonance (NMR) Spectroscopy

Samples were sent to Spectral Data Services, Champaign, Ill. ³⁹K NMR was performed in D₂O solution on a Tecmag 360-1 instrument. Final pulse generation was from a ATM amplifier. The ³⁹K NMR frequency was 16.9543 MHz. A 35 μsec pulse corresponding to a 45° pulse length and a 1 second recycle delay were used. The window was ±1 kHz. The number of scans was 100. Chemical shifts were referenced to KBr(D₂) at 0.00 ppm. The offset was −150.4 Hz.

### 13.13.3 Results and Discussion

A single intense ³⁹K NMR peak was observed in the spectra of sample #1 and sample #2. The results are given in TABLE 43 with peak assignments. A ³⁹K NMR chemical shift was observed for sample #1 relative to the starting material, sample #2 which was significant compared to typical ³⁹K NMR chemical shifts. The presence of one peak in the spectrum of sample #1 indicates that exchange occurred. To provide the observed peak shift, a new potassium compound was present. The ³⁹K NMR chemical shift corresponds to and identifies potassium hydrino hydride, according to the present invention. The assignment of potassium hydrino hydride compounds was confirmed by XPS (XPS sample #7), TOFSIMS (TOFSIMS sample #8), Raman spectroscopy (Raman sample #4), mass spectroscopy (FIG. 63), and ESITOFMS (ESITOFMS sample #3) described in the corresponding sections.

TABLE 43
The ³⁹K NMR peaks of sample #1 and #2 with their
assignments.

| Sample | Shift | |
|---|---|---|
| Number | (ppm) | Assignment |
| 1 | −0.80 | K₂CO₃ shifted by |
| | | potassium hydrino |
| | | hydride compound |
| 2 | +1.24 | K₂CO₃ |

1-4. (canceled)

5. A reactor for preparing hydride compounds, said compounds comprising:
a) at least one neutral (Hₙ), positive (Hₙ⁺), or negative (Hₙ⁻) hydrogen species wherein n is an integer from 1 to 4; and
b) at least one other element, said reactor comprising:
i) a vessel;
ii) a means for supplying a source of atomic hydrogen;
iii) a container for containing at least one catalyst;
iv) at least one other element; and
v) optionally an electron source,
wherein reaction between atomic hydrogen and the at least one catalyst has an enthalpy of reaction of about m(27.2 eV), wherein m is an integer.

6. The reactor according to claim 5, wherein the at least one catalyst comprises potassium, rubidium, or titanium ions.

7. The reactor according to claim 6, wherein the at least one catalyst is chosen from RbF, RbCl, RbBr, RbI, Rb₂S₂, RbOH, Rb₂SO₄, Rb₂CO₃, Rb₃PO₄, KF, KCl, KBr, KI, K₂S₂, KOH, K₂SO₄, K₂CO₃, KNO₃, and K₃PO₄.

8. The reactor according to claim 5, further comprising a heater for heating the at least one catalyst, and a means for controlling and maintaining the temperature of the at least one catalyst.

9. The reactor according to claim 8, wherein said heater maintains the temperature of said vessel at about 50° C. above the melting point of the at least one catalyst, or about 50° C. above the melting point of the compound having the highest melting point of a plurality of compounds comprising said catalyst.

10. The reactor according to claim 5, wherein the source of atomic hydrogen comprises a source of UV light for disassociating hydrogen-containing molecules to form gaseous hydrogen atoms.

11. The reactor according to claim 5, wherein the source of atomic hydrogen comprises a means for pyrolysis of hydrocarbons or water to form gaseous hydrogen atoms.

12. The reactor according to claim 5, further comprising a second catalyst for disassociating molecular hydrogen into atomic hydrogen.

13. The reactor according to claim 5, wherein the at least one other element comprises at least one of: a hydrogen atom or hydrogen molecule; an organic molecule or an inorganic compound; a metal or metal ion; an anion chosen from halogen, hydroxide, hydrogen carbonate, carbonate, nitrate, sulfate, hydrogen phosphate, and phosphate ions; a dopant or dopant component; or a semiconductor.

14. The reactor according to claim 5, wherein said vessel is capable of containing pressures less than atmospheric, pressures greater than atmospheric, or both.

15. The reactor according to claim 14, wherein said vessel comprises stainless steel, molybdenum, tungsten, quartz, or a combination thereof.

16. The reactor according to claim 5, further comprising a temperature controlling structure for controlling the temperature of said vessel, wherein the temperature controlling structure is chosen from an internal heater, an external heater, a heat exchanger, and a combination thereof.

17. The reactor according to claim 5, further comprising a cathode, an anode, and a power supply for providing current to said cathode and anode.

18. The reactor according to claim 17, further comprising a current control structure to control said current.

19. The reactor according to claim 18, wherein the cathode comprises at least one chosen from nickel, titanium, iron, and graphite.

20. The reactor according to claim 17, wherein the anode comprises at least one chosen from nickel, platinized titanium, and platinum.

21. The reactor according to claim 17, wherein at least one of said cathode and anode is coated with a source of the at least one catalyst.

22. The reactor according to claim 21, wherein the cathode is coated with RbI or KI.

23. The reactor according to claim 17, wherein said vessel comprises a gas-filled vacuum chamber.

24. The reactor according to claim 23, wherein the source of atomic hydrogen comprises a hydrogen-containing gas stream and a hot filament or a heated capillary.

25. The reactor according to claim 24, wherein the heated capillary comprises tungsten.

26. The reactor according to claim 5, further comprising a pressure sensor and means for controlling pressure in said reactor.

27. The reactor according to claim 26, wherein the pressure in said vessel is maintained in the range of 10 millitorr to 100 torr.

28. The reactor according to claim 27, further comprising a power supply for supplying an electric current to the at least one catalyst to vaporize said catalyst.

29. The reactor according to claim 26, wherein said reactor comprises an electrolytic cell with an electrolyte in contact with said cathode and anode.

30. The reactor according to claim 29, wherein the electrolyte comprises aqueous K₂CO₃.

31. The reactor according to claim 29, wherein the at least one catalyst comprises Rb⁺, Mo²⁺, K⁺, or Ti²⁺ in solution.

32. The reactor according to claim 5, wherein said reactor comprises a hydrogen plasma torch cell comprising a plasma torch with source of plasma gas, and a manifold to encompass a plasma produced by said torch.

33. The reactor according to claim 32, wherein said plasma gas comprises argon.

34. The reactor according to claim 32, further comprising a microwave generator for powering said plasma.

35. The reactor according to claim 32, further comprising a gas supply line and means to control a flow of hydrogen gas to said plasma torch, and/or a means to control the amount of catalyst supplied to said plasma torch.

36. The reactor according to claim 35, further comprising a catalyst reservoir connected to the plasma torch through said supply line.

37. The reactor according to claim 36, wherein said catalyst reservoir further comprises a heater.

38. The reactor according to claim 32, further comprising a catalyst boat located in the manifold to contain said source of catalyst.

39. The reactor according to claim 38, wherein said catalyst boat comprises a ceramic material.

40. The reactor according to claim 38, further comprising a heater for heating said catalyst boat.

41. The reactor according to claim 32, further comprising an aspirator, atomizer, or nebulizer constructed and arranged to form an aerosol of said catalyst in a carrier gas.

42. The reactor according to claim 32, further comprising a cryogenic trap to collect products of said reaction between atomic hydrogen and the at least one catalyst.
